(19) United States
(12) Patent Application Publication
(10) Pub. No.: US 2024/0345496 A1
(43) Pub. Date: Oct. 17, 2024

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: AKIHIRO MARUYAMA, Shizuoka (JP); MICHIYO SEKIYA, Shizuoka (JP); MASASHI NISHI, Kanagawa (JP); NANAMI KATO, Shizuoka (JP); TOMOHITO ISHIDA, Shizuoka (JP); TSUTOMU NISHIDA, Shizuoka (JP)

(21) Appl. No.: 18/609,744

(22) Filed: Mar. 19, 2024

(30) Foreign Application Priority Data
Apr. 13, 2023 (JP) 2023-065927

(51) Int. Cl. G03G 5/05; G03G 5/047; G03G 5/06; G03G 21/18

(52) U.S. Cl. CPC G03G 5/0592; G03G 5/047; G03G 5/0535; G03G 5/0696; G03G 21/1842; G03G 2221/183

(57) ABSTRACT

Provided is an electrophotographic photosensitive member including in this order: a support; an undercoat layer, and a photosensitive layer, wherein the undercoat layer comprises at least one kind of polymer selected from the group consisting of: a polymer having a structural unit represented by the following formula (1); and a polymer having a structural unit represented by the following formula (2).

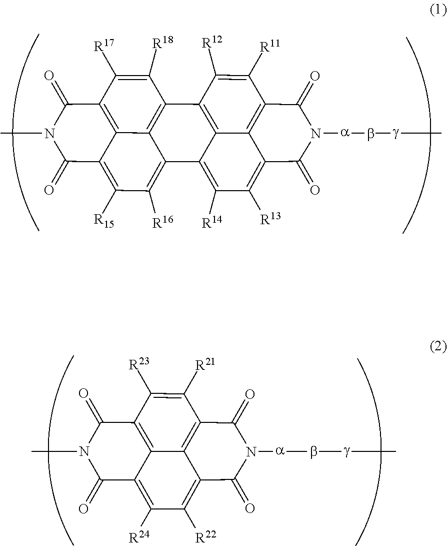

### BACKGROUND OF THE INVENTION

### Field of the Invention

The present invention relates to an electrophotographic photosensitive member, a process cartridge, and an electrophotographic apparatus.

### Description of the Related Art

In recent years, an electrophotographic apparatus that can form an image having higher quality has been required, and the provision of such an apparatus that the stability of the quality of an image to be output at the time of its repeated use is high has been desired.

In an electrophotographic photosensitive member to be used in an electrophotographic process, there is known a technology involving arranging an undercoat layer containing an electron transporting substance between a support and a photosensitive layer for the purpose of suppressing charge injection from the support side to the photosensitive layer side to suppress the occurrence of an image failure such as a black spot.

In Japanese Patent Application Laid-Open No. 2014-029479, there is a description of an undercoat layer containing a cured product of a composition containing: an electron transporting substance having a polymerizable functional group; a crosslinking agent; and a resin. In addition, in Japanese Patent Application Laid-Open No. H11-228675, there is a description of an intermediate layer containing a polymer obtained by polymerizing a diphenoquinone derivative. In addition, in Japanese Patent Application Laid-Open No. 2012-032458, there is a description of an aqueous coating liquid for forming an intermediate layer, the coating liquid containing a composition containing: an electron transporting substance having a carboxyl group; a dispersant; and a resin.

In recent years, the electrophotographic process has been required to achieve mass printing and high-speed printing. Through an investigation made by the inventors of the present invention, it has been found that in an electrophotographic photosensitive member described in each of Japanese Patent Application Laid-Open No. 2014-029479, Japanese Patent Application Laid-Open No. H11-228675, and Japanese Patent Application Laid-Open No. 2012-032458, when the mass printing and the high-speed printing are performed, a potential fluctuation may become larger.

### SUMMARY OF THE INVENTION

Accordingly, an object of the present invention is to provide an electrophotographic photosensitive member that can suppress a potential fluctuation.

The above-mentioned object is achieved by the present invention described below. That is, according to the present invention, there is provided an electrophotographic photosensitive member including in this order: a support; an undercoat layer; and a photosensitive layer, wherein the undercoat layer comprises at least one kind of polymer selected from the group consisting of: a polymer having a structural unit represented by the following formula (1); and a polymer having a structural unit represented by the following formula (2):

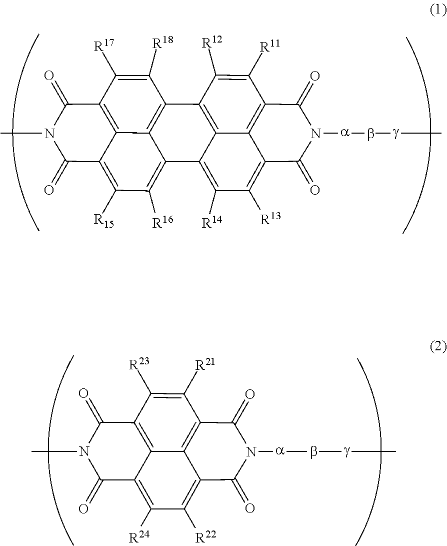

in the formulae (1) and (2), α, β, and γ represent structures represented by the following formulae (α), (β), and (γ), respectively, and R¹¹, R¹², R¹³, R¹⁴, R¹⁵, R¹⁶, R¹⁷, R¹⁸, R²¹, R²², R²³, and R²⁴ each independently represent a hydrogen atom, a halogen atom, a nitro group, a cyano group, a trifluoromethyl group, a substituted or unsubstituted alkoxy group, a substituted or unsubstituted thiol group, a substituted or unsubstituted amino group, a substituted or unsubstituted alkyl group, a substituted or unsubstituted alkynyl group, or a substituted or unsubstituted aryl group:

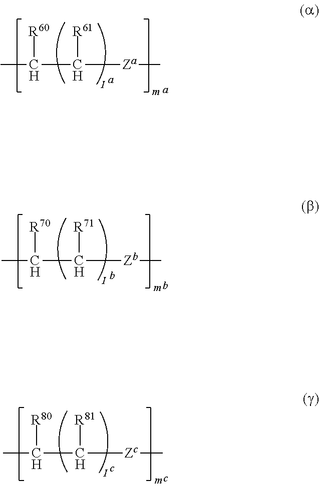

in the formulae (α), (β), and (γ), R⁶⁰, R⁶¹, R⁷⁰, R⁷¹, R⁸⁰, and R⁸¹ each independently represent a hydrogen atom, a substituted or unsubstituted alkyl group, or a substituted or unsubstituted aryl group, Z^{a}, Z^{b}, and Z^{c} each independently represent a single bond, an imino group, an oxygen atom, or a sulfur atom, 1^{a}, 1^{b}, and 1^{c} each independently represent an integer of 0 or more, m^{a} represents an integer of 1 or more, m^{b} and m^{c} each independently represent an integer of 0 or more, when Z^{a} represents a single bond, R⁶⁰ represents a substituted or unsubstituted alkyl group, when Z^{a} represents an imino group or a sulfur atom, R⁶⁰ represents a hydrogen atom, or a substituted or unsubstituted alkyl group, when Z^{a} represents an oxygen atom, and R⁶⁰ represents a hydrogen atom, m^{a} represents an integer of 2 or more, and when Z^{a} represents an oxygen atom, and R⁶⁰ represents a substituted or unsubstituted alkyl group, m^{a} represents an integer of 1 or more.

Further features of the present invention will become apparent from the following description of exemplary embodiments with reference to the attached drawings.

### BRIEF DESCRIPTION OF THE DRAWINGS

FIG. 1 is a view for illustrating an example of the layer configuration of an electrophotographic photosensitive member according to the present invention.

FIG. 2 is a view for illustrating an example of the schematic configuration of an electrophotographic apparatus including a process cartridge including the electrophotographic photosensitive member according to the present invention.

### DESCRIPTION OF THE EMBODIMENTS

The present invention is described in detail below by way of exemplary embodiments.

A possible cause for the fact that when mass printing and high-speed printing are performed, a potential fluctuation may become larger in a related-art electrophotographic photosensitive member is as described below.

To correspond to the mass printing and the high-speed printing, the electrophotographic photosensitive member is required to have high sensitivity and high durability. In view of the foregoing, a substance having higher sensitivity has been used as a charge generating substance to be incorporated into the electrophotographic photosensitive member.

In addition, along with an improvement in sensitivity of the charge generating substance, the amount of charge to be generated increases. However, the related-art electrophotographic photosensitive member does not have a sufficient electron conveying ability, and hence when an image is repeatedly output, the charge may remain in an exposed portion in its photosensitive layer to cause the potential fluctuation. When the potential fluctuation becomes larger in the exposed portion of the electrophotographic photosensitive member, the density of the image after repeated use of the photosensitive member becomes lower than that at the initial stage, and hence the quality of the image reduces.

The inventors of the present invention have considered incorporating a perylene imide and a naphthalene imide having high π-conjugation properties at high concentrations for the purpose of an improvement in electron mobility toward the suppression of the potential fluctuation. However, a sufficient improvement in electron mobility is not achieved merely by forming a film containing high concentrations of the perylene imide and the naphthalene imide in some cases. A factor therefor is, for example, the rigid planar structure of each of the perylene imide and the naphthalene imide. Each of the perylene imide and the naphthalene imide has a rigid planar structure, and hence its molecules are liable to stack densely. The stacked molecules form an aggregated moiety in the film to be nonuniformly distributed. The foregoing may serve as an inhibiting factor for the improvement in electron mobility.

In view of the foregoing, the inventors of the present invention have made further investigations, and have found that the above-mentioned problem can be solved by using a polymer having a specific film forming unit as an electron transporting substance in addition to the perylene imide and the naphthalene imide. That is, the use of the above-mentioned polymer as an electron transporting substance was able to cause the perylene imide and the naphthalene imide to exist in the film with a proper distance therebetween, and was hence able to suppress the formation of the aggregated moiety. In addition, the use of the above-mentioned polymer as an electron transporting substance showed an improvement in electron mobility. The inventors of the present invention have achieved the suppression of the potential fluctuation via the foregoing mechanism.

Specifically, there is used an undercoat layer containing, as an electron transporting substance, at least one kind of polymer selected from the group consisting of: a polymer having a repeating structural unit represented by the formula (1) to be described later; and a polymer having a repeating structural unit represented by the formula (2) to be described later. The inventors of the present invention have found that problems in the related art can be solved by using an electrophotographic photosensitive member including the undercoat layer.

The configuration of the electrophotographic photosensitive member according to the present invention is described in detail below.

### [Electrophotographic Photosensitive Member]

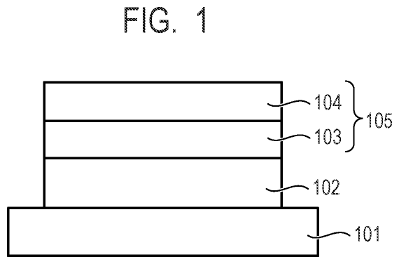

An electrophotographic photosensitive member according to the present invention includes a support, an undercoat layer, and a photosensitive layer in the stated order. FIG. 1 is a view for illustrating an example of the layer configuration of the electrophotographic photosensitive member. In the layer configuration illustrated in FIG. 1, an undercoat layer 102, and a photosensitive layer (laminate type photosensitive layer) 105 formed of a charge generating layer 103 and a charge transporting layer 104 are laminated in the stated order on a support 101.

A method of producing the electrophotographic photosensitive member according to the present invention is, for example, a method involving: preparing coating liquids for the respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

A support and the respective layers are described below.

### <Support>

In the present invention, the electrophotographic photosensitive member includes the support. In the present invention, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Electroconductive Layer>

In the present invention, an electroconductive layer may be arranged on the support. The arrangement of the electroconductive layer can conceal a flaw and unevenness on the surface of the support, and can control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles. In particular, titanium oxide, tin oxide, or zinc oxide is more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each have a laminated configuration including a core particle and a covering layer covering the core particle. A material for the core particle is, for example, titanium oxide, barium sulfate, or zinc oxide. A material for the covering layer is, for example, a metal oxide such as tin oxide.

In addition, when the metal oxide is used as the electroconductive particles, the volume-average particle diameter of the particles is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The thickness of the electroconductive layer is preferably 1 to 50 μm, particularly preferably 3 to 40 μm.

The electroconductive layer may be formed by: preparing a coating liquid for an electroconductive layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent. A dispersion method for the dispersion of the electroconductive particles in the coating liquid for an electroconductive layer is, for example, a method including using a paint shaker, a sand mill, a ball mill, or a liquid collision-type high-speed dispersing machine.

### <Undercoat Layer>

The electrophotographic photosensitive member according to the present invention includes the undercoat layer on the support or the electroconductive layer.

In the present invention, the undercoat layer is obtained by: forming a coating film of a coating liquid for an undercoat layer containing a specific polymer; and heating and drying the coating film. The specific polymer is at least one kind of polymer selected from the group consisting of: a polymer having a structural unit represented by the following formula (1); and a polymer having a structural unit represented by the following formula (2). A temperature at the time of the heat drying of the coating film is preferably a temperature of 50 to 200° C.

In the present invention, the undercoat layer contains, as an electron transporting substance, at least one kind of polymer selected from the group consisting of: a polymer having a structural unit represented by the following formula (1); and a polymer having a structural unit represented by the following formula (2):

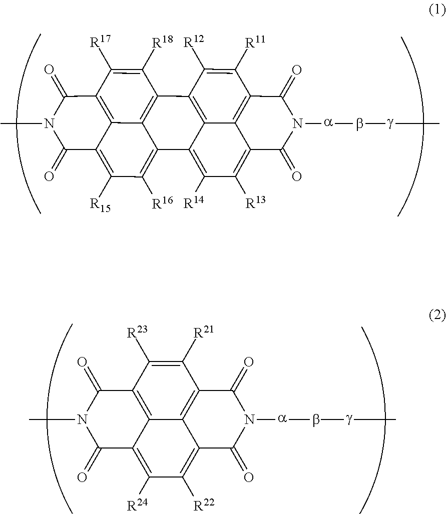

in the formulae (1) and (2),
α, β, and γ represent structures represented by the following formulae (α), (β), and (γ), respectively, and
R¹¹, R¹², R¹³, R¹⁴, R¹⁵, R¹⁶, R¹⁷, R¹⁸, R²¹, R²², R²³, and R²⁴ each independently represent a hydrogen atom, a halogen atom, a nitro group, a cyano group, a trifluoromethyl group, a substituted or unsubstituted alkoxy group, a substituted or unsubstituted thiol group, a substituted or unsubstituted amino group, a substituted or unsubstituted alkyl group, a substituted or unsubstituted alkynyl group, or a substituted or unsubstituted aryl group:

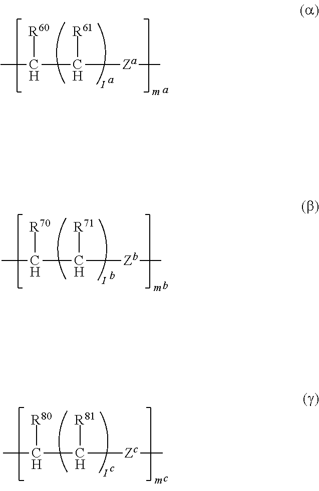

in the formulae (α), (β), and (γ),
R⁶⁰, R⁶¹, R⁷⁰, R⁷¹, R⁸⁰, and R⁸¹ each independently represent a hydrogen atom, a substituted or unsubstituted alkyl group, or a substituted or unsubstituted aryl group,
Z^{a}, Z^{b}, and Z^{c} each independently represent a single bond, an imino group, an oxygen atom, or a sulfur atom,
1^{a}, 1^{b}, and 1^{c} each independently represent an integer of 0 or more,
m^{a} represents an integer of 1 or more,
m^{b} and m^{c} each independently represent an integer of 0 or more,
when Z^{a} represents a single bond, R⁶⁰ represents a substituted or unsubstituted alkyl group,
when Z^{a} represents an imino group or a sulfur atom, R⁶⁰ represents a hydrogen atom, or a substituted or unsubstituted alkyl group,
when Z^{a} represents an oxygen atom, and R⁶⁰ represents a hydrogen atom, m^{a} represents an integer of 2 or more, and
when Z^{a} represents an oxygen atom, and R⁶⁰ represents a substituted or unsubstituted alkyl group, m^{a} represents an integer of 1 or more.

In each of the structural unit represented by the formula (1) and the structural unit represented by the formula (2), examples of the substituent of the substituted alkyl group include an aryl group, a halogen atom, a nitro group, and a cyano group.

In addition, examples of the substituent of the substituted aryl group include a halogen atom, a nitro group, a cyano group, a trifluoromethyl group, an alkyl group, a halogen-substituted alkyl group, and an alkoxy group.

In addition, examples of the substituent of the substituted alkoxy group include a halogen atom, a nitro group, a cyano group, a trifluoromethyl group, an alkyl group, a halogen-substituted alkyl group, and an alkoxy group.

In addition, examples of the substituent of the substituted thiol group include a halogen atom, a nitro group, a cyano group, a trifluoromethyl group, an alkyl group, a halogen-substituted alkyl group, and an alkoxy group.

In addition, examples of the substituent of the substituted amino group include a halogen atom, a nitro group, a cyano group, a trifluoromethyl group, an alkyl group, a halogen-substituted alkyl group, a hydroxyalkyl group, an aryl group, and an alkoxy group.

In addition, examples of the substituent of the substituted alkynyl group include a halogen atom, a nitro group, a cyano group, a trifluoromethyl group, an alkyl group, a halogen-substituted alkyl group, and an alkoxy group.

In each of the structural unit represented by the formula (1) and the structural unit represented by the formula (2), specific examples of the substituted or unsubstituted alkyl group include a methyl group, an ethyl group, a n-propyl group, an isopropyl group, a n-butyl group, an isobutyl group, a sec-butyl group, a tert-butyl group, a n-pentyl group, an isopentyl group, a neopentyl group, a tert-pentyl group, a cyclopentyl group, a n-hexyl group, a 1-methylpentyl group, a 4-methyl-2-pentyl group, a 3,3-dimethylbutyl group, a 2-ethylbutyl group, a cyclohexyl group, a hexyl group, an isohexyl group, a heptyl group, an octyl group, a nonyl group, a decyl group, an undecyl group, a dodecyl group, a tridecyl group, a tetradecyl group, a hexadecyl group, a heptadecyl group, an octadecyl group, a nonadecyl group, an icosyl group, a henicosyl group, a triacontyl group, a benzyl group, and a trityl group.

In addition, specific examples of the substituted or unsubstituted alkynyl group include an ethynyl group, a propynyl group, a butynyl group, a pentynyl group, a hexynyl group, a heptynyl group, and an octynyl group.

In addition, specific examples of the substituted or unsubstituted aryl group include a phenyl group, a biphenylyl group, a fluorenyl group, a 1-naphthyl group, a 2-naphthyl group, and a tolyl group.

In addition, specific examples of the substituted or unsubstituted alkoxy group include a methoxy group, an ethoxy group, a propoxy group, a tert-butoxy group, a phenoxy group, a pentyloxy group, a cyclohexyloxy group, a benzyloxy group, an allyloxy group, and a 1-naphthyloxy group.

In addition, specific examples of the substituted or unsubstituted thiol group include a thiol group (sulfanyl group), a methylthio group, an ethylthio group, a propylthio group, a butylthio group, a pentylthio group, a hexylthio group, a heptylthio group, an octylthio group, and a phenylthio group.

In addition, specific examples of the substituted or unsubstituted amino group include an amino group, a methylamino group, a dimethylamino group, a trimethylamino group, an ethylamino group, a diethylamino group, a propylamino group, an isopropylamino group, a butylamino group, a pentylamino group, a hexylamino group, a heptylamino group, an octylamino group, a phenylamino group, and a pyrrolidinyl group.

From the viewpoint of forming a uniform film state of a perylene imide and a naphthalene imide in the undercoat layer, and the viewpoint of improving an electron mobility in the layer, at least one of R¹¹, R¹², R¹³, R¹⁴, R¹⁵, R¹⁶, R¹⁷, and R¹⁸ in the formula (1), and at least one of R²¹, R²², R²³, and R²⁴ in the formula (2) each preferably represent a halogen atom, a nitro group, a cyano group, a trifluoromethyl group, a substituted or unsubstituted alkoxy group having 20 or less carbon atoms, a substituted or unsubstituted thiol group having 20 or less carbon atoms, a substituted or unsubstituted amino group having 20 or less carbon atoms, a substituted or unsubstituted alkyl group having 20 or less carbon atoms, a substituted or unsubstituted alkynyl group having 20 or less carbon atoms, or a substituted or unsubstituted aryl group having 20 or less carbon atoms.

In addition, from the viewpoint of forming the uniform film state of the perylene imide and the naphthalene imide in the undercoat layer, and the viewpoint of improving the electron mobility, at least one of R⁶⁰ and R⁶¹ in the formula (α), R⁷⁰ and R⁷¹ in the formula (β), and R⁸⁰ and R⁸¹ in the formula (γ) preferably represents a substituted or unsubstituted alkyl group having 20 or less carbon atoms, or a substituted or unsubstituted aryl group having 20 or less carbon atoms. Further, R⁶⁰ in the formula (α) more preferably represents a substituted or unsubstituted alkyl group having 20 or less carbon atoms.

In addition, from the viewpoint of forming the uniform film state of the perylene imide and the naphthalene imide in the undercoat layer, and the viewpoint of improving the electron mobility, it is preferred that 1ª in the formula (α), 1^{b} in the formula (β), and 1^{c} in the formula (γ) each independently represent an integer of 0 to 10.

In addition, from the viewpoint of forming the uniform film state of the perylene imide and the naphthalene imide in the undercoat layer, and the viewpoint of improving the electron mobility, it is preferred that m^{a} in the formula (α) represent an integer of 1 to 40, and m^{b} in the formula (β) and me in the formula (γ) each independently represent an integer of 0 to 40. In addition, it is more preferred that m^{a} in the formula (α) represent an integer of 2 to 30, and the sum of m^{a} in the formula (α), m^{b} in the formula (β), and m^{c} in the formula (γ) be 3 to 30.

Specific examples of the polymer having the structural unit represented by the formula (1) and the polymer having the structural unit represented by the formula (2) are shown below. In addition, detailed exemplified compounds (P-1) to (P-549) and (N-1) to (N-549) are shown in Tables 1 to 22. The abbreviation “(SB)” in each of Tables 1 to 22 represents a single bond, and a bonding site indicated by a broken line means a bonding site bonded to the main skeleton of a compound.

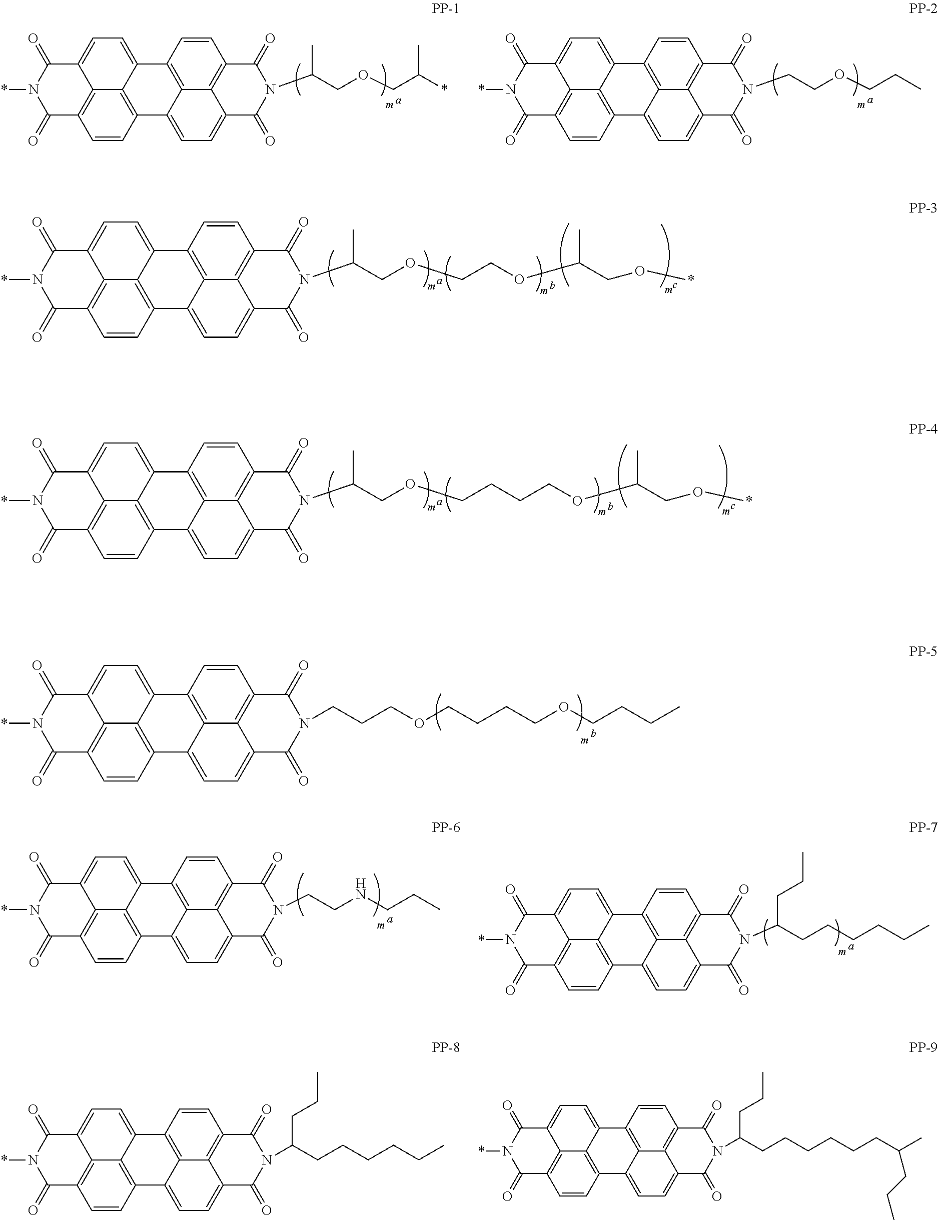

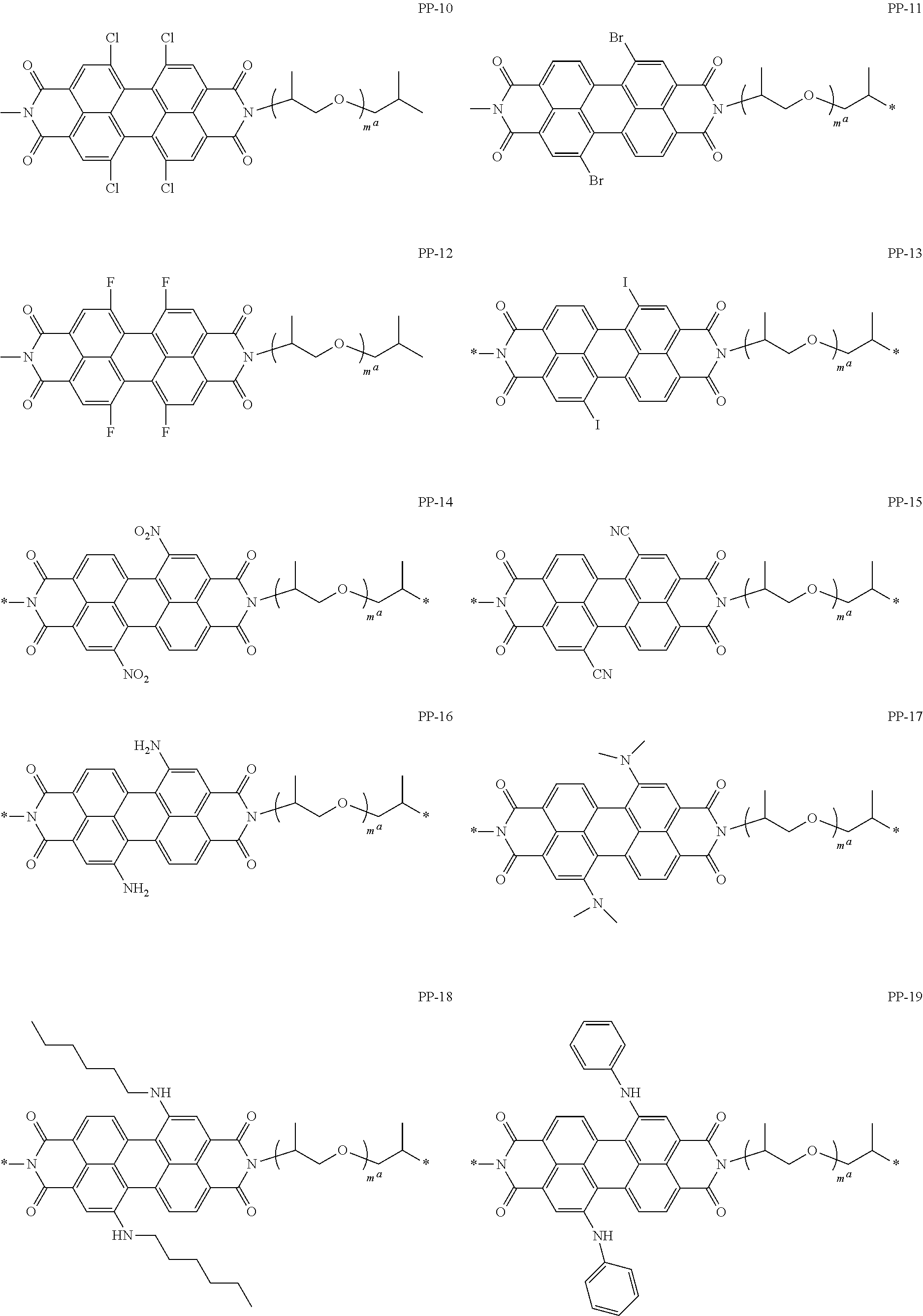

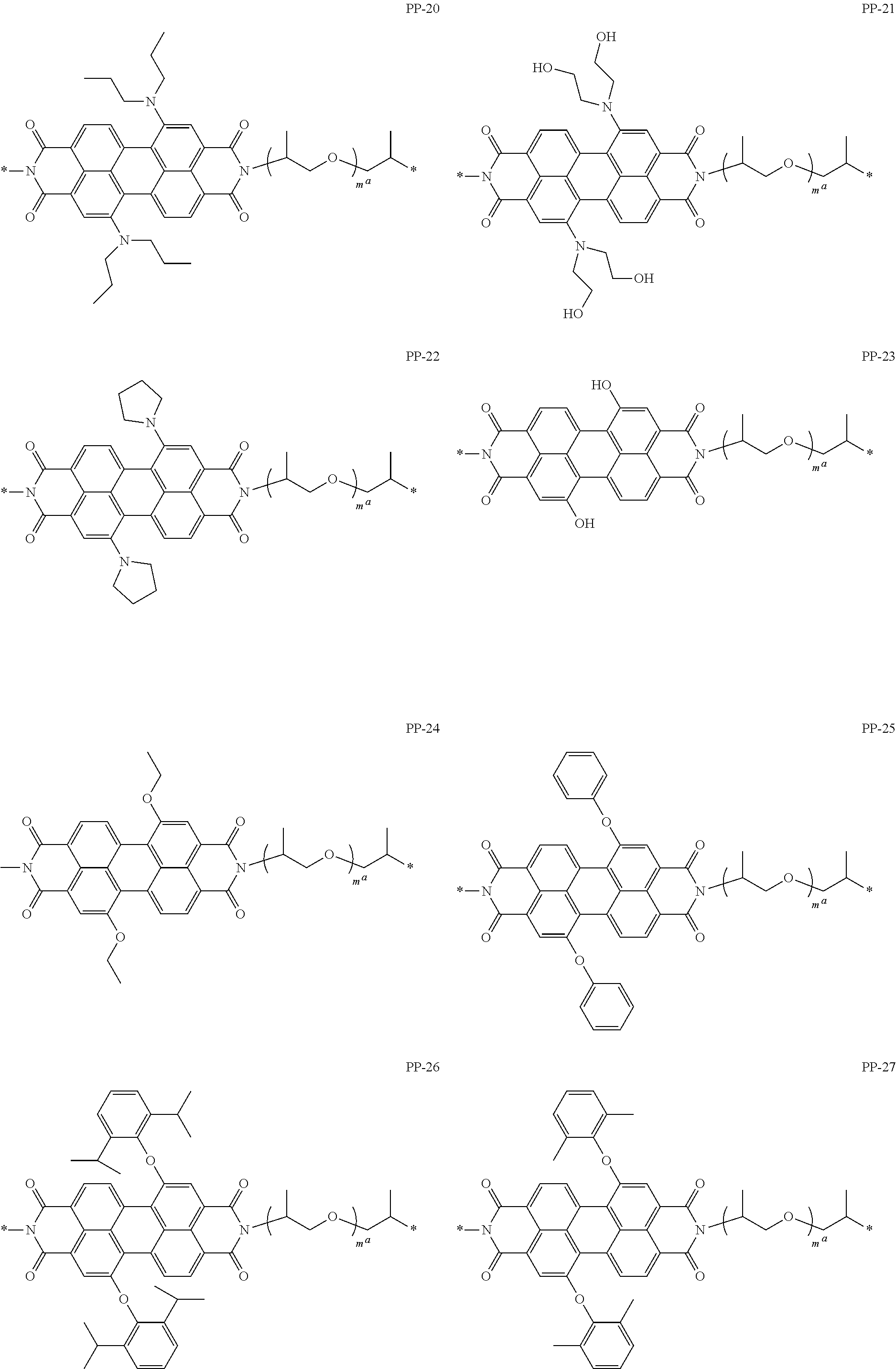

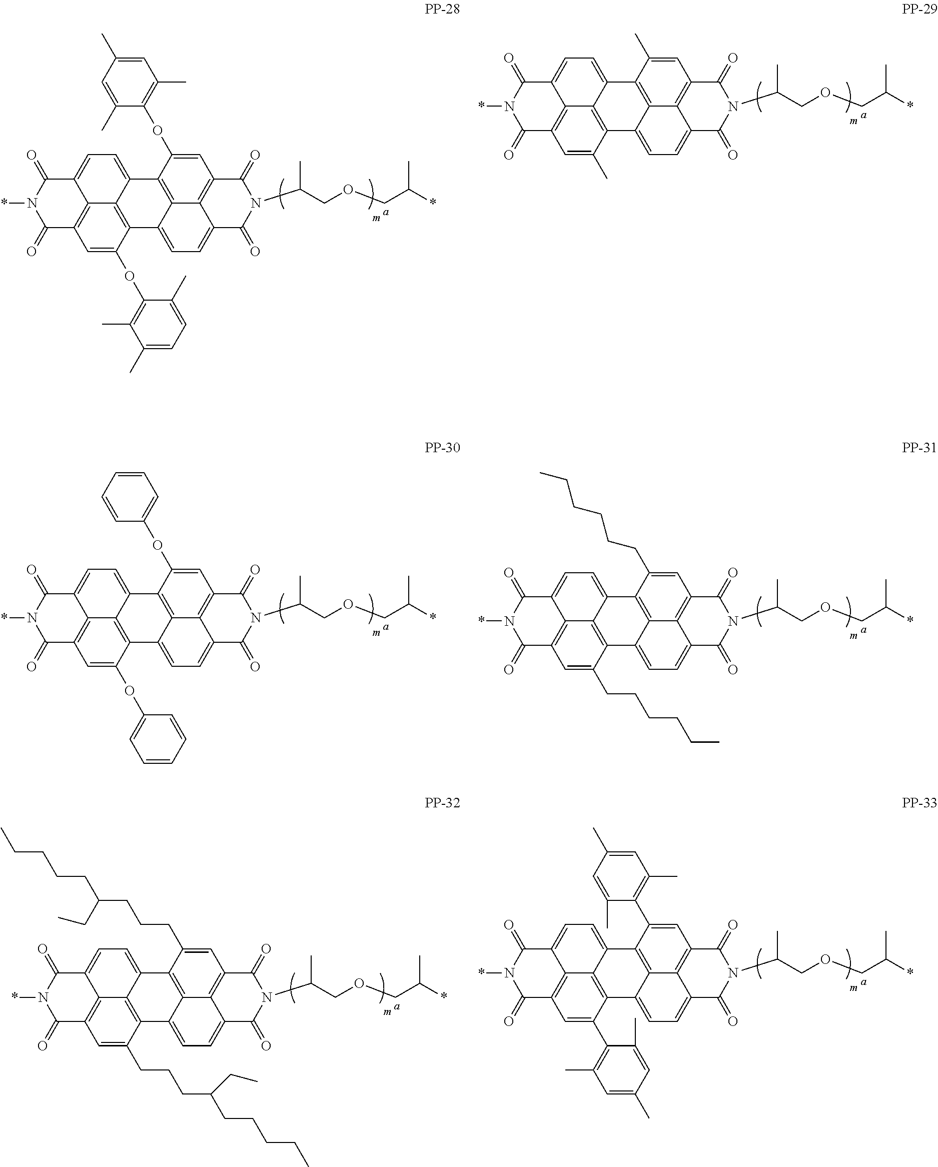

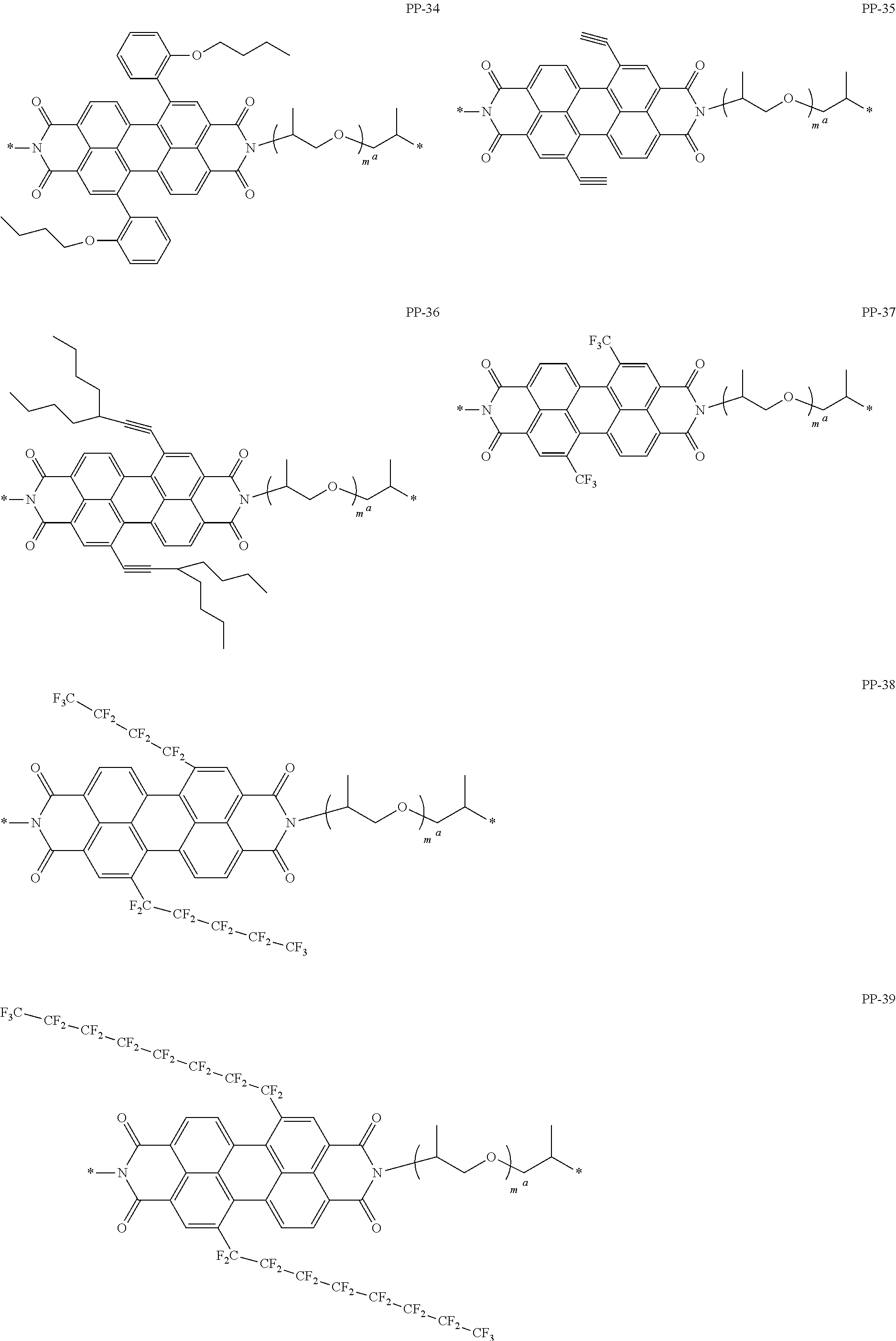

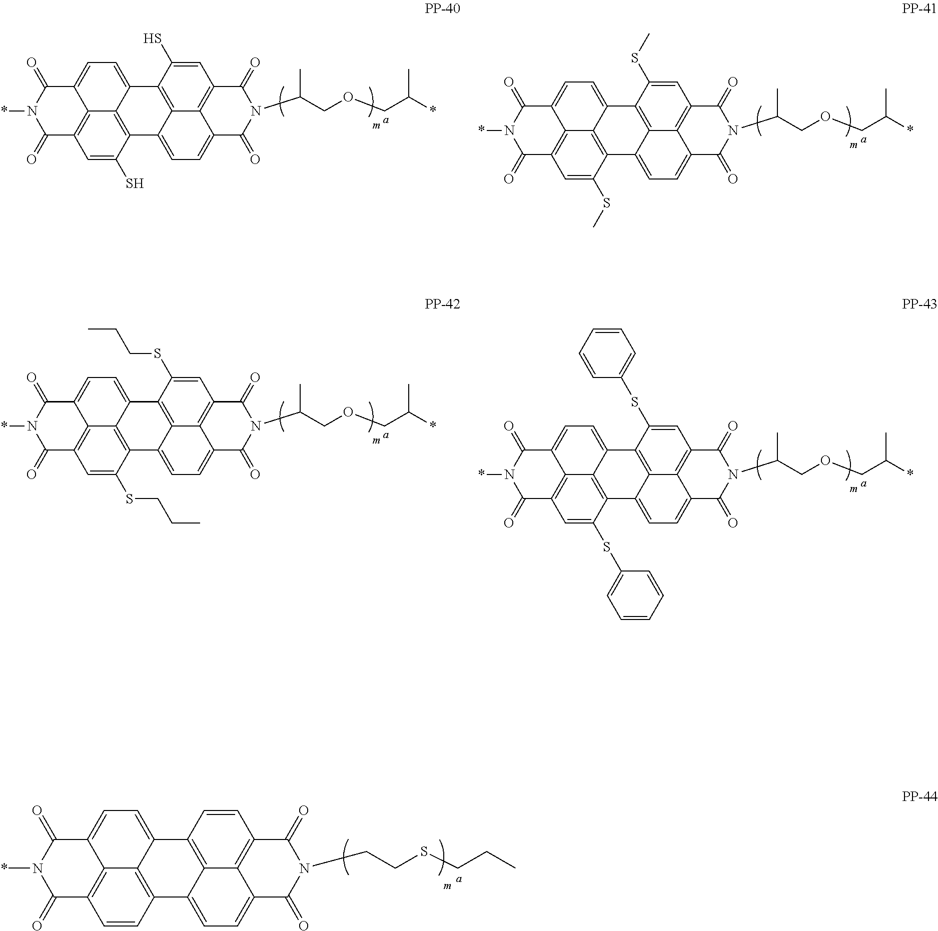

TABLE 1

| | | | | | | | | | α | | | |
|---|---|---|---|---|---|---|---|---|---|---|---|---|
| | R11 | R12 | R13 | R14 | R15 | R16 | R17 | R18 | R60 | R61 | Za | la |
| P-1 | —H | —H | —H | —H | —H | —H | —H | —H | —CH3 | —H | —O— | 1 |
| P-2 | —H | —H | —H | —H | —H | —H | —H | —H | —CH3 | —H | —O— | 1 |
| P-3 | —H | —H | —H | —H | —H | —H | —H | —H | —CH3 | —H | —O— | 1 |
| P-4 | —H | —H | —H | —H | —H | —H | —H | —H | —CH3 | —H | —O— | 1 |
| P-5 | —H | —H | —H | —H | —H | —H | —H | —H | —CH3 | —H | —O— | 1 |
| P-6 | —H | —H | —H | —H | —H | —H | —H | —H | —CH3 | —H | —O— | 1 |
| P-7 | —H | —H | —H | —H | —H | —H | —H | —H | —CH3 | —H | —O— | 1 |
| P-8 | —H | —H | —H | —H | —H | —H | —H | —H | —CH3 | —H | —O— | 1 |
| P-9 | —H | —H | —H | —H | —H | —H | —H | —H | —CH3 | —H | —O— | 1 |
| P-10 | —H | —H | —H | —H | —H | —H | —H | —H | —CH3 | —H | —O— | 1 |
| P-11 | —H | —H | —H | —H | —H | —H | —H | —H | —CH3 | —H | —O— | 1 |
| P-12 | —H | —H | —H | —H | —H | —H | —H | —H | —CH3 | —H | —O— | 1 |
| P-13 | —H | —H | —H | —H | —H | —H | —H | —H | —CH3 | —H | —O— | 1 |
| P-14 | —H | —H | —H | —H | —H | —H | —H | —H | —CH3 | —H | —O— | 1 |
| P-15 | —H | —H | —H | —H | —H | —H | —H | —H | —CH3 | —H | —O— | 1 |
| P-16 | —H | —H | —H | —H | —H | —H | —H | —H | —CH3 | —H | —O— | 1 |
| P-17 | —H | —H | —H | —H | —H | —H | —H | —H | —CH3 | —H | —O— | 1 |
| P-18 | —H | —H | —H | —H | —H | —H | —H | —H | —CH3 | —H | —O— | 1 |
| P-19 | —H | —H | —H | —H | —H | —H | —H | —H | —CH3 | —H | —O— | 1 |
| P-20 | —H | —H | —H | —H | —H | —H | —H | —H | —CH3 | —H | —O— | 1 |
| P-21 | —H | —H | —H | —H | —H | —H | —H | —H | —CH3 | —H | —O— | 1 |
| P-22 | —H | —H | —H | —H | —H | —H | —H | —H | —CH3 | —H | —O— | 1 |
| P-23 | —H | —H | —H | —H | —H | —H | —H | —H | —CH3 | —H | —O— | 1 |
| P-24 | —H | —H | —H | —H | —H | —H | —H | —H | —CH3 | —H | —O— | 1 |
| P-25 | —H | —H | —H | —H | —H | —H | —H | —H | —CH3 | —H | —O— | 1 |
| P-26 | —H | —H | —H | —H | —H | —H | —H | —H | —CH3 | —H | —O— | 1 |
| P-27 | —H | —H | —H | —H | —H | —H | —H | —H | —CH3 | —H | —O— | 1 |
| P-28 | —H | —H | —H | —H | —H | —H | —H | —H | —CH3 | —H | —O— | 1 |
| P-29 | —H | —H | —H | —H | —H | —H | —H | —H | —CH3 | —H | —O— | 1 |
| P-30 | —H | —H | —H | —H | —H | —H | —H | —H | —CH3 | —H | —O— | 1 |
| P-31 | —H | —Cl | —H | —Cl | —H | —Cl | —H | —Cl | —CH3 | —H | —O— | 1 |
| P-32 | —H | —Cl | —H | —Cl | —H | —Cl | —H | —Cl | —CH3 | —H | —O— | 1 |
| P-33 | —H | —Cl | —H | —Cl | —H | —Cl | —H | —Cl | —CH3 | —H | —O— | 1 |
| P-34 | —H | —Cl | —H | —Cl | —H | —Cl | —H | —Cl | —CH3 | —H | —O— | 1 |
| P-35 | —H | —Cl | —H | —Cl | —H | —Cl | —H | —Cl | —CH3 | —H | —O— | 1 |
| P-36 | —H | —Cl | —H | —Cl | —H | —Cl | —H | —Cl | —CH3 | —H | —O— | 1 |
| P-37 | —H | —Cl | —H | —Cl | —H | —Cl | —H | —Cl | —CH3 | —H | —O— | 1 |
| P-38 | —H | —Cl | —H | —Cl | —H | —Cl | —H | —Cl | —CH3 | —H | —O— | 1 |
| P-39 | —H | —Cl | —H | —Cl | —H | —Cl | —H | —Cl | —CH3 | —H | —O— | 1 |
| P-40 | —H | —Cl | —H | —Cl | —H | —Cl | —H | —Cl | —CH3 | —H | —O— | 1 |
| P-41 | —H | —Cl | —H | —Cl | —H | —Cl | —H | —Cl | —CH3 | —H | —O— | 1 |
| P-42 | —H | —Cl | —H | —Cl | —H | —Cl | —H | —Cl | —CH3 | —H | —O— | 1 |
| P-43 | —H | —Cl | —H | —Cl | —H | —Cl | —H | —Cl | —CH3 | —H | —O— | 1 |
| P-44 | —H | —Cl | —H | —Cl | —H | —Cl | —H | —Cl | —CH3 | —H | —O— | 1 |
| P-45 | —H | —Cl | —H | —Cl | —H | —Cl | —H | —Cl | —CH3 | —H | —O— | 1 |
| P-46 | —H | —Cl | —H | —Cl | —H | —Cl | —H | —Cl | —CH3 | —H | —O— | 1 |
| P-47 | —H | —Cl | —H | —Cl | —H | —Cl | —H | —Cl | —CH3 | —H | —O— | 1 |
| P-48 | —H | —Cl | —H | —Cl | —H | —Cl | —H | —Cl | —CH3 | —H | —O— | 1 |
| P-49 | —H | —Cl | —H | —Cl | —H | —Cl | —H | —Cl | —CH3 | —H | —O— | 1 |
| P-50 | —H | —Cl | —H | —Cl | —H | —Cl | —H | —Cl | —CH3 | —H | —O— | 1 |

| | α | β | | | | | γ | | | | |
|---|---|---|---|---|---|---|---|---|---|---|---|
| | ma | R70 | R71 | Zb | lb | mb | R80 | R81 | Zc | lc | mc |
| P-1 | 1 | —H | —CH3 | (SB) | 1 | 1 | — | — | — | 0 | 0 |
| P-2 | 2 | —H | —CH3 | (SB) | 1 | 1 | — | — | — | 0 | 0 |
| P-3 | 3 | —H | —CH3 | (SB) | 1 | 1 | — | — | — | 0 | 0 |
| P-4 | 4 | —H | —CH3 | (SB) | 1 | 1 | — | — | — | 0 | 0 |
| P-5 | 5 | —H | —CH3 | (SB) | 1 | 1 | — | — | — | 0 | 0 |
| P-6 | 6 | —H | —CH3 | (SB) | 1 | 1 | — | — | — | 0 | 0 |
| P-7 | 7 | —H | —CH3 | (SB) | 1 | 1 | — | — | — | 0 | 0 |
| P-8 | 8 | —H | —CH3 | (SB) | 1 | 1 | — | — | — | 0 | 0 |
| P-9 | 9 | —H | —CH3 | (SB) | 1 | 1 | — | — | — | 0 | 0 |
| P-10 | 10 | —H | —CH3 | (SB) | 1 | 1 | — | — | — | 0 | 0 |
| P-11 | 11 | —H | —CH3 | (SB) | 1 | 1 | — | — | — | 0 | 0 |
| P-12 | 12 | —H | —CH3 | (SB) | 1 | 1 | — | — | — | 0 | 0 |
| P-13 | 13 | —H | —CH3 | (SB) | 1 | 1 | — | — | — | 0 | 0 |
| P-14 | 14 | —H | —CH3 | (SB) | 1 | 1 | — | — | — | 0 | 0 |
| P-15 | 15 | —H | —CH3 | (SB) | 1 | 1 | — | — | — | 0 | 0 |
| P-16 | 16 | —H | —CH3 | (SB) | 1 | 1 | — | — | — | 0 | 0 |
| P-17 | 17 | —H | —CH3 | (SB) | 1 | 1 | — | — | — | 0 | 0 |
| P-18 | 18 | —H | —CH3 | (SB) | 1 | 1 | — | — | — | 0 | 0 |
| P-19 | 19 | —H | —CH3 | (SB) | 1 | 1 | — | — | — | 0 | 0 |
| P-20 | 20 | —H | —CH3 | (SB) | 1 | 1 | — | — | — | 0 | 0 |
| P-21 | 22 | —H | —CH3 | (SB) | 1 | 1 | — | — | — | 0 | 0 |
| P-22 | 25 | —H | —CH3 | (SB) | 1 | 1 | — | — | — | 0 | 0 |
| P-23 | 28 | —H | —CH3 | (SB) | 1 | 1 | — | — | — | 0 | 0 |
| P-24 | 30 | —H | —CH3 | (SB) | 1 | 1 | — | — | — | 0 | 0 |
| P-25 | 32 | —H | —CH3 | (SB) | 1 | 1 | — | — | — | 0 | 0 |
| P-26 | 33 | —H | —CH3 | (SB) | 1 | 1 | — | — | — | 0 | 0 |
| P-27 | 40 | —H | —CH3 | (SB) | 1 | 1 | — | — | — | 0 | 0 |
| P-28 | 50 | —H | —CH3 | (SB) | 1 | 1 | — | — | — | 0 | 0 |
| P-29 | 60 | —H | —CH3 | (SB) | 1 | 1 | — | — | — | 0 | 0 |
| P-30 | 70 | —H | —CH3 | (SB) | 1 | 1 | — | — | — | 0 | 0 |
| P-31 | 1 | —H | —CH3 | (SB) | 1 | 1 | — | — | — | 0 | 0 |
| P-32 | 2 | —H | —CH3 | (SB) | 1 | 1 | — | — | — | 0 | 0 |
| P-33 | 3 | —H | —CH3 | (SB) | 1 | 1 | — | — | — | 0 | 0 |
| P-34 | 4 | —H | —CH3 | (SB) | 1 | 1 | — | — | — | 0 | 0 |
| P-35 | 5 | —H | —CH3 | (SB) | 1 | 1 | — | — | — | 0 | 0 |
| P-36 | 6 | —H | —CH3 | (SB) | 1 | 1 | — | — | — | 0 | 0 |
| P-37 | 7 | —H | —CH3 | (SB) | 1 | 1 | — | — | — | 0 | 0 |
| P-38 | 8 | —H | —CH3 | (SB) | 1 | 1 | — | — | — | 0 | 0 |
| P-39 | 9 | —H | —CH3 | (SB) | 1 | 1 | — | — | — | 0 | 0 |
| P-40 | 10 | —H | —CH3 | (SB) | 1 | 1 | — | — | — | 0 | 0 |
| P-41 | 11 | —H | —CH3 | (SB) | 1 | 1 | — | — | — | 0 | 0 |
| P-42 | 12 | —H | —CH3 | (SB) | 1 | 1 | — | — | — | 0 | 0 |
| P-43 | 13 | —H | —CH3 | (SB) | 1 | 1 | — | — | — | 0 | 0 |
| P-44 | 14 | —H | —CH3 | (SB) | 1 | 1 | — | — | — | 0 | 0 |
| P-45 | 15 | —H | —CH3 | (SB) | 1 | 1 | — | — | — | 0 | 0 |
| P-46 | 16 | —H | —CH3 | (SB) | 1 | 1 | — | — | — | 0 | 0 |
| P-47 | 17 | —H | —CH3 | (SB) | 1 | 1 | — | — | — | 0 | 0 |
| P-48 | 18 | —H | —CH3 | (SB) | 1 | 1 | — | — | — | 0 | 0 |
| P-49 | 19 | —H | —CH3 | (SB) | 1 | 1 | — | — | — | 0 | 0 |
| P-50 | 20 | —H | —CH3 | (SB) | 1 | 1 | — | — | — | 0 | 0 |

TABLE 2

| | | | | | | | | | α | | | |
|---|---|---|---|---|---|---|---|---|---|---|---|---|
| | R11 | R12 | R13 | R14 | R15 | R16 | R17 | R18 | R60 | R61 | Za | la |
| P-51 | —H | —Cl | —H | —Cl | —H | —Cl | —H | —Cl | —CH3 | —H | —O— | 1 |
| P-52 | —H | —Cl | —H | —Cl | —H | —Cl | —H | —Cl | —CH3 | —H | —O— | 1 |
| P-53 | —H | —Cl | —H | —Cl | —H | —Cl | —H | —Cl | —CH3 | —H | —O— | 1 |
| P-54 | —H | —Cl | —H | —Cl | —H | —Cl | —H | —Cl | —CH3 | —H | —O— | 1 |
| P-55 | —H | —Cl | —H | —Cl | —H | —Cl | —H | —Cl | —CH3 | —H | —O— | 1 |
| P-56 | —H | —Cl | —H | —Cl | —H | —Cl | —H | —Cl | —CH3 | —H | —O— | 1 |
| P-57 | —H | —Cl | —H | —Cl | —H | —Cl | —H | —Cl | —CH3 | —H | —O— | 1 |
| P-58 | —H | —Cl | —H | —Cl | —H | —Cl | —H | —Cl | —CH3 | —H | —O— | 1 |
| P-59 | —H | —Cl | —H | —Cl | —H | —Cl | —H | —Cl | —CH3 | —H | —O— | 1 |
| P-60 | —H | —Cl | —H | —Cl | —H | —Cl | —H | —Cl | —CH3 | —H | —O— | 1 |
| P-61 | —H | —Br | —H | —H | —H | —Br | —H | —H | —CH3 | —H | —O— | 1 |
| P-62 | —H | —Br | —H | —H | —H | —Br | —H | —H | —CH3 | —H | —O— | 1 |
| P-63 | —H | —Br | —H | —H | —H | —Br | —H | —H | —CH3 | —H | —O— | 1 |
| P-64 | —H | —Br | —H | —H | —H | —Br | —H | —H | —CH3 | —H | —O— | 1 |
| P-65 | —H | —Br | —H | —H | —H | —Br | —H | —H | —CH3 | —H | —O— | 1 |
| P-66 | —H | —Br | —H | —H | —H | —Br | —H | —H | —CH3 | —H | —O— | 1 |
| P-67 | —H | —Br | —H | —H | —H | —Br | —H | —H | —CH3 | —H | —O— | 1 |
| P-68 | —H | —Br | —H | —H | —H | —Br | —H | —H | —CH3 | —H | —O— | 1 |
| P-69 | —H | —Br | —H | —H | —H | —Br | —H | —H | —CH3 | —H | —O— | 1 |
| P-70 | —H | —Br | —H | —H | —H | —Br | —H | —H | —CH3 | —H | —O— | 1 |
| P-71 | —H | —Br | —H | —H | —H | —Br | —H | —H | —CH3 | —H | —O— | 1 |
| P-72 | —H | —Br | —H | —H | —H | —Br | —H | —H | —CH3 | —H | —O— | 1 |
| P-73 | —H | —Br | —H | —H | —H | —Br | —H | —H | —CH3 | —H | —O— | 1 |
| P-74 | —H | —Br | —H | —H | —H | —Br | —H | —H | —CH3 | —H | —O— | 1 |
| P-75 | —H | —Br | —H | —H | —H | —Br | —H | —H | —CH3 | —H | —O— | 1 |
| P-76 | —H | —Br | —H | —H | —H | —Br | —H | —H | —CH3 | —H | —O— | 1 |
| P-77 | —H | —Br | —H | —H | —H | —Br | —H | —H | —CH3 | —H | —O— | 1 |
| P-78 | —H | —Br | —H | —H | —H | —Br | —H | —H | —CH3 | —H | —O— | 1 |
| P-79 | —H | —Br | —H | —H | —H | —Br | —H | —H | —CH3 | —H | —O— | 1 |
| P-80 | —H | —Br | —H | —H | —H | —Br | —H | —H | —CH3 | —H | —O— | 1 |
| P-81 | —H | —Br | —H | —H | —H | —Br | —H | —H | —CH3 | —H | —O— | 1 |
| P-82 | —H | —Br | —H | —H | —H | —Br | —H | —H | —CH3 | —H | —O— | 1 |
| B-83 | —H | —Br | —H | —H | —H | —Br | —H | —H | —CH3 | —H | —O— | 1 |
| P-84 | —H | —Br | —H | —H | —H | —Br | —H | —H | —CH3 | —H | —O— | 1 |
| P-85 | —H | —Br | —H | —H | —H | —Br | —H | —H | —CH3 | —H | —O— | 1 |
| p-86 | —H | —Br | —H | —H | —H | —Br | —H | —H | —CH3 | —H | —O— | 1 |
| P-87 | —H | —Br | —H | —H | —H | —Br | —H | —H | —CH3 | —H | —O— | 1 |
| P-88 | —H | —Br | —H | —H | —H | —Br | —H | —H | —CH3 | —H | —O— | 1 |
| P-89 | —H | —Br | —H | —H | —H | —Br | —H | —H | —CH3 | —H | —O— | 1 |
| P-90 | —H | —Br | —H | —H | —H | —Br | —H | —H | —CH3 | —H | —O— | 1 |
| P-91 | —H | —H | —H | —H | —H | —H | —H | —H | —CH3 | —H | —O— | 1 |
| P-92 | —H | —H | —H | —H | —H | —H | —H | —H | —CH3 | —H | —O— | 1 |
| P-93 | —H | —H | —H | —H | —H | —H | —H | —H | —CH3 | —H | —O— | 1 |
| P-94 | —H | —H | —H | —H | —H | —H | —H | —H | —CH3 | —H | —O— | 1 |
| P-95 | —H | —H | —H | —H | —H | —H | —H | —H | —CH3 | —H | —O— | 1 |
| P-96 | —H | —H | —H | —H | —H | —H | —H | —H | —CH3 | —H | —O— | 1 |
| P-97 | —H | —H | —H | —H | —H | —H | —H | —H | —CH3 | —H | —O— | 1 |
| P-98 | —H | —H | —H | —H | —H | —H | —H | —H | —CH3 | —H | —O— | 1 |
| P-99 | —H | —H | —H | —H | —H | —H | —H | —H | —CH3 | —H | —O— | 1 |
| P-100 | —H | —H | —H | —H | —H | —H | —H | —H | —CH3 | —H | —O— | 1 |

| | α | β | | | | | γ | | | | |
|---|---|---|---|---|---|---|---|---|---|---|---|
| | ma | R70 | R71 | Zb | lb | mb | R80 | R81 | Zc | lc | mc |
| P-51 | 22 | —H | —CH3 | (SB) | 1 | 1 | — | — | — | 0 | 0 |
| P-52 | 25 | —H | —CH3 | (SB) | 1 | 1 | — | — | — | 0 | 0 |
| P-53 | [symbol] | —H | —CH3 | (SB) | 1 | 1 | — | — | — | 0 | 0 |
| P-54 | 30 | —H | —CH3 | (SB) | 1 | 1 | — | — | — | 0 | 0 |
| P-55 | 32 | —H | —CH3 | (SB) | 1 | 1 | — | — | — | 0 | 0 |
| P-56 | 38 | —H | —CH3 | (SB) | 1 | 1 | — | — | — | 0 | 0 |
| P-57 | 40 | —H | —CH3 | (SB) | 1 | 1 | — | — | — | 0 | 0 |
| P-58 | 50 | —H | —CH3 | (SB) | 1 | 1 | — | — | — | 0 | 0 |
| P-59 | 60 | —H | —CH3 | (SB) | 1 | 1 | — | — | — | 0 | 0 |
| P-60 | 70 | —H | —CH3 | (SB) | 1 | 1 | — | — | — | 0 | 0 |
| P-61 | 1 | —H | —CH3 | (SB) | 1 | 1 | — | — | — | 0 | 0 |
| P-62 | 2 | —H | —CH3 | (SB) | 1 | 1 | — | — | — | 0 | 0 |
| P-63 | 3 | —H | —CH3 | (SB) | 1 | 1 | — | — | — | 0 | 0 |
| P-64 | 4 | —H | —CH3 | (SB) | 1 | 1 | — | — | — | 0 | 0 |
| P-65 | 5 | —H | —CH3 | (SB) | 1 | 1 | — | — | — | 0 | 0 |
| P-66 | 6 | —H | —CH3 | (SB) | 1 | 1 | — | — | — | 0 | 0 |
| P-67 | 7 | —H | —CH3 | (SB) | 1 | 1 | — | — | — | 0 | 0 |
| P-68 | 8 | —H | —CH3 | (SB) | 1 | 1 | — | — | — | 0 | 0 |
| P-69 | 9 | —H | —CH3 | (SB) | 1 | 1 | — | — | — | 0 | 0 |
| P-70 | 10 | —H | —CH3 | (SB) | 1 | 1 | — | — | — | 0 | 0 |
| P-71 | 11 | —H | —CH3 | (SB) | 1 | 1 | — | — | — | 0 | 0 |
| P-72 | 12 | —H | —CH3 | (SB) | 1 | 1 | — | — | — | 0 | 0 |
| P-73 | 13 | —H | —CH3 | (SB) | 1 | 1 | — | — | — | 0 | 0 |
| P-74 | 14 | —H | —CH3 | (SB) | 1 | 1 | — | — | — | 0 | 0 |
| P-75 | 15 | —H | —CH3 | (SB) | 1 | 1 | — | — | — | 0 | 0 |
| P-76 | 16 | —H | —CH3 | (SB) | 1 | 1 | — | — | — | 0 | 0 |
| P-77 | 17 | —H | —CH3 | (SB) | 1 | 1 | — | — | — | 0 | 0 |
| P-78 | 18 | —H | —CH3 | (SB) | 1 | 1 | — | — | — | 0 | 0 |
| P-79 | 19 | —H | —CH3 | (SB) | 1 | 1 | — | — | — | 0 | 0 |
| P-80 | 20 | —H | —CH3 | (SB) | 1 | 1 | — | — | — | 0 | 0 |
| P-81 | 22 | —H | —CH3 | (SB) | 1 | 1 | — | — | — | 0 | 0 |
| P-82 | 25 | —H | —CH3 | (SB) | 1 | 1 | — | — | — | 0 | 0 |
| B-83 | [symbol] | —H | —CH3 | (SB) | 1 | 1 | — | — | — | 0 | 0 |
| P-84 | 30 | —H | —CH3 | (SB) | 1 | 1 | — | — | — | 0 | 0 |
| P-85 | 32 | —H | —CH3 | (SB) | 1 | 1 | — | — | — | 0 | 0 |
| p-86 | [symbol] | —H | —CH3 | (SB) | 1 | 1 | — | — | — | 0 | 0 |
| P-87 | 40 | —H | —CH3 | (SB) | 1 | 1 | — | — | — | 0 | 0 |
| P-88 | 50 | —H | —CH3 | (SB) | 1 | 1 | — | — | — | 0 | 0 |
| P-89 | 80 | —H | —CH3 | (SB) | 1 | 1 | — | — | — | 0 | 0 |
| P-90 | 70 | —H | —CH3 | (SB) | 1 | 1 | — | — | — | 0 | 0 |
| P-91 | 1 | —H | —H | —O— | 1 | 1 | —CH3 | —H | —O— | 1 | 1 |
| P-92 | 2 | —H | —H | —O— | 1 | 2 | —CH3 | —H | —O— | 1 | 2 |
| P-93 | 2 | —H | —H | —O— | 1 | 6 | —CH3 | —H | —O— | 1 | [symbol] |
| P-94 | 2 | —H | —H | —O— | 1 | 7 | —CH3 | —H | —O— | 1 | 2 |
| P-95 | 1 | —H | —H | —O— | 1 | 7 | —CH3 | —H | —O— | 1 | 2 |
| P-96 | 2 | —H | —H | —O— | 1 | 7 | —CH3 | —H | —O— | 1 | 1 |
| P-97 | 1 | —H | —H | —O— | 1 | 8 | —CH3 | —H | —O— | 1 | 2 |
| P-98 | 2 | —H | —H | —O— | 1 | 8 | —CH3 | —H | —O— | 1 | 2 |
| P-99 | 3 | —H | —H | —O— | 1 | 7 | —CH3 | —H | —O— | 1 | 1 |
| P-100 | 1 | —H | —H | —O— | 1 | 7 | —CH3 | —H | —O— | 1 | [symbol] |

[symbol]

indicates data missing or illegible when filed

TABLE 3

| | | | | | | | | | α | | | |
|---|---|---|---|---|---|---|---|---|---|---|---|---|
| | R11 | R12 | R13 | R14 | R15 | R16 | R17 | R18 | R60 | R61 | Za | la |
| P-101 | —H | —H | —H | —H | —H | —H | —H | —H | —CH3 | —H | —O— | 1 |
| P-102 | —H | —H | —H | —H | —H | —H | —H | —H | —CH3 | —H | —O— | 1 |
| P-103 | —H | —H | —H | —H | —H | —H | —H | —H | —CH3 | —H | —O— | 1 |
| P-104 | —H | —H | —H | —H | —H | —H | —H | —H | —CH3 | —H | —O— | 1 |
| P-105 | —H | —H | —H | —H | —H | —H | —H | —H | —CH3 | —H | —O— | 1 |
| P-106 | —H | —H | —H | —H | —H | —H | —H | —H | —CH3 | —H | —O— | 1 |
| P-107 | —H | —H | —H | —H | —H | —H | —H | —H | —CH3 | —H | —O— | 1 |
| P-108 | —H | —H | —H | —H | —H | —H | —H | —H | —CH3 | —H | —O— | 1 |
| P-109 | —H | —H | —H | —H | —H | —H | —H | —H | —CH3 | —H | —O— | 1 |
| P-110 | —H | —H | —H | —H | —H | —H | —H | —H | —CH3 | —H | —O— | 1 |
| P-111 | —H | —H | —H | —H | —H | —H | —H | —H | —CH3 | —H | —O— | 1 |
| P-112 | —H | —H | —H | —H | —H | —H | —H | —H | —CH3 | —H | —O— | 1 |
| P-113 | —H | —H | —H | —H | —H | —H | —H | —H | —CH3 | —H | —O— | 1 |
| P-114 | —H | —H | —H | —H | —H | —H | —H | —H | —CH3 | —H | —O— | 1 |
| P-115 | —H | —H | —H | —H | —H | —H | —H | —H | —CH3 | —H | —O— | 1 |
| P-116 | —H | —H | —H | —H | —H | —H | —H | —H | —CH3 | —H | —O— | 1 |
| P-117 | —H | —H | —H | —H | —H | —H | —H | —H | —CH3 | —H | —O— | 1 |
| P-118 | —H | —H | —H | —H | —H | —H | —H | —H | —CH3 | —H | —O— | 1 |
| P-119 | —H | —H | —H | —H | —H | —H | —H | —H | —CH3 | —H | —O— | 1 |
| P-120 | —H | —H | —H | —H | —H | —H | —H | —H | —CH3 | —H | —O— | 1 |
| P-121 | —H | —H | —H | —H | —H | —H | —H | —H | —CH3 | —H | —O— | 1 |
| P-122 | —H | —H | —H | —H | —H | —H | —H | —H | —CH3 | —H | —O— | 1 |
| P-123 | —H | —H | —H | —H | —H | —H | —H | —H | —CH3 | —H | —O— | 1 |
| P-124 | —H | —H | —H | —H | —H | —H | —H | —H | —CH3 | —H | —O— | 1 |
| P-125 | —H | —H | —H | —H | —H | —H | —H | —H | —CH3 | —H | —O— | 1 |
| P-126 | —H | —H | —H | —H | —H | —H | —H | —H | —CH3 | —H | —O— | 1 |
| P-127 | —H | —H | —H | —H | —H | —H | —H | —H | —CH3 | —H | —O— | 1 |
| P-128 | —H | —H | —H | —H | —H | —H | —H | —H | —CH3 | —H | —O— | 1 |
| P-129 | —H | —H | —H | —H | —H | —H | —H | —H | —CH3 | —H | —O— | 1 |
| P-130 | —H | —H | —H | —H | —H | —H | —H | —H | —CH3 | —H | —O— | 1 |
| P-131 | —H | —H | —H | —H | —H | —H | —H | —H | —CH3 | —H | —O— | 1 |
| P-132 | —H | —H | —H | —H | —H | —H | —H | —H | —CH3 | —H | —O— | 1 |
| P-133 | —H | —H | —H | —H | —H | —H | —H | —H | —CH3 | —H | —O— | 1 |
| P-134 | —H | —H | —H | —H | —H | —H | —H | —H | —CH3 | —H | —O— | 1 |
| P-135 | —H | —H | —H | —H | —H | —H | —H | —H | —CH3 | —H | —O— | 1 |
| P-136 | —H | —H | —H | —H | —H | —H | —H | —H | —CH3 | —H | —O— | 1 |
| P-137 | —H | —H | —H | —H | —H | —H | —H | —H | —CH3 | —H | —O— | 1 |
| P-138 | —H | —H | —H | —H | —H | —H | —H | —H | —CH3 | —H | —O— | 1 |
| P-139 | —H | —H | —H | —H | —H | —H | —H | —H | —CH3 | —H | —O— | 1 |
| P-140 | —H | —H | —H | —H | —H | —H | —H | —H | —CH3 | —H | —O— | 1 |
| P-141 | —H | —H | —H | —H | —H | —H | —H | —H | —CH3 | —H | —O— | 1 |
| P-142 | —H | —H | —H | —H | —H | —H | —H | —H | —CH3 | —H | —O— | 1 |
| R-143 | —H | —H | —H | —H | —H | —H | —H | —H | —CH3 | —H | —O— | 1 |
| P-144 | —H | —H | —H | —H | —H | —H | —H | —H | —CH3 | —H | —O— | 1 |
| P-145 | —H | —H | —H | —H | —H | —H | —H | —H | —CH3 | —H | —O— | 1 |
| P-146 | —H | —H | —H | —H | —H | —H | —H | —H | —CH3 | —H | —O— | 1 |
| P-147 | —H | —H | —H | —H | —H | —H | —H | —H | —CH3 | —H | —O— | 1 |
| P-148 | —H | —H | —H | —H | —H | —H | —H | —H | —H | —H | —O— | 2 |
| P-149 | —H | —H | —H | —H | —H | —H | —H | —H | —H | —H | —O— | 2 |
| P-150 | —H | —H | —H | —H | —H | —H | —H | —H | —H | —H | —O— | 2 |

| | α | β | | | | | γ | | | | |
|---|---|---|---|---|---|---|---|---|---|---|---|
| | ma | R70 | R71 | Zb | lb | mb | R80 | R81 | Zc | lc | mc |
| P-101 | 1 | —H | —H | —O— | 1 | 9 | —CH3 | —H | —O— | 1 | 1 |
| P-102 | 2 | —H | —H | —O— | 1 | 9 | —CH3 | —H | —O— | 1 | 1 |
| P-103 | 1 | —H | —H | —O— | 1 | 9 | —CH3 | —H | —O— | 1 | 2 |
| P-104 | 2 | —H | —H | —O— | 1 | 9 | —CH3 | —H | —O— | 1 | 2 |
| P-105 | 1 | —H | —H | —O— | 1 | 9 | —CH3 | —H | —O— | 1 | 3 |
| P-106 | 2 | —H | —H | —O— | 1 | 9 | —CH3 | —H | —O— | 1 | 1 |
| P-107 | 1 | —H | —H | —O— | 1 | 10 | —CH3 | —H | —O— | 1 | 1 |
| P-108 | 3 | —H | —H | —O— | 1 | 10 | —CH3 | —H | —O— | 1 | 2 |
| P-109 | 1 | —H | —H | —O— | 1 | 11 | —CH3 | —H | —O— | 1 | 1 |
| P-110 | 2 | —H | —H | —O— | 1 | 11 | —CH3 | —H | —O— | 1 | 2 |
| P-111 | 3 | —H | —H | —O— | 1 | 11 | —CH3 | —H | —O— | 1 | 3 |
| P-112 | 4 | —H | —H | —O— | 1 | 11 | —CH3 | —H | —O— | 1 | 4 |
| P-113 | 1 | —H | —H | —O— | 1 | 12 | —CH3 | —H | —O— | 1 | 1 |
| P-114 | 1 | —H | —H | —O— | 1 | 12 | —CH3 | —H | —O— | 1 | 2 |
| P-115 | 2 | —H | —H | —O— | 1 | 12 | —CH3 | —H | —O— | 1 | 2 |
| P-116 | 3 | —H | —H | —O— | 1 | 12 | —CH3 | —H | —O— | 1 | 1 |
| P-117 | 3 | —H | —H | —O— | 1 | 12 | —CH3 | —H | —O— | 1 | 2 |
| P-118 | 3 | —H | —H | —O— | 1 | 12 | —CH3 | —H | —O— | 1 | 3 |
| P-119 | 2 | —H | —H | —O— | 1 | 12 | —CH3 | —H | —O— | 1 | 3 |
| P-120 | 4 | —H | —H | —O— | 1 | 12 | —CH3 | —H | —O— | 1 | 1 |
| P-121 | 1 | —H | —H | —O— | 1 | 12 | —CH3 | —H | —O— | 1 | 4 |
| P-122 | 4 | —H | —H | —O— | 1 | 12 | —CH3 | —H | —O— | 1 | 2 |
| P-123 | 2 | —H | —H | —O— | 1 | 12 | —CH3 | —H | —O— | 1 | 4 |
| P-124 | 3 | —H | —H | —O— | 1 | 20 | —CH3 | —H | —O— | 1 | 3 |
| P-125 | 3 | —H | —H | —O— | 1 | 30 | —CH3 | —H | —O— | 1 | 3 |
| P-126 | 3 | —H | —H | —O— | 1 | [symbol] | —CH3 | —H | —O— | 1 | 3 |
| P-127 | 2 | —H | —H | —O— | 1 | 45 | —CH3 | —H | —O— | 1 | 4 |
| P-128 | 3 | —H | —H | —O— | 1 | [symbol] | —CH3 | —H | —O— | 1 | 3 |
| P-129 | 1 | —H | —H | —O— | 1 | 1 | —CH3 | —H | —O— | 1 | 1 |
| P-130 | 2 | —H | —H | —O— | 3 | 2 | —CH3 | —H | —O— | 1 | 2 |
| P-131 | 2 | —H | —H | —O— | 3 | 4 | —CH3 | —H | —O— | 1 | 2 |
| P-132 | 2 | —H | —H | —O— | 3 | 5 | —CH3 | —H | —O— | 1 | 2 |
| P-133 | 3 | —H | —H | —O— | 3 | 4 | —CH3 | —H | —O— | 1 | 3 |
| P-134 | 1 | —H | —H | —O— | 3 | 4 | —CH3 | —H | —O— | 1 | 5 |
| P-135 | 5 | —H | —H | —O— | 3 | 5 | —CH3 | —H | —O— | 1 | 5 |
| P-136 | 4 | —H | —H | —O— | 3 | 4 | —CH3 | —H | —O— | 1 | 4 |
| P-137 | 4 | —H | —H | —O— | 3 | 6 | —CH3 | —H | —O— | 1 | 4 |
| P-138 | 6 | —H | —H | —O— | 3 | 6 | —CH3 | —H | —O— | 1 | 5 |
| P-139 | 4 | —H | —H | —O— | 3 | 7 | —CH3 | —H | —O— | 1 | 4 |
| P-140 | 3 | —H | —H | —O— | 3 | 7 | —CH3 | —H | —O— | 1 | 5 |
| P-141 | 5 | —H | —H | —O— | 3 | 7 | —CH3 | —H | —O— | 1 | 3 |
| P-142 | 4 | —H | —H | —O— | 3 | 8 | —CH3 | —H | —O— | 1 | 3 |
| R-143 | 6 | —H | —H | —O— | 3 | 8 | —CH3 | —H | —O— | 1 | 2 |
| P-144 | 3 | —H | —H | —O— | 3 | 9 | —CH3 | —H | —O— | 1 | 3 |
| P-145 | 5 | —H | —H | —O— | 3 | 9 | —CH3 | —H | —O— | 1 | 4 |
| P-146 | 2 | —H | —H | —O— | 3 | 10 | —CH3 | —H | —O— | 1 | 2 |
| P-147 | 4 | —H | —H | —O— | 3 | 10 | —CH3 | —H | —O— | 1 | 4 |
| P-148 | 1 | —H | —H | —O— | 3 | 1 | —H | —H | (SB) | 1 | 1 |
| P-149 | 2 | —H | —H | —O— | 3 | 1 | —H | —H | (SB) | 1 | 1 |
| P-150 | 3 | —H | —H | —O— | 3 | 1 | —H | —H | (SB) | 1 | 1 |

[symbol]

indicates data missing or illegible when filed

TABLE 4

| | | | | | | | | | α | | | |
|---|---|---|---|---|---|---|---|---|---|---|---|---|
| | R11 | R12 | R13 | R14 | R15 | R16 | R17 | R18 | R60 | R61 | Za | la |
| P-151 | —H | —H | —H | —H | —H | —H | —H | —H | —H | —H | —O— | 2 |
| P-152 | —H | —H | —H | —H | —H | —H | —H | —H | —H | —H | —O— | 2 |
| P-153 | —H | —H | —H | —H | —H | —H | —H | —H | —H | —H | —O— | 2 |
| P-154 | —H | —H | —H | —H | —H | —H | —H | —H | —H | —H | —O— | 2 |
| P-155 | —H | —H | —H | —H | —H | —H | —H | —H | —H | —H | —O— | 2 |
| P-156 | —H | —H | —H | —H | —H | —H | —H | —H | —H | —H | —O— | 2 |
| P-157 | —H | —H | —H | —H | —H | —H | —H | —H | —H | —H | —O— | 2 |
| P-158 | —H | —H | —H | —H | —H | —H | —H | —H | —H | —H | —O— | 2 |
| P-159 | —H | —H | —H | —H | —H | —H | —H | —H | —H | —H | —O— | 2 |
| P-160 | —H | —H | —H | —H | —H | —H | —H | —H | —H | —H | —O— | 2 |
| P-161 | —H | —H | —H | —H | —H | —H | —H | —H | —H | —H | —O— | 2 |
| P-162 | —H | —H | —H | —H | —H | —H | —H | —H | —H | —H | —O— | 2 |
| P-163 | —H | —H | —H | —H | —H | —H | —H | —H | —H | —H | —O— | 2 |
| P-164 | —H | —H | —H | —H | —H | —H | —H | —H | —H | —H | —O— | 2 |
| P-165 | —H | —H | —H | —H | —H | —H | —H | —H | —H | —H | —O— | 2 |
| P-166 | —H | —H | —H | —H | —H | —H | —H | —H | —H | —H | —O— | 1 |
| P-167 | —H | —H | —H | —H | —H | —H | —H | —H | —H | —H | —O— | 1 |
| P-168 | —H | —H | —H | —H | —H | —H | —H | —H | —H | —H | —O— | 1 |
| P-169 | —H | —H | —H | —H | —H | —H | —H | —H | —H | —H | —O— | 1 |
| P-170 | —H | —H | —H | —H | —H | —H | —H | —H | —H | —H | —O— | 1 |
| P-171 | —H | —H | —H | —H | —H | —H | —H | —H | —H | —H | —O— | 1 |
| P-172 | —H | —H | —H | —H | —H | —H | —H | —H | —H | —H | —O— | 1 |
| P-173 | —H | —H | —H | —H | —H | —H | —H | —H | —H | —H | —O— | 1 |
| P-174 | —H | —H | —H | —H | —H | —H | —H | —H | —H | —H | —O— | 1 |
| P-175 | —H | —H | —H | —H | —H | —H | —H | —H | —H | —H | —O— | 1 |
| P-176 | —H | —H | —H | —H | —H | —H | —H | —H | —H | —H | —O— | 1 |
| P-177 | —H | —H | —H | —H | —H | —H | —H | —H | —H | —H | —O— | 1 |
| P-178 | —H | —H | —H | —H | —H | —H | —H | —H | —H | —H | —O— | 1 |
| P-179 | —H | —H | —H | —H | —H | —H | —H | —H | —H | —H | —O— | 1 |
| P-180 | —H | —H | —H | —H | —H | —H | —H | —H | —H | —H | —O— | 1 |
| P-181 | —H | —H | —H | —H | —H | —H | —H | —H | —H | —H | —O— | 1 |
| P-182 | —H | —H | —H | —H | —H | —H | —H | —H | —H | —H | —O— | 1 |
| P-183 | —H | —H | —H | —H | —H | —H | —H | —H | —H | —H | —O— | 1 |
| P-184 | —H | —H | —H | —H | —H | —H | —H | —H | —H | —H | —O— | 1 |
| P-185 | —H | —H | —H | —H | —H | —H | —H | —H | —H | —H | —NH | 1 |
| P-186 | —H | —H | —H | —H | —H | —H | —H | —H | —H | —H | —NH | 1 |
| P-187 | —H | —H | —H | —H | —H | —H | —H | —H | —H | —H | —NH | 1 |
| P-188 | —H | —H | —H | —H | —H | —H | —H | —H | —H | —H | —NH | 1 |
| P-189 | —H | —H | —H | —H | —H | —H | —H | —H | —H | —H | —NH | 1 |
| P-190 | —H | —H | —H | —H | —H | —H | —H | —H | —H | —H | —NH | 1 |
| P-191 | —H | —H | —H | —H | —H | —H | —H | —H | —H | —H | —NH | 1 |
| P-192 | —H | —H | —H | —H | —H | —H | —H | —H | —H | —H | —NH | 1 |
| P-193 | —H | —H | —H | —H | —H | —H | —H | —H | —H | —H | —NH | 1 |
| P-194 | —H | —H | —H | —H | —H | —H | —H | —H | —H | —H | —NH | 1 |
| P-195 | —H | —H | —H | —H | —H | —H | —H | —H | —H | —H | —NH | 1 |
| P-196 | —H | —H | —H | —H | —H | —H | —H | —H | —H | —H | —NH | 1 |
| P-197 | —H | —H | —H | —H | —H | —H | —H | —H | —H | —H | —NH | 1 |
| P-198 | —H | —H | —H | —H | —H | —H | —H | —H | —H | —H | —NH | 1 |
| P-199 | —H | —H | —H | —H | —H | —H | —H | —H | —H | —H | —NH | 1 |
| P-200 | —H | —H | —H | —H | —H | —H | —H | —H | —H | —H | —NH | 1 |

| | α | β | | | | | γ | | | | |
|---|---|---|---|---|---|---|---|---|---|---|---|
| | ma | R70 | R71 | Zb | lb | mb | R80 | R81 | Zc | lc | mc |
| P-151 | 4 | —H | —H | —O— | 3 | 1 | —H | —H | (SB) | 1 | 1 |
| P-152 | 5 | —H | —H | —O— | 3 | 1 | —H | —H | (SB) | 1 | 1 |
| P-153 | 8 | —H | —H | —O— | 3 | 1 | —H | —H | (SB) | 1 | 1 |
| P-154 | 7 | —H | —H | —O— | 3 | 1 | —H | —H | (SB) | 1 | 1 |
| P-155 | 8 | —H | —H | —O— | 3 | 1 | —H | —H | (SB) | 1 | 1 |
| P-156 | 9 | —H | —H | —O— | 3 | 1 | —H | —H | (SB) | 1 | 1 |
| P-157 | 10 | —H | —H | —O— | 3 | 1 | —H | —H | (SB) | 1 | 1 |
| P-158 | 12 | —H | —H | —O— | 3 | 1 | —H | —H | (SB) | 1 | 1 |
| P-159 | 15 | —H | —H | —O— | 3 | 1 | —H | —H | (SB) | 1 | 1 |
| P-160 | 20 | —H | —H | —O— | 3 | 1 | —H | —H | (SB) | 1 | 1 |
| P-161 | 30 | —H | —H | —O— | 3 | 1 | —H | —H | (SB) | 1 | 1 |
| P-162 | 40 | —H | —H | —O— | 3 | 1 | —H | —H | (SB) | 1 | 1 |
| P-163 | 50 | —H | —H | —O— | 3 | 1 | —H | —H | (SB) | 1 | 1 |
| P-164 | 60 | —H | —H | —O— | 3 | 1 | —H | —H | (SB) | 1 | 1 |
| P-165 | 70 | —H | —H | —O— | 3 | 1 | —H | —H | (SB) | 1 | 1 |
| P-166 | 1 | —H | —H | (SB) | 1 | 1 | — | — | — | 0 | 0 |
| P-167 | 2 | —H | —H | (SB) | 1 | 1 | — | — | — | 0 | 0 |
| P-168 | 3 | —H | —H | (SB) | 1 | 1 | — | — | — | 0 | 0 |
| P-169 | 4 | —H | —H | (SB) | 1 | 1 | — | — | — | 0 | 0 |
| P-170 | 5 | —H | —H | (SB) | 1 | 1 | — | — | — | 0 | 0 |
| P-171 | 6 | —H | —H | (SB) | 1 | 1 | — | — | — | 0 | 0 |
| P-172 | 7 | —H | —H | (SB) | 1 | 1 | — | — | — | 0 | 0 |
| P-173 | 8 | —H | —H | (SB) | 1 | 1 | — | — | — | 0 | 0 |
| P-174 | 9 | —H | —H | (SB) | 1 | 1 | — | — | — | 0 | 0 |
| P-175 | 10 | —H | —H | (SB) | 1 | 1 | — | — | — | 0 | 0 |
| P-176 | 11 | —H | —H | (SB) | 1 | 1 | — | — | — | 0 | 0 |
| P-177 | 12 | —H | —H | (SB) | 1 | 1 | — | — | — | 0 | 0 |
| P-178 | 15 | —H | —H | (SB) | 1 | 1 | — | — | — | 0 | 0 |
| P-179 | 20 | —H | —H | (SB) | 1 | 1 | — | — | — | 0 | 0 |
| P-180 | 30 | —H | —H | (SB) | 1 | 1 | — | — | — | 0 | 0 |
| P-181 | 40 | —H | —H | (SB) | 1 | 1 | — | — | — | 0 | 0 |
| P-182 | 50 | —H | —H | (SB) | 1 | 1 | — | — | — | 0 | 0 |
| P-183 | 60 | —H | —H | (SB) | 1 | 1 | — | — | — | 0 | 0 |
| P-184 | 70 | —H | —H | (SB) | 1 | 1 | — | — | — | 0 | 0 |
| P-185 | 1 | —H | —H | (SB) | 1 | 1 | — | — | — | 0 | 0 |
| P-186 | 1 | —H | —H | (SB) | 1 | 1 | — | — | — | 0 | 0 |
| P-187 | 2 | —H | —H | (SB) | 1 | 1 | — | — | — | 0 | 0 |
| P-188 | 3 | —H | —H | (SB) | 1 | 1 | — | — | — | 0 | 0 |
| P-189 | 4 | —H | —H | (SB) | 1 | 1 | — | — | — | 0 | 0 |
| P-190 | 5 | —H | —H | (SB) | 1 | 1 | — | — | — | 0 | 0 |
| P-191 | 6 | —H | —H | (SB) | 1 | 1 | — | — | — | 0 | 0 |
| P-192 | 7 | —H | —H | (SB) | 1 | 1 | — | — | — | 0 | 0 |
| P-193 | 8 | —H | —H | (SB) | 1 | 1 | — | — | — | 0 | 0 |
| P-194 | 9 | —H | —H | (SB) | 1 | 1 | — | — | — | 0 | 0 |
| P-195 | 10 | —H | —H | (SB) | 1 | 1 | — | — | — | 0 | 0 |
| P-196 | 11 | —H | —H | (SB) | 1 | 1 | — | — | — | 0 | 0 |
| P-197 | 12 | —H | —H | (SB) | 1 | 1 | — | — | — | 0 | 0 |
| P-198 | 15 | —H | —H | (SB) | 1 | 1 | — | — | — | 0 | 0 |
| P-199 | 20 | —H | —H | (SB) | 1 | 1 | — | — | — | 0 | 0 |
| P-200 | 30 | —H | —H | (SB) | 1 | 1 | — | — | — | 0 | 0 |

TABLE 5

| | | | | | | | | | α | | |
|---|---|---|---|---|---|---|---|---|---|---|---|
| | R11 | R12 | R13 | R14 | R15 | R16 | R17 | R18 | R60 | R61 | Za |
| P-201 | —H | —H | —H | —H | —H | —H | —H | —H | —H | —H | —NH |
| R-202 | —H | —H | —H | —H | —H | —H | —H | —H | —H | —H | —NH |
| P-203 | —H | —H | —H | —H | —H | —H | —H | —H | —H | —H | —NH |
| P-204 | —H | —H | —H | —H | —H | —H | —H | —H | —H | —H | —NH |
| P-205 | —H | —H | —H | —H | —H | —H | —H | —H | —n-C3H7 | —H | (SB) |
| P-206 | —H | —H | —H | —H | —H | —H | —H | —H | —n-C3H7 | —H | (SB) |
| P-207 | —H | —H | —H | —H | —H | —H | —H | —H | —n-C3H7 | —H | (SB) |
| P-208 | —H | —H | —H | —H | —H | —H | —H | —H | —n-C3H7 | —H | (SB) |
| P-209 | —H | —H | —H | —H | —H | —H | —H | —H | —n-C3H7 | —H | (SB) |
| P-210 | —H | —H | —H | —H | —H | —H | —H | —H | —n-C3H7 | —H | (SB) |
| P-211 | —H | —H | —H | —H | —H | —H | —H | —H | —n-C3H7 | —H | (SB) |
| P-212 | —H | —H | —H | —H | —H | —H | —H | —H | —n-C3H7 | —H | (SB) |
| P-213 | —H | —H | —H | —H | —H | —H | —H | —H | —n-C3H7 | —H | (SB) |
| P-214 | —H | —H | —H | —H | —H | —H | —H | —H | —n-C3H7 | —H | (SB) |
| P-215 | —H | —H | —H | —H | —H | —H | —H | —H | —n-C3H7 | —H | (SB) |
| P-216 | —H | —H | —H | —H | —H | —H | —H | —H | —n-C3H7 | —H | (SB) |
| P-217 | —H | —H | —H | —H | —H | —H | —H | —H | —n-C3H7 | —H | (SB) |
| P-218 | —H | —H | —H | —H | —H | —H | —H | —H | —n-C3H7 | —H | (SB) |
| P-219 | —H | —H | —H | —H | —H | —H | —H | —H | —n-C3H7 | —H | (SB) |
| P-220 | —H | —F | —H | —F | —H | —F | —H | —F | —CH3 | —H | —O— |
| P-221 | —H | —F | —H | —F | —H | —F | —H | —F | —CH3 | —H | —O— |
| P-222 | —H | —F | —H | —F | —H | —F | —H | —F | —CH3 | —H | —O— |
| P-223 | —H | —F | —H | —F | —H | —F | —H | —F | —CH3 | —H | —O— |
| P-224 | —H | —F | —H | —F | —H | —F | —H | —F | —CH3 | —H | —O— |
| P-225 | —H | —F | —H | —F | —H | —F | —H | —F | —CH3 | —H | —O— |
| P-226 | —H | —F | —H | —F | —H | —F | —H | —F | —CH3 | —H | —O— |
| P-227 | —H | —F | —H | —F | —H | —F | —H | —F | —CH3 | —H | —O— |
| P-228 | —H | —F | —H | —F | —H | —F | —H | —F | —CH3 | —H | —O— |
| P-229 | —H | —F | —H | —F | —H | —F | —H | —F | —CH3 | —H | —O— |
| P-230 | —H | —I | —H | —H | —H | —I | —H | —H | —CH3 | —H | —O— |
| P-231 | —H | —I | —H | —H | —H | —I | —H | —H | —CH3 | —H | —O— |
| P-232 | —H | —I | —H | —H | —H | —I | —H | —H | —CH3 | —H | —O— |
| P-233 | —H | —I | —H | —H | —H | —I | —H | —H | —CH3 | —H | —O— |
| P-234 | —H | —I | —H | —H | —H | —I | —H | —H | —CH3 | —H | —O— |
| P-235 | —H | —I | —H | —H | —H | —I | —H | —H | —CH3 | —H | —O— |
| P-236 | —H | —I | —H | —H | —H | —I | —H | —H | —CH3 | —H | —O— |
| P-237 | —H | —I | —H | —H | —H | —I | —H | —H | —CH3 | —H | —O— |
| P-238 | —H | —I | —H | —H | —H | —I | —H | —H | —CH3 | —H | —O— |
| P-239 | —H | —I | —H | —H | —H | —I | —H | —H | —CH3 | —H | —O— |
| P-240 | —H | —NO2 | —H | —H | —H | —NO2 | —H | —H | —CH3 | —H | —O— |
| P-241 | —H | —NO2 | —H | —H | —H | —NO2 | —H | —H | —CH3 | —H | —O— |
| P-242 | —H | —NO2 | —H | —H | —H | —NO2 | —H | —H | —CH3 | —H | —O— |
| P-243 | —H | —NO2 | —H | —H | —H | —NO2 | —H | —H | —CH3 | —H | —O— |
| P-244 | —H | —NO2 | —H | —H | —H | —NO2 | —H | —H | —CH3 | —H | —O— |
| P-245 | —H | —NO2 | —H | —H | —H | —NO2 | —H | —H | —CH3 | —H | —O— |
| P-246 | —H | —NO2 | —H | —H | —H | —NO2 | —H | —H | —CH3 | —H | —O— |
| P-247 | —H | —NO2 | —H | —H | —H | —NO2 | —H | —H | —CH3 | —H | —O— |
| P-248 | —H | —NO2 | —H | —H | —H | —NO2 | —H | —H | —CH3 | —H | —O— |
| P-249 | —H | —NO2 | —H | —H | —H | —NO2 | —H | —H | —CH3 | —H | —O— |
| P-250 | —H | —CN | —H | —H | —H | —CN | —H | —H | —CH3 | —H | —O— |

| | α | | β | | | | | γ | | | | |
|---|---|---|---|---|---|---|---|---|---|---|---|---|
| | la | ma | R70 | R71 | Zb | lb | mb | R80 | R81 | Zc | lc | mc |
| P-201 | 1 | 40 | —H | —H | (SB) | 1 | 1 | — | — | — | 0 | 0 |
| R-202 | 1 | 50 | —H | —H | (SB) | 1 | 1 | — | — | — | 0 | 0 |
| P-203 | 1 | 60 | —H | —H | (SB) | 1 | 1 | — | — | — | 0 | 0 |
| P-204 | 1 | 70 | —H | —H | (SB) | 1 | 1 | — | — | — | 0 | 0 |
| P-205 | 2 | 1 | —H | —H | —H | 2 | 1 | — | — | — | 0 | 0 |
| P-206 | 2 | 2 | —H | —H | —H | 2 | 1 | — | — | — | 0 | 0 |
| P-207 | 2 | 3 | —H | —H | —H | 2 | 1 | — | — | — | 0 | 0 |
| P-208 | 2 | 4 | —H | —H | —H | 2 | 1 | — | — | — | 0 | 0 |
| P-209 | 2 | 5 | —H | —H | —H | 2 | 1 | — | — | — | 0 | 0 |
| P-210 | 2 | 6 | —H | —H | —H | 2 | 1 | — | — | — | 0 | 0 |
| P-211 | 2 | 7 | —H | —H | —H | 2 | 1 | — | — | — | 0 | 0 |
| P-212 | 2 | 8 | —H | —H | —H | 2 | 1 | — | — | — | 0 | 0 |
| P-213 | 2 | 9 | —H | —H | —H | 2 | 1 | — | — | — | 0 | 0 |
| P-214 | 2 | 10 | —H | —H | —H | 2 | 1 | — | — | — | 0 | 0 |
| P-215 | 2 | 20 | —H | —H | —H | 2 | 1 | — | — | — | 0 | 0 |
| P-216 | 2 | 30 | —H | —H | —H | 2 | 1 | — | — | — | 0 | 0 |
| P-217 | 2 | 40 | —H | —H | —H | 2 | 1 | — | — | — | 0 | 0 |
| P-218 | [symbol] | 1 | — | — | — | 0 | 0 | — | — | — | 0 | 0 |
| P-219 | 6 | 1 | —n-C3H7 | — | (SB) | 0 | 1 | — | — | — | 0 | 0 |
| P-220 | 1 | 1 | —H | —CH3 | (SB) | 1 | 1 | — | — | — | 0 | 0 |
| P-221 | 1 | 2 | —H | —CH3 | (SB) | 1 | 1 | — | — | — | 0 | 0 |
| P-222 | 1 | 3 | —H | —CH3 | (SB) | 1 | 1 | — | — | — | 0 | 0 |
| P-223 | 1 | 4 | —H | —CH3 | (SB) | 1 | 1 | — | — | — | 0 | 0 |
| P-224 | 1 | 5 | —H | —CH3 | (SB) | 1 | 1 | — | — | — | 0 | 0 |
| P-225 | 1 | 6 | —H | —CH3 | (SB) | 1 | 1 | — | — | — | 0 | 0 |
| P-226 | 1 | 7 | —H | —CH3 | (SB) | 1 | 1 | — | — | — | 0 | 0 |
| P-227 | 1 | 30 | —H | —CH3 | (SB) | 1 | 1 | — | — | — | 0 | 0 |
| P-228 | 1 | 32 | —H | —CH3 | (SB) | 1 | 1 | — | — | — | 0 | 0 |
| P-229 | 1 | 33 | —H | —CH3 | (SB) | 1 | 1 | — | — | — | 0 | 0 |
| P-230 | 1 | 1 | —H | —CH3 | (SB) | 1 | 1 | — | — | — | 0 | 0 |
| P-231 | 1 | 2 | —H | —CH3 | (SB) | 1 | 1 | — | — | — | 0 | 0 |
| P-232 | 1 | 3 | —H | —CH3 | (SB) | 1 | 1 | — | — | — | 0 | 0 |
| P-233 | 1 | 4 | —H | —CH3 | (SB) | 1 | 1 | — | — | — | 0 | 0 |
| P-234 | 1 | 5 | —H | —CH3 | (SB) | 1 | 1 | — | — | — | 0 | 0 |
| P-235 | 1 | 6 | —H | —CH3 | (SB) | 1 | 1 | — | — | — | 0 | 0 |
| P-236 | 1 | 7 | —H | —CH3 | (SB) | 1 | 1 | — | — | — | 0 | 0 |
| P-237 | 1 | 30 | —H | —CH3 | (SB) | 1 | 1 | — | — | — | 0 | 0 |
| P-238 | 1 | 32 | —H | —CH3 | (SB) | 1 | 1 | — | — | — | 0 | 0 |
| P-239 | 1 | 33 | —H | —CH3 | (SB) | 1 | 1 | — | — | — | 0 | 0 |
| P-240 | 1 | 1 | —H | —CH3 | (SB) | 1 | 1 | — | — | — | 0 | 0 |
| P-241 | 1 | 2 | —H | —CH3 | (SB) | 1 | 1 | — | — | — | 0 | 0 |
| P-242 | 1 | 3 | —H | —CH3 | (SB) | 1 | 1 | — | — | — | 0 | 0 |
| P-243 | 1 | 4 | —H | —CH3 | (SB) | 1 | 1 | — | — | — | 0 | 0 |
| P-244 | 1 | 5 | —H | —CH3 | (SB) | 1 | 1 | — | — | — | 0 | 0 |
| P-245 | 1 | 6 | —H | —CH3 | (SB) | 1 | 1 | — | — | — | 0 | 0 |
| P-246 | 1 | 7 | —H | —CH3 | (SB) | 1 | 1 | — | — | — | 0 | 0 |
| P-247 | 1 | 30 | —H | —CH3 | (SB) | 1 | 1 | — | — | — | 0 | 0 |
| P-248 | 1 | 32 | —H | —CH3 | (SB) | 1 | 1 | — | — | — | 0 | 0 |
| P-249 | 1 | 33 | —H | —CH3 | (SB) | 1 | 1 | — | — | — | 0 | 0 |
| P-250 | 1 | 1 | —H | —CH3 | (SB) | 1 | 1 | — | — | — | 0 | 0 |

[symbol]

indicates data missing or illegible when filed

TABLE 6

| | | | | | | | | | [symbol] | | | | | [symbol] | | | | | [symbol] | | | | |
|---|---|---|---|---|---|---|---|---|---|---|---|---|---|---|---|---|---|---|---|---|---|---|---|
| | R11 | R12 | R13 | R14 | R15 | R16 | R17 | R18 | R60 | R61 | Za | [symbol] | [symbol] | R70 | R71 | Zb | 1b | mb | R80 | R81 | Za | [symbol] | mc |
| P-251 | —H | —CN | —H | —H | —H | —CN | —H | —H | —CH3 | —H | —O— | 1 | 2 | —H | —CH3 | (SB) | 1 | 1 | — | — | — | 0 | 0 |
| P-252 | —H | —CN | —H | —H | —H | —CN | —H | —H | —CH3 | —H | —O— | 1 | 3 | —H | —CH3 | (SB) | 1 | 1 | — | — | — | 0 | 0 |
| P-253 | —H | —CN | —H | —H | —H | —CN | —H | —H | —CH3 | —H | —O— | 1 | 4 | —H | —CH3 | (SB) | 1 | 1 | — | — | — | 0 | 0 |
| P-254 | —H | —CN | —H | —H | —H | —CN | —H | —H | —CH3 | —H | —O— | 1 | 5 | —H | —CH3 | (SB) | 1 | 1 | — | — | — | 0 | 0 |
| P-255 | —H | —CN | —H | —H | —H | —CN | —H | —H | —CH3 | —H | —O— | 1 | 6 | —H | —CH3 | (SB) | 1 | 1 | — | — | — | 0 | 0 |
| P-256 | —H | —CN | —H | —H | —H | —CN | —H | —H | —CH3 | —H | —O— | 1 | 7 | —H | —CH3 | (SB) | 1 | 1 | — | — | — | 0 | 0 |
| P-257 | —H | —CN | —H | —H | —H | —CN | —H | —H | —CH3 | —H | —O— | 1 | 30 | —H | —CH3 | (SB) | 1 | 1 | — | — | — | 0 | 0 |
| P-258 | —H | —CN | —H | —H | —H | —CN | —H | —H | —CH3 | —H | —O— | 1 | 32 | —H | —CH3 | (SB) | 1 | 1 | — | — | — | 0 | 0 |
| P-259 | —H | —CN | —H | —H | —H | —CN | —H | —H | —CH3 | —H | —O— | 1 | 33 | —H | —CH3 | (SB) | 1 | 1 | — | — | — | 0 | 0 |
| P-260 | —H | —CN | —H | —H | —H | —CN | —H | —H | —CH3 | —H | —O— | 1 | 1 | —H | —CH3 | (SB) | 1 | 1 | — | — | — | 0 | 0 |
| P-261 | —H | —NH2 | —H | —H | —H | —NH2 | —H | —H | —CH3 | —H | —O— | 1 | 2 | —H | —CH3 | (SB) | 1 | 1 | — | — | — | 0 | 0 |
| P-262 | —H | —NH2 | —H | —H | —H | —NH2 | —H | —H | —CH3 | —H | —O— | 1 | 3 | —H | —CH3 | (SB) | 1 | 1 | — | — | — | 0 | 0 |
| P-263 | —H | —NH2 | —H | —H | —H | —NH2 | —H | —H | —CH3 | —H | —O— | 1 | 4 | —H | —CH3 | (SB) | 1 | 1 | — | — | — | 0 | 0 |
| P-264 | —H | —NH2 | —H | —H | —H | —NH2 | —H | —H | —CH3 | —H | —O— | 1 | 5 | —H | —CH3 | (SB) | 1 | 1 | — | — | — | 0 | 0 |
| P-265 | —H | —NH2 | —H | —H | —H | —NH2 | —H | —H | —CH3 | —H | —O— | 1 | 6 | —H | —CH3 | (SB) | 1 | 1 | — | — | — | 0 | 0 |
| P-266 | —H | —NH2 | —H | —H | —H | —NH2 | —H | —H | —CH3 | —H | —O— | 1 | 7 | —H | —CH3 | (SB) | 1 | 1 | — | — | — | 0 | 0 |
| P-267 | —H | —NH2 | —H | —H | —H | —NH2 | —H | —H | —CH3 | —H | —O— | 1 | 30 | —H | —CH3 | (SB) | 1 | 1 | — | — | — | 0 | 0 |
| P-268 | —H | —NH2 | —H | —H | —H | —NH2 | —H | —H | —CH3 | —H | —O— | 1 | 32 | —H | —CH3 | (SB) | 1 | 1 | — | — | — | 0 | 0 |
| P-269 | —H | —NH2 | —H | —H | —H | —NH2 | —H | —H | —CH3 | —H | —O— | 1 | 33 | —H | —CH3 | (SB) | 1 | 1 | — | — | — | 0 | 0 |
| P-270 | —H | —N(CH3)2 | —H | —H | —H | —N(CH3)2 | —H | —H | —CH3 | —H | —O— | 1 | 1 | —H | —CH3 | (SB) | 1 | 1 | — | — | — | 0 | 0 |
| P-271 | —H | —N(CH3)2 | —H | —H | —H | —N(CH3)2 | —H | —H | —CH3 | —H | —O— | 1 | 2 | —H | —CH3 | (SB) | 1 | 1 | — | — | — | 0 | 0 |
| P-272 | —H | —N(CH3)2 | —H | —H | —H | —N(CH3)2 | —H | —H | —CH3 | —H | —O— | 1 | 3 | —H | —CH3 | (SB) | 1 | 1 | — | — | — | 0 | 0 |
| P-273 | —H | —N(CH3)2 | —H | —H | —H | —N(CH3)2 | —H | —H | —CH3 | —H | —O— | 1 | 4 | —H | —CH3 | (SB) | 1 | 1 | — | — | — | 0 | 0 |
| P-274 | —H | —N(CH3)2 | —H | —H | —H | —N(CH3)2 | —H | —H | —CH3 | —H | —O— | 1 | 5 | —H | —CH3 | (SB) | 1 | 1 | — | — | — | 0 | 0 |
| P-275 | —H | —N(CH3)2 | —H | —H | —H | —N(CH3)2 | —H | —H | —CH3 | —H | —O— | 1 | 6 | —H | —CH3 | (SB) | 1 | 1 | — | — | — | 0 | 0 |
| P-276 | —H | —N(CH3)2 | —H | —H | —H | —N(CH3)2 | —H | —H | —CH3 | —H | —O— | 1 | 7 | —H | —CH3 | (SB) | 1 | 1 | — | — | — | 0 | 0 |
| P-277 | —H | —N(CH3)2 | —H | —H | —H | —N(CH3)2 | —H | —H | —CH3 | —H | —O— | 1 | 30 | —H | —CH3 | (SB) | 1 | 1 | — | — | — | 0 | 0 |
| P-278 | —H | —N(CH3)2 | —H | —H | —H | —N(CH3)2 | —H | —H | —CH3 | —H | —O— | 1 | 32 | —H | —CH3 | (SB) | 1 | 1 | — | — | — | 0 | 0 |
| P-279 | —H | —N(CH3)2 | —H | —H | —H | —N(CH3)2 | —H | —H | —CH3 | —H | —O— | 1 | 33 | —H | —CH3 | (SB) | 1 | 1 | — | — | — | 0 | 0 |
| P-280 | —H | [symbol] | —H | —H | —H | [symbol] | —H | —H | —CH3 | —H | —O— | 1 | 1 | —H | —CH3 | (SB) | 1 | 1 | — | — | — | 0 | 0 |
| P-281 | —H | [symbol] | —H | —H | —H | [symbol] | —H | —H | —CH3 | —H | —O— | 1 | 2 | —H | —CH3 | (SB) | 1 | 1 | — | — | — | 0 | 0 |
| P-282 | —H | [symbol] | —H | —H | —H | [symbol] | —H | —H | —CH3 | —H | —O— | 1 | 3 | —H | —CH3 | (SB) | 1 | 1 | — | — | — | 0 | 0 |
| P-283 | —H | [symbol] | —H | —H | —H | [symbol] | —H | —H | —CH3 | —H | —O— | 1 | 4 | —H | —CH3 | (SB) | 1 | 1 | — | — | — | 0 | 0 |
| P-284 | —H | [symbol] | —H | —H | —H | [symbol] | —H | —H | —CH3 | —H | —O— | 1 | 5 | —H | —CH3 | (SB) | 1 | 1 | — | — | — | 0 | 0 |
| P-285 | —H | [symbol] | —H | —H | —H | [symbol] | —H | —H | —CH3 | —H | —O— | 1 | 6 | —H | —CH3 | (SB) | 1 | 1 | — | — | — | 0 | 0 |
| P-286 | —H | [symbol] | —H | —H | —H | [symbol] | —H | —H | —CH3 | —H | —O— | 1 | 7 | —H | —CH3 | (SB) | 1 | 1 | — | — | — | 0 | 0 |
| P-287 | —H | [symbol] | —H | —H | —H | [symbol] | —H | —H | —CH3 | —H | —O— | 1 | 30 | —H | —CH3 | (SB) | 1 | 1 | — | — | — | 0 | 0 |
| P-288 | —H | [symbol] | —H | —H | —H | [symbol] | —H | —H | —CH3 | —H | —O— | 1 | 32 | —H | —CH3 | (SB) | 1 | 1 | — | — | — | 0 | 0 |
| P-299 | —H | [symbol] | —H | —H | —H | [symbol] | —H | —H | —CH3 | —H | —O— | 1 | 33 | —H | —CH3 | (SB) | 1 | 1 | — | — | — | 0 | 0 |
| P-290 | —H | 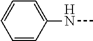 | —H | —H | —H | 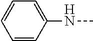 | —H | —H | —CH3 | —H | —O— | 1 | 1 | —H | —CH3 | (SB) | 1 | 1 | — | — | — | 0 | 0 |
| P-291 | —H | | —H | —H | —H | | —H | —H | —CH3 | —H | —O— | 1 | 2 | —H | —CH3 | (SB) | 1 | 1 | — | — | — | 0 | 0 |
| P-292 | —H | | —H | —H | —H | | —H | —H | —CH3 | —H | —O— | 1 | 3 | —H | —CH3 | (SB) | 1 | 1 | — | — | — | 0 | 0 |
| P-293 | —H | | —H | —H | —H | | —H | —H | —CH3 | —H | —O— | 1 | 4 | —H | —CH3 | (SB) | 1 | 1 | — | — | — | 0 | 0 |
| P-294 | —H | | —H | —H | —H | | —H | —H | —CH3 | —H | —O— | 1 | 5 | —H | —CH3 | (SB) | 1 | 1 | — | — | — | 0 | 0 |
| P-295 | —H | | —H | —H | —H | | —H | —H | —CH3 | —H | —O— | 1 | 56 | —H | —CH3 | (SB) | 1 | 1 | — | — | — | 0 | 0 |
| P-296 | —H | | —H | —H | —H | | —H | —H | —CH3 | —H | —O— | 1 | 7 | —H | —CH3 | (SB) | 1 | 1 | — | — | — | 0 | 0 |
| P-297 | —H | | —H | —H | —H | | —H | —H | —CH3 | —H | —O— | 1 | 30 | —H | —CH3 | (SB) | 1 | 1 | — | — | — | 0 | 0 |
| P-298 | —H | | —H | —H | —H | | —H | —H | —CH3 | —H | —O— | 1 | 32 | —H | —CH3 | (SB) | 1 | 1 | — | — | — | 0 | 0 |
| P-299 | —H | | —H | —H | —H | | —H | —H | —CH3 | —H | —O— | 1 | 33 | —H | —CH3 | (SB) | 1 | 1 | — | — | — | 0 | 0 |

[symbol]

indicates data missing or illegible when filed

TABLE 7

| | | | | | | | | | [symbol] | | | | | [symbol] | | | | | [symbol] | | | | |
|---|---|---|---|---|---|---|---|---|---|---|---|---|---|---|---|---|---|---|---|---|---|---|---|
| | R11 | R12 | R13 | R14 | R15 | R16 | R17 | R18 | R60 | R61 | Za | 1a | [symbol] | R70 | R71 | Zb | 1b | [symbol] | R80 | R81 | Zc | 1c | mc |
| P-300 | —H | 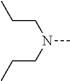 | —H | —H | —H | 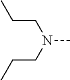 | —H | —H | —CH3 | —H | —O— | 1 | 1 | —H | —CH3 | (SB) | 1 | 1 | — | — | — | 0 | 0 |
| P-301 | —H | | —H | —H | —H | | —H | —H | —CH3 | —H | —O— | 1 | 2 | —H | —CH3 | (SB) | 1 | 1 | — | — | — | 0 | 0 |
| P-302 | —H | | —H | —H | —H | | —H | —H | —CH3 | —H | —O— | 1 | 3 | —H | —CH3 | (SB) | 1 | 1 | — | — | — | 0 | 0 |
| P-303 | —H | | —H | —H | —H | | —H | —H | —CH3 | —H | —O— | 1 | 4 | —H | —CH3 | (SB) | 1 | 1 | — | — | — | 0 | 0 |
| P-304 | —H | | —H | —H | —H | | —H | —H | —CH3 | —H | —O— | 1 | 5 | —H | —CH3 | (SB) | 1 | 1 | — | — | — | 0 | 0 |
| P-305 | —H | | —H | —H | —H | | —H | —H | —CH3 | —H | —O— | 1 | 6 | —H | —CH3 | (SB) | 1 | 1 | — | — | — | 0 | 0 |
| P-306 | —H | | —H | —H | —H | | —H | —H | —CH3 | —H | —O— | 1 | 7 | —H | —CH3 | (SB) | 1 | 1 | — | — | — | 0 | 0 |
| P-307 | —H | | —H | —H | —H | | —H | —H | —CH3 | —H | —O— | 1 | 30 | —H | —CH3 | (SB) | 1 | 1 | — | — | — | 0 | 0 |
| P-308 | —H | | —H | —H | —H | | —H | —H | —CH3 | —H | —O— | 1 | 32 | —H | —CH3 | (SB) | 1 | 1 | — | — | — | 0 | 0 |
| P-309 | —H | | —H | —H | —H | | —H | —H | —CH3 | —H | —O— | 1 | 33 | —H | —CH3 | (SB) | 1 | 1 | — | — | — | 0 | 0 |
| P-310 | —H | 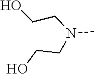 | —H | —H | —H | 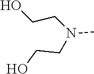 | —H | —H | —CH3 | —H | —O— | 1 | 1 | —H | —CH3 | (SB) | 1 | 1 | — | — | — | 0 | 0 |
| P-311 | —H | | —H | —H | —H | | —H | —H | —CH3 | —H | —O— | 1 | 2 | —H | —CH3 | (SB) | 1 | 1 | — | — | — | 0 | 0 |
| P-312 | —H | | —H | —H | —H | | —H | —H | —CH3 | —H | —O— | 1 | 3 | —H | —CH3 | (SB) | 1 | 1 | — | — | — | 0 | 0 |
| P-313 | —H | | —H | —H | —H | | —H | —H | —CH3 | —H | —O— | 1 | 4 | —H | —CH3 | (SB) | 1 | 1 | — | — | — | 0 | 0 |
| P-314 | —H | | —H | —H | —H | | —H | —H | —CH3 | —H | —O— | 1 | 5 | —H | —CH3 | (SB) | 1 | 1 | — | — | — | 0 | 0 |
| P-315 | —H | | —H | —H | —H | | —H | —H | —CH3 | —H | —O— | 1 | 6 | —H | —CH3 | (SB) | 1 | 1 | — | — | — | 0 | 0 |
| P-316 | —H | | —H | —H | —H | | —H | —H | —CH3 | —H | —O— | 1 | 7 | —H | —CH3 | (SB) | 1 | 1 | — | — | — | 0 | 0 |
| P-317 | —H | | —H | —H | —H | | —H | —H | —CH3 | —H | —O— | 1 | 30 | —H | —CH3 | (SB) | 1 | 1 | — | — | — | 0 | 0 |
| P-318 | —H | | —H | —H | —H | | —H | —H | —CH3 | —H | —O— | 1 | 32 | —H | —CH3 | (SB) | 1 | 1 | — | — | — | 0 | 0 |
| P-319 | —H | | —H | —H | —H | | —H | —H | —CH3 | —H | —O— | 1 | 33 | —H | —CH3 | (SB) | 1 | 1 | — | — | — | 0 | 0 |
| P-320 | —H | 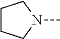 | —H | —H | —H | 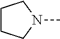 | —H | —H | —CH3 | —H | —O— | 1 | 1 | —H | —CH3 | (SB) | 1 | 1 | — | — | — | 0 | 0 |
| P-321 | —H | | —H | —H | —H | | —H | —H | —CH3 | —H | —O— | 1 | 2 | —H | —CH3 | (SB) | 1 | 1 | — | — | — | 0 | 0 |
| P-322 | —H | | —H | —H | —H | | —H | —H | —CH3 | —H | —O— | 1 | 3 | —H | —CH3 | (SB) | 1 | 1 | — | — | — | 0 | 0 |
| P-323 | —H | | —H | —H | —H | | —H | —H | —CH3 | —H | —O— | 1 | 4 | —H | —CH3 | (SB) | 1 | 1 | — | — | — | 0 | 0 |
| P-324 | —H | | —H | —H | —H | | —H | —H | —CH3 | —H | —O— | 1 | 5 | —H | —CH3 | (SB) | 1 | 1 | — | — | — | 0 | 0 |
| P-325 | —H | | —H | —H | —H | | —H | —H | —CH3 | —H | —O— | 1 | 6 | —H | —CH3 | (SB) | 1 | 1 | — | — | — | 0 | 0 |
| P-326 | —H | | —H | —H | —H | | —H | —H | —CH3 | —H | —O— | 1 | 7 | —H | —CH3 | (SB) | 1 | 1 | — | — | — | 0 | 0 |
| P-327 | —H | | —H | —H | —H | | —H | —H | —CH3 | —H | —O— | 1 | 30 | —H | —CH3 | (SB) | 1 | 1 | — | — | — | 0 | 0 |
| P-328 | —H | | —H | —H | —H | | —H | —H | —CH3 | —H | —O— | 1 | 32 | —H | —CH3 | (SB) | 1 | 1 | — | — | — | 0 | 0 |
| P-329 | —H | | —H | —H | —H | | —H | —H | —CH3 | —H | —O— | 1 | 33 | —H | —CH3 | (SB) | 1 | 1 | — | — | — | 0 | 0 |
| P-330 | —H | —OH | —H | —H | —H | —OH | —H | —H | —CH3 | —H | —O— | 1 | 1 | —H | —CH3 | (SB) | 1 | 1 | — | — | — | 0 | 0 |
| P-331 | —H | —OH | —H | —H | —H | —OH | —H | —H | —CH3 | —H | —O— | 1 | 2 | —H | —CH3 | (SB) | 1 | 1 | — | — | — | 0 | 0 |
| P-332 | —H | —OH | —H | —H | —H | —OH | —H | —H | —CH3 | —H | —O— | 1 | 3 | —H | —CH3 | (SB) | 1 | 1 | — | — | — | 0 | 0 |
| P-333 | —H | —OH | —H | —H | —H | —OH | —H | —H | —CH3 | —H | —O— | 1 | 4 | —H | —CH3 | (SB) | 1 | 1 | — | — | — | 0 | 0 |
| P-334 | —H | —OH | —H | —H | —H | —OH | —H | —H | —CH3 | —H | —O— | 1 | 5 | —H | —CH3 | (SB) | 1 | 1 | — | — | — | 0 | 0 |
| P-335 | —H | —OH | —H | —H | —H | —OH | —H | —H | —CH3 | —H | —O— | 1 | 6 | —H | —CH3 | (SB) | 1 | 1 | — | — | — | 0 | 0 |
| P-336 | —H | —OH | —H | —H | —H | —OH | —H | —H | —CH3 | —H | —O— | 1 | 7 | —H | —CH3 | (SB) | 1 | 1 | — | — | — | 0 | 0 |
| P-337 | —H | —OH | —H | —H | —H | —OH | —H | —H | —CH3 | —H | —O— | 1 | 30 | —H | —CH3 | (SB) | 1 | 1 | — | — | — | 0 | 0 |
| P-338 | —H | —OH | —H | —H | —H | —OH | —H | —H | —CH3 | —H | —O— | 1 | 32 | —H | —CH3 | (SB) | 1 | 1 | — | — | — | 0 | 0 |
| P-339 | —H | —OH | —H | —H | —H | —OH | —H | —H | —CH3 | —H | —O— | 1 | 33 | —H | —CH3 | (SB) | 1 | 1 | — | — | — | 0 | 0 |
| P-340 | —H | [symbol] | —H | —H | —H | [symbol] | —H | —H | —CH3 | —H | —O— | 1 | 1 | —H | —CH3 | (SB) | 1 | 1 | — | — | — | 0 | 0 |
| P-341 | —H | [symbol] | —H | —H | —H | [symbol] | —H | —H | —CH3 | —H | —O— | 1 | 2 | —H | —CH3 | (SB) | 1 | 1 | — | — | — | 0 | 0 |
| P-342 | —H | [symbol] | —H | —H | —H | [symbol] | —H | —H | —CH3 | —H | —O— | 1 | 3 | —H | —CH3 | (SB) | 1 | 1 | — | — | — | 0 | 0 |
| P-343 | —H | [symbol] | —H | —H | —H | [symbol] | —H | —H | —CH3 | —H | —O— | 1 | 4 | —H | —CH3 | (SB) | 1 | 1 | — | — | — | 0 | 0 |
| P-344 | —H | [symbol] | —H | —H | —H | [symbol] | —H | —H | —CH3 | —H | —O— | 1 | 5 | —H | —CH3 | (SB) | 1 | 1 | — | — | — | 0 | 0 |
| P-345 | —H | [symbol] | —H | —H | —H | [symbol] | —H | —H | —CH3 | —H | —O— | 1 | 6 | —H | —CH3 | (SB) | 1 | 1 | — | — | — | 0 | 0 |
| P-346 | —H | [symbol] | —H | —H | —H | [symbol] | —H | —H | —CH3 | —H | —O— | 1 | 7 | —H | —CH3 | (SB) | 1 | 1 | — | — | — | 0 | 0 |
| P-347 | —H | [symbol] | —H | —H | —H | [symbol] | —H | —H | —CH3 | —H | —O— | 1 | 30 | —H | —CH3 | (SB) | 1 | 1 | — | — | — | 0 | 0 |
| P-348 | —H | [symbol] | —H | —H | —H | [symbol] | —H | —H | —CH3 | —H | —O— | 1 | 32 | —H | —CH3 | (SB) | 1 | 1 | — | — | — | 0 | 0 |
| P-349 | —H | [symbol] | —H | —H | —H | [symbol] | —H | —H | —CH3 | —H | —O— | 1 | 33 | —H | —CH3 | (SB) | 1 | 1 | — | — | — | 0 | 0 |
| P-350 | —H | [symbol] | —H | —H | —H | [symbol] | —H | —H | —CH3 | —H | —O— | 1 | 1 | —H | —CH3 | (SB) | 1 | 1 | — | — | — | 0 | 0 |

[symbol]

indicates data missing or illegible when filed

TABLE 8

| | | | | | | | | | α | | | | | β | | | | | γ | | | | |
|---|---|---|---|---|---|---|---|---|---|---|---|---|---|---|---|---|---|---|---|---|---|---|---|
| | R11 | R12 | R13 | R14 | R15 | R16 | R17 | R18 | R60 | R61 | Za | Ia | ma | R70 | R71 | Zb | 1b | mb | R80 | R81 | Zc | Ic | mc |
| P-351 | —H | [symbol] | —H | —H | —H | [symbol] | —H | —H | —CH3 | —H | —O— | 1 | 2 | —H | —CH3 | (SB) | 1 | 1 | — | — | — | 0 | 0 |
| P-352 | —H | [symbol] | —H | —H | —H | [symbol] | —H | —H | —CH3 | —H | —O— | 1 | 3 | —H | —CH3 | (SB) | 1 | 1 | — | — | — | 0 | 0 |
| P-353 | —H | [symbol] | —H | —H | —H | [symbol] | —H | —H | —CH3 | —H | —O— | 1 | 4 | —H | —CH3 | (SB) | 1 | 1 | — | — | — | 0 | 0 |
| P-354 | —H | [symbol] | —H | —H | —H | [symbol] | —H | —H | —CH3 | —H | —O— | 1 | 5 | —H | —CH3 | (SB) | 1 | 1 | — | — | — | 0 | 0 |
| P-355 | —H | [symbol] | —H | —H | —H | [symbol] | —H | —H | —CH3 | —H | —O— | 1 | 6 | —H | —CH3 | (SB) | 1 | 1 | — | — | — | 0 | 0 |
| P-356 | —H | [symbol] | —H | —H | —H | [symbol] | —H | —H | —CH3 | —H | —O— | 1 | 7 | —H | —CH3 | (SB) | 1 | 1 | — | — | — | 0 | 0 |
| P-357 | —H | [symbol] | —H | —H | —H | [symbol] | —H | —H | —CH3 | —H | —O— | 1 | 30 | —H | —CH3 | (SB) | 1 | 1 | — | — | — | 0 | 0 |
| P-358 | —H | [symbol] | —H | —H | —H | [symbol] | —H | —H | —CH3 | —H | —O— | 1 | 32 | —H | —CH3 | (SB) | 1 | 1 | — | — | — | 0 | 0 |
| P-359 | —H | [symbol] | —H | —H | —H | [symbol] | —H | —H | —CH3 | —H | —O— | 1 | 33 | —H | —CH3 | (SB) | 1 | 1 | — | — | — | 0 | 0 |
| P-360 | —H | 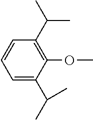 | —H | —H | —H | 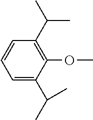 | —H | —H | —CH3 | —H | —O— | 1 | 1 | —H | —CH3 | (SB) | 1 | 1 | — | — | — | 0 | 0 |
| P-361 | —H | | —H | —H | —H | | —H | —H | —CH3 | —H | —O— | 1 | 2 | —H | —CH3 | (SB) | 1 | 1 | — | — | — | 0 | 0 |
| P-362 | —H | | —H | —H | —H | | —H | —H | —CH3 | —H | —O— | 1 | 3 | —H | —CH3 | (SB) | 1 | 1 | — | — | — | 0 | 0 |
| P-363 | —H | | —H | —H | —H | | —H | —H | —CH3 | —H | —O— | 1 | 4 | —H | —CH3 | (SB) | 1 | 1 | — | — | — | 0 | 0 |
| P-364 | —H | | —H | —H | —H | | —H | —H | —CH3 | —H | —O— | 1 | 5 | —H | —CH3 | (SB) | 1 | 1 | — | — | — | 0 | 0 |
| P-365 | —H | | —H | —H | —H | | —H | —H | —CH3 | —H | —O— | 1 | 6 | —H | —CH3 | (SB) | 1 | 1 | — | — | — | 0 | 0 |
| P-366 | —H | | —H | —H | —H | | —H | —H | —CH3 | —H | —O— | 1 | 7 | —H | —CH3 | (SB) | 1 | 1 | — | — | — | 0 | 0 |
| P-367 | —H | | —H | —H | —H | | —H | —H | —CH3 | —H | —O— | 1 | 30 | —H | —CH3 | (SB) | 1 | 1 | — | — | — | 0 | 0 |
| P-368 | —H | | —H | —H | —H | | —H | —H | —CH3 | —H | —O— | 1 | 32 | —H | —CH3 | (SB) | 1 | 1 | — | — | — | 0 | 0 |
| P-369 | —H | | —H | —H | —H | | —H | —H | —CH3 | —H | —O— | 1 | 33 | —H | —CH3 | (SB) | 1 | 1 | — | — | — | 0 | 0 |
| P-370 | —H | 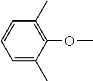 | —H | —H | —H | 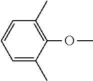 | —H | —H | —CH3 | —H | —O— | 1 | 1 | —H | —CH3 | (SB) | 1 | 1 | — | — | — | 0 | 0 |
| P-371 | —H | | —H | —H | —H | | —H | —H | —CH3 | —H | —O— | 1 | 2 | —H | —CH3 | (SB) | 1 | 1 | — | — | — | 0 | 0 |
| P-372 | —H | | —H | —H | —H | | —H | —H | —CH3 | —H | —O— | 1 | 3 | —H | —CH3 | (SB) | 1 | 1 | — | — | — | 0 | 0 |
| P-373 | —H | | —H | —H | —H | | —H | —H | —CH3 | —H | —O— | 1 | 4 | —H | —CH3 | (SB) | 1 | 1 | — | — | — | 0 | 0 |
| P-374 | —H | | —H | —H | —H | | —H | —H | —CH3 | —H | —O— | 1 | 5 | —H | —CH3 | (SB) | 1 | 1 | — | — | — | 0 | 0 |
| P-375 | —H | | —H | —H | —H | | —H | —H | —CH3 | —H | —O— | 1 | 6 | —H | —CH3 | (SB) | 1 | 1 | — | — | — | 0 | 0 |
| P-376 | —H | | —H | —H | —H | | —H | —H | —CH3 | —H | —O— | 1 | 7 | —H | —CH3 | (SB) | 1 | 1 | — | — | — | 0 | 0 |
| P-377 | —H | | —H | —H | —H | | —H | —H | —CH3 | —H | —O— | 1 | 30 | —H | —CH3 | (SB) | 1 | 1 | — | — | — | 0 | 0 |
| P-378 | —H | | —H | —H | —H | | —H | —H | —CH3 | —H | —O— | 1 | 32 | —H | —CH3 | (SB) | 1 | 1 | — | — | — | 0 | 0 |
| P-379 | —H | | —H | —H | —H | | —H | —H | —CH3 | —H | —O— | 1 | 33 | —H | —CH3 | (SB) | 1 | 1 | — | — | — | 0 | 0 |
| P-380 | —H | 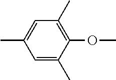 | —H | —H | —H | 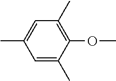 | —H | —H | —CH3 | —H | —O— | 1 | 1 | —H | —CH3 | (SB) | 1 | 1 | — | — | — | 0 | 0 |
| P-381 | —H | | —H | —H | —H | | —H | —H | —CH3 | —H | —O— | 1 | 2 | —H | —CH3 | (SB) | 1 | 1 | — | — | — | 0 | 0 |
| P-382 | —H | | —H | —H | —H | | —H | —H | —CH3 | —H | —O— | 1 | 3 | —H | —CH3 | (SB) | 1 | 1 | — | — | — | 0 | 0 |
| P-383 | —H | | —H | —H | —H | | —H | —H | —CH3 | —H | —O— | 1 | 4 | —H | —CH3 | (SB) | 1 | 1 | — | — | — | 0 | 0 |
| P-384 | —H | | —H | —H | —H | | —H | —H | —CH3 | —H | —O— | 1 | 5 | —H | —CH3 | (SB) | 1 | 1 | — | — | — | 0 | 0 |
| P-385 | —H | | —H | —H | —H | | —H | —H | —CH3 | —H | —O— | 1 | 6 | —H | —CH3 | (SB) | 1 | 1 | — | — | — | 0 | 0 |
| P-386 | —H | | —H | —H | —H | | —H | —H | —CH3 | —H | —O— | 1 | 7 | —H | —CH3 | (SB) | 1 | 1 | — | — | — | 0 | 0 |
| P-387 | —H | | —H | —H | —H | | —H | —H | —CH3 | —H | —O— | 1 | 30 | —H | —CH3 | (SB) | 1 | 1 | — | — | — | 0 | 0 |
| P-388 | —H | | —H | —H | —H | | —H | —H | —CH3 | —H | —O— | 1 | 32 | —H | —CH3 | (SB) | 1 | 1 | — | — | — | 0 | 0 |
| P-389 | —H | | —H | —H | —H | | —H | —H | —CH3 | —H | —O— | 1 | 33 | —H | —CH3 | (SB) | 1 | 1 | — | — | — | 0 | 0 |
| P-390 | —H | —CH3 | —H | —H | —H | —CH3 | —H | —H | —CH3 | —H | —O— | 1 | 1 | —H | —CH3 | (SB) | 1 | 1 | — | — | — | 0 | 0 |
| P-391 | —H | —CH3 | —H | —H | —H | —CH3 | —H | —H | —CH3 | —H | —O— | 1 | 2 | —H | —CH3 | (SB) | 1 | 1 | — | — | — | 0 | 0 |
| P-392 | —H | —CH3 | —H | —H | —H | —CH3 | —H | —H | —CH3 | —H | —O— | 1 | 3 | —H | —CH3 | (SB) | 1 | 1 | — | — | — | 0 | 0 |
| P-393 | —H | —CH3 | —H | —H | —H | —CH3 | —H | —H | —CH3 | —H | —O— | 1 | 4 | —H | —CH3 | (SB) | 1 | 1 | — | — | — | 0 | 0 |
| P-394 | —H | —CH3 | —H | —H | —H | —CH3 | —H | —H | —CH3 | —H | —O— | 1 | 5 | —H | —CH3 | (SB) | 1 | 1 | — | — | — | 0 | 0 |
| P-395 | —H | —CH3 | —H | —H | —H | —CH3 | —H | —H | —CH3 | —H | —O— | 1 | 6 | —H | —CH3 | (SB) | 1 | 1 | — | — | — | 0 | 0 |
| P-396 | —H | —CH3 | —H | —H | —H | —CH3 | —H | —H | —CH3 | —H | —O— | 1 | 7 | —H | —CH3 | (SB) | 1 | 1 | — | — | — | 0 | 0 |
| P-397 | —H | —CH3 | —H | —H | —H | —CH3 | —H | —H | —CH3 | —H | —O— | 1 | 30 | —H | —CH3 | (SB) | 1 | 1 | — | — | — | 0 | 0 |
| P-398 | —H | —CH3 | —H | —H | —H | —CH3 | —H | —H | —CH3 | —H | —O— | 1 | 32 | —H | —CH3 | (SB) | 1 | 1 | — | — | — | 0 | 0 |
| P-399 | —H | —CH3 | —H | —H | —H | —CH3 | —H | —H | —CH3 | —H | —O— | 1 | 33 | —H | —CH3 | (SB) | 1 | 1 | — | — | — | 0 | 0 |

[symbol]

indicates data missing or illegible when filed

TABLE 9

| | | | | | | | | | α | | | | | β | | | | | γ | | | | |
|---|---|---|---|---|---|---|---|---|---|---|---|---|---|---|---|---|---|---|---|---|---|---|---|
| | R11 | R12 | R13 | R14 | R15 | R16 | R17 | R18 | R60 | R61 | Za | Ia | ma | R70 | R71 | Zb | 1b | mb | R80 | R81 | Zc | Ic | mc |
| P-400 | —H | [symbol] | —H | —H | —H | [symbol] | —H | —H | —CH3 | —H | —O— | 1 | 1 | —H | —CH3 | (SB) | 1 | 1 | — | — | — | 0 | 0 |
| P-401 | —H | [symbol] | —H | —H | —H | [symbol] | —H | —H | —CH3 | —H | —O— | 1 | 2 | —H | —CH3 | (SB) | 1 | 1 | — | — | — | 0 | 0 |
| P-402 | —H | [symbol] | —H | —H | —H | [symbol] | —H | —H | —CH3 | —H | —O— | 1 | 3 | —H | —CH3 | (SB) | 1 | 1 | — | — | — | 0 | 0 |
| P-403 | —H | [symbol] | —H | —H | —H | [symbol] | —H | —H | —CH3 | —H | —O— | 1 | 4 | —H | —CH3 | (SB) | 1 | 1 | — | — | — | 0 | 0 |
| P-404 | —H | [symbol] | —H | —H | —H | [symbol] | —H | —H | —CH3 | —H | —O— | 1 | 5 | —H | —CH3 | (SB) | 1 | 1 | — | — | — | 0 | 0 |
| P-405 | —H | [symbol] | —H | —H | —H | [symbol] | —H | —H | —CH3 | —H | —O— | 1 | 6 | —H | —CH3 | (SB) | 1 | 1 | — | — | — | 0 | 0 |
| P-406 | —H | [symbol] | —H | —H | —H | [symbol] | —H | —H | —CH3 | —H | —O— | 1 | 7 | —H | —CH3 | (SB) | 1 | 1 | — | — | — | 0 | 0 |
| P-407 | —H | [symbol] | —H | —H | —H | [symbol] | —H | —H | —CH3 | —H | —O— | 1 | 30 | —H | —CH3 | (SB) | 1 | 1 | — | — | — | 0 | 0 |
| P-408 | —H | [symbol] | —H | —H | —H | [symbol] | —H | —H | —CH3 | —H | —O— | 1 | 32 | —H | —CH3 | (SB) | 1 | 1 | — | — | — | 0 | 0 |
| P-409 | —H | [symbol] | —H | —H | —H | [symbol] | —H | —H | —CH3 | —H | —O— | 1 | 33 | —H | —CH3 | (SB) | 1 | 1 | — | — | — | 0 | 0 |
| P-410 | —H | [symbol] | —H | —H | —H | [symbol] | —H | —H | —CH3 | —H | —O— | 1 | 1 | —H | —CH3 | (SB) | 1 | 1 | — | — | — | 0 | 0 |
| P-411 | —H | [symbol] | —H | —H | —H | [symbol] | —H | —H | —CH3 | —H | —O— | 1 | 2 | —H | —CH3 | (SB) | 1 | 1 | — | — | — | 0 | 0 |
| P-412 | —H | [symbol] | —H | —H | —H | [symbol] | —H | —H | —CH3 | —H | —O— | 1 | 3 | —H | —CH3 | (SB) | 1 | 1 | — | — | — | 0 | 0 |
| P-413 | —H | [symbol] | —H | —H | —H | [symbol] | —H | —H | —CH3 | —H | —O— | 1 | 4 | —H | —CH3 | (SB) | 1 | 1 | — | — | — | 0 | 0 |
| P-414 | —H | [symbol] | —H | —H | —H | [symbol] | —H | —H | —CH3 | —H | —O— | 1 | 5 | —H | —CH3 | (SB) | 1 | 1 | — | — | — | 0 | 0 |
| P-415 | —H | [symbol] | —H | —H | —H | [symbol] | —H | —H | —CH3 | —H | —O— | 1 | 6 | —H | —CH3 | (SB) | 1 | 1 | — | — | — | 0 | 0 |
| P-416 | —H | [symbol] | —H | —H | —H | [symbol] | —H | —H | —CH3 | —H | —O— | 1 | 7 | —H | —CH3 | (SB) | 1 | 1 | — | — | — | 0 | 0 |
| P-417 | —H | [symbol] | —H | —H | —H | [symbol] | —H | —H | —CH3 | —H | —O— | 1 | 30 | —H | —CH3 | (SB) | 1 | 1 | — | — | — | 0 | 0 |
| P-418 | —H | [symbol] | —H | —H | —H | [symbol] | —H | —H | —CH3 | —H | —O— | 1 | 32 | —H | —CH3 | (SB) | 1 | 1 | — | — | — | 0 | 0 |
| P-419 | —H | [symbol] | —H | —H | —H | [symbol] | —H | —H | —CH3 | —H | —O— | 1 | 33 | —H | —CH3 | (SB) | 1 | 1 | — | — | — | 0 | 0 |
| P-420 | —H | 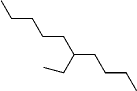 | —H | —H | —H | 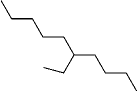 | —H | —H | —CH3 | —H | —O— | 1 | 1 | —H | —CH3 | (SB) | 1 | 1 | — | — | — | 0 | 0 |
| P-421 | —H | | —H | —H | —H | | —H | —H | —CH3 | —H | —O— | 1 | 2 | —H | —CH3 | (SB) | 1 | 1 | — | — | — | 0 | 0 |
| P-422 | —H | | —H | —H | —H | | —H | —H | —CH3 | —H | —O— | 1 | 3 | —H | —CH3 | (SB) | 1 | 1 | — | — | — | 0 | 0 |
| P-423 | —H | | —H | —H | —H | | —H | —H | —CH3 | —H | —O— | 1 | 4 | —H | —CH3 | (SB) | 1 | 1 | — | — | — | 0 | 0 |
| P-424 | —H | | —H | —H | —H | | —H | —H | —CH3 | —H | —O— | 1 | 5 | —H | —CH3 | (SB) | 1 | 1 | — | — | — | 0 | 0 |
| P-425 | —H | | —H | —H | —H | | —H | —H | —CH3 | —H | —O— | 1 | 6 | —H | —CH3 | (SB) | 1 | 1 | — | — | — | 0 | 0 |
| P-426 | —H | | —H | —H | —H | | —H | —H | —CH3 | —H | —O— | 1 | 7 | —H | —CH3 | (SB) | 1 | 1 | — | — | — | 0 | 0 |
| P-427 | —H | | —H | —H | —H | | —H | —H | —CH3 | —H | —O— | 1 | 30 | —H | —CH3 | (SB) | 1 | 1 | — | — | — | 0 | 0 |
| P-428 | —H | | —H | —H | —H | | —H | —H | —CH3 | —H | —O— | 1 | 32 | —H | —CH3 | (SB) | 1 | 1 | — | — | — | 0 | 0 |
| P-429 | —H | | —H | —H | —H | | —H | —H | —CH3 | —H | —O— | 1 | 33 | —H | —CH3 | (SB) | 1 | 1 | — | — | — | 0 | 0 |
| P-430 | —H | 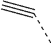 | —H | —H | —H | 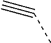 | —H | —H | —CH3 | —H | —O— | 1 | 1 | —H | —CH3 | (SB) | 1 | 1 | — | — | — | 0 | 0 |
| P-431 | —H | | —H | —H | —H | | —H | —H | —CH3 | —H | —O— | 1 | 2 | —H | —CH3 | (SB) | 1 | 1 | — | — | — | 0 | 0 |
| P-432 | —H | | —H | —H | —H | | —H | —H | —CH3 | —H | —O— | 1 | 3 | —H | —CH3 | (SB) | 1 | 1 | — | — | — | 0 | 0 |
| P-433 | —H | | —H | —H | —H | | —H | —H | —CH3 | —H | —O— | 1 | 4 | —H | —CH3 | (SB) | 1 | 1 | — | — | — | 0 | 0 |
| P-434 | —H | | —H | —H | —H | | —H | —H | —CH3 | —H | —O— | 1 | 5 | —H | —CH3 | (SB) | 1 | 1 | — | — | — | 0 | 0 |
| P-435 | —H | | —H | —H | —H | | —H | —H | —CH3 | —H | —O— | 1 | 6 | —H | —CH3 | (SB) | 1 | 1 | — | — | — | 0 | 0 |
| P-436 | —H | | —H | —H | —H | | —H | —H | —CH3 | —H | —O— | 1 | 7 | —H | —CH3 | (SB) | 1 | 1 | — | — | — | 0 | 0 |
| P-437 | —H | | —H | —H | —H | | —H | —H | —CH3 | —H | —O— | 1 | 30 | —H | —CH3 | (SB) | 1 | 1 | — | — | — | 0 | 0 |
| P-438 | —H | | —H | —H | —H | | —H | —H | —CH3 | —H | —O— | 1 | 32 | —H | —CH3 | (SB) | 1 | 1 | — | — | — | 0 | 0 |
| P-439 | —H | | —H | —H | —H | | —H | —H | —CH3 | —H | —O— | 1 | 33 | —H | —CH3 | (SB) | 1 | 1 | — | — | — | 0 | 0 |
| P-440 | —H | 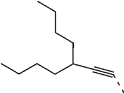 | —H | —H | —H | 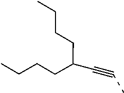 | —H | —H | —CH3 | —H | —O— | 1 | 1 | —H | —CH3 | (SB) | 1 | 1 | — | — | — | 0 | 0 |
| P-441 | —H | | —H | —H | —H | | —H | —H | —CH3 | —H | —O— | 1 | 2 | —H | —CH3 | (SB) | 1 | 1 | — | — | — | 0 | 0 |
| P-442 | —H | | —H | —H | —H | | —H | —H | —CH3 | —H | —O— | 1 | 3 | —H | —CH3 | (SB) | 1 | 1 | — | — | — | 0 | 0 |
| P-443 | —H | | —H | —H | —H | | —H | —H | —CH3 | —H | —O— | 1 | 4 | —H | —CH3 | (SB) | 1 | 1 | — | — | — | 0 | 0 |
| P-444 | —H | | —H | —H | —H | | —H | —H | —CH3 | —H | —O— | 1 | 5 | —H | —CH3 | (SB) | 1 | 1 | — | — | — | 0 | 0 |
| P-445 | —H | | —H | —H | —H | | —H | —H | —CH3 | —H | —O— | 1 | 6 | —H | —CH3 | (SB) | 1 | 1 | — | — | — | 0 | 0 |
| P-446 | —H | | —H | —H | —H | | —H | —H | —CH3 | —H | —O— | 1 | 7 | —H | —CH3 | (SB) | 1 | 1 | — | — | — | 0 | 0 |
| P-447 | —H | | —H | —H | —H | | —H | —H | —CH3 | —H | —O— | 1 | 30 | —H | —CH3 | (SB) | 1 | 1 | — | — | — | 0 | 0 |
| P-448 | —H | | —H | —H | —H | | —H | —H | —CH3 | —H | —O— | 1 | 32 | —H | —CH3 | (SB) | 1 | 1 | — | — | — | 0 | 0 |
| P-449 | —H | | —H | —H | —H | | —H | —H | —CH3 | —H | —O— | 1 | 33 | —H | —CH3 | (SB) | 1 | 1 | — | — | — | 0 | 0 |

[symbol]

indicates data missing or illegible when filed

TABLE 10

| | | | | | | | | | α | | | | | β | | | | | γ | | | | |
|---|---|---|---|---|---|---|---|---|---|---|---|---|---|---|---|---|---|---|---|---|---|---|---|
| | R11 | R12 | R13 | R14 | R15 | R16 | R17 | R18 | R60 | R61 | Za | Ia | ma | R70 | R71 | Zb | 1b | mb | R80 | R81 | Zc | Ic | mc |
| P-450 | —H | 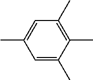 | —H | —H | —H | 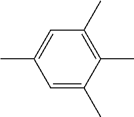 | —H | —H | —CH3 | —H | —O— | 1 | 1 | —H | —CH3 | (SB) | 1 | 1 | — | — | — | 0 | 0 |
| P-451 | —H | | —H | —H | —H | | —H | —H | —CH3 | —H | —O— | 1 | 2 | —H | —CH3 | (SB) | 1 | 1 | — | — | — | 0 | 0 |
| P-452 | —H | | —H | —H | —H | | —H | —H | —CH3 | —H | —O— | 1 | 3 | —H | —CH3 | (SB) | 1 | 1 | — | — | — | 0 | 0 |
| P-453 | —H | | —H | —H | —H | | —H | —H | —CH3 | —H | —O— | 1 | 4 | —H | —CH3 | (SB) | 1 | 1 | — | — | — | 0 | 0 |
| P-454 | —H | | —H | —H | —H | | —H | —H | —CH3 | —H | —O— | 1 | 5 | —H | —CH3 | (SB) | 1 | 1 | — | — | — | 0 | 0 |
| P-455 | —H | | —H | —H | —H | | —H | —H | —CH3 | —H | —O— | 1 | 6 | —H | —CH3 | (SB) | 1 | 1 | — | — | — | 0 | 0 |
| P-456 | —H | | —H | —H | —H | | —H | —H | —CH3 | —H | —O— | 1 | 7 | —H | —CH3 | (SB) | 1 | 1 | — | — | — | 0 | 0 |
| P-457 | —H | | —H | —H | —H | | —H | —H | —CH3 | —H | —O— | 1 | 30 | —H | —CH3 | (SB) | 1 | 1 | — | — | — | 0 | 0 |
| P-458 | —H | | —H | —H | —H | | —H | —H | —CH3 | —H | —O— | 1 | 32 | —H | —CH3 | (SB) | 1 | 1 | — | — | — | 0 | 0 |
| P-459 | —H | | —H | —H | —H | | —H | —H | —CH3 | —H | —O— | 1 | 33 | —H | —CH3 | (SB) | 1 | 1 | — | — | — | 0 | 0 |
| P-460 | —H | 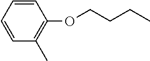 | —H | —H | —H | 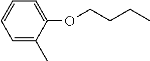 | —H | —H | —CH3 | —H | —O— | 1 | 1 | —H | —CH3 | (SB) | 1 | 1 | — | — | — | 0 | 0 |
| P-461 | —H | | —H | —H | —H | | —H | —H | —CH3 | —H | —O— | 1 | 2 | —H | —CH3 | (SB) | 1 | 1 | — | — | — | 0 | 0 |
| P-462 | —H | | —H | —H | —H | | —H | —H | —CH3 | —H | —O— | 1 | 3 | —H | —CH3 | (SB) | 1 | 1 | — | — | — | 0 | 0 |
| P-463 | —H | | —H | —H | —H | | —H | —H | —CH3 | —H | —O— | 1 | 4 | —H | —CH3 | (SB) | 1 | 1 | — | — | — | 0 | 0 |
| P-464 | —H | | —H | —H | —H | | —H | —H | —CH3 | —H | —O— | 1 | 5 | —H | —CH3 | (SB) | 1 | 1 | — | — | — | 0 | 0 |
| P-465 | —H | | —H | —H | —H | | —H | —H | —CH3 | —H | —O— | 1 | 6 | —H | —CH3 | (SB) | 1 | 1 | — | — | — | 0 | 0 |
| P-466 | —H | | —H | —H | —H | | —H | —H | —CH3 | —H | —O— | 1 | 7 | —H | —CH3 | (SB) | 1 | 1 | — | — | — | 0 | 0 |
| P-467 | —H | | —H | —H | —H | | —H | —H | —CH3 | —H | —O— | 1 | 30 | —H | —CH3 | (SB) | 1 | 1 | — | — | — | 0 | 0 |
| P-468 | —H | | —H | —H | —H | | —H | —H | —CH3 | —H | —O— | 1 | 32 | —H | —CH3 | (SB) | 1 | 1 | — | — | — | 0 | 0 |
| P-469 | —H | | —H | —H | —H | | —H | —H | —CH3 | —H | —O— | 1 | 33 | —H | —CH3 | (SB) | 1 | 1 | — | — | — | 0 | 0 |
| P-470 | —H | —CF3 | —H | —H | —H | —CF3 | —H | —H | —CH3 | —H | —O— | 1 | 1 | —H | —CH3 | (SB) | 1 | 1 | — | — | — | 0 | 0 |
| P-471 | —H | —CF3 | —H | —H | —H | —CF3 | —H | —H | —CH3 | —H | —O— | 1 | 2 | —H | —CH3 | (SB) | 1 | 1 | — | — | — | 0 | 0 |
| P-472 | —H | —CF3 | —H | —H | —H | —CF3 | —H | —H | —CH3 | —H | —O— | 1 | 3 | —H | —CH3 | (SB) | 1 | 1 | — | — | — | 0 | 0 |
| P-473 | —H | —CF3 | —H | —H | —H | —CF3 | —H | —H | —CH3 | —H | —O— | 1 | 4 | —H | —CH3 | (SB) | 1 | 1 | — | — | — | 0 | 0 |
| P-474 | —H | —CF3 | —H | —H | —H | —CF3 | —H | —H | —CH3 | —H | —O— | 1 | 5 | —H | —CH3 | (SB) | 1 | 1 | — | — | — | 0 | 0 |
| P-475 | —H | —CF3 | —H | —H | —H | —CF3 | —H | —H | —CH3 | —H | —O— | 1 | 6 | —H | —CH3 | (SB) | 1 | 1 | — | — | — | 0 | 0 |
| P-476 | —H | —CF3 | —H | —H | —H | —CF3 | —H | —H | —CH3 | —H | —O— | 1 | 7 | —H | —CH3 | (SB) | 1 | 1 | — | — | — | 0 | 0 |
| P-477 | —H | —CF3 | —H | —H | —H | —CF3 | —H | —H | —CH3 | —H | —O— | 1 | 30 | —H | —CH3 | (SB) | 1 | 1 | — | — | — | 0 | 0 |
| P-478 | —H | —CF3 | —H | —H | —H | —CF3 | —H | —H | —CH3 | —H | —O— | 1 | 32 | —H | —CH3 | (SB) | 1 | 1 | — | — | — | 0 | 0 |
| P-479 | —H | —CF3 | —H | —H | —H | —CF3 | —H | —H | —CH3 | —H | —O— | 1 | 33 | —H | —CH3 | (SB) | 1 | 1 | — | — | — | 0 | 0 |
| P-480 | —H | [symbol] | —H | —H | —H | [symbol] | —H | —H | —CH3 | —H | —O— | 1 | 1 | —H | —CH3 | (SB) | 1 | 1 | — | — | — | 0 | 0 |
| P-481 | —H | [symbol] | —H | —H | —H | [symbol] | —H | —H | —CH3 | —H | —O— | 1 | 2 | —H | —CH3 | (SB) | 1 | 1 | — | — | — | 0 | 0 |
| P-482 | —H | [symbol] | —H | —H | —H | [symbol] | —H | —H | —CH3 | —H | —O— | 1 | 3 | —H | —CH3 | (SB) | 1 | 1 | — | — | — | 0 | 0 |
| P-488 | —H | [symbol] | —H | —H | —H | [symbol] | —H | —H | —CH3 | —H | —O— | 1 | 4 | —H | —CH3 | (SB) | 1 | 1 | — | — | — | 0 | 0 |
| P-484 | —H | [symbol] | —H | —H | —H | [symbol] | —H | —H | —CH3 | —H | —O— | 1 | 5 | —H | —CH3 | (SB) | 1 | 1 | — | — | — | 0 | 0 |
| P-485 | —H | [symbol] | —H | —H | —H | [symbol] | —H | —H | —CH3 | —H | —O— | 1 | 6 | —H | —CH3 | (SB) | 1 | 1 | — | — | — | 0 | 0 |
| P-486 | —H | [symbol] | —H | —H | —H | [symbol] | —H | —H | —CH3 | —H | —O— | 1 | 7 | —H | —CH3 | (SB) | 1 | 1 | — | — | — | 0 | 0 |
| P-487 | —H | [symbol] | —H | —H | —H | [symbol] | —H | —H | —CH3 | —H | —O— | 1 | 30 | —H | —CH3 | (SB) | 1 | 1 | — | — | — | 0 | 0 |
| P-488 | —H | [symbol] | —H | —H | —H | [symbol] | —H | —H | —CH3 | —H | —O— | 1 | 32 | —H | —CH3 | (SB) | 1 | 1 | — | — | — | 0 | 0 |
| P-489 | —H | [symbol] | —H | —H | —H | [symbol] | —H | —H | —CH3 | —H | —O— | 1 | 33 | —H | —CH3 | (SB) | 1 | 1 | — | — | — | 0 | 0 |
| P-490 | —H | [symbol] | —H | —H | —H | [symbol] | —H | —H | —CH3 | —H | —O— | 1 | 1 | —H | —CH3 | (SB) | 1 | 1 | — | — | — | 0 | 0 |
| P-491 | —H | [symbol] | —H | —H | —H | [symbol] | —H | —H | —CH3 | —H | —O— | 1 | 2 | —H | —CH3 | (SB) | 1 | 1 | — | — | — | 0 | 0 |
| P-492 | —H | [symbol] | —H | —H | —H | [symbol] | —H | —H | —CH3 | —H | —O— | 1 | 3 | —H | —CH3 | (SB) | 1 | 1 | — | — | — | 0 | 0 |
| P-493 | —H | [symbol] | —H | —H | —H | [symbol] | —H | —H | —CH3 | —H | —O— | 1 | 4 | —H | —CH3 | (SB) | 1 | 1 | — | — | — | 0 | 0 |
| P-494 | —H | [symbol] | —H | —H | —H | [symbol] | —H | —H | —CH3 | —H | —O— | 1 | 5 | —H | —CH3 | (SB) | 1 | 1 | — | — | — | 0 | 0 |
| P-495 | —H | [symbol] | —H | —H | —H | [symbol] | —H | —H | —CH3 | —H | —O— | 1 | 6 | —H | —CH3 | (SB) | 1 | 1 | — | — | — | 0 | 0 |
| P-496 | —H | [symbol] | —H | —H | —H | [symbol] | —H | —H | —CH3 | —H | —O— | 1 | 7 | —H | —CH3 | (SB) | 1 | 1 | — | — | — | 0 | 0 |
| P-497 | —H | [symbol] | —H | —H | —H | [symbol] | —H | —H | —CH3 | —H | —O— | 1 | 30 | —H | —CH3 | (SB) | 1 | 1 | — | — | — | 0 | 0 |
| P-498 | —H | [symbol] | —H | —H | —H | [symbol] | —H | —H | —CH3 | —H | —O— | 1 | 32 | —H | —CH3 | (SB) | 1 | 1 | — | — | — | 0 | 0 |
| P-499 | —H | [symbol] | —H | —H | —H | [symbol] | —H | —H | —CH3 | —H | —O— | 1 | 33 | —H | —CH3 | (SB) | 1 | 1 | — | — | — | 0 | 0 |

[symbol]

indicates data missing or illegible when filed

TABLE 11

| | | | | | | | | | α | |
|---|---|---|---|---|---|---|---|---|---|---|
| | R11 | R12 | R13 | R14 | R15 | R16 | R17 | R18 | R60 | R61 |
| P-500 | —H | —SH | —H | —H | —H | —SH | —H | —H | —CH3 | —H |
| P-501 | —H | —SH | —H | —H | —H | —SH | —H | —H | —CH3 | —H |
| P-502 | —H | —SH | —H | —H | —H | —SH | —H | —H | —CH3 | —H |
| P-503 | —H | —SH | —H | —H | —H | —SH | —H | —H | —CH3 | —H |
| P-504 | —H | —SH | —H | —H | —H | —SH | —H | —H | —CH3 | —H |
| P-505 | —H | —SH | —H | —H | —H | —SH | —H | —H | —CH3 | —H |
| P-506 | —H | —SH | —H | —H | —H | —SH | —H | —H | —CH3 | —H |
| P-507 | —H | —SH | —H | —H | —H | —SH | —H | —H | —CH3 | —H |
| P-508 | —H | —SH | —H | —H | —H | —SH | —H | —H | —CH3 | —H |
| P-509 | —H | —SH | —H | —H | —H | —SH | —H | —H | —CH3 | —H |
| P-510 | —H | —SCH3 | —H | —H | —H | —SCH3 | —H | —H | —CH3 | —H |
| P-511 | —H | —SCH3 | —H | —H | —H | —SCH3 | —H | —H | —CH3 | —H |
| P-512 | —H | —SCH3 | —H | —H | —H | —SCH3 | —H | —H | —CH3 | —H |
| P-513 | —H | —SCH3 | —H | —H | —H | —SCH3 | —H | —H | —CH3 | —H |
| P-514 | —H | —SCH3 | —H | —H | —H | —SCH3 | —H | —H | —CH3 | —H |
| P-515 | —H | —SCH3 | —H | —H | —H | —SCH3 | —H | —H | —CH3 | —H |
| P-516 | —H | —SCH3 | —H | —H | —H | —SCH3 | —H | —H | —CH3 | —H |
| P-517 | —H | —SCH3 | —H | —H | —H | —SCH3 | —H | —H | —CH3 | —H |
| P-518 | —H | —SCH3 | —H | —H | —H | —SCH3 | —H | —H | —CH3 | —H |
| P-519 | —H | —SCH3 | —H | —H | —H | —SCH3 | —H | —H | —CH3 | —H |
| P-520 | —H | —SC6H5 | —H | —H | —H | —SC6H5 | —H | —H | —CH3 | —H |
| P-521 | —H | —SC6H5 | —H | —H | —H | —SC6H5 | —H | —H | —CH3 | —H |
| P-522 | —H | —SC6H5 | —H | —H | —H | —SC6H5 | —H | —H | —CH3 | —H |
| P-523 | —H | —SC6H5 | —H | —H | —H | —SC6H5 | —H | —H | —CH3 | —H |
| P-524 | —H | —SC6H5 | —H | —H | —H | —SC6H5 | —H | —H | —CH3 | —H |
| P-525 | —H | —SC6H5 | —H | —H | —H | —SC6H5 | —H | —H | —CH3 | —H |
| P-526 | —H | —SC6H5 | —H | —H | —H | —SC6H5 | —H | —H | —CH3 | —H |
| P-527 | —H | —SC6H5 | —H | —H | —H | —SC6H5 | —H | —H | —CH3 | —H |
| P-528 | —H | —SC6H5 | —H | —H | —H | —SC6H5 | —H | —H | —CH3 | —H |
| P-529 | —H | —SC6H5 | —H | —H | —H | —SC6H5 | —H | —H | —CH3 | —H |
| P-530 | —H | —S(n-C3H7) | —H | —H | —H | —S(n-C3H7) | —H | —H | —CH3 | —H |
| P-531 | —H | —S(n-C3H7) | —H | —H | —H | —S(n-C3H7) | —H | —H | —CH3 | —H |
| P-532 | —H | —S(n-C3H7) | —H | —H | —H | —S(n-C3H7) | —H | —H | —CH3 | —H |
| P-533 | —H | —S(n-C3H7) | —H | —H | —H | —S(n-C3H7) | —H | —H | —CH3 | —H |
| P-534 | —H | —S(n-C3H7) | —H | —H | —H | —S(n-C3H7) | —H | —H | —CH3 | —H |
| P-535 | —H | —S(n-C3H7) | —H | —H | —H | —S(n-C3H7) | —H | —H | —CH3 | —H |
| P-536 | —H | —S(n-C3H7) | —H | —H | —H | —S(n-C3H7) | —H | —H | —CH3 | —H |
| P-537 | —H | —S(n-C3H7) | —H | —H | —H | —S(n-C3H7) | —H | —H | —CH3 | —H |
| P-538 | —H | —S(n-C3H7) | —H | —H | —H | —S(n-C3H7) | —H | —H | —CH3 | —H |
| P-539 | —H | —S(n-C3H7) | —H | —H | —H | —S(n-C3H7) | —H | —H | —CH3 | —H |
| P-540 | —H | —H | —H | —H | —H | —H | —H | —H | —H | —H |
| P-541 | —H | —H | —H | —H | —H | —H | —H | —H | —H | —H |
| P-542 | —H | —H | —H | —H | —H | —H | —H | —H | —H | —H |
| P-543 | —H | —H | —H | —H | —H | —H | —H | —H | —H | —H |
| P-544 | —H | —H | —H | —H | —H | —H | —H | —H | —H | —H |
| P-545 | —H | —H | —H | —H | —H | —H | —H | —H | —H | —H |
| P-546 | —H | —H | —H | —H | —H | —H | —H | —H | —H | —H |
| P-547 | —H | —H | —H | —H | —H | —H | —H | —H | —H | —H |
| P-548 | —H | —H | —H | —H | —H | —H | —H | —H | —H | —H |
| P-549 | —H | —H | —H | —H | —H | —H | —H | —H | —H | —H |

| | α | | | β | | | | | γ | | | | |
|---|---|---|---|---|---|---|---|---|---|---|---|---|---|
| | Za | la | ma | R70 | R71 | Zb | lb | mb | R80 | R81 | Zc | lc | mc |
| P-500 | —O— | 1 | 1 | —H | —CH3 | (SB) | 1 | 1 | — | — | — | 0 | 0 |
| P-501 | —O— | 1 | 2 | —H | —CH3 | (SB) | 1 | 1 | — | — | — | 0 | 0 |
| P-502 | —O— | 1 | 3 | —H | —CH3 | (SB) | 1 | 1 | — | — | — | 0 | 0 |
| P-503 | —O— | 1 | 4 | —H | —CH3 | (SB) | 1 | 1 | — | — | — | 0 | 0 |
| P-504 | —O— | 1 | 5 | —H | —CH3 | (SB) | 1 | 1 | — | — | — | 0 | 0 |
| P-505 | —O— | 1 | 6 | —H | —CH3 | (SB) | 1 | 1 | — | — | — | 0 | 0 |
| P-506 | —O— | 1 | 7 | —H | —CH3 | (SB) | 1 | 1 | — | — | — | 0 | 0 |
| P-507 | —O— | 1 | 30 | —H | —CH3 | (SB) | 1 | 1 | — | — | — | 0 | 0 |
| P-508 | —O— | 1 | 32 | —H | —CH3 | (SB) | 1 | 1 | — | — | — | 0 | 0 |
| P-509 | —O— | 1 | 33 | —H | —CH3 | (SB) | 1 | 1 | — | — | — | 0 | 0 |
| P-510 | —O— | 1 | 1 | —H | —CH3 | (SB) | 1 | 1 | — | — | — | 0 | 0 |
| P-511 | —O— | 1 | 2 | —H | —CH3 | (SB) | 1 | 1 | — | — | — | 0 | 0 |
| P-512 | —O— | 1 | 3 | —H | —CH3 | (SB) | 1 | 1 | — | — | — | 0 | 0 |
| P-513 | —O— | 1 | 4 | —H | —CH3 | (SB) | 1 | 1 | — | — | — | 0 | 0 |
| P-514 | —O— | 1 | 5 | —H | —CH3 | (SB) | 1 | 1 | — | — | — | 0 | 0 |
| P-515 | —O— | 1 | 6 | —H | —CH3 | (SB) | 1 | 1 | — | — | — | 0 | 0 |
| P-516 | —O— | 1 | 7 | —H | —CH3 | (SB) | 1 | 1 | — | — | — | 0 | 0 |
| P-517 | —O— | 1 | 30 | —H | —CH3 | (SB) | 1 | 1 | — | — | — | 0 | 0 |
| P-518 | —O— | 1 | 32 | —H | —CH3 | (SB) | 1 | 1 | — | — | — | 0 | 0 |
| P-519 | —O— | 1 | 33 | —H | —CH3 | (SB) | 1 | 1 | — | — | — | 0 | 0 |
| P-520 | —O— | 1 | 1 | —H | —CH3 | (SB) | 1 | 1 | — | — | — | 0 | 0 |
| P-521 | —O— | 1 | 2 | —H | —CH3 | (SB) | 1 | 1 | — | — | — | 0 | 0 |
| P-522 | —O— | 1 | 3 | —H | —CH3 | (SB) | 1 | 1 | — | — | — | 0 | 0 |
| P-523 | —O— | 1 | 4 | —H | —CH3 | (SB) | 1 | 1 | — | — | — | 0 | 0 |
| P-524 | —O— | 1 | 5 | —H | —CH3 | (SB) | 1 | 1 | — | — | — | 0 | 0 |
| P-525 | —O— | 1 | 6 | —H | —CH3 | (SB) | 1 | 1 | — | — | — | 0 | 0 |
| P-526 | —O— | 1 | 7 | —H | —CH3 | (SB) | 1 | 1 | — | — | — | 0 | 0 |
| P-527 | —O— | 1 | 30 | —H | —CH3 | (SB) | 1 | 1 | — | — | — | 0 | 0 |
| P-528 | —O— | 1 | 32 | —H | —CH3 | (SB) | 1 | 1 | — | — | — | 0 | 0 |
| P-529 | —O— | 1 | 33 | —H | —CH3 | (SB) | 1 | 1 | — | — | — | 0 | 0 |
| P-530 | —O— | 1 | 1 | —H | —CH3 | (SB) | 1 | 1 | — | — | — | 0 | 0 |
| P-531 | —O— | 1 | 2 | —H | —CH3 | (SB) | 1 | 1 | — | — | — | 0 | 0 |
| P-532 | —O— | 1 | 3 | —H | —CH3 | (SB) | 1 | 1 | — | — | — | 0 | 0 |
| P-533 | —O— | 1 | 4 | —H | —CH3 | (SB) | 1 | 1 | — | — | — | 0 | 0 |
| P-534 | —O— | 1 | 5 | —H | —CH3 | (SB) | 1 | 1 | — | — | — | 0 | 0 |
| P-535 | —O— | 1 | 6 | —H | —CH3 | (SB) | 1 | 1 | — | — | — | 0 | 0 |
| P-536 | —O— | 1 | 7 | —H | —CH3 | (SB) | 1 | 1 | — | — | — | 0 | 0 |
| P-537 | —O— | 1 | 30 | —H | —CH3 | (SB) | 1 | 1 | — | — | — | 0 | 0 |
| P-538 | —O— | 1 | 32 | —H | —CH3 | (SB) | 1 | 1 | — | — | — | 0 | 0 |
| P-539 | —O— | 1 | 33 | —H | —CH3 | (SB) | 1 | 1 | — | — | — | 0 | 0 |
| P-540 | —S— | 1 | 1 | —H | —CH3 | (SB) | 1 | 1 | — | — | — | 0 | 0 |
| P-541 | —S— | 1 | 2 | —H | —CH3 | (SB) | 1 | 1 | — | — | — | 0 | 0 |
| P-542 | —S— | 1 | 3 | —H | —CH3 | (SB) | 1 | 1 | — | — | — | 0 | 0 |
| P-543 | —S— | 1 | 4 | —H | —CH3 | (SB) | 1 | 1 | — | — | — | 0 | 0 |
| P-544 | —S— | 1 | 5 | —H | —CH3 | (SB) | 1 | 1 | — | — | — | 0 | 0 |
| P-545 | —S— | 1 | 6 | —H | —CH3 | (SB) | 1 | 1 | — | — | — | 0 | 0 |
| P-546 | —S— | 1 | 7 | —H | —CH3 | (SB) | 1 | 1 | — | — | — | 0 | 0 |
| P-547 | —S— | 1 | 30 | —H | —CH3 | (SB) | 1 | 1 | — | — | — | 0 | 0 |
| P-548 | —S— | 1 | 32 | —H | —CH3 | (SB) | 1 | 1 | — | — | — | 0 | 0 |
| P-549 | —S— | 1 | 33 | —H | —CH3 | (SB) | 1 | 1 | — | — | — | 0 | 0 |

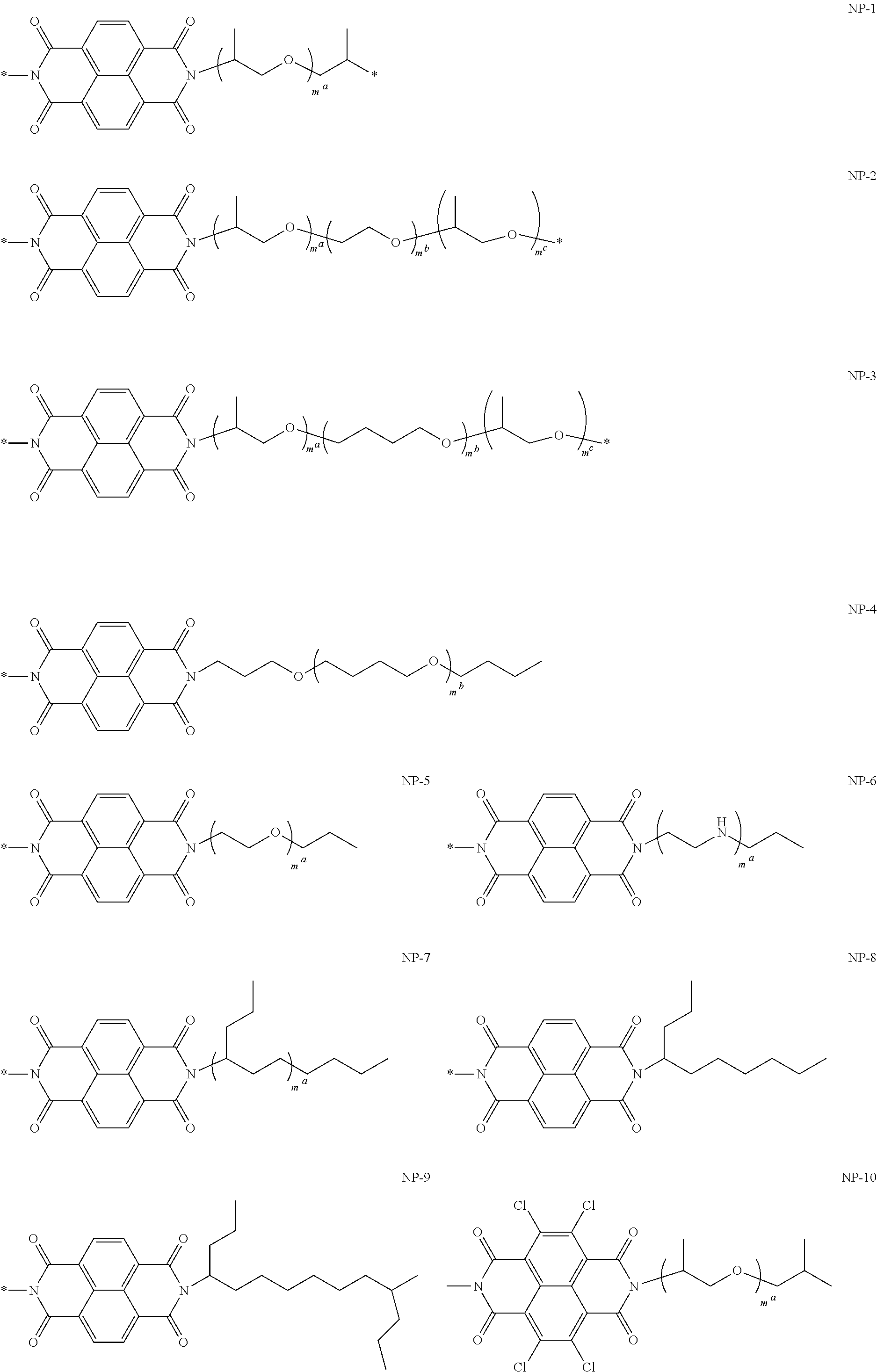

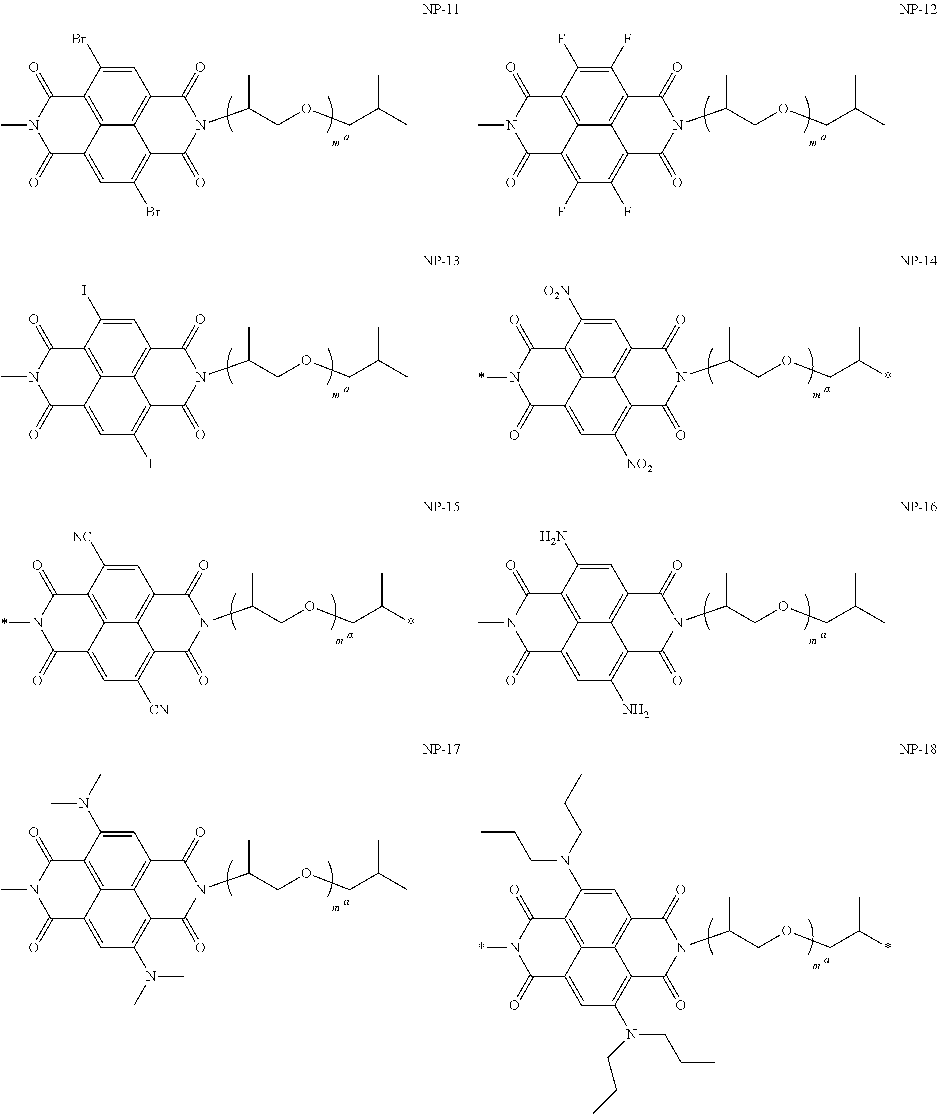

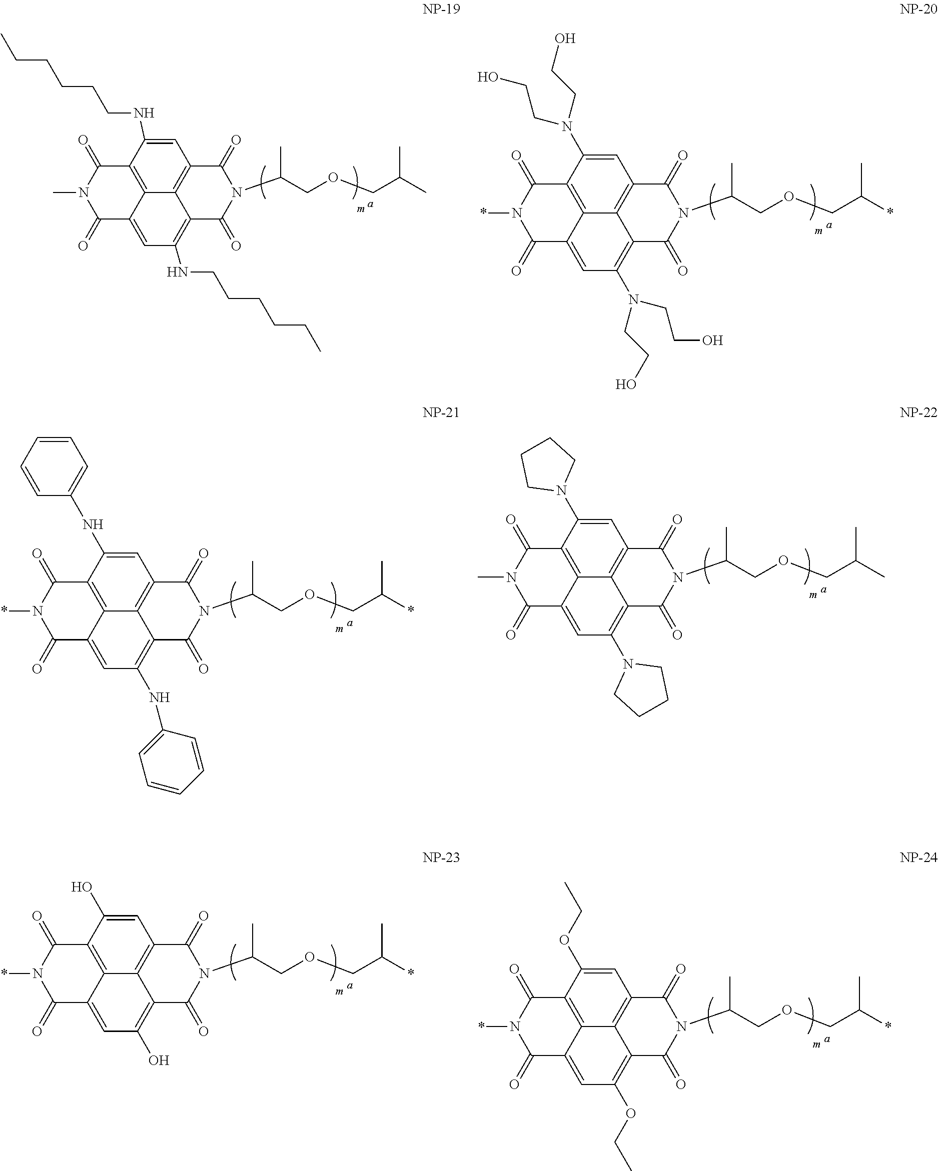

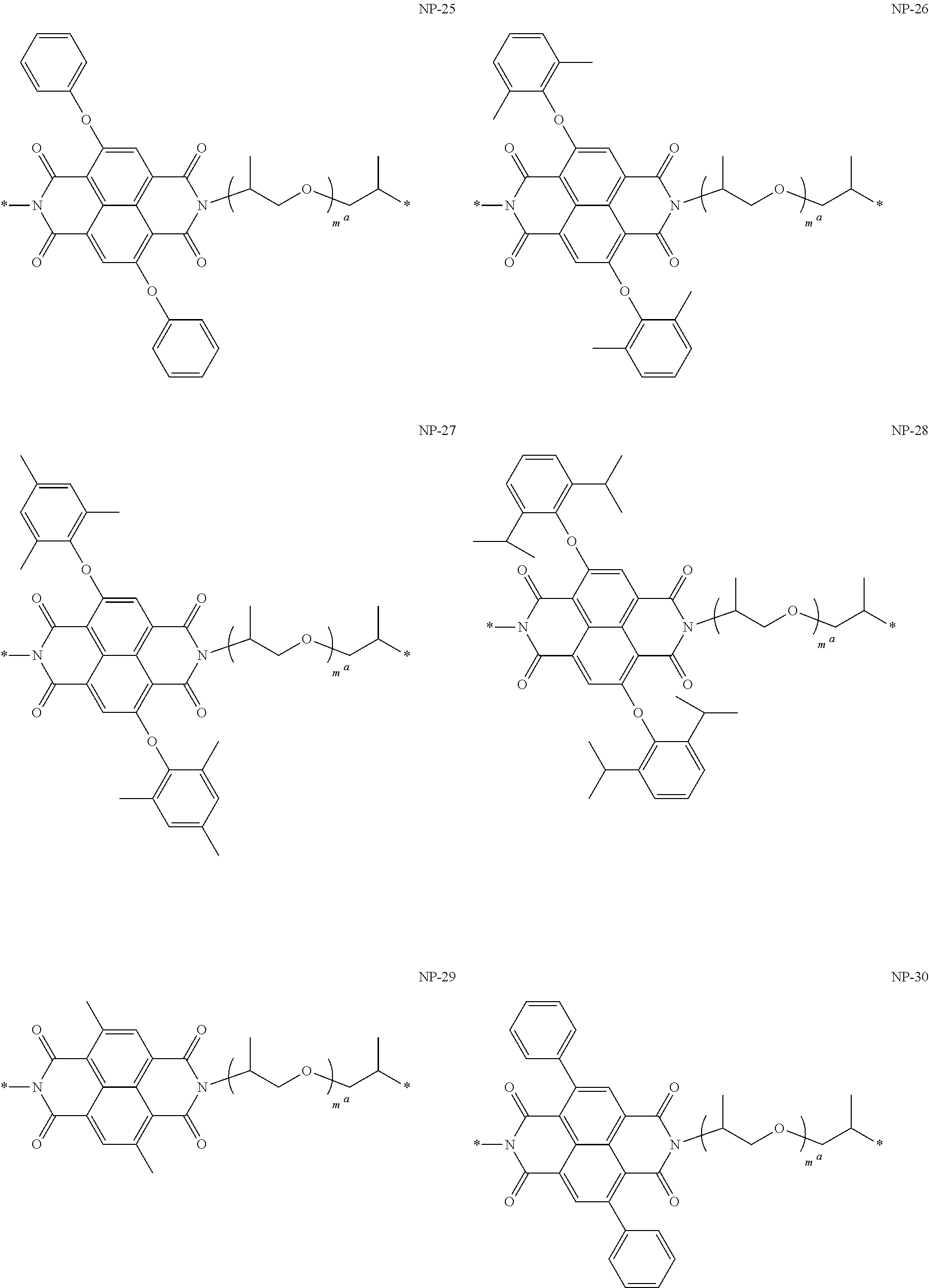

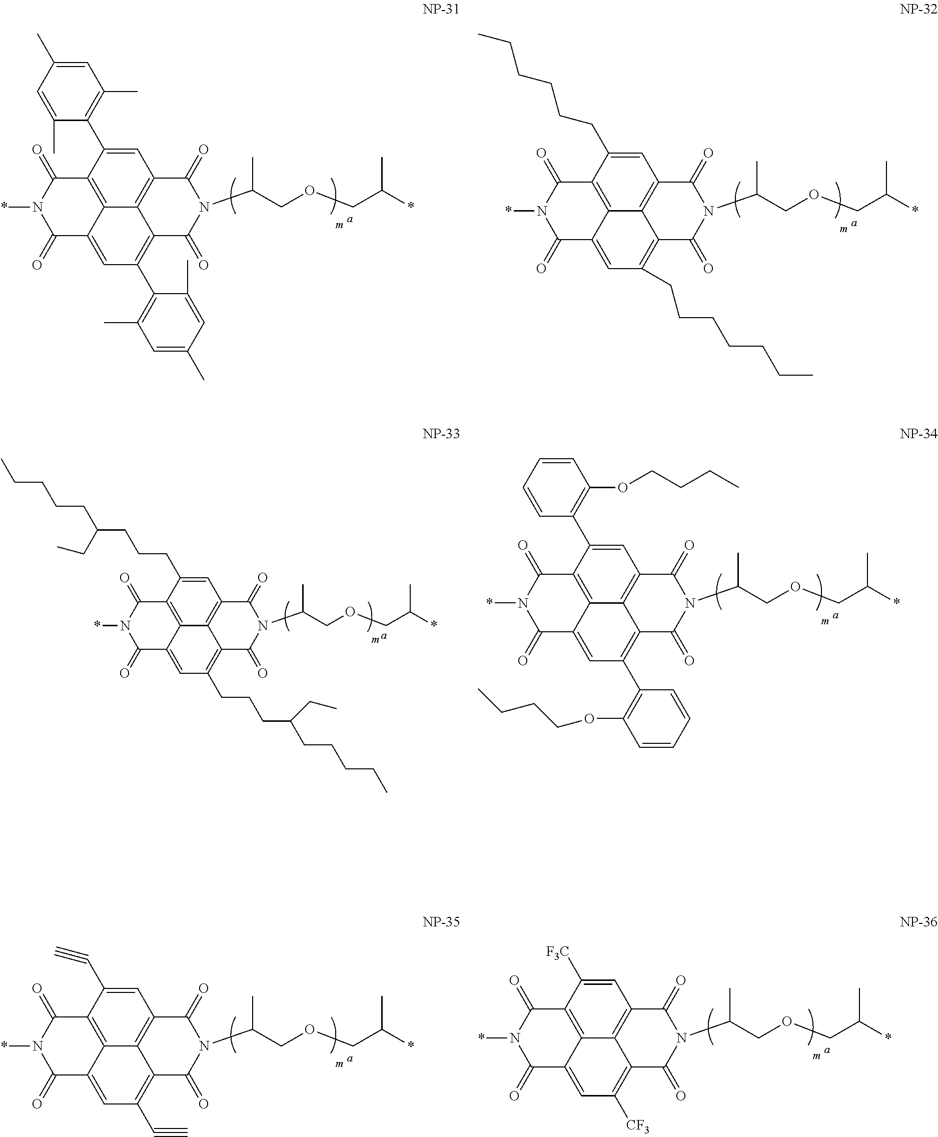

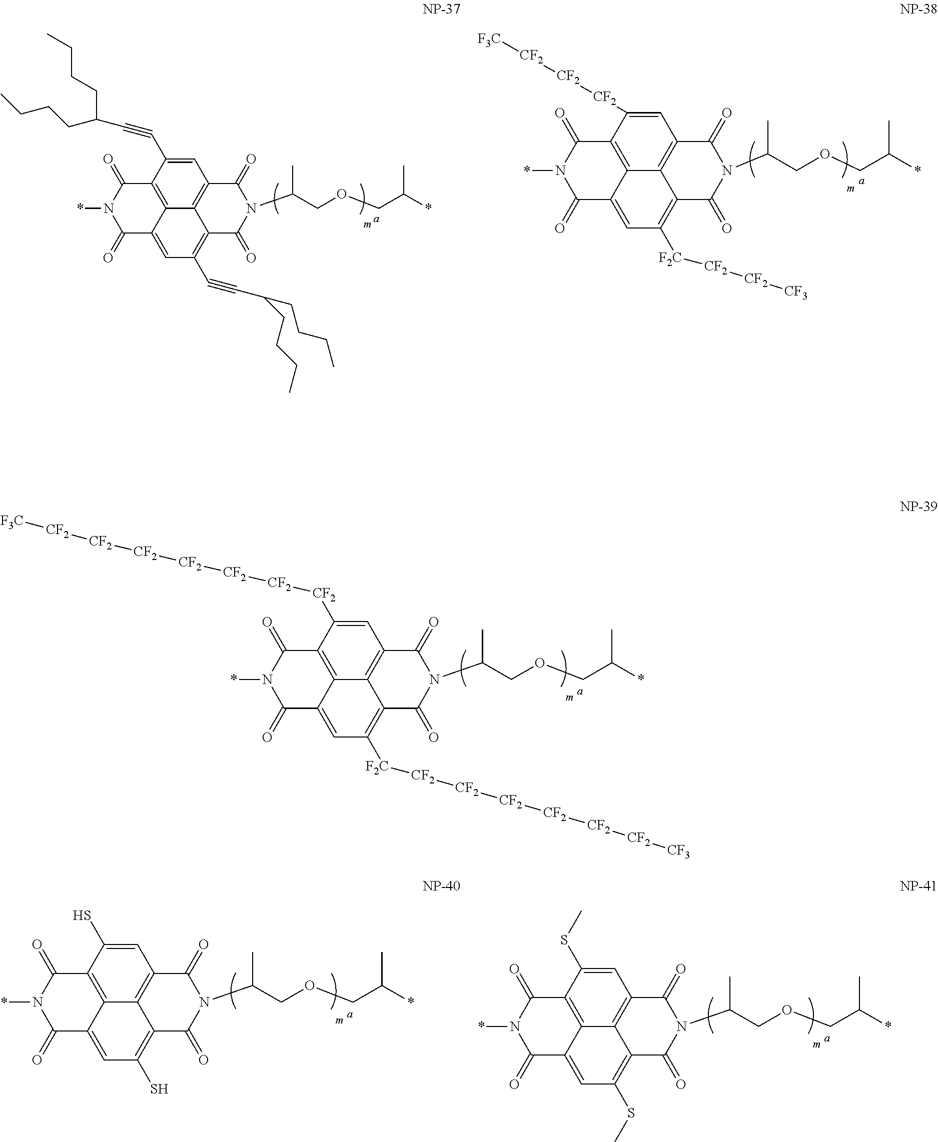

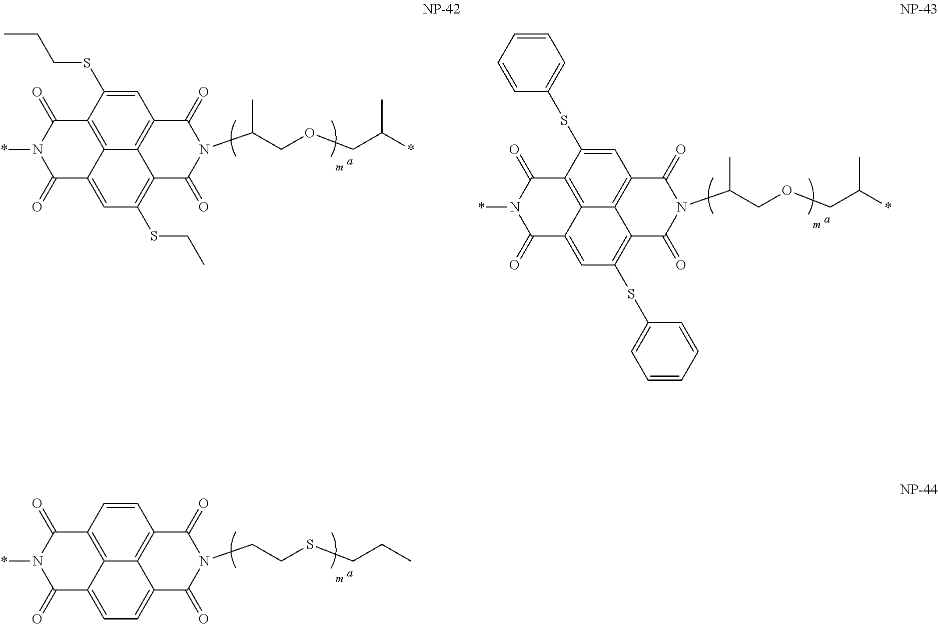

TABLE 12

| | | | | | α | | | | | β | | | |
|---|---|---|---|---|---|---|---|---|---|---|---|---|---|
| | R21 | R22 | R23 | R24 | R60 | R61 | Za | la | ma | R70 | R71 | Zb | lb |
| N-1 | —H | —H | —H | —H | —CH3 | —H | —O— | 1 | 1 | —H | —CH3 | (SB) | 1 |
| N-2 | —H | —H | —H | —H | —CH3 | —H | —O— | 1 | 2 | —H | —CH3 | (SB) | 1 |
| N-3 | —H | —H | —H | —H | —CH3 | —H | —O— | 1 | 3 | —H | —CH3 | (SB) | 1 |
| N-4 | —H | —H | —H | —H | —CH3 | —H | —O— | 1 | 4 | —H | —CH3 | (SB) | 1 |
| N-5 | —H | —H | —H | —H | —CH3 | —H | —O— | 1 | 5 | —H | —CH3 | (SB) | 1 |
| N-6 | —H | —H | —H | —H | —CH3 | —H | —O— | 1 | 6 | —H | —CH3 | (SB) | 1 |
| N-7 | —H | —H | —H | —H | —CH3 | —H | —O— | 1 | 7 | —H | —CH3 | (SB) | 1 |
| N-8 | —H | —H | —H | —H | —CH3 | —H | —O— | 1 | 8 | —H | —CH3 | (SB) | 1 |
| N-9 | —H | —H | —H | —H | —CH3 | —H | —O— | 1 | 9 | —H | —CH3 | (SB) | 1 |
| N-10 | —H | —H | —H | —H | —CH3 | —H | —O— | 1 | 10 | —H | —CH3 | (SB) | 1 |
| N-11 | —H | —H | —H | —H | —CH3 | —H | —O— | 1 | 11 | —H | —CH3 | (SB) | 1 |
| N-12 | —H | —H | —H | —H | —CH3 | —H | —O— | 1 | 12 | —H | —CH3 | (SB) | 1 |
| N-13 | —H | —H | —H | —H | —CH3 | —H | —O— | 1 | 13 | —H | —CH3 | (SB) | 1 |
| N-14 | —H | —H | —H | —H | —CH3 | —H | —O— | 1 | 14 | —H | —CH3 | (SB) | 1 |
| N-15 | —H | —H | —H | —H | —CH3 | —H | —O— | 1 | 15 | —H | —CH3 | (SB) | 1 |
| N-16 | —H | —H | —H | —H | —CH3 | —H | —O— | 1 | 16 | —H | —CH3 | (SB) | 1 |
| N-17 | —H | —H | —H | —H | —CH3 | —H | —O— | 1 | 17 | —H | —CH3 | (SB) | 1 |
| N.18 | —H | —H | —H | —H | —CH3 | —H | —O— | 1 | 18 | —H | —CH3 | (SB) | 1 |
| N-19 | —H | —H | —H | —H | —CH3 | —H | —O— | 1 | 19 | —H | —CH3 | (SB) | 1 |
| N-20 | —H | —H | —H | —H | —CH3 | —H | —O— | 1 | 20 | —H | —CH3 | (SB) | 1 |
| M-21 | —H | —H | —H | —H | —CH3 | —H | —O— | 1 | 22 | —H | —CH3 | (SB) | 1 |
| N-22 | —H | —H | —H | —H | —CH3 | —H | —O— | 1 | 25 | —H | —CH3 | (SB) | 1 |
| N-23 | —H | —H | —H | —H | —CH3 | —H | —O— | 1 | 28 | —H | —CH3 | (SB) | 1 |
| N-24 | —H | —H | —H | —H | —CH3 | —H | —O— | 1 | 30 | —H | —CH3 | (SB) | 1 |
| N-25 | —H | —H | —H | —H | —CH3 | —H | —O— | 1 | 32 | —H | —CH3 | (SB) | 1 |
| N-26 | —H | —H | —H | —H | —CH3 | —H | —O— | 1 | 33 | —H | —CH3 | (SB) | 1 |
| N-27 | —H | —H | —H | —H | —CH3 | —H | —O— | 1 | 40 | —H | —CH3 | (SB) | 1 |
| N-28 | —H | —H | —H | —H | —CH3 | —H | —O— | 1 | 50 | —H | —CH3 | (SB) | 1 |
| N-29 | —H | —H | —H | —H | —CH3 | —H | —O— | 1 | 60 | —H | —CH3 | (SB) | 1 |
| N-30 | —H | —H | —H | —H | —CH3 | —H | —O— | 1 | 70 | —H | —CH3 | (SB) | 1 |
| N-31 | —H | —Cl | —H | —Cl | —CH3 | —H | —O— | 1 | 1 | —H | —CH3 | (SB) | 1 |
| N-32 | —H | —Cl | —H | —Cl | —CH3 | —H | —O— | 1 | 2 | —H | —CH3 | (SB) | 1 |
| N-33 | —H | —Cl | —H | —Cl | —CH3 | —H | —O— | 1 | 3 | —H | —CH3 | (SB) | 1 |
| N-34 | —H | —Cl | —H | —Cl | —CH3 | —H | —O— | 1 | 4 | —H | —CH3 | (SB) | 1 |
| N-35 | —H | —Cl | —H | —Cl | —CH3 | —H | —O— | 1 | 5 | —H | —CH3 | (SB) | 1 |
| N-36 | —H | —Cl | —H | —Cl | —CH3 | —H | —O— | 1 | 6 | —H | —CH3 | (SB) | 1 |
| N-37 | —H | —Cl | —H | —Cl | —CH3 | —H | —O— | 1 | 7 | —H | —CH3 | (SB) | 1 |
| N-38 | —H | —Cl | —H | —Cl | —CH3 | —H | —O— | 1 | 8 | —H | —CH3 | (SB) | 1 |
| N-39 | —H | —Cl | —H | —Cl | —CH3 | —H | —O— | 1 | 9 | —H | —CH3 | (SB) | 1 |
| N-40 | —H | —Cl | —H | —Cl | —CH3 | —H | —O— | 1 | 10 | —H | —CH3 | (SB) | 1 |
| N-41 | —H | —Cl | —H | —Cl | —CH3 | —H | —O— | 1 | 11 | —H | —CH3 | (SB) | 1 |
| N-42 | —H | —Cl | —H | —Cl | —CH3 | —H | —O— | 1 | 12 | —H | —CH3 | (SB) | 1 |
| N-43 | —H | —Cl | —H | —Cl | —CH3 | —H | —O— | 1 | 13 | —H | —CH3 | (SB) | 1 |
| N-44 | —H | —Cl | —H | —Cl | —CH3 | —H | —O— | 1 | 14 | —H | —CH3 | (SB) | 1 |
| N-45 | —H | —Cl | —H | —Cl | —CH3 | —H | —O— | 1 | 15 | —H | —CH3 | (SB) | 1 |
| N-46 | —H | —Cl | —H | —Cl | —CH3 | —H | —O— | 1 | 16 | —H | —CH3 | (SB) | 1 |
| N-47 | —H | —Cl | —H | —Cl | —CH3 | —H | —O— | 1 | 17 | —H | —CH3 | (SB) | 1 |
| N-48 | —H | —Cl | —H | —Cl | —CH3 | —H | —O— | 1 | 18 | —H | —CH3 | (SB) | 1 |
| N-49 | —H | —Cl | —H | —Cl | —CH3 | —H | —O— | 1 | 19 | —H | —CH3 | (SB) | 1 |
| N-50 | —H | —Cl | —H | —Cl | —CH3 | —H | —O— | 1 | 20 | —H | —CH3 | (SB) | 1 |

| | β | γ | | | | |
|---|---|---|---|---|---|---|
| | mb | R80 | R81 | Zc | lc | mc |
| N-1 | 1 | — | — | — | 0 | 0 |
| N-2 | 1 | — | — | — | 0 | 0 |
| N-3 | 1 | — | — | — | 0 | 0 |
| N-4 | 1 | — | — | — | 0 | 0 |
| N-5 | 1 | — | — | — | 0 | 0 |
| N-6 | 1 | — | — | — | 0 | 0 |
| N-7 | 1 | — | — | — | 0 | 0 |
| N-8 | 1 | — | — | — | 0 | 0 |
| N-9 | 1 | — | — | — | 0 | 0 |
| N-10 | 1 | — | — | — | 0 | 0 |
| N-11 | 1 | — | — | — | 0 | 0 |
| N-12 | 1 | — | — | — | 0 | 0 |
| N-13 | 1 | — | — | — | 0 | 0 |
| N-14 | 1 | — | — | — | 0 | 0 |
| N-15 | 1 | — | — | — | 0 | 0 |
| N-16 | 1 | — | — | — | 0 | 0 |
| N-17 | 1 | — | — | — | 0 | 0 |
| N.18 | 1 | — | — | — | 0 | 0 |
| N-19 | 1 | — | — | — | 0 | 0 |
| N-20 | 1 | — | — | — | 0 | 0 |
| M-21 | 1 | — | — | — | 0 | 0 |
| N-22 | 1 | — | — | — | 0 | 0 |
| N-23 | 1 | — | — | — | 0 | 0 |
| N-24 | 1 | — | — | — | 0 | 0 |
| N-25 | 1 | — | — | — | 0 | 0 |
| N-26 | 1 | — | — | — | 0 | 0 |
| N-27 | 1 | — | — | — | 0 | 0 |
| N-28 | 1 | — | — | — | 0 | 0 |
| N-29 | 1 | — | — | — | 0 | 0 |
| N-30 | 1 | — | — | — | 0 | 0 |
| N-31 | 1 | — | — | — | 0 | 0 |
| N-32 | 1 | — | — | — | 0 | 0 |
| N-33 | 1 | — | — | — | 0 | 0 |
| N-34 | 1 | — | — | — | 0 | 0 |
| N-35 | 1 | — | — | — | 0 | 0 |
| N-36 | 1 | — | — | — | 0 | 0 |
| N-37 | 1 | — | — | — | 0 | 0 |
| N-38 | 1 | — | — | — | 0 | 0 |
| N-39 | 1 | — | — | — | 0 | 0 |
| N-40 | 1 | — | — | — | 0 | 0 |
| N-41 | 1 | — | — | — | 0 | 0 |
| N-42 | 1 | — | — | — | 0 | 0 |
| N-43 | 1 | — | — | — | 0 | 0 |
| N-44 | 1 | — | — | — | 0 | 0 |
| N-45 | 1 | — | — | — | 0 | 0 |
| N-46 | 1 | — | — | — | 0 | 0 |
| N-47 | 1 | — | — | — | 0 | 0 |
| N-48 | 1 | — | — | — | 0 | 0 |
| N-49 | 1 | — | — | — | 0 | 0 |
| N-50 | 1 | — | — | — | 0 | 0 |

TABLE 13

| | | | | | α | | | | | β | | |
|---|---|---|---|---|---|---|---|---|---|---|---|---|
| | R21 | R22 | R23 | R24 | | R61 | Za | la | ma | R70 | R71 | Zb |
| N-51 | —H | —Cl | —H | —Cl | —CH3 | —H | —O— | 1 | 22 | —H | —CH3 | (SB) |
| N-52 | —H | —Cl | —H | —Cl | —CH3 | —H | —O— | 1 | 25 | —H | —CH3 | (SB) |
| N-53 | —H | —Cl | —H | —Cl | —CH3 | —H | —O— | 1 | 28 | —H | —CH3 | (SB) |
| N-54 | —H | —Cl | —H | —Cl | —CH3 | —H | —O— | 1 | 30 | —H | —CH3 | (SB) |
| N-55 | —H | —Cl | —H | —Cl | —CH3 | —H | —O— | 1 | 32 | —H | —CH3 | (SB) |
| N-56 | —H | —Cl | —H | —Cl | —CH3 | —H | —O— | 1 | 33 | —H | —CH3 | (SB) |
| N-57 | —H | —Cl | —H | —Cl | —CH3 | —H | —O— | 1 | 40 | —H | —CH3 | (SB) |
| N-58 | —H | —Cl | —H | —Cl | —CH3 | —H | —O— | 1 | 50 | —H | —CH3 | (SB) |
| N-59 | —H | —Cl | —H | —Cl | —CH3 | —H | —O— | 1 | 60 | —H | —CH3 | (SB) |
| N-60 | —H | —Cl | —H | —Cl | —CH3 | —H | —O— | 1 | 70 | —H | —CH3 | (SB) |
| N-61 | —H | —Br | —H | —Br | —CH3 | —H | —O— | 1 | 1 | —H | —CH3 | (SB) |
| N-62 | —H | —Br | —H | —Br | —CH3 | —H | —O— | 1 | 2 | —H | —CH3 | (SB) |
| N-63 | —H | —Br | —H | —Br | —CH3 | —H | —O— | 1 | 3 | —H | —CH3 | (SB) |
| N-64 | —H | —Br | —H | —Br | —CH3 | —H | —O— | 1 | 4 | —H | —CH3 | (SB) |
| N-65 | —H | —Br | —H | —Br | —CH3 | —H | —O— | 1 | 5 | —H | —CH3 | (SB) |
| N-66 | —H | —Br | —H | —Br | —CH3 | —H | —O— | 1 | 6 | —H | —CH3 | (SB) |
| N-67 | —H | —Br | —H | —Br | —CH3 | —H | —O— | 1 | 7 | —H | —CH3 | (SB) |
| N-68 | —H | —Br | —H | —Br | —CH3 | —H | —O— | 1 | 8 | —H | —CH3 | (SB) |
| N-69 | —H | —Br | —H | —Br | —CH3 | —H | —O— | 1 | 9 | —H | —CH3 | (SB) |
| N-70 | —H | —Br | —H | —Br | —CH3 | —H | —O— | 1 | 10 | —H | —CH3 | (SB) |
| N-71 | —H | —Br | —H | —Br | —CH3 | —H | —O— | 1 | 11 | —H | —CH3 | (SB) |
| N-72 | —H | —Br | —H | —Br | —CH3 | —H | —O— | 1 | 12 | —H | —CH3 | (SB) |
| N-73 | —H | —Br | —H | —Br | —CH3 | —H | —O— | 1 | 13 | —H | —CH3 | (SB) |
| N-74 | —H | —Br | —H | —Br | —CH3 | —H | —O— | 1 | 14 | —H | —CH3 | (SB) |
| N-75 | —H | —Br | —H | —Br | —CH3 | —H | —O— | 1 | 15 | —H | —CH3 | (SB) |
| N-76 | —H | —Br | —H | —Br | —CH3 | —H | —O— | 1 | 16 | —H | —CH3 | (SB) |
| N-77 | —H | —Br | —H | —Br | —CH3 | —H | —O— | 1 | 17 | —H | —CH3 | (SB) |
| N-78 | —H | —Br | —H | —Br | —CH3 | —H | —O— | 1 | 18 | —H | —CH3 | (SB) |
| N-79 | —H | —Br | —H | —Br | —CH3 | —H | —O— | 1 | 19 | —H | —CH3 | (SB) |
| N-80 | —H | —Br | —H | —Br | —CH3 | —H | —O— | 1 | 20 | —H | —CH3 | (SB) |
| N-81 | —H | —Br | —H | —Br | —CH3 | —H | —O— | 1 | 22 | —H | —CH3 | (SB) |
| N-82 | —H | —Br | —H | —Br | —CH3 | —H | —O— | 1 | 25 | —H | —CH3 | (SB) |
| N-83 | —H | —Br | —H | —Br | —CH3 | —H | —O— | 1 | 28 | —H | —CH3 | (SB) |
| N-84 | —H | —Br | —H | —Br | —CH3 | —H | —O— | 1 | 30 | —H | —CH3 | (SB) |
| N-85 | —H | —Br | —H | —Br | —CH3 | —H | —O— | 1 | 32 | —H | —CH3 | (SB) |
| N-86 | —H | —Br | —H | —Br | —CH3 | —H | —O— | 1 | 33 | —H | —CH3 | (SB) |
| N-87 | —H | —Br | —H | —Br | —CH3 | —H | —O— | 1 | 40 | —H | —CH3 | (SB) |
| N-88 | —H | —Br | —H | —Br | —CH3 | —H | —O— | 1 | 50 | —H | —CH3 | (SB) |
| N-89 | —H | —Br | —H | —Br | —CH3 | —H | —O— | 1 | 60 | —H | —CH3 | (SB) |
| N-90 | —H | —Br | —H | —Br | —CH3 | —H | —O— | 1 | 70 | —H | —CH3 | (SB) |
| N-91 | —H | —H | —H | —H | —CH3 | —H | —O— | 1 | 1 | —H | —CH3 | (SB) |
| N-92 | —H | —H | —H | —H | —CH3 | —H | —O— | 1 | 2 | —H | —CH3 | (SB) |
| N-93 | —H | —H | —H | —H | —CH3 | —H | —O— | 1 | 2 | —H | —CH3 | (SB) |
| N-94 | —H | —H | —H | —H | —CH3 | —H | —O— | 1 | 2 | —H | —CH3 | (SB) |
| N-95 | —H | —H | —H | —H | —CH3 | —H | —O— | 1 | 1 | —H | —CH3 | (SB) |
| N-96 | —H | —H | —H | —H | —CH3 | —H | —O— | 1 | 2 | —H | —CH3 | (SB) |
| N-97 | —H | —H | —H | —H | —CH3 | —H | —O— | 1 | 1 | —H | —CH3 | (SB) |
| N-98 | —H | —H | —H | —H | —CH3 | —H | —O— | 1 | 2 | —H | —CH3 | (SB) |
| N-99 | —H | —H | —H | —H | —CH3 | —H | —O— | 1 | 3 | —H | —CH3 | (SB) |
| N-100 | —H | —H | —H | —H | —CH3 | —H | —O— | 1 | 1 | —H | —CH3 | (SB) |

| | β | | γ | | | | |
|---|---|---|---|---|---|---|---|
| | lb | mb | R80 | R81 | Zc | lc | mc |
| N-51 | 1 | 1 | — | — | — | 0 | 0 |
| N-52 | 1 | 1 | — | — | — | 0 | 0 |
| N-53 | 1 | 1 | — | — | — | 0 | 0 |
| N-54 | 1 | 1 | — | — | — | 0 | 0 |
| N-55 | 1 | 1 | — | — | — | 0 | 0 |
| N-56 | 1 | 1 | — | — | — | 0 | 0 |
| N-57 | 1 | 1 | — | — | — | 0 | 0 |
| N-58 | 1 | 1 | — | — | — | 0 | 0 |
| N-59 | 1 | 1 | — | — | — | 0 | 0 |
| N-60 | 1 | 1 | — | — | — | 0 | 0 |
| N-61 | 1 | 1 | — | — | — | 0 | 0 |
| N-62 | 1 | 1 | — | — | — | 0 | 0 |
| N-63 | 1 | 1 | — | — | — | 0 | 0 |
| N-64 | 1 | 1 | — | — | — | 0 | 0 |
| N-65 | 1 | 1 | — | — | — | 0 | 0 |
| N-66 | 1 | 1 | — | — | — | 0 | 0 |
| N-67 | 1 | 1 | — | — | — | 0 | 0 |
| N-68 | 1 | 1 | — | — | — | 0 | 0 |
| N-69 | 1 | 1 | — | — | — | 0 | 0 |
| N-70 | 1 | 1 | — | — | — | 0 | 0 |
| N-71 | 1 | 1 | — | — | — | 0 | 0 |
| N-72 | 1 | 1 | — | — | — | 0 | 0 |
| N-73 | 1 | 1 | — | — | — | 0 | 0 |
| N-74 | 1 | 1 | — | — | — | 0 | 0 |
| N-75 | 1 | 1 | — | — | — | 0 | 0 |
| N-76 | 1 | 1 | — | — | — | 0 | 0 |
| N-77 | 1 | 1 | — | — | — | 0 | 0 |
| N-78 | 1 | 1 | — | — | — | 0 | 0 |
| N-79 | 1 | 1 | — | — | — | 0 | 0 |
| N-80 | 1 | 1 | — | — | — | 0 | 0 |
| N-81 | 1 | 1 | — | — | — | 0 | 0 |
| N-82 | 1 | 1 | — | — | — | 0 | 0 |
| N-83 | 1 | 1 | — | — | — | 0 | 0 |
| N-84 | 1 | 1 | — | — | — | 0 | 0 |
| N-85 | 1 | 1 | — | — | — | 0 | 0 |
| N-86 | 1 | 1 | — | — | — | 0 | 0 |
| N-87 | 1 | 1 | — | — | — | 0 | 0 |
| N-88 | 1 | 1 | — | — | — | 0 | 0 |
| N-89 | 1 | 1 | — | — | — | 0 | 0 |
| N-90 | 1 | 1 | — | — | — | 0 | 0 |
| N-91 | 1 | 1 | —CH3 | —H | —O— | 1 | 1 |
| N-92 | 1 | 2 | —CH3 | —H | —O— | 1 | 2 |
| N-93 | 1 | 6 | —CH3 | —H | —O— | 1 | 2 |
| N-94 | 1 | 7 | —CH3 | —H | —O— | 1 | 2 |
| N-95 | 1 | 7 | —CH3 | —H | —O— | 1 | 2 |
| N-96 | 1 | 7 | —CH3 | —H | —O— | 1 | 1 |
| N-97 | 1 | 8 | —CH3 | —H | —O— | 1 | 2 |
| N-98 | 1 | 8 | —CH3 | —H | —O— | 1 | 2 |
| N-99 | 1 | 7 | —CH3 | —H | —O— | 1 | 1 |
| N-100 | 1 | 7 | —CH3 | —H | —O— | 1 | 3 |

TABLE 14

| | | | | | α | | | | | β | | |
|---|---|---|---|---|---|---|---|---|---|---|---|---|
| | R21 | R22 | R23 | R24 | R60 | R61 | Za | la | ma | R70 | R71 | Zb |
| N-101 | —H | —H | —H | —H | —CH3 | —H | —O— | 1 | 1 | —H | —H | —O— |
| N-102 | —H | —H | —H | —H | —CH3 | —H | —O— | 1 | 2 | —H | —H | —O— |
| N-103 | —H | —H | —H | —H | —CH3 | —H | —O— | 1 | 1 | —H | —H | —O— |
| N-104 | —H | —H | —H | —H | —CH3 | —H | —O— | 1 | 2 | —H | —H | —O— |
| N-105 | —H | —H | —H | —H | —CH3 | —H | —O— | 1 | 1 | —H | —H | —O— |
| N-106 | —H | —H | —H | —H | —CH3 | —H | —O— | 1 | 3 | —H | —H | —O— |
| N-107 | —H | —H | —H | —H | —CH3 | —H | —O— | 1 | 1 | —H | —H | —O— |
| N-108 | —H | —H | —H | —H | —CH3 | —H | —O— | 1 | 2 | —H | —H | —O— |
| N-109 | —H | —H | —H | —H | —CH3 | —H | —O— | 1 | 1 | —H | —H | —O— |
| N-110 | —H | —H | —H | —H | —CH3 | —H | —O— | 1 | 2 | —H | —H | —O— |
| N-111 | —H | —H | —H | —H | —CH3 | —H | —O— | 1 | 3 | —H | —H | —O— |
| N-112 | —H | —H | —H | —H | —CH3 | —H | —O— | 1 | 4 | —H | —H | —O— |
| N-113 | —H | —H | —H | —H | —CH3 | —H | —O— | 1 | 1 | —H | —H | —O— |
| N-114 | —H | —H | —H | —H | —CH3 | —H | —O— | 1 | 1 | —H | —H | —O— |
| N-115 | —H | —H | —H | —H | —CH3 | —H | —O— | 1 | 2 | —H | —H | —O— |
| N-116 | —H | —H | —H | —H | —CH3 | —H | —O— | 1 | 3 | —H | —H | —O— |
| N-117 | —H | —H | —H | —H | —CH3 | —H | —O— | 1 | 3 | —H | —H | —O— |
| N-118 | —H | —H | —H | —H | —CH3 | —H | —O— | 1 | 3 | —H | —H | —O— |
| N-119 | —H | —H | —H | —H | —CH3 | —H | —O— | 1 | 2 | —H | —H | —O— |
| N-120 | —H | —H | —H | —H | —CH3 | —H | —O— | 1 | 4 | —H | —H | —O— |
| N-121 | —H | —H | —H | —H | —CH3 | —H | —O— | 1 | 1 | —H | —H | —O— |
| N-122 | —H | —H | —H | —H | —CH3 | —H | —O— | 1 | 4 | —H | —H | —O— |
| N-123 | —H | —H | —H | —H | —CH3 | —H | —O— | 1 | 2 | —H | —H | —O— |
| N-124 | —H | —H | —H | —H | —CH3 | —H | —O— | 1 | 3 | —H | —H | —O— |
| N-125 | —H | —H | —H | —H | —CH3 | —H | —O— | 1 | 3 | —H | —H | —O— |
| N-126 | —H | —H | —H | —H | —CH3 | —H | —O— | 1 | 3 | —H | —H | —O— |
| N-127 | —H | —H | —H | —H | —CH3 | —H | —O— | 1 | 2 | —H | —H | —O— |
| N-128 | —H | —H | —H | —H | —CH3 | —H | —O— | 1 | 3 | —H | —H | —O— |
| N-129 | —H | —H | —H | —H | —CH3 | —H | —O— | 1 | 1 | —H | —H | —O— |
| N-130 | —H | —H | —H | —H | —CH3 | —H | —O— | 1 | 2 | —H | —H | —O— |
| N-131 | —H | —H | —H | —H | —CH3 | —H | —O— | 1 | 2 | —H | —H | —O— |
| N-132 | —H | —H | —H | —H | —CH3 | —H | —O— | 1 | 2 | —H | —H | —O— |
| N-133 | —H | —H | —H | —H | —CH3 | —H | —O— | 1 | 3 | —H | —H | —O— |
| N-134 | —H | —H | —H | —H | —CH3 | —H | —O— | 1 | 1 | —H | —H | —O— |
| N-135 | —H | —H | —H | —H | —CH3 | —H | —O— | 1 | 5 | —H | —H | —O— |
| N-136 | —H | —H | —H | —H | —CH3 | —H | —O— | 1 | 4 | —H | —H | —O— |
| N-137 | —H | —H | —H | —H | —CH3 | —H | —O— | 1 | 4 | —H | —H | —O— |
| N-138 | —H | —H | —H | —H | —CH3 | —H | —O— | 1 | 6 | —H | —H | —O— |
| N-139 | —H | —H | —H | —H | —CH3 | —H | —O— | 1 | 4 | —H | —H | —O— |
| N-140 | —H | —H | —H | —H | —CH3 | —H | —O— | 1 | 3 | —H | —H | —O— |
| N-141 | —H | —H | —H | —H | —CH3 | —H | —O— | 1 | 5 | —H | —H | —O— |
| N-142 | —H | —H | —H | —H | —CH3 | —H | —O— | 1 | 4 | —H | —H | —O— |
| N-143 | —H | —H | —H | —H | —CH3 | —H | —O— | 1 | 6 | —H | —H | —O— |
| N-144 | —H | —H | —H | —H | —CH3 | —H | —O— | 1 | 3 | —H | —H | —O— |
| N-145 | —H | —H | —H | —H | —CH3 | —H | —O— | 1 | 5 | —H | —H | —O— |
| N-146 | —H | —H | —H | —H | —CH3 | —H | —O— | 1 | 2 | —H | —H | —O— |
| N-147 | —H | —H | —H | —H | —CH3 | —H | —O— | 1 | 4 | —H | —H | —O— |
| N-148 | —H | —H | —H | —H | —H | —H | —O— | 2 | 1 | —H | —H | —O— |
| N-149 | —H | —H | —H | —H | —H | —H | —O— | 2 | 2 | —H | —H | —O— |
| N-150 | —H | —H | —H | —H | —H | —H | —O— | 2 | 3 | —H | —H | —O— |

| | β | | γ | | | | |
|---|---|---|---|---|---|---|---|
| | lb | mb | R80 | R81 | Zc | lc | mc |
| N-101 | 1 | 9 | —CH3 | —H | —O— | 1 | 1 |
| N-102 | 1 | 9 | —CH3 | —H | —O— | 1 | 1 |
| N-103 | 1 | 9 | —CH3 | —H | —O— | 1 | 2 |
| N-104 | 1 | 9 | —CH3 | —H | —O— | 1 | 2 |
| N-105 | 1 | 9 | —CH3 | —H | —O— | 1 | 3 |
| N-106 | 1 | 9 | —CH3 | —H | —O— | 1 | 1 |
| N-107 | 1 | 10 | —CH3 | —H | —O— | 1 | 1 |
| N-108 | 1 | 10 | —CH3 | —H | —O— | 1 | 2 |
| N-109 | 1 | 11 | —CH3 | —H | —O— | 1 | 1 |
| N-110 | 1 | 11 | —CH3 | —H | —O— | 1 | 2 |
| N-111 | 1 | 11 | —CH3 | —H | —O— | 1 | 3 |
| N-112 | 1 | 11 | —CH3 | —H | —O— | 1 | 4 |
| N-113 | 1 | 12 | —CH3 | —H | —O— | 1 | 1 |
| N-114 | 1 | 12 | —CH3 | —H | —O— | 1 | 2 |
| N-115 | 1 | 12 | —CH3 | —H | —O— | 1 | 2 |
| N-116 | 1 | 12 | —CH3 | —H | —O— | 1 | 1 |
| N-117 | 1 | 12 | —CH3 | —H | —O— | 1 | 2 |
| N-118 | 1 | 12 | —CH3 | —H | —O— | 1 | 3 |
| N-119 | 1 | 12 | —CH3 | —H | —O— | 1 | 3 |
| N-120 | 1 | 12 | —CH3 | —H | —O— | 1 | 1 |
| N-121 | 1 | 12 | —CH3 | —H | —O— | 1 | 4 |
| N-122 | 1 | 12 | —CH3 | —H | —O— | 1 | 2 |
| N-123 | 1 | 12 | —CH3 | —H | —O— | 1 | 4 |
| N-124 | 1 | 20 | —CH3 | —H | —O— | 1 | 3 |
| N-125 | 1 | 30 | —CH3 | —H | —O— | 1 | 3 |
| N-126 | 1 | 39 | —CH3 | —H | —O— | 1 | 3 |
| N-127 | 1 | 45 | —CH3 | —H | —O— | 1 | 4 |
| N-128 | 1 | 45 | —CH3 | —H | —O— | 1 | 3 |
| N-129 | 1 | 1 | —CH3 | —H | —O— | 1 | 1 |
| N-130 | 3 | 2 | —CH3 | —H | —O— | 1 | 2 |
| N-131 | 3 | 4 | —CH3 | —H | —O— | 1 | 2 |
| N-132 | 3 | 5 | —CH3 | —H | —O— | 1 | 2 |
| N-133 | 3 | 4 | —CH3 | —H | —O— | 1 | 3 |
| N-134 | 3 | 4 | —CH3 | —H | —O— | 1 | 5 |
| N-135 | 3 | 5 | —CH3 | —H | —O— | 1 | 5 |
| N-136 | 3 | 4 | —CH3 | —H | —O— | 1 | 4 |
| N-137 | 3 | 6 | —CH3 | —H | —O— | 1 | 4 |
| N-138 | 3 | 6 | —CH3 | —H | —O— | 1 | 5 |
| N-139 | 3 | 7 | —CH3 | —H | —O— | 1 | 4 |
| N-140 | 3 | 7 | —CH3 | —H | —O— | 1 | 5 |
| N-141 | 3 | 7 | —CH3 | —H | —O— | 1 | 3 |
| N-142 | 3 | 8 | —CH3 | —H | —O— | 1 | 3 |
| N-143 | 3 | 8 | —CH3 | —H | —O— | 1 | 2 |
| N-144 | 3 | 9 | —CH3 | —H | —O— | 1 | 3 |
| N-145 | 3 | 9 | —CH3 | —H | —O— | 1 | 4 |
| N-146 | 3 | 10 | —CH3 | —H | —O— | 1 | 2 |
| N-147 | 3 | 10 | —CH3 | —H | —O— | 1 | 4 |
| N-148 | 3 | 1 | —H | —H | (SB) | 1 | 1 |
| N-149 | 3 | 1 | —H | —H | (SB) | 1 | 1 |
| N-150 | 3 | 1 | —H | —H | (SB) | 1 | 1 |

TABLE 15

| | | | | | α | | | | | β | | | |
|---|---|---|---|---|---|---|---|---|---|---|---|---|---|
| | R21 | R22 | R23 | R24 | R60 | R61 | Za | la | ma | R70 | R71 | Zb | lb |
| N-151 | —H | —H | —H | —H | —H | —H | —O— | 2 | 4 | —H | —H | —O— | 3 |
| N-152 | —H | —H | —H | —H | —H | —H | —O— | 2 | 5 | —H | —H | —O— | 3 |
| N-153 | —H | —H | —H | —H | —H | —H | —O— | 2 | 6 | —H | —H | —O— | 3 |
| N-154 | —H | —H | —H | —H | —H | —H | —O— | 2 | 7 | —H | —H | —O— | 3 |
| N-155 | —H | —H | —H | —H | —H | —H | —O— | 2 | 8 | —H | —H | —O— | 3 |
| N-156 | —H | —H | —H | —H | —H | —H | —O— | 2 | 9 | —H | —H | —O— | 3 |
| N-157 | —H | —H | —H | —H | —H | —H | —O— | 2 | 10 | —H | —H | —O— | 3 |
| N-158 | —H | —H | —H | —H | —H | —H | —O— | 2 | 12 | —H | —H | —O— | 3 |
| N-159 | —H | —H | —H | —H | —H | —H | —O— | 2 | 15 | —H | —H | —O— | 3 |
| N-160 | —H | —H | —H | —H | —H | —H | —O— | 2 | 20 | —H | —H | —O— | 3 |
| N-161 | —H | —H | —H | —H | —H | —H | —O— | 2 | 30 | —H | —H | —O— | 3 |
| N-162 | —H | —H | —H | —H | —H | —H | —O— | 2 | 40 | —H | —H | —O— | 3 |
| N-163 | —H | —H | —H | —H | —H | —H | —O— | 2 | 50 | —H | —H | —O— | 3 |
| N-164 | —H | —H | —H | —H | —H | —H | —O— | 2 | 60 | —H | —H | —O— | 3 |
| N-165 | —H | —H | —H | —H | —H | —H | —O— | 2 | 70 | —H | —H | —O— | 3 |
| N-166 | —H | —H | —H | —H | —H | —H | —O— | 1 | 1 | —H | —H | (SB) | 1 |
| N-167 | —H | —H | —H | —H | —H | —H | —O— | 1 | 2 | —H | —H | (SB) | 1 |
| N-168 | —H | —H | —H | —H | —H | —H | —O— | 1 | 3 | —H | —H | (SB) | 1 |
| N-169 | —H | —H | —H | —H | —H | —H | —O— | 1 | 4 | —H | —H | (SB) | 1 |
| N-170 | —H | —H | —H | —H | —H | —H | —O— | 1 | 5 | —H | —H | (SB) | 1 |
| N-171 | —H | —H | —H | —H | —H | —H | —O— | 1 | 6 | —H | —H | (SB) | 1 |
| N-172 | —H | —H | —H | —H | —H | —H | —O— | 1 | 7 | —H | —H | (SB) | 1 |
| N-173 | —H | —H | —H | —H | —H | —H | —O— | 1 | 8 | —H | —H | (SB) | 1 |
| N-174 | —H | —H | —H | —H | —H | —H | —O— | 1 | 9 | —H | —H | (SB) | 1 |
| N-175 | —H | —H | —H | —H | —H | —H | —O— | 1 | 10 | —H | —H | (SB) | 1 |
| N-176 | —H | —H | —H | —H | —H | —H | —O— | 1 | 11 | —H | —H | (SB) | 1 |
| N-177 | —H | —H | —H | —H | —H | —H | —O— | 1 | 12 | —H | —H | (SB) | 1 |
| N-178 | —H | —H | —H | —H | —H | —H | —O— | 1 | 15 | —H | —H | (SB) | 1 |
| N-179 | —H | —H | —H | —H | —H | —H | —O— | 1 | 20 | —H | —H | (SB) | 1 |
| N-180 | —H | —H | —H | —H | —H | —H | —O— | 1 | 30 | —H | —H | (SB) | 1 |
| N-181 | —H | —H | —H | —H | —H | —H | —O— | 1 | 40 | —H | —H | (SB) | 1 |
| N-182 | —H | —H | —H | —H | —H | —H | —O— | 1 | 50 | —H | —H | (SB) | 1 |
| N-183 | —H | —H | —H | —H | —H | —H | —O— | 1 | 60 | —H | —H | (SB) | 1 |
| N-184 | —H | —H | —H | —H | —H | —H | —O— | 1 | 70 | —H | —H | (SB) | 1 |
| N-185 | —H | —H | —H | —H | —H | —H | —NH | 1 | 1 | —H | —H | (SB) | 1 |
| N-186 | —H | —H | —H | —H | —H | —H | —NH | 1 | 1 | —H | —H | (SB) | 1 |
| N-187 | —H | —H | —H | —H | —H | —H | —NH | 1 | 2 | —H | —H | (SB) | 1 |
| N-188 | —H | —H | —H | —H | —H | —H | —NH | 1 | 3 | —H | —H | (SB) | 1 |
| N-189 | —H | —H | —H | —H | —H | —H | —NH | 1 | 4 | —H | —H | (SB) | 1 |
| N-190 | —H | —H | —H | —H | —H | —H | —NH | 1 | 5 | —H | —H | (SB) | 1 |
| N-191 | —H | —H | —H | —H | —H | —H | —NH | 1 | 6 | —H | —H | (SB) | 1 |
| N-192 | —H | —H | —H | —H | —H | —H | —NH | 1 | 7 | —H | —H | (SB) | 1 |
| N-193 | —H | —H | —H | —H | —H | —H | —NH | 1 | 8 | —H | —H | (SB) | 1 |
| N-194 | —H | —H | —H | —H | —H | —H | —NH | 1 | 9 | —H | —H | (SB) | 1 |
| N-195 | —H | —H | —H | —H | —H | —H | —NH | 1 | 10 | —H | —H | (SB) | 1 |
| N-196 | —H | —H | —H | —H | —H | —H | —NH | 1 | 11 | —H | —H | (SB) | 1 |
| N-197 | —H | —H | —H | —H | —H | —H | —NH | 1 | 12 | —H | —H | (SB) | 1 |
| N-198 | —H | —H | —H | —H | —H | —H | —NH | 1 | 15 | —H | —H | (SB) | 1 |
| N-199 | —H | —H | —H | —H | —H | —H | —NH | 1 | 20 | —H | —H | (SB) | 1 |
| N-200 | —H | —H | —H | —H | —H | —H | —NH | 1 | 30 | —H | —H | (SB) | 1 |

| | β | γ | | | | |
|---|---|---|---|---|---|---|
| | mb | R80 | R81 | Zc | lc | mc |
| N-151 | 1 | —H | —H | (SB) | 1 | 1 |
| N-152 | 1 | —H | —H | (SB) | 1 | 1 |
| N-153 | 1 | —H | —H | (SB) | 1 | 1 |
| N-154 | 1 | —H | —H | (SB) | 1 | 1 |
| N-155 | 1 | —H | —H | (SB) | 1 | 1 |
| N-156 | 1 | —H | —H | (SB) | 1 | 1 |
| N-157 | 1 | —H | —H | (SB) | 1 | 1 |
| N-158 | 1 | —H | —H | (SB) | 1 | 1 |
| N-159 | 1 | —H | —H | (SB) | 1 | 1 |
| N-160 | 1 | —H | —H | (SB) | 1 | 1 |
| N-161 | 1 | —H | —H | (SB) | 1 | 1 |
| N-162 | 1 | —H | —H | (SB) | 1 | 1 |
| N-163 | 1 | —H | —H | (SB) | 1 | 1 |
| N-164 | 1 | —H | —H | (SB) | 1 | 1 |
| N-165 | 1 | —H | —H | (SB) | 1 | 1 |
| N-166 | 1 | — | — | — | 0 | 0 |
| N-167 | 1 | — | — | — | 0 | 0 |
| N-168 | 1 | — | — | — | 0 | 0 |
| N-169 | 1 | — | — | — | 0 | 0 |
| N-170 | 1 | — | — | — | 0 | 0 |
| N-171 | 1 | — | — | — | 0 | 0 |
| N-172 | 1 | — | — | — | 0 | 0 |
| N-173 | 1 | — | — | — | 0 | 0 |
| N-174 | 1 | — | — | — | 0 | 0 |
| N-175 | 1 | — | — | — | 0 | 0 |
| N-176 | 1 | — | — | — | 0 | 0 |
| N-177 | 1 | — | — | — | 0 | 0 |
| N-178 | 1 | — | — | — | 0 | 0 |
| N-179 | 1 | — | — | — | 0 | 0 |
| N-180 | 1 | — | — | — | 0 | 0 |
| N-181 | 1 | — | — | — | 0 | 0 |
| N-182 | 1 | — | — | — | 0 | 0 |
| N-183 | 1 | — | — | — | 0 | 0 |
| N-184 | 1 | — | — | — | 0 | 0 |
| N-185 | 1 | — | — | — | 0 | 0 |
| N-186 | 1 | — | — | — | 0 | 0 |
| N-187 | 1 | — | — | — | 0 | 0 |
| N-188 | 1 | — | — | — | 0 | 0 |
| N-189 | 1 | — | — | — | 0 | 0 |
| N-190 | 1 | — | — | — | 0 | 0 |
| N-191 | 1 | — | — | — | 0 | 0 |
| N-192 | 1 | — | — | — | 0 | 0 |
| N-193 | 1 | — | — | — | 0 | 0 |
| N-194 | 1 | — | — | — | 0 | 0 |
| N-195 | 1 | — | — | — | 0 | 0 |
| N-196 | 1 | — | — | — | 0 | 0 |
| N-197 | 1 | — | — | — | 0 | 0 |
| N-198 | 1 | — | — | — | 0 | 0 |
| N-199 | 1 | — | — | — | 0 | 0 |
| N-200 | 1 | — | — | — | 0 | 0 |

TABLE 16

| | | | | | α | | | | | β |
|---|---|---|---|---|---|---|---|---|---|---|
| | R21 | R22 | R23 | R24 | R60 | R61 | Za | la | ma | R70 |
| N-201 | —H | —H | —H | —H | —H | —H | —NH | 1 | 40 | —H |
| N-202 | —H | —H | —H | —H | —H | —H | —NH | 1 | 50 | —H |
| N-203 | —H | —H | —H | —H | —H | —H | —NH | 1 | 60 | —H |
| N-204 | —H | —H | —H | —H | —H | —H | —NH | 1 | 70 | —H |
| N-205 | —H | —H | —H | —H | —n-C3H7 | —H | (SB) | 2 | 1 | —H |
| N-206 | —H | —H | —H | —H | —n-C3H7 | —H | (SB) | 2 | 2 | —H |
| N-207 | —H | —H | —H | —H | —n-C3H7 | —H | (SB) | 2 | 3 | —H |
| N-208 | —H | —H | —H | —H | —n-C3H7 | —H | (SB) | 2 | 4 | —H |
| N-209 | —H | —H | —H | —H | —n-C3H7 | —H | (SB) | 2 | 5 | —H |
| N-210 | —H | —H | —H | —H | —n-C3H7 | —H | (SB) | 2 | 6 | —H |
| N-211 | —H | —H | —H | —H | —n-C3H7 | —H | (SB) | 2 | 7 | —H |
| N-212 | —H | —H | —H | —H | —n-C3H7 | —H | (SB) | 2 | 8 | —H |
| N-213 | —H | —H | —H | —H | —n-C3H7 | —H | (SB) | 2 | 9 | —H |
| N-214 | —H | —H | —H | —H | —n-C3H7 | —H | (SB) | 2 | 10 | —H |
| N-215 | —H | —H | —H | —H | —n-C3H7 | —H | (SB) | 2 | 20 | —H |
| N-216 | —H | —H | —H | —H | —n-C3H7 | —H | (SB) | 2 | 30 | —H |
| N-217 | —H | —H | —H | —H | —n-C3H7 | —H | (SB) | 2 | 40 | —H |
| N-218 | —H | —H | —H | —H | —n-C3H7 | —H | (SB) | 5 | 1 | — |
| N-219 | —H | —H | —H | —H | —n-C3H7 | —H | (SB) | 6 | 1 | —n-C3H7 |
| N-220 | —H | —F | —H | —F | —CH3 | —H | —O— | 1 | 1 | —H |
| N-221 | —H | —F | —H | —F | —CH3 | —H | —O— | 1 | 2 | —H |
| N-222 | —H | —F | —H | —F | —CH3 | —H | —O— | 1 | 3 | —H |
| M-223 | —H | —F | —H | —F | —CH3 | —H | —O— | 1 | 4 | —H |
| N-224 | —H | —F | —H | —F | —CH3 | —H | —O— | 1 | 5 | —H |
| N-225 | —H | —F | —H | —F | —CH3 | —H | —O— | 1 | 6 | —H |
| N-226 | —H | —F | —H | —F | —CH3 | —H | —O— | 1 | 7 | —H |
| N-227 | —H | —F | —H | —F | —CH3 | —H | —O— | 1 | 30 | —H |
| N-228 | —H | —F | —H | —F | —CH3 | —H | —O— | 1 | 32 | —H |
| N-229 | —H | —F | —H | —F | —CH3 | —H | —O— | 1 | 33 | —H |
| N-230 | —H | —I | —H | —I | —CH3 | —H | —O— | 1 | 1 | —H |
| N-231 | —H | —I | —H | —I | —CH3 | —H | —O— | 1 | 2 | —H |
| N-232 | —H | —I | —H | —I | —CH3 | —H | —O— | 1 | 3 | —H |
| N-233 | —H | —I | —H | —I | —CH3 | —H | —O— | 1 | 4 | —H |
| N-234 | —H | —I | —H | —I | —CH3 | —H | —O— | 1 | 5 | —H |
| N-235 | —H | —I | —H | —I | —CH3 | —H | —O— | 1 | 6 | —H |
| N-236 | —H | —I | —H | —I | —CH3 | —H | —O— | 1 | 7 | —H |
| N-237 | —H | —I | —H | —I | —CH3 | —H | —O— | 1 | 30 | —H |
| N-238 | —H | —I | —H | —I | —CH3 | —H | —O— | 1 | 32 | —H |
| N-239 | —H | —I | —H | —I | —CH3 | —H | —O— | 1 | 33 | —H |
| N-240 | —H | —NO2 | —H | —NO2 | —CH3 | —H | —O— | 1 | 1 | —H |
| N-241 | —H | —NO2 | —H | —NO2 | —CH3 | —H | —O— | 1 | 2 | —H |
| N-242 | —H | —NO2 | —H | —NO2 | —CH3 | —H | —O— | 1 | 3 | —H |
| N-243 | —H | —NO2 | —H | —NO2 | —CH3 | —H | —O— | 1 | 4 | —H |
| N-244 | —H | —NO2 | —H | —NO2 | —CH3 | —H | —O— | 1 | 5 | —H |
| N-245 | —H | —NO2 | —H | —NO2 | —CH3 | —H | —O— | 1 | 6 | —H |
| N-246 | —H | —NO2 | —H | —NO2 | —CH3 | —H | —O— | 1 | 7 | —H |
| N-247 | —H | —NO2 | —H | —NO2 | —CH3 | —H | —O— | 1 | 30 | —H |
| N-248 | —H | —NO2 | —H | —NO2 | —CH3 | —H | —O— | 1 | 32 | —H |
| N-249 | —H | —NO2 | —H | —NO2 | —CH3 | —H | —O— | 1 | 33 | —H |
| N-250 | —H | —NO2 | —H | —NO2 | —CH3 | —H | —O— | 1 | 1 | —H |

| | β | | | | γ | | | | |
|---|---|---|---|---|---|---|---|---|---|
| | R71 | Zb | lb | mb | R80 | R81 | Zc | lc | mc |
| N-201 | —H | (SB) | 1 | 1 | — | — | — | 0 | 0 |
| N-202 | —H | (SB) | 1 | 1 | — | — | — | 0 | 0 |
| N-203 | —H | (SB) | 1 | 1 | — | — | — | 0 | 0 |
| N-204 | —H | (SB) | 1 | 1 | — | — | — | 0 | 0 |
| N-205 | —H | —H | 2 | 1 | — | — | — | 0 | 0 |
| N-206 | —H | —H | 2 | 1 | — | — | — | 0 | 0 |
| N-207 | —H | —H | 2 | 1 | — | — | — | 0 | 0 |
| N-208 | —H | —H | 2 | 1 | — | — | — | 0 | 0 |
| N-209 | —H | —H | 2 | 1 | — | — | — | 0 | 0 |
| N-210 | —H | —H | 2 | 1 | — | — | — | 0 | 0 |
| N-211 | —H | —H | 2 | 1 | — | — | — | 0 | 0 |
| N-212 | —H | —H | 2 | 1 | — | — | — | 0 | 0 |
| N-213 | —H | —H | 2 | 1 | — | — | — | 0 | 0 |
| N-214 | —H | —H | 2 | 1 | — | — | — | 0 | 0 |
| N-215 | —H | —H | 2 | 1 | — | — | — | 0 | 0 |
| N-216 | —H | —H | 2 | 1 | — | — | — | 0 | 0 |
| N-217 | —H | —H | 2 | 1 | — | — | — | 0 | 0 |
| N-218 | — | — | 0 | 0 | — | — | — | 0 | 0 |
| N-219 | — | (SB) | 0 | 1 | — | — | — | 0 | 0 |
| N-220 | —CH3 | (SB) | 1 | 1 | — | — | — | 0 | 0 |
| N-221 | —CH3 | (SB) | 1 | 1 | — | — | — | 0 | 0 |
| N-222 | —CH3 | (SB) | 1 | 1 | — | — | — | 0 | 0 |
| M-223 | —CH3 | (SB) | 1 | 1 | — | — | — | 0 | 0 |
| N-224 | —CH3 | (SB) | 1 | 1 | — | — | — | 0 | 0 |
| N-225 | —CH3 | (SB) | 1 | 1 | — | — | — | 0 | 0 |
| N-226 | —CH3 | (SB) | 1 | 1 | — | — | — | 0 | 0 |
| N-227 | —CH3 | (SB) | 1 | 1 | — | — | — | 0 | 0 |
| N-228 | —CH3 | (SB) | 1 | 1 | — | — | — | 0 | 0 |
| N-229 | —CH3 | (SB) | 1 | 1 | — | — | — | 0 | 0 |
| N-230 | —CH3 | (SB) | 1 | 1 | — | — | — | 0 | 0 |
| N-231 | —CH3 | (SB) | 1 | 1 | — | — | — | 0 | 0 |
| N-232 | —CH3 | (SB) | 1 | 1 | — | — | — | 0 | 0 |
| N-233 | —CH3 | (SB) | 1 | 1 | — | — | — | 0 | 0 |
| N-234 | —CH3 | (SB) | 1 | 1 | — | — | — | 0 | 0 |
| N-235 | —CH3 | (SB) | 1 | 1 | — | — | — | 0 | 0 |
| N-236 | —CH3 | (SB) | 1 | 1 | — | — | — | 0 | 0 |
| N-237 | —CH3 | (SB) | 1 | 1 | — | — | — | 0 | 0 |
| N-238 | —CH3 | (SB) | 1 | 1 | — | — | — | 0 | 0 |
| N-239 | —CH3 | (SB) | 1 | 1 | — | — | — | 0 | 0 |
| N-240 | —CH3 | (SB) | 1 | 1 | — | — | — | 0 | 0 |
| N-241 | —CH3 | (SB) | 1 | 1 | — | — | — | 0 | 0 |
| N-242 | —CH3 | (SB) | 1 | 1 | — | — | — | 0 | 0 |
| N-243 | —CH3 | (SB) | 1 | 1 | — | — | — | 0 | 0 |
| N-244 | —CH3 | (SB) | 1 | 1 | — | — | — | 0 | 0 |
| N-245 | —CH3 | (SB) | 1 | 1 | — | — | — | 0 | 0 |
| N-246 | —CH3 | (SB) | 1 | 1 | — | — | — | 0 | 0 |
| N-247 | —CH3 | (SB) | 1 | 1 | — | — | — | 0 | 0 |
| N-248 | —CH3 | (SB) | 1 | 1 | — | — | — | 0 | 0 |
| N-249 | —CH3 | (SB) | 1 | 1 | — | — | — | 0 | 0 |
| N-250 | —CH3 | (SB) | 1 | 1 | — | — | — | 0 | 0 |

TABLE 17

| | | | | | α | | | | | β | | | | | γ | | | | |
|---|---|---|---|---|---|---|---|---|---|---|---|---|---|---|---|---|---|---|---|
| | R21 | R22 | R23 | R24 | R60 | R61 | Za | Ia | ma | R70 | R71 | Zb | Ib | mb | R80 | R81 | Zc | Ic | mc |
| N-251 | —H | —CN | —H | —CN | —CH3 | —H | —O— | 1 | 2 | —H | —CH3 | (SB) | 1 | 1 | — | — | — | 0 | 0 |
| N-252 | —H | —CN | —H | —CN | —CH3 | —H | —O— | 1 | 3 | —H | —CH3 | (SB) | 1 | 1 | — | — | — | 0 | 0 |
| N-253 | —H | —CN | —H | —CN | —CH3 | —H | —O— | 1 | 4 | —H | —CH3 | (SB) | 1 | 1 | — | — | — | 0 | 0 |
| N-254 | —H | —CN | —H | —CN | —CH3 | —H | —O— | 1 | 5 | —H | —CH3 | (SB) | 1 | 1 | — | — | — | 0 | 0 |
| N-255 | —H | —CN | —H | —CN | —CH3 | —H | —O— | 1 | 6 | —H | —CH3 | (SB) | 1 | 1 | — | — | — | 0 | 0 |
| N-256 | —H | —CN | —H | —CN | —CH3 | —H | —O— | 1 | 7 | —H | —CH3 | (SB) | 1 | 1 | — | — | — | 0 | 0 |
| N-257 | —H | —CN | —H | —CN | —CH3 | —H | —O— | 1 | 30 | —H | —CH3 | (SB) | 1 | 1 | — | — | — | 0 | 0 |
| N-258 | —H | —CN | —H | —CN | —CH3 | —H | —O— | 1 | 32 | —H | —CH3 | (SB) | 1 | 1 | — | — | — | 0 | 0 |
| N-259 | —H | —CN | —H | —CN | —CH3 | —H | —O— | 1 | 33 | —H | —CH3 | (SB) | 1 | 1 | — | — | — | 0 | 0 |
| N-260 | —H | —NH2 | —H | —NH2 | —CH3 | —H | —O— | 1 | 1 | —H | —CH3 | (SB) | 1 | 1 | — | — | — | 0 | 0 |
| N-261 | —H | —NH2 | —H | —NH2 | —CH3 | —H | —O— | 1 | 2 | —H | —CH3 | (SB) | 1 | 1 | — | — | — | 0 | 0 |
| N-262 | —H | —NH2 | —H | —NH2 | —CH3 | —H | —O— | 1 | 3 | —H | —CH3 | (SB) | 1 | 1 | — | — | — | 0 | 0 |
| N-263 | —H | —NH2 | —H | —NH2 | —CH3 | —H | —O— | 1 | 4 | —H | —CH3 | (SB) | 1 | 1 | — | — | — | 0 | 0 |
| N-264 | —H | —NH2 | —H | —NH2 | —CH3 | —H | —O— | 1 | 5 | —H | —CH3 | (SB) | 1 | 1 | — | — | — | 0 | 0 |
| N-265 | —H | —NH2 | —H | —NH2 | —CH3 | —H | —O— | 1 | 6 | —H | —CH3 | (SB) | 1 | 1 | — | — | — | 0 | 0 |
| N-266 | —H | —NH2 | —H | —NH2 | —CH3 | —H | —O— | 1 | 7 | —H | —CH3 | (SB) | 1 | 1 | — | — | — | 0 | 0 |
| N-267 | —H | —NH2 | —H | —NH2 | —CH3 | —H | —O— | 1 | 30 | —H | —CH3 | (SB) | 1 | 1 | — | — | — | 0 | 0 |
| N-268 | —H | —NH2 | —H | —NH2 | —CH3 | —H | —O— | 1 | 32 | —H | —CH3 | (SB) | 1 | 1 | — | — | — | 0 | 0 |
| N-269 | —H | —NH2 | —H | —NH2 | —CH3 | —H | —O— | 1 | 33 | —H | —CH3 | (SB) | 1 | 1 | — | — | — | 0 | 0 |
| N-270 | —H | [symbol] | —H | [symbol] | —CH3 | —H | —O— | 1 | 1 | —H | —CH3 | (SB) | 1 | 1 | — | — | — | 0 | 0 |
| M-271 | —H | [symbol] | —H | [symbol] | —CH3 | —H | —O— | 1 | 2 | —H | —CH3 | (SB) | 1 | 1 | — | — | — | 0 | 0 |
| N:272 | —H | [symbol] | —H | [symbol] | —CH3 | —H | —O— | 1 | 3 | —H | —CH3 | (SB) | 1 | 1 | — | — | — | 0 | 0 |
| N-273 | —H | [symbol] | —H | [symbol] | —CH3 | —H | —O— | 1 | 4 | —H | —CH3 | (SB) | 1 | 1 | — | — | — | 0 | 0 |
| N-274 | —H | [symbol] | —H | [symbol] | —CH3 | —H | —O— | 1 | 5 | —H | —CH3 | (SB) | 1 | 1 | — | — | — | 0 | 0 |
| N-275 | —H | [symbol] | —H | [symbol] | —CH3 | —H | —O— | 1 | 6 | —H | —CH3 | (SB) | 1 | 1 | — | — | — | 0 | 0 |
| N-276 | —H | [symbol] | —H | [symbol] | —CH3 | —H | —O— | 1 | 7 | —H | —CH3 | (SB) | 1 | 1 | — | — | — | 0 | 0 |
| N-277 | —H | [symbol] | —H | [symbol] | —CH3 | —H | —O— | 1 | 30 | —H | —CH3 | (SB) | 1 | 1 | — | — | — | 0 | 0 |
| N-278 | —H | [symbol] | —H | [symbol] | —CH3 | —H | —O— | 1 | 32 | —H | —CH3 | (SB) | 1 | 1 | — | — | — | 0 | 0 |
| N-279 | —H | [symbol] | —H | [symbol] | —CH3 | —H | —O— | 1 | 33 | —H | —CH3 | (SB) | 1 | 1 | — | — | — | 0 | 0 |
| N-280 | —H | [symbol] | —H | [symbol] | —CH3 | —H | —O— | 1 | 1 | —H | —CH3 | (SB) | 1 | 1 | — | — | — | 0 | 0 |
| N-281 | —H | [symbol] | —H | [symbol] | —CH3 | —H | —O— | 1 | 2 | —H | —CH3 | (SB) | 1 | 1 | — | — | — | 0 | 0 |
| N-282 | —H | [symbol] | —H | [symbol] | —CH3 | —H | —O— | 1 | 3 | —H | —CH3 | (SB) | 1 | 1 | — | — | — | 0 | 0 |
| N-283 | —H | [symbol] | —H | [symbol] | —CH3 | —H | —O— | 1 | 4 | —H | —CH3 | (SB) | 1 | 1 | — | — | — | 0 | 0 |
| N-284 | —H | [symbol] | —H | [symbol] | —CH3 | —H | —O— | 1 | 5 | —H | —CH3 | (SB) | 1 | 1 | — | — | — | 0 | 0 |
| N-285 | —H | [symbol] | —H | [symbol] | —CH3 | —H | —O— | 1 | 6 | —H | —CH3 | (SB) | 1 | 1 | — | — | — | 0 | 0 |
| N-286 | —H | [symbol] | —H | [symbol] | —CH3 | —H | —O— | 1 | 7 | —H | —CH3 | (SB) | 1 | 1 | — | — | — | 0 | 0 |
| N-287 | —H | [symbol] | —H | [symbol] | —CH3 | —H | —O— | 1 | 30 | —H | —CH3 | (SB) | 1 | 1 | — | — | — | 0 | 0 |
| N-288 | —H | [symbol] | —H | [symbol] | —CH3 | —H | —O— | 1 | 32 | —H | —CH3 | (SB) | 1 | 1 | — | — | — | 0 | 0 |
| N-289 | —H | [symbol] | —H | [symbol] | —CH3 | —H | —O— | 1 | 33 | —H | —CH3 | (SB) | 1 | 1 | — | — | — | 0 | 0 |
| N-290 | —H | 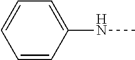 | —H | 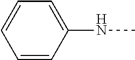 | —CH3 | —H | —O— | 1 | 1 | —H | —CH3 | (SB) | 1 | 1 | — | — | — | 0 | 0 |
| N-291 | —H | | —H | | —CH3 | —H | —O— | 1 | 2 | —H | —CH3 | (SB) | 1 | 1 | — | — | — | 0 | 0 |
| N-292 | —H | | —H | | —CH3 | —H | —O— | 1 | 3 | —H | —CH3 | (SB) | 1 | 1 | — | — | — | 0 | 0 |
| N-293 | —H | | —H | | —CH3 | —H | —O— | 1 | 4 | —H | —CH3 | (SB) | 1 | 1 | — | — | — | 0 | 0 |
| N-294 | —H | | —H | | —CH3 | —H | —O— | 1 | 5 | —H | —CH3 | (SB) | 1 | 1 | — | — | — | 0 | 0 |
| N-295 | —H | | —H | | —CH3 | —H | —O— | 1 | 6 | —H | —CH3 | (SB) | 1 | 1 | — | — | — | 0 | 0 |
| M-296 | —H | | —H | | —CH3 | —H | —O— | 1 | 7 | —H | —CH3 | (SB) | 1 | 1 | — | — | — | 0 | 0 |
| N-297 | —H | | —H | | —CH3 | —H | —O— | 1 | 30 | —H | —CH3 | (SB) | 1 | 1 | — | — | — | 0 | 0 |
| N-298 | —H | | —H | | —CH3 | —H | —O— | 1 | 32 | —H | —CH3 | (SB) | 1 | 1 | — | — | — | 0 | 0 |
| N-299 | —H | | —H | | —CH3 | —H | —O— | 1 | 33 | —H | —CH3 | (SB) | 1 | 1 | — | — | — | 0 | 0 |

[symbol]

indicates data missing or illegible when filed

TABLE 18

| | | | | | α | | | | | β | | | | | γ | | | | |
|---|---|---|---|---|---|---|---|---|---|---|---|---|---|---|---|---|---|---|---|
| | R21 | R22 | R23 | R24 | R60 | R61 | Za | Ia | ma | R70 | R71 | Zb | Ib | mb | R80 | R81 | Zc | Ic | mc |
| N-300 | —H | 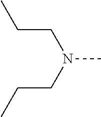 | —H | 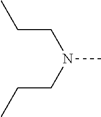 | —CH3 | —H | —O— | 1 | 1 | —H | —CH3 | (SB) | 1 | 1 | — | — | — | 0 | 0 |
| N-301 | —H | | —H | | —CH3 | —H | —O— | 1 | 2 | —H | —CH3 | (SB) | 1 | 1 | — | — | — | 0 | 0 |
| N-302 | —H | | —H | | —CH3 | —H | —O— | 1 | 3 | —H | —CH3 | (SB) | 1 | 1 | — | — | — | 0 | 0 |
| N-303 | —H | | —H | | —CH3 | —H | —O— | 1 | 4 | —H | —CH3 | (SB) | 1 | 1 | — | — | — | 0 | 0 |
| N-304 | —H | | —H | | —CH3 | —H | —O— | 1 | 5 | —H | —CH3 | (SB) | 1 | 1 | — | — | — | 0 | 0 |
| N-305 | —H | | —H | | —CH3 | —H | —O— | 1 | 6 | —H | —CH3 | (SB) | 1 | 1 | — | — | — | 0 | 0 |
| N-306 | —H | | —H | | —CH3 | —H | —O— | 1 | 7 | —H | —CH3 | (SB) | 1 | 1 | — | — | — | 0 | 0 |
| N-307 | —H | | —H | | —CH3 | —H | —O— | 1 | 30 | —H | —CH3 | (SB) | 1 | 1 | — | — | — | 0 | 0 |
| N-308 | —H | | —H | | —CH3 | —H | —O— | 1 | 32 | —H | —CH3 | (SB) | 1 | 1 | — | — | — | 0 | 0 |
| N-309 | —H | | —H | | —CH3 | —H | —O— | 1 | 33 | —H | —CH3 | (SB) | 1 | 1 | — | — | — | 0 | 0 |
| N-310 | —H | 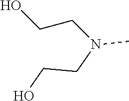 | —H | 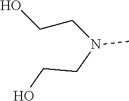 | —CH3 | —H | —O— | 1 | 1 | —H | —CH3 | (SB) | 1 | 1 | — | — | — | 0 | 0 |
| N-311 | —H | | —H | | —CH3 | —H | —O— | 1 | 2 | —H | —CH3 | (SB) | 1 | 1 | — | — | — | 0 | 0 |
| N-312 | —H | | —H | | —CH3 | —H | —O— | 1 | 3 | —H | —CH3 | (SB) | 1 | 1 | — | — | — | 0 | 0 |
| N-313 | —H | | —H | | —CH3 | —H | —O— | 1 | 4 | —H | —CH3 | (SB) | 1 | 1 | — | — | — | 0 | 0 |
| N-314 | —H | | —H | | —CH3 | —H | —O— | 1 | 5 | —H | —CH3 | (SB) | 1 | 1 | — | — | — | 0 | 0 |
| N-315 | —H | | —H | | —CH3 | —H | —O— | 1 | 6 | —H | —CH3 | (SB) | 1 | 1 | — | — | — | 0 | 0 |
| N-316 | —H | | —H | | —CH3 | —H | —O— | 1 | 7 | —H | —CH3 | (SB) | 1 | 1 | — | — | — | 0 | 0 |
| N-317 | —H | | —H | | —CH3 | —H | —O— | 1 | 30 | —H | —CH3 | (SB) | 1 | 1 | — | — | — | 0 | 0 |
| N-318 | —H | | —H | | —CH3 | —H | —O— | 1 | 32 | —H | —CH3 | (SB) | 1 | 1 | — | — | — | 0 | 0 |
| N-319 | —H | | —H | | —CH3 | —H | —O— | 1 | 33 | —H | —CH3 | (SB) | 1 | 1 | — | — | — | 0 | 0 |
| N-320 | —H | 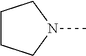 | —H | 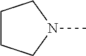 | —CH3 | —H | —O— | 1 | 1 | —H | —CH3 | (SB) | 1 | 1 | — | — | — | 0 | 0 |
| N-321 | —H | | —H | | —CH3 | —H | —O— | 1 | 2 | —H | —CH3 | (SB) | 1 | 1 | — | — | — | 0 | 0 |
| N-322 | —H | | —H | | —CH3 | —H | —O— | 1 | 3 | —H | —CH3 | (SB) | 1 | 1 | — | — | — | 0 | 0 |
| N-323 | —H | | —H | | —CH3 | —H | —O— | 1 | 4 | —H | —CH3 | (SB) | 1 | 1 | — | — | — | 0 | 0 |
| N-324 | —H | | —H | | —CH3 | —H | —O— | 1 | 5 | —H | —CH3 | (SB) | 1 | 1 | — | — | — | 0 | 0 |
| N-325 | —H | | —H | | —CH3 | —H | —O— | 1 | 6 | —H | —CH3 | (SB) | 1 | 1 | — | — | — | 0 | 0 |
| N-326 | —H | | —H | | —CH3 | —H | —O— | 1 | 7 | —H | —CH3 | (SB) | 1 | 1 | — | — | — | 0 | 0 |
| N-327 | —H | | —H | | —CH3 | —H | —O— | 1 | 30 | —H | —CH3 | (SB) | 1 | 1 | — | — | — | 0 | 0 |
| N-328 | —H | | —H | | —CH3 | —H | —O— | 1 | 32 | —H | —CH3 | (SB) | 1 | 1 | — | — | — | 0 | 0 |
| N-329 | —H | | —H | | —CH3 | —H | —O— | 1 | 33 | —H | —CH3 | (SB) | 1 | 1 | — | — | — | 0 | 0 |
| N-330 | —H | —OH | —H | —OH | —CH3 | —H | —O— | 1 | 1 | —H | —CH3 | (SB) | 1 | 1 | — | — | — | 0 | 0 |
| N-331 | —H | —OH | —H | —OH | —CH3 | —H | —O— | 1 | 2 | —H | —CH3 | (SB) | 1 | 1 | — | — | — | 0 | 0 |
| N-332 | —H | —OH | —H | —OH | —CH3 | —H | —O— | 1 | 3 | —H | —CH3 | (SB) | 1 | 1 | — | — | — | 0 | 0 |
| N-333 | —H | —OH | —H | —OH | —CH3 | —H | —O— | 1 | 4 | —H | —CH3 | (SB) | 1 | 1 | — | — | — | 0 | 0 |
| N-334 | —H | —OH | —H | —OH | —CH3 | —H | —O— | 1 | 5 | —H | —CH3 | (SB) | 1 | 1 | — | — | — | 0 | 0 |
| N-335 | —H | —OH | —H | —OH | —CH3 | —H | —O— | 1 | 6 | —H | —CH3 | (SB) | 1 | 1 | — | — | — | 0 | 0 |
| N-336 | —H | —OH | —H | —OH | —CH3 | —H | —O— | 1 | 7 | —H | —CH3 | (SB) | 1 | 1 | — | — | — | 0 | 0 |
| N-337 | —H | —OH | —H | —OH | —CH3 | —H | —O— | 1 | 30 | —H | —CH3 | (SB) | 1 | 1 | — | — | — | 0 | 0 |
| N-338 | —H | —OH | —H | —OH | —CH3 | —H | —O— | 1 | 32 | —H | —CH3 | (SB) | 1 | 1 | — | — | — | 0 | 0 |
| N-339 | —H | —OH | —H | —OH | —CH3 | —H | —O— | 1 | 33 | —H | —CH3 | (SB) | 1 | 1 | — | — | — | 0 | 0 |
| N-340 | —H | [symbol] | —H | [symbol] | —CH3 | —H | —O— | 1 | 1 | —H | —CH3 | (SB) | 1 | 1 | — | — | — | 0 | 0 |
| N-341 | —H | [symbol] | —H | [symbol] | —CH3 | —H | —O— | 1 | 2 | —H | —CH3 | (SB) | 1 | 1 | — | — | — | 0 | 0 |
| N-342 | —H | [symbol] | —H | [symbol] | —CH3 | —H | —O— | 1 | 3 | —H | —CH3 | (SB) | 1 | 1 | — | — | — | 0 | 0 |
| N-343 | —H | [symbol] | —H | [symbol] | —CH3 | —H | —O— | 1 | 4 | —H | —CH3 | (SB) | 1 | 1 | — | — | — | 0 | 0 |
| N-344 | —H | [symbol] | —H | [symbol] | —CH3 | —H | —O— | 1 | 5 | —H | —CH3 | (SB) | 1 | 1 | — | — | — | 0 | 0 |
| N-345 | —H | [symbol] | —H | [symbol] | —CH3 | —H | —O— | 1 | 6 | —H | —CH3 | (SB) | 1 | 1 | — | — | — | 0 | 0 |
| N-346 | —H | [symbol] | —H | [symbol] | —CH3 | —H | —O— | 1 | 7 | —H | —CH3 | (SB) | 1 | 1 | — | — | — | 0 | 0 |
| N-347 | —H | [symbol] | —H | [symbol] | —CH3 | —H | —O— | 1 | 30 | —H | —CH3 | (SB) | 1 | 1 | — | — | — | 0 | 0 |
| N-348 | —H | [symbol] | —H | [symbol] | —CH3 | —H | —O— | 1 | 32 | —H | —CH3 | (SB) | 1 | 1 | — | — | — | 0 | 0 |
| N-349 | —H | [symbol] | —H | [symbol] | —CH3 | —H | —O— | 1 | 33 | —H | —CH3 | (SB) | 1 | 1 | — | — | — | 0 | 0 |
| N-350 | —H | [symbol] | —H | [symbol] | —CH3 | —H | —O— | 1 | 1 | —H | —CH3 | (SB) | 1 | 1 | — | — | — | 0 | 0 |

[symbol]

indicates data missing or illegible when filed

TABLE 19

| | | | | | α | | | | | β | | | | | γ | | | | |
|---|---|---|---|---|---|---|---|---|---|---|---|---|---|---|---|---|---|---|---|
| | R21 | R22 | R23 | R24 | R60 | R61 | Za | Ia | ma | R70 | R71 | Zb | Ib | mb | R80 | R81 | Zc | Ic | mc |
| N-351 | —H | [symbol] | —H | [symbol] | —CH3 | —H | —O— | 1 | 2 | —H | —CH3 | (SB) | 1 | 1 | — | — | — | 0 | 0 |
| N-352 | —H | [symbol] | —H | [symbol] | —CH3 | —H | —O— | 1 | 3 | —H | —CH3 | (SB) | 1 | 1 | — | — | — | 0 | 0 |
| N-353 | —H | [symbol] | —H | [symbol] | —CH3 | —H | —O— | 1 | 4 | —H | —CH3 | (SB) | 1 | 1 | — | — | — | 0 | 0 |
| N-354 | —H | [symbol] | —H | [symbol] | —CH3 | —H | —O— | 1 | 5 | —H | —CH3 | (SB) | 1 | 1 | — | — | — | 0 | 0 |
| N-355 | —H | [symbol] | —H | [symbol] | —CH3 | —H | —O— | 1 | 6 | —H | —CH3 | (SB) | 1 | 1 | — | — | — | 0 | 0 |
| N-356 | —H | [symbol] | —H | [symbol] | —CH3 | —H | —O— | 1 | 7 | —H | —CH3 | (SB) | 1 | 1 | — | — | — | 0 | 0 |
| N-357 | —H | [symbol] | —H | [symbol] | —CH3 | —H | —O— | 1 | 30 | —H | —CH3 | (SB) | 1 | 1 | — | — | — | 0 | 0 |
| N-358 | —H | [symbol] | —H | [symbol] | —CH3 | —H | —O— | 1 | 32 | —H | —CH3 | (SB) | 1 | 1 | — | — | — | 0 | 0 |
| N-359 | —H | [symbol] | —H | [symbol] | —CH3 | —H | —O— | 1 | 33 | —H | —CH3 | (SB) | 1 | 1 | — | — | — | 0 | 0 |
| N-360 | —H | 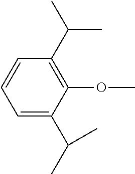 | —H | 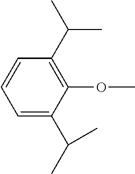 | —CH3 | —H | —O— | 1 | 1 | —H | —CH3 | (SB) | 1 | 1 | — | — | — | 0 | 0 |
| N-361 | —H | | —H | | —CH3 | —H | —O— | 1 | 2 | —H | —CH3 | (SB) | 1 | 1 | — | — | — | 0 | 0 |
| N-362 | —H | | —H | | —CH3 | —H | —O— | 1 | 3 | —H | —CH3 | (SB) | 1 | 1 | — | — | — | 0 | 0 |
| N-363 | —H | | —H | | —CH3 | —H | —O— | 1 | 4 | —H | —CH3 | (SB) | 1 | 1 | — | — | — | 0 | 0 |
| N-364 | —H | | —H | | —CH3 | —H | —O— | 1 | 5 | —H | —CH3 | (SB) | 1 | 1 | — | — | — | 0 | 0 |
| N-365 | —H | | —H | | —CH3 | —H | —O— | 1 | 6 | —H | —CH3 | (SB) | 1 | 1 | — | — | — | 0 | 0 |
| N-366 | —H | | —H | | —CH3 | —H | —O— | 1 | 7 | —H | —CH3 | (SB) | 1 | 1 | — | — | — | 0 | 0 |
| N-367 | —H | | —H | | —CH3 | —H | —O— | 1 | 30 | —H | —CH3 | (SB) | 1 | 1 | — | — | — | 0 | 0 |
| N-368 | —H | | —H | | —CH3 | —H | —O— | 1 | 32 | —H | —CH3 | (SB) | 1 | 1 | — | — | — | 0 | 0 |
| N-369 | —H | | —H | | —CH3 | —H | —O— | 1 | 33 | —H | —CH3 | (SB) | 1 | 1 | — | — | — | 0 | 0 |
| N-370 | —H | 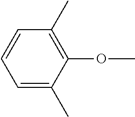 | —H | 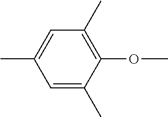 | —CH3 | —H | —O— | 1 | 1 | —H | —CH3 | (SB) | 1 | 1 | — | — | — | 0 | 0 |
| N-371 | —H | | —H | | —CH3 | —H | —O— | 1 | 2 | —H | —CH3 | (SB) | 1 | 1 | — | — | — | 0 | 0 |
| N-372 | —H | | —H | | —CH3 | —H | —O— | 1 | 3 | —H | —CH3 | (SB) | 1 | 1 | — | — | — | 0 | 0 |
| N-373 | —H | | —H | | —CH3 | —H | —O— | 1 | 4 | —H | —CH3 | (SB) | 1 | 1 | — | — | — | 0 | 0 |
| N-374 | —H | | —H | | —CH3 | —H | —O— | 1 | 5 | —H | —CH3 | (SB) | 1 | 1 | — | — | — | 0 | 0 |
| N-375 | —H | | —H | | —CH3 | —H | —O— | 1 | 6 | —H | —CH3 | (SB) | 1 | 1 | — | — | — | 0 | 0 |
| N-376 | —H | | —H | | —CH3 | —H | —O— | 1 | 7 | —H | —CH3 | (SB) | 1 | 1 | — | — | — | 0 | 0 |
| N-377 | —H | | —H | | —CH3 | —H | —O— | 1 | 30 | —H | —CH3 | (SB) | 1 | 1 | — | — | — | 0 | 0 |
| N-378 | —H | | —H | | —CH3 | —H | —O— | 1 | 32 | —H | —CH3 | (SB) | 1 | 1 | — | — | — | 0 | 0 |
| N-379 | —H | | —H | | —CH3 | —H | —O— | 1 | 33 | —H | —CH3 | (SB) | 1 | 1 | — | — | — | 0 | 0 |
| N-380 | —H | 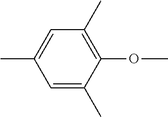 | —H | 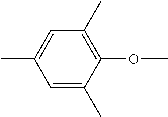 | —CH3 | —H | —O— | 1 | 1 | —H | —CH3 | (SB) | 1 | 1 | — | — | — | 0 | 0 |
| N-381 | —H | | —H | | —CH3 | —H | —O— | 1 | 2 | —H | —CH3 | (SB) | 1 | 1 | — | — | — | 0 | 0 |
| N-382 | —H | | —H | | —CH3 | —H | —O— | 1 | 3 | —H | —CH3 | (SB) | 1 | 1 | — | — | — | 0 | 0 |
| N-383 | —H | | —H | | —CH3 | —H | —O— | 1 | 4 | —H | —CH3 | (SB) | 1 | 1 | — | — | — | 0 | 0 |
| N-384 | —H | | —H | | —CH3 | —H | —O— | 1 | 5 | —H | —CH3 | (SB) | 1 | 1 | — | — | — | 0 | 0 |
| N-385 | —H | | —H | | —CH3 | —H | —O— | 1 | 6 | —H | —CH3 | (SB) | 1 | 1 | — | — | — | 0 | 0 |
| N-386 | —H | | —H | | —CH3 | —H | —O— | 1 | 7 | —H | —CH3 | (SB) | 1 | 1 | — | — | — | 0 | 0 |
| N-387 | —H | | —H | | —CH3 | —H | —O— | 1 | 30 | —H | —CH3 | (SB) | 1 | 1 | — | — | — | 0 | 0 |
| N-388 | —H | | —H | | —CH3 | —H | —O— | 1 | 32 | —H | —CH3 | (SB) | 1 | 1 | — | — | — | 0 | 0 |
| N-389 | —H | | —H | | —CH3 | —H | —O— | 1 | 33 | —H | —CH3 | (SB) | 1 | 1 | — | — | — | 0 | 0 |
| N-390 | —H | [symbol] | —H | [symbol] | —CH3 | —H | —O— | 1 | 1 | —H | —CH3 | (SB) | 1 | 1 | — | — | — | 0 | 0 |
| N-391 | —H | [symbol] | —H | [symbol] | —CH3 | —H | —O— | 1 | 2 | —H | —CH3 | (SB) | 1 | 1 | — | — | — | 0 | 0 |
| N-392 | —H | [symbol] | —H | [symbol] | —CH3 | —H | —O— | 1 | 3 | —H | —CH3 | (SB) | 1 | 1 | — | — | — | 0 | 0 |
| N-393 | —H | [symbol] | —H | [symbol] | —CH3 | —H | —O— | 1 | 4 | —H | —CH3 | (SB) | 1 | 1 | — | — | — | 0 | 0 |
| N-394 | —H | [symbol] | —H | [symbol] | —CH3 | —H | —O— | 1 | 5 | —H | —CH3 | (SB) | 1 | 1 | — | — | — | 0 | 0 |
| N-395 | —H | [symbol] | —H | [symbol] | —CH3 | —H | —O— | 1 | 6 | —H | —CH3 | (SB) | 1 | 1 | — | — | — | 0 | 0 |
| N-396 | —H | [symbol] | —H | [symbol] | —CH3 | —H | —O— | 1 | 7 | —H | —CH3 | (SB) | 1 | 1 | — | — | — | 0 | 0 |
| N-397 | —H | [symbol] | —H | [symbol] | —CH3 | —H | —O— | 1 | 30 | —H | —CH3 | (SB) | 1 | 1 | — | — | — | 0 | 0 |
| N-398 | —H | [symbol] | —H | [symbol] | —CH3 | —H | —O— | 1 | 32 | —H | —CH3 | (SB) | 1 | 1 | — | — | — | 0 | 0 |
| N-399 | —H | [symbol] | —H | [symbol] | —CH3 | —H | —O— | 1 | 33 | —H | —CH3 | (SB) | 1 | 1 | — | — | — | 0 | 0 |

[symbol]

indicates data missing or illegible when filed

TABLE 20

| | | | | | α | | | | | β | | | | | γ | | | | |
|---|---|---|---|---|---|---|---|---|---|---|---|---|---|---|---|---|---|---|---|
| | R21 | R22 | R23 | R24 | R60 | R61 | Za | Ia | ma | R70 | R71 | Zb | Ib | mb | R80 | R81 | Zc | Ic | mc |
| N-400 | —H | [symbol] | —H | [symbol] | —CH3 | —H | —O— | 1 | 1 | —H | —CH3 | (SB) | 1 | 1 | — | — | — | 0 | 0 |
| N-401 | —H | [symbol] | —H | [symbol] | —CH3 | —H | —O— | 1 | 2 | —H | —CH3 | (SB) | 1 | 1 | — | — | — | 0 | 0 |
| N-402 | —H | [symbol] | —H | [symbol] | —CH3 | —H | —O— | 1 | 3 | —H | —CH3 | (SB) | 1 | 1 | — | — | — | 0 | 0 |
| N-403 | —H | [symbol] | —H | [symbol] | —CH3 | —H | —O— | 1 | 4 | —H | —CH3 | (SB) | 1 | 1 | — | — | — | 0 | 0 |
| N-404 | —H | [symbol] | —H | [symbol] | —CH3 | —H | —O— | 1 | 5 | —H | —CH3 | (SB) | 1 | 1 | — | — | — | 0 | 0 |
| N-405 | —H | [symbol] | —H | [symbol] | —CH3 | —H | —O— | 1 | 6 | —H | —CH3 | (SB) | 1 | 1 | — | — | — | 0 | 0 |
| N-406 | —H | [symbol] | —H | [symbol] | —CH3 | —H | —O— | 1 | 7 | —H | —CH3 | (SB) | 1 | 1 | — | — | — | 0 | 0 |
| N-407 | —H | [symbol] | —H | [symbol] | —CH3 | —H | —O— | 1 | 30 | —H | —CH3 | (SB) | 1 | 1 | — | — | — | 0 | 0 |
| N-408 | —H | [symbol] | —H | [symbol] | —CH3 | —H | —O— | 1 | 32 | —H | —CH3 | (SB) | 1 | 1 | — | — | — | 0 | 0 |
| N-409 | —H | [symbol] | —H | [symbol] | —CH3 | —H | —O— | 1 | 33 | —H | —CH3 | (SB) | 1 | 1 | — | — | — | 0 | 0 |
| N-410 | —H | [symbol] | —H | [symbol] | —CH3 | —H | —O— | 1 | 1 | —H | —CH3 | (SB) | 1 | 1 | — | — | — | 0 | 0 |
| N-411 | —H | [symbol] | —H | [symbol] | —CH3 | —H | —O— | 1 | 2 | —H | —CH3 | (SB) | 1 | 1 | — | — | — | 0 | 0 |
| N-412 | —H | [symbol] | —H | [symbol] | —CH3 | —H | —O— | 1 | 3 | —H | —CH3 | (SB) | 1 | 1 | — | — | — | 0 | 0 |
| N-413 | —H | [symbol] | —H | [symbol] | —CH3 | —H | —O— | 1 | 4 | —H | —CH3 | (SB) | 1 | 1 | — | — | — | 0 | 0 |
| N-414 | —H | [symbol] | —H | [symbol] | —CH3 | —H | —O— | 1 | 5 | —H | —CH3 | (SB) | 1 | 1 | — | — | — | 0 | 0 |
| N-415 | —H | [symbol] | —H | [symbol] | —CH3 | —H | —O— | 1 | 6 | —H | —CH3 | (SB) | 1 | 1 | — | — | — | 0 | 0 |
| N-416 | —H | [symbol] | —H | [symbol] | —CH3 | —H | —O— | 1 | 7 | —H | —CH3 | (SB) | 1 | 1 | — | — | — | 0 | 0 |
| N-417 | —H | [symbol] | —H | [symbol] | —CH3 | —H | —O— | 1 | 30 | —H | —CH3 | (SB) | 1 | 1 | — | — | — | 0 | 0 |
| N-418 | —H | [symbol] | —H | [symbol] | —CH3 | —H | —O— | 1 | 32 | —H | —CH3 | (SB) | 1 | 1 | — | — | — | 0 | 0 |
| N-419 | —H | [symbol] | —H | [symbol] | —CH3 | —H | —O— | 1 | 33 | —H | —CH3 | (SB) | 1 | 1 | — | — | — | 0 | 0 |
| N-420 | —H | 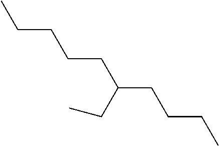 | —H | 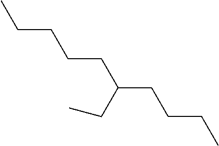 | —CH3 | —H | —O— | 1 | 1 | —H | —CH3 | (SB) | 1 | 1 | — | — | — | 0 | 0 |
| N-421 | —H | | —H | | —CH3 | —H | —O— | 1 | 2 | —H | —CH3 | (SB) | 1 | 1 | — | — | — | 0 | 0 |
| N-422 | —H | | —H | | —CH3 | —H | —O— | 1 | 3 | —H | —CH3 | (SB) | 1 | 1 | — | — | — | 0 | 0 |
| N-423 | —H | | —H | | —CH3 | —H | —O— | 1 | 4 | —H | —CH3 | (SB) | 1 | 1 | — | — | — | 0 | 0 |
| N-424 | —H | | —H | | —CH3 | —H | —O— | 1 | 5 | —H | —CH3 | (SB) | 1 | 1 | — | — | — | 0 | 0 |
| N-425 | —H | | —H | | —CH3 | —H | —O— | 1 | 6 | —H | —CH3 | (SB) | 1 | 1 | — | — | — | 0 | 0 |
| N-426 | —H | | —H | | —CH3 | —H | —O— | 1 | 7 | —H | —CH3 | (SB) | 1 | 1 | — | — | — | 0 | 0 |
| N-427 | —H | | —H | | —CH3 | —H | —O— | 1 | 30 | —H | —CH3 | (SB) | 1 | 1 | — | — | — | 0 | 0 |
| N-428 | —H | | —H | | —CH3 | —H | —O— | 1 | 32 | —H | —CH3 | (SB) | 1 | 1 | — | — | — | 0 | 0 |
| N-429 | —H | | —H | | —CH3 | —H | —O— | 1 | 33 | —H | —CH3 | (SB) | 1 | 1 | — | — | — | 0 | 0 |
| N-430 | —H | 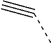 | —H | 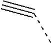 | —CH3 | —H | —O— | 1 | 1 | —H | —CH3 | (SB) | 1 | 1 | — | — | — | 0 | 0 |
| N-431 | —H | | —H | | —CH3 | —H | —O— | 1 | 2 | —H | —CH3 | (SB) | 1 | 1 | — | — | — | 0 | 0 |
| N-432 | —H | | —H | | —CH3 | —H | —O— | 1 | 3 | —H | —CH3 | (SB) | 1 | 1 | — | — | — | 0 | 0 |
| N-433 | —H | | —H | | —CH3 | —H | —O— | 1 | 4 | —H | —CH3 | (SB) | 1 | 1 | — | — | — | 0 | 0 |
| N-434 | —H | | —H | | —CH3 | —H | —O— | 1 | 5 | —H | —CH3 | (SB) | 1 | 1 | — | — | — | 0 | 0 |
| N-435 | —H | | —H | | —CH3 | —H | —O— | 1 | 6 | —H | —CH3 | (SB) | 1 | 1 | — | — | — | 0 | 0 |
| N-436 | —H | | —H | | —CH3 | —H | —O— | 1 | 7 | —H | —CH3 | (SB) | 1 | 1 | — | — | — | 0 | 0 |
| N-437 | —H | | —H | | —CH3 | —H | —O— | 1 | 30 | —H | —CH3 | (SB) | 1 | 1 | — | — | — | 0 | 0 |
| N-438 | —H | | —H | | —CH3 | —H | —O— | 1 | 32 | —H | —CH3 | (SB) | 1 | 1 | — | — | — | 0 | 0 |
| N-439 | —H | | —H | | —CH3 | —H | —O— | 1 | 33 | —H | —CH3 | (SB) | 1 | 1 | — | — | — | 0 | 0 |
| N-440 | —H | 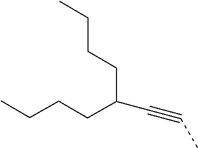 | —H | 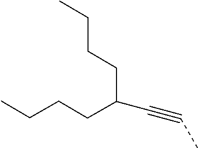 | —CH3 | —H | —O— | 1 | 1 | —H | —CH3 | (SB) | 1 | 1 | — | — | — | 0 | 0 |
| N-411 | —H | | —H | | —CH3 | —H | —O— | 1 | 2 | —H | —CH3 | (SB) | 1 | 1 | — | — | — | 0 | 0 |
| N-412 | —H | | —H | | —CH3 | —H | —O— | 1 | 3 | —H | —CH3 | (SB) | 1 | 1 | — | — | — | 0 | 0 |
| N-443 | —H | | —H | | —CH3 | —H | —O— | 1 | 4 | —H | —CH3 | (SB) | 1 | 1 | — | — | — | 0 | 0 |
| N-444 | —H | | —H | | —CH3 | —H | —O— | 1 | 5 | —H | —CH3 | (SB) | 1 | 1 | — | — | — | 0 | 0 |
| N-445 | —H | | —H | | —CH3 | —H | —O— | 1 | 6 | —H | —CH3 | (SB) | 1 | 1 | — | — | — | 0 | 0 |
| N-446 | —H | | —H | | —CH3 | —H | —O— | 1 | 7 | —H | —CH3 | (SB) | 1 | 1 | — | — | — | 0 | 0 |
| N-447 | —H | | —H | | —CH3 | —H | —O— | 1 | 30 | —H | —CH3 | (SB) | 1 | 1 | — | — | — | 0 | 0 |
| N-448 | —H | | —H | | —CH3 | —H | —O— | 1 | 32 | —H | —CH3 | (SB) | 1 | 1 | — | — | — | 0 | 0 |
| N-449 | —H | | —H | | —CH3 | —H | —O— | 1 | 33 | —H | —CH3 | (SB) | 1 | 1 | — | — | — | 0 | 0 |

[symbol]

indicates data missing or illegible when filed

TABLE 21

| | | | | | α | | | | | β | | | | | γ | | | | |
|---|---|---|---|---|---|---|---|---|---|---|---|---|---|---|---|---|---|---|---|
| | R21 | R22 | R23 | R24 | R60 | R61 | Za | Ia | ma | R70 | R71 | Zb | Ib | mb | R80 | R81 | Zc | Ic | mc |
| N-450 | —H | 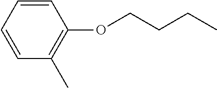 | —H | 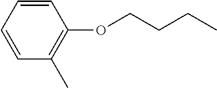 | —CH3 | —H | —O— | 1 | 1 | —H | —CH3 | (SB) | 1 | 1 | — | — | — | 0 | 0 |
| N-451 | —H | | —H | | —CH3 | —H | —O— | 1 | 2 | —H | —CH3 | (SB) | 1 | 1 | — | — | — | 0 | 0 |
| N-452 | —H | | —H | | —CH3 | —H | —O— | 1 | 3 | —H | —CH3 | (SB) | 1 | 1 | — | — | — | 0 | 0 |
| N-453 | —H | | —H | | —CH3 | —H | —O— | 1 | 4 | —H | —CH3 | (SB) | 1 | 1 | — | — | — | 0 | 0 |
| N-454 | —H | | —H | | —CH3 | —H | —O— | 1 | 5 | —H | —CH3 | (SB) | 1 | 1 | — | — | — | 0 | 0 |
| N-455 | —H | | —H | | —CH3 | —H | —O— | 1 | 6 | —H | —CH3 | (SB) | 1 | 1 | — | — | — | 0 | 0 |
| N-456 | —H | | —H | | —CH3 | —H | —O— | 1 | 7 | —H | —CH3 | (SB) | 1 | 1 | — | — | — | 0 | 0 |
| N-457 | —H | | —H | | —CH3 | —H | —O— | 1 | 30 | —H | —CH3 | (SB) | 1 | 1 | — | — | — | 0 | 0 |
| N-458 | —H | | —H | | —CH3 | —H | —O— | 1 | 32 | —H | —CH3 | (SB) | 1 | 1 | — | — | — | 0 | 0 |
| N-459 | —H | | —H | | —CH3 | —H | —O— | 1 | 33 | —H | —CH3 | (SB) | 1 | 1 | — | — | — | 0 | 0 |
| N-460 | —H | 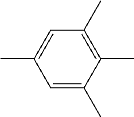 | —H | 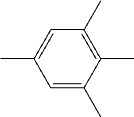 | —CH3 | —H | —O— | 1 | 1 | —H | —CH3 | (SB) | 1 | 1 | — | — | — | 0 | 0 |
| N-461 | —H | | —H | | —CH3 | —H | —O— | 1 | 2 | —H | —CH3 | (SB) | 1 | 1 | — | — | — | 0 | 0 |
| N-462 | —H | | —H | | —CH3 | —H | —O— | 1 | 3 | —H | —CH3 | (SB) | 1 | 1 | — | — | — | 0 | 0 |
| N-463 | —H | | —H | | —CH3 | —H | —O— | 1 | 4 | —H | —CH3 | (SB) | 1 | 1 | — | — | — | 0 | 0 |
| N-464 | —H | | —H | | —CH3 | —H | —O— | 1 | 5 | —H | —CH3 | (SB) | 1 | 1 | — | — | — | 0 | 0 |
| N-465 | —H | | —H | | —CH3 | —H | —O— | 1 | 6 | —H | —CH3 | (SB) | 1 | 1 | — | — | — | 0 | 0 |
| N-466 | —H | | —H | | —CH3 | —H | —O— | 1 | 7 | —H | —CH3 | (SB) | 1 | 1 | — | — | — | 0 | 0 |
| N-467 | —H | | —H | | —CH3 | —H | —O— | 1 | 30 | —H | —CH3 | (SB) | 1 | 1 | — | — | — | 0 | 0 |
| N-468 | —H | | —H | | —CH3 | —H | —O— | 1 | 32 | —H | —CH3 | (SB) | 1 | 1 | — | — | — | 0 | 0 |
| N-469 | —H | | —H | | —CH3 | —H | —O— | 1 | 33 | —H | —CH3 | (SB) | 1 | 1 | — | — | — | 0 | 0 |
| N-470 | —H | —CF3 | —H | —CF3 | —CH3 | —H | —O— | 1 | 1 | —H | —CH3 | (SB) | 1 | 1 | — | — | — | 0 | 0 |
| N-471 | —H | —CF3 | —H | —CF3 | —CH3 | —H | —O— | 1 | 2 | —H | —CH3 | (SB) | 1 | 1 | — | — | — | 0 | 0 |
| N-472 | —H | —CF3 | —H | —CF3 | —CH3 | —H | —O— | 1 | 3 | —H | —CH3 | (SB) | 1 | 1 | — | — | — | 0 | 0 |
| N-473 | —H | —CF3 | —H | —CF3 | —CH3 | —H | —O— | 1 | 4 | —H | —CH3 | (SB) | 1 | 1 | — | — | — | 0 | 0 |
| N-474 | —H | —CF3 | —H | —CF3 | —CH3 | —H | —O— | 1 | 5 | —H | —CH3 | (SB) | 1 | 1 | — | — | — | 0 | 0 |
| N-475 | —H | —CF3 | —H | —CF3 | —CH3 | —H | —O— | 1 | 6 | —H | —CH3 | (SB) | 1 | 1 | — | — | — | 0 | 0 |
| N-476 | —H | —CF3 | —H | —CF3 | —CH3 | —H | —O— | 1 | 7 | —H | —CH3 | (SB) | 1 | 1 | — | — | — | 0 | 0 |
| N-477 | —H | —CF3 | —H | —CF3 | —CH3 | —H | —O— | 1 | 30 | —H | —CH3 | (SB) | 1 | 1 | — | — | — | 0 | 0 |
| N-478 | —H | —CF3 | —H | —CF3 | —CH3 | —H | —O— | 1 | 32 | —H | —CH3 | (SB) | 1 | 1 | — | — | — | 0 | 0 |
| N-479 | —H | —CF3 | —H | —CF3 | —CH3 | —H | —O— | 1 | 33 | —H | —CH3 | (SB) | 1 | 1 | — | — | — | 0 | 0 |
| N-480 | —H | [symbol] | —H | [symbol] | —CH3 | —H | —O— | 1 | 1 | —H | —CH3 | (SB) | 1 | 1 | — | — | — | 0 | 0 |
| N·481 | —H | [symbol] | —H | [symbol] | —CH3 | —H | —O— | 1 | 2 | —H | —CH3 | (SB) | 1 | 1 | — | — | — | 0 | 0 |
| N-482 | —H | [symbol] | —H | [symbol] | —CH3 | —H | —O— | 1 | 3 | —H | —CH3 | (SB) | 1 | 1 | — | — | — | 0 | 0 |
| N-483 | —H | [symbol] | —H | [symbol] | —CH3 | —H | —O— | 1 | 4 | —H | —CH3 | (SB) | 1 | 1 | — | — | — | 0 | 0 |
| N-484 | —H | [symbol] | —H | [symbol] | —CH3 | —H | —O— | 1 | 5 | —H | —CH3 | (SB) | 1 | 1 | — | — | — | 0 | 0 |
| N-485 | —H | [symbol] | —H | [symbol] | —CH3 | —H | —O— | 1 | 6 | —H | —CH3 | (SB) | 1 | 1 | — | — | — | 0 | 0 |
| N-486 | —H | [symbol] | —H | [symbol] | —CH3 | —H | —O— | 1 | 7 | —H | —CH3 | (SB) | 1 | 1 | — | — | — | 0 | 0 |
| N-487 | —H | [symbol] | —H | [symbol] | —CH3 | —H | —O— | 1 | 30 | —H | —CH3 | (SB) | 1 | 1 | — | — | — | 0 | 0 |
| N-488 | —H | [symbol] | —H | [symbol] | —CH3 | —H | —O— | 1 | 32 | —H | —CH3 | (SB) | 1 | 1 | — | — | — | 0 | 0 |
| N-489 | —H | [symbol] | —H | [symbol] | —CH3 | —H | —O— | 1 | 33 | —H | —CH3 | (SB) | 1 | 1 | — | — | — | 0 | 0 |
| N-490 | —H | [symbol] | —H | [symbol] | —CH3 | —H | —O— | 1 | 1 | —H | —CH3 | (SB) | 1 | 1 | — | — | — | 0 | 0 |
| N-491 | —H | [symbol] | —H | [symbol] | —CH3 | —H | —O— | 1 | 2 | —H | —CH3 | (SB) | 1 | 1 | — | — | — | 0 | 0 |
| N-492 | —H | [symbol] | —H | [symbol] | —CH3 | —H | —O— | 1 | 3 | —H | —CH3 | (SB) | 1 | 1 | — | — | — | 0 | 0 |
| N-493 | —H | [symbol] | —H | [symbol] | —CH3 | —H | —O— | 1 | 4 | —H | —CH3 | (SB) | 1 | 1 | — | — | — | 0 | 0 |
| N-494 | —H | [symbol] | —H | [symbol] | —CH3 | —H | —O— | 1 | 5 | —H | —CH3 | (SB) | 1 | 1 | — | — | — | 0 | 0 |
| N-495 | —H | [symbol] | —H | [symbol] | —CH3 | —H | —O— | 1 | 6 | —H | —CH3 | (SB) | 1 | 1 | — | — | — | 0 | 0 |
| N-496 | —H | [symbol] | —H | [symbol] | —CH3 | —H | —O— | 1 | 7 | —H | —CH3 | (SB) | 1 | 1 | — | — | — | 0 | 0 |
| N-497 | —H | [symbol] | —H | [symbol] | —CH3 | —H | —O— | 1 | 30 | —H | —CH3 | (SB) | 1 | 1 | — | — | — | 0 | 0 |
| N-498 | —H | [symbol] | —H | [symbol] | —CH3 | —H | —O— | 1 | 32 | —H | —CH3 | (SB) | 1 | 1 | — | — | — | 0 | 0 |
| N-499 | —H | [symbol] | —H | [symbol] | —CH3 | —H | —O— | 1 | 33 | —H | —CH3 | (SB) | 1 | 1 | — | — | — | 0 | 0 |

[symbol]

indicates data missing or illegible when filed

TABLE 22

| | | | | | α | | | | | β |
|---|---|---|---|---|---|---|---|---|---|---|
| | R21 | R22 | R23 | R24 | R60 | R61 | Za | la | ma | R70 |
| N-500 | —H | —SH | —H | —SH | —CH3 | —H | —O— | 1 | 1 | —H |
| N-501 | —H | —SH | —H | —SH | —CH3 | —H | —O— | 1 | 2 | —H |
| N-502 | —H | —SH | —H | —SH | —CH3 | —H | —O— | 1 | 3 | —H |
| N-503 | —H | —SH | —H | —SH | —CH3 | —H | —O— | 1 | 4 | —H |
| N-504 | —H | —SH | —H | —SH | —CH3 | —H | —O— | 1 | 5 | —H |
| N-505 | —H | —SH | —H | —SH | —CH3 | —H | —O— | 1 | 6 | —H |
| N-506 | —H | —SH | —H | —SH | —CH3 | —H | —O— | 1 | 7 | —H |
| N-507 | —H | —SH | —H | —SH | —CH3 | —H | —O— | 1 | 30 | —H |
| N-508 | —H | —SH | —H | —SH | —CH3 | —H | —O— | 1 | 32 | —H |
| N-509 | —H | —SH | —H | —SH | —CH3 | —H | —O— | 1 | 33 | —H |
| N-510 | —H | —SCH3 | —H | —SCH3 | —CH3 | —H | —O— | 1 | 1 | —H |
| N-511 | —H | —SCH3 | —H | —SCH3 | —CH3 | —H | —O— | 1 | 2 | —H |
| N-512 | —H | —SCH3 | —H | —SCH3 | —CH3 | —H | —O— | 1 | 3 | —H |
| N-513 | —H | —SCH3 | —H | —SCH3 | —CH3 | —H | —O— | 1 | 4 | —H |
| N-514 | —H | —SCH3 | —H | —SCH3 | —CH3 | —H | —O— | 1 | 5 | —H |
| N-515 | —H | —SCH3 | —H | —SCH3 | —CH3 | —H | —O— | 1 | 6 | —H |
| N-516 | —H | —SCH3 | —H | —SCH3 | —CH3 | —H | —O— | 1 | 7 | —H |
| N-517 | —H | —SCH3 | —H | —SCH3 | —CH3 | —H | —O— | 1 | 30 | —H |
| N-518 | —H | —SCH3 | —H | —SCH3 | —CH3 | —H | —O— | 1 | 32 | —H |
| N-519 | —H | —SCH3 | —H | —SCH3 | —CH3 | —H | —O— | 1 | 33 | —H |
| N-520 | —H | —SC6H5 | —H | —SC6H5 | —CH3 | —H | —O— | 1 | 1 | —H |
| N-521 | —H | —SC6H5 | —H | —SC6H5 | —CH3 | —H | —O— | 1 | 2 | —H |
| N-522 | —H | —SC6H5 | —H | —SC6H5 | —CH3 | —H | —O— | 1 | 3 | —H |
| N-523 | —H | —SC6H5 | —H | —SC6H5 | —CH3 | —H | —O— | 1 | 4 | —H |
| N-524 | —H | —SC6H5 | —H | —SC6H5 | —CH3 | —H | —O— | 1 | 5 | —H |
| N-525 | —H | —SC6H5 | —H | —SC6H5 | —CH3 | —H | —O— | 1 | 6 | —H |
| N-526 | —H | —SC6H5 | —H | —SC6H5 | —CH3 | —H | —O— | 1 | 7 | —H |
| N-527 | —H | —SC6H5 | —H | —SC6H5 | —CH3 | —H | —O— | 1 | 30 | —H |
| N-528 | —H | —SC6H5 | —H | —SC6H5 | —CH3 | —H | —O— | 1 | 32 | —H |
| N-529 | —H | —SC6H5 | —H | —SC6H5 | —CH3 | —H | —O— | 1 | 33 | —H |
| N-530 | —H | —S(n-C3H7) | —H | —S(n-C3H7) | —CH3 | —H | —O— | 1 | 1 | —H |
| N-531 | —H | —S(n-C3H7) | —H | —S(n-C3H7) | —CH3 | —H | —O— | 1 | 2 | —H |
| N-532 | —H | —S(n-C3H7) | —H | —S(n-C3H7) | —CH3 | —H | —O— | 1 | 3 | —H |
| N-533 | —H | —S(n-C3H7) | —H | —S(n-C3H7) | —CH3 | —H | —O— | 1 | 4 | —H |
| N-534 | —H | —S(n-C3H7) | —H | —S(n-C3H7) | —CH3 | —H | —O— | 1 | 5 | —H |
| N-535 | —H | —S(n-C3H7) | —H | —S(n-C3H7) | —CH3 | —H | —O— | 1 | 6 | —H |
| N-536 | —H | —S(n-C3H7) | —H | —S(n-C3H7) | —CH3 | —H | —O— | 1 | 7 | —H |
| N-537 | —H | —S(n-C3H7) | —H | —S(n-C3H7) | —CH3 | —H | —O— | 1 | 30 | —H |
| N-538 | —H | —S(n-C3H7) | —H | —S(n-C3H7) | —CH3 | —H | —O— | 1 | 32 | —H |
| N-539 | —H | —S(n-C3H7) | —H | —S(n-C3H7) | —CH3 | —H | —O— | 1 | 33 | —H |
| N-540 | —H | —H | —H | —H | —H | —H | —O— | 1 | 1 | —H |
| N-541 | —H | —H | —H | —H | —H | —H | —O— | 1 | 2 | —H |
| N-542 | —H | —H | —H | —H | —H | —H | —O— | 1 | 3 | —H |
| N-543 | —H | —H | —H | —H | —H | —H | —O— | 1 | 4 | —H |
| N-544 | —H | —H | —H | —H | —H | —H | —O— | 1 | 5 | —H |
| N-545 | —H | —H | —H | —H | —H | —H | —O— | 1 | 6 | —H |
| N-546 | —H | —H | —H | —H | —H | —H | —O— | 1 | 7 | —H |
| N-547 | —H | —H | —H | —H | —H | —H | —O— | 1 | 30 | —H |
| N-548 | —H | —H | —H | —H | —H | —H | —O— | 1 | 32 | —H |
| N-549 | —H | —H | —H | —H | —H | —H | —O— | 1 | 33 | —H |

| | β | | | | γ | | | | |
|---|---|---|---|---|---|---|---|---|---|
| | R71 | Zb | lb | mb | R80 | R81 | Zc | lc | mc |
| N-500 | —CH3 | (SB) | 1 | 1 | — | — | — | 0 | 0 |
| N-501 | —CH3 | (SB) | 1 | 1 | — | — | — | 0 | 0 |
| N-502 | —CH3 | (SB) | 1 | 1 | — | — | — | 0 | 0 |
| N-503 | —CH3 | (SB) | 1 | 1 | — | — | — | 0 | 0 |
| N-504 | —CH3 | (SB) | 1 | 1 | — | — | — | 0 | 0 |
| N-505 | —CH3 | (SB) | 1 | 1 | — | — | — | 0 | 0 |
| N-506 | —CH3 | (SB) | 1 | 1 | — | — | — | 0 | 0 |
| N-507 | —CH3 | (SB) | 1 | 1 | — | — | — | 0 | 0 |
| N-508 | —CH3 | (SB) | 1 | 1 | — | — | — | 0 | 0 |
| N-509 | —CH3 | (SB) | 1 | 1 | — | — | — | 0 | 0 |
| N-510 | —CH3 | (SB) | 1 | 1 | — | — | — | 0 | 0 |
| N-511 | —CH3 | (SB) | 1 | 1 | — | — | — | 0 | 0 |
| N-512 | —CH3 | (SB) | 1 | 1 | — | — | — | 0 | 0 |
| N-513 | —CH3 | (SB) | 1 | 1 | — | — | — | 0 | 0 |
| N-514 | —CH3 | (SB) | 1 | 1 | — | — | — | 0 | 0 |
| N-515 | —CH3 | (SB) | 1 | 1 | — | — | — | 0 | 0 |
| N-516 | —CH3 | (SB) | 1 | 1 | — | — | — | 0 | 0 |
| N-517 | —CH3 | (SB) | 1 | 1 | — | — | — | 0 | 0 |
| N-518 | —CH3 | (SB) | 1 | 1 | — | — | — | 0 | 0 |
| N-519 | —CH3 | (SB) | 1 | 1 | — | — | — | 0 | 0 |
| N-520 | —CH3 | (SB) | 1 | 1 | — | — | — | 0 | 0 |
| N-521 | —CH3 | (SB) | 1 | 1 | — | — | — | 0 | 0 |
| N-522 | —CH3 | (SB) | 1 | 1 | — | — | — | 0 | 0 |
| N-523 | —CH3 | (SB) | 1 | 1 | — | — | — | 0 | 0 |
| N-524 | —CH3 | (SB) | 1 | 1 | — | — | — | 0 | 0 |
| N-525 | —CH3 | (SB) | 1 | 1 | — | — | — | 0 | 0 |
| N-526 | —CH3 | (SB) | 1 | 1 | — | — | — | 0 | 0 |
| N-527 | —CH3 | (SB) | 1 | 1 | — | — | — | 0 | 0 |
| N-528 | —CH3 | (SB) | 1 | 1 | — | — | — | 0 | 0 |
| N-529 | —CH3 | (SB) | 1 | 1 | — | — | — | 0 | 0 |
| N-530 | —CH3 | (SB) | 1 | 1 | — | — | — | 0 | 0 |
| N-531 | —CH3 | (SB) | 1 | 1 | — | — | — | 0 | 0 |
| N-532 | —CH3 | (SB) | 1 | 1 | — | — | — | 0 | 0 |
| N-533 | —CH3 | (SB) | 1 | 1 | — | — | — | 0 | 0 |
| N-534 | —CH3 | (SB) | 1 | 1 | — | — | — | 0 | 0 |
| N-535 | —CH3 | (SB) | 1 | 1 | — | — | — | 0 | 0 |
| N-536 | —CH3 | (SB) | 1 | 1 | — | — | — | 0 | 0 |
| N-537 | —CH3 | (SB) | 1 | 1 | — | — | — | 0 | 0 |
| N-538 | —CH3 | (SB) | 1 | 1 | — | — | — | 0 | 0 |
| N-539 | —CH3 | (SB) | 1 | 1 | — | — | — | 0 | 0 |
| N-540 | —CH3 | (SB) | 1 | 1 | — | — | — | 0 | 0 |
| N-541 | —CH3 | (SB) | 1 | 1 | — | — | — | 0 | 0 |
| N-542 | —CH3 | (SB) | 1 | 1 | — | — | — | 0 | 0 |
| N-543 | —CH3 | (SB) | 1 | 1 | — | — | — | 0 | 0 |
| N-544 | —CH3 | (SB) | 1 | 1 | — | — | — | 0 | 0 |
| N-545 | —CH3 | (SB) | 1 | 1 | — | — | — | 0 | 0 |
| N-546 | —CH3 | (SB) | 1 | 1 | — | — | — | 0 | 0 |
| N-547 | —CH3 | (SB) | 1 | 1 | — | — | — | 0 | 0 |
| N-548 | —CH3 | (SB) | 1 | 1 | — | — | — | 0 | 0 |
| N-549 | —CH3 | (SB) | 1 | 1 | — | — | — | 0 | 0 |

The weight-average molecular weight of the at least one kind of polymer selected from the group consisting of: the polymer having the structural unit represented by the formula (1); and the polymer having the structural unit represented by the formula (2) is preferably 30,000 or less.

In the present invention, the content of the at least one kind of polymer selected from the group consisting of: the polymer having the structural unit represented by the formula (1); and the polymer having the structural unit represented by the formula (2) with respect to the total mass of the undercoat layer is preferably 30 mass % or more, and is more preferably 50 mass % or more from the viewpoint of improving the electron mobility in the undercoat layer.

The thickness of the undercoat layer is preferably 0.1 to 10 μm, more preferably 0.5 to 5 μm.

The undercoat layer controls charge injection at an interface, and functions as an adhesion layer. The undercoat layer in the present invention has a function of transporting charge having the same polarity as the charging polarity of the surface of the electrophotographic photosensitive member. Specifically, the charging polarity of the electrophotographic photosensitive member is negative polarity, and hence the undercoat layer has a negative charge transporting ability, that is, an electron transporting ability. The electron mobility of the layer is preferably 10⁻⁷ cm²/V·sec or more, more preferably 10⁻⁶ cm²/V·sec or more. In addition, to retain the surface potential of the electrophotographic photosensitive member, the volume resistivity of the undercoat layer is preferably 1×10¹⁰Ω·cm or more, more preferably 1×10¹²Ω·cm or more.

A coating liquid for forming the undercoat layer according to the present invention may contain a crosslinking agent in addition to the electron transporting substance.

Any known material may be used as the crosslinking agent. Specific examples thereof include compounds described in “Crosslinking Agent Handbook” edited by Shinzo Yamashita and Tosuke Kaneko and published by Taiseisha Ltd. (1981).

In the present invention, the crosslinking agent is preferably an isocyanate compound having an isocyanate group or a blocked isocyanate group, or an amine compound having an N-methylol group or an alkyl-etherified N-methylol group. Of those, an isocyanate compound having 2 to 6 isocyanate groups or blocked isocyanate groups is preferred.

Examples of the isocyanate compound serving as the crosslinking agent include isocyanate compounds described below, but the present invention is not limited thereto. In addition, the isocyanate compounds described below may be used in combination.

Examples of the isocyanate compound include triisocyanatobenzene, triisocyanatomethylbenzene, triphenylmethane triisocyanate, lysine triisocyanate, diisocyanates, such as tolylene diisocyanate, hexamethylene diisocyanate, dicyclohexylmethane diisocyanate, naphthalene diisocyanate, diphenylmethane diisocyanate, isophorone diisocyanate, xylylene diisocyanate, 2,2,4-trimethylhexamethylene diisocyanate, methyl-2,6-diisocyanate hexanoate, and norbornane diisocyanate, isocyanurate modified forms, biuret modified forms, and allophanate modified forms thereof, and adduct modified forms thereof with trimethylolpropane or pentaerythritol. The blocked isocyanate group is a group having a structure represented by —NHCOX¹ (X¹ represents a protective group). X¹ represents any protective group capable of being introduced into an isocyanate group.

Examples of a commercially available isocyanate compound include isocyanate-based crosslinking agents, such as DURANATE MFK-60B, SBA-70B, 17B-60P, SBN-70D, or SBB-70P manufactured by Asahi Kasei Corporation, and Desmodur BL3175 or BL3475 manufactured by Sumika Bayer Urethane Co., Ltd.

The amine compound serving as the crosslinking agent preferably has an N-methylol group or an alkyl-etherified N-methylol group. In addition, an amine compound having a plurality of (two or more)N-methylol groups or alkyl-etherified N-methylol groups is more preferred. Examples of the amine compound include methylolated melamine, a methylolated guanamine, a methylolated urea derivative, a methylolated ethyleneurea derivative, methylolated glycoluril, and a compound having an alkyl-etherified methylol moiety, and derivatives thereof.

Examples of a commercially available amine compound (crosslinking agent), include SUPER MELAMI No. 90 (manufactured by NOF Corporation (former Nippon Oil & Fats Co., Ltd.)), SUPER BECKAMINE (trademark) TD-139-60, L-105-60, L127-60, L110-60, J-820-60, and G-821-60 (manufactured by DIC Corporation), U-VAN 2020 (Mitsui Chemicals, Inc.), Sumitex Resin M-3 (manufactured by Sumitomo Chemical Co., Ltd. (former Sumitomo Chemical Industry Co., Ltd.)), NIKALAC MW-30, MW-390, and MX-750 LM (manufactured by Sanwa Chemical Co., Ltd.), SUPER BECKAMINE (trademark) L-148-55, 13-535, L-145-60, and TD-126 (manufactured by DIC Corporation), NIKALAC BL-60 and BX-4000 (manufactured by Sanwa Chemical Co., Ltd.), and NIKALAC MX-280, NIKALAC MX-270, and NIKALAC MX-290 (manufactured by Sanwa Chemical Co., Ltd.).

The coating liquid for forming the undercoat layer according to the present invention may contain a thermoplastic resin having a polymerizable functional group in addition to the electron transporting substance and the crosslinking agent. Examples of the thermoplastic resin include a polyacetal resin, a polyolefin resin, a polyester resin, a polyether resin, and a polyamide resin. In addition, examples of the polymerizable functional group of the thermoplastic resin include a hydroxyl group, a thiol group, an amino group, and a methoxy group.

Further, the thermoplastic resin is preferably a thermoplastic resin having a repeating unit formed of —(CH₂—CH₂—O)n—(“n” represents an integer of 2 to 200), —(CH₂—CH₃CH—O)n—(“n” represents an integer of 2 to 200), or —(CH₂—CH₂—O—CH₂—CH₂—S—S)n—(“n” represents an integer of 2 to 50).

As a product that is commercially available as the thermoplastic resin having a polymerizable functional group, there are given, for example: polyether polyol-based resins, such as AQD-457 and AQD-473 (all of which are manufactured by Nippon Polyurethane Industry Co., Ltd.), and SANNIX GP-400 and GP-700 (all of which are manufactured by Sanyo Chemical Industries, Ltd.); polyester polyol-based resins, such as Phthalkid W2343 (manufactured by Hitachi Chemical Company, Ltd.), WATERSOL S-118 and CD-520, and BECKOLITE M-6402-50 and M-6201-40IM (all of which are manufactured by DIC Corporation), HARIDIP WH-1188 (manufactured by Harima Chemicals, Inc.), and ES3604 and ES6538 (all of which are manufactured by Japan U-pica Co., Ltd.); polyacrylic polyol-based resins, such as BURNOCK WE-300 and WE-304 (all of which are manufactured by DIC Corporation); polyvinyl alcohol-based resins such as Kuraray Poval PVA-203 (manufactured by Kuraray Co., Ltd.); polyvinyl acetal-based resins, such as BX-1, BM-1, and KS-5 (all of which are manufactured by Sekisui Chemical Co., Ltd.); polyamide-based resins such as Toresin FS-350 (manufactured by Nagase ChemteX Corporation); polyamine resins such as LUCKAMIDE (manufactured by DIC Corporation); and polythiol resins such as QE-340M (manufactured by Toray Industries, Inc.). Of those, a polyvinyl acetal-based resin having a polymerizable functional group and a polyester polyol-based resin having a polymerizable functional group are preferred from the viewpoint of polymerizability.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Photosensitive Layer>

The photosensitive layer of the electrophotographic photosensitive member is mainly classified into (1) a laminate type photosensitive layer and (2) a monolayer type photosensitive layer. (1) The laminate type photosensitive layer includes a charge generating layer containing a charge generating substance and a charge transporting layer containing a charge transporting substance. (2) The monolayer type photosensitive layer includes a photosensitive layer containing both of the charge generating substance and the charge transporting substance.

### (1) Laminate Type Photosensitive Layer

The laminate type photosensitive layer includes the charge generating layer and the charge transporting layer.

### (1-1) Charge Generating Layer

The charge generating layer preferably contains the charge generating substance and a resin.

Examples of the charge generating substance include an azo pigment, a perylene pigment, a polycyclic quinone pigment, an indigo pigment, and a phthalocyanine pigment. Of those, an azo pigment and a phthalocyanine pigment are preferred. Of the phthalocyanine pigments, an oxytitanium phthalocyanine pigment, a chlorogallium phthalocyanine pigment, and a hydroxygallium phthalocyanine pigment are preferred.

The content of the charge generating substance in the charge generating layer is preferably 40 to 85 mass %, more preferably 60 to 80 mass % with respect to the total mass of the charge generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge generating layer may further contain an additive, such as an antioxidant or a UV absorber. Specific examples thereof include a hindered phenol compound, a hindered amine compound, a sulfur compound, a phosphorus compound, and a benzophenone compound.

The thickness of the charge generating layer is preferably 0.1 to 1 μm, more preferably 0.15 to 0.4 μm.

The charge generating layer may be formed by: preparing a coating liquid for a charge generating layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

### (1-2) Charge Transporting Layer

The charge transporting layer preferably contains the charge transporting substance and a resin.

Examples of the charge transporting substance include a polycyclic aromatic compound, a heterocyclic compound, a hydrazone compound, a styryl compound, an enamine compound, a benzidine compound, a triarylamine compound, and a resin having a group derived from any of those substances. Of those, a triarylamine compound and a benzidine compound are preferred.

The content of the charge transporting substance in the charge transporting layer is preferably from 25 to 70 mass %, more preferably from 30 to 55 mass % with respect to the total mass of the charge transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge transporting substance and the resin is preferably from 4:10 to 20:10, more preferably from 5:10 to 12:10.

In addition, the charge transporting layer may contain an additive, such as an antioxidant, a UV absorber, a plasticizer, a leveling agent, a slipperiness imparting agent, or a wear resistance improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The thickness of the charge transporting layer is preferably 5 to 50 μm, more preferably 8 to 40 μm, particularly preferably 10 to 30 μm.

The charge transporting layer may be formed by: preparing a coating liquid for a charge transporting layer containing the above-mentioned respective materials and a solvent; forming a coating film of the coating liquid; and drying the coating film. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### (2) Monolayer Type Photosensitive Layer

The monolayer type photosensitive layer may be formed by: preparing a coating liquid for a photosensitive layer containing the charge generating substance, the charge transporting substance, a resin, and a solvent; forming a coating film of the coating liquid; and drying the coating film. The charge generating substance, the charge transporting substance, and the resin are the same as the examples of the materials in the above-mentioned section “(1) Laminate Type Photosensitive Layer.”

### <Protection Layer>

In the present invention, a protection layer may be arranged on the photosensitive layer. The arrangement of the protection layer can improve durability.

The protection layer preferably contains electroconductive particles and/or a charge transporting substance, and a resin.

Examples of the electroconductive particles include particles of metal oxides, such as titanium oxide, zinc oxide, tin oxide, and indium oxide.

Examples of the charge transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protection layer may be formed as a cured film by polymerizing a composition containing a monomer having a polymerizable functional group. As a reaction in this case, there are given, for example, a thermal polymerization reaction, a photopolymerization reaction, and a radiation polymerization reaction. Examples of the polymerizable functional group of the monomer having a polymerizable functional group include an acryl group and a methacryl group. A material having a charge transporting ability may be used as the monomer having a polymerizable functional group.

The protection layer may contain an additive, such as an antioxidant, a UV absorber, a plasticizer, a leveling agent, a slipperiness imparting agent, or a wear resistance improving agent. Specific examples of the additive include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The protection layer has a thickness of preferably from 0.5 to 10 μm, more preferably from 1 to 7 μm.

The protection layer may be formed by: preparing a coating liquid for a protection layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, a sulfoxide-based solvent, an ester-based solvent, and an aromatic hydrocarbon-based solvent.

### [Process Cartridge and Electrophotographic Apparatus]

A process cartridge according to the present invention is characterized in that the process cartridge integrally supports the electrophotographic photosensitive member described above and at least one unit selected from the group consisting of: a charging unit; a developing unit; and a cleaning unit, and is detachably attachable to the main body of an electrophotographic apparatus.

In addition, an electrophotographic apparatus according to the present invention is characterized by including the electrophotographic photosensitive member described above, a charging unit, an exposing unit, a developing unit, and a transfer unit.

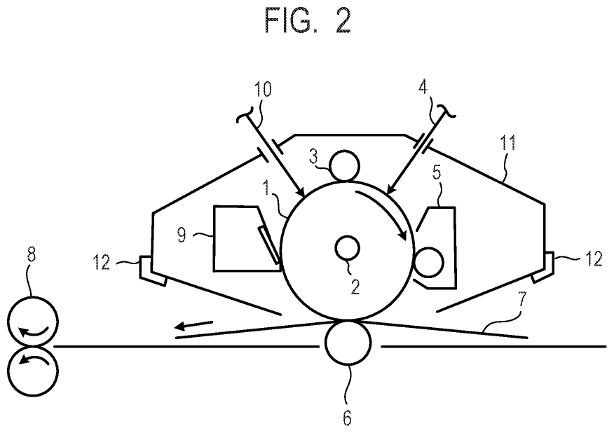

An example of the schematic configuration of an electrophotographic apparatus including a process cartridge including an electrophotographic photosensitive member is illustrated in FIG. 2.

An electrophotographic photosensitive member 1 having a cylindrical shape is rotationally driven about a shaft 2 in a direction indicated by the arrow at a predetermined peripheral speed. The surface of the electrophotographic photosensitive member 1 is charged to a predetermined positive or negative potential by a charging unit 3.

Although a roller charging system based on a roller-type charging member is illustrated in the figure, a charging system, such as a corona charging system, a contact charging system, or an injection charging system, may be adopted.

The charged surface of the electrophotographic photosensitive member 1 is irradiated with exposure light 4 from an exposing unit (not shown), and hence an electrostatic latent image corresponding to target image information is formed thereon. The electrostatic latent image formed on the surface of the electrophotographic photosensitive member 1 is developed with a toner stored in a developing unit 5, and a toner image is formed on the surface of the electrophotographic photosensitive member 1. The toner image formed on the surface of the electrophotographic photosensitive member 1 is transferred onto a transfer material 7 by a transfer unit 6. The transfer material 7 onto which the toner image has been transferred is conveyed to a fixing unit 8, is subjected to treatment for fixing the toner image, and is printed out to the outside of the electrophotographic apparatus.

The electrophotographic apparatus may include a cleaning unit 9 for removing a deposit such as the toner remaining on the surface of the electrophotographic photosensitive member 1 after the transfer. In addition, a so-called cleaner-less system in which the deposit is removed with the developing unit 5 or the like without separate arrangement of the cleaning unit 9 may be used.

The electrophotographic apparatus may include an electricity-removing mechanism for subjecting the surface of the electrophotographic photosensitive member 1 to electricity-removing treatment with pre-exposure light 10 from a pre-exposing unit (not shown). In addition, a guiding unit 12 such as a rail may be arranged for detachably attaching a process cartridge 11 according to the present invention onto the main body of the electrophotographic apparatus.

The electrophotographic photosensitive member according to the present invention can be used in, for example, a laser beam printer, an LED printer, a copying machine, a facsimile, and a multifunctional peripheral thereof.

According to the present invention, there can be provided the electrophotographic photosensitive member that can suppress a potential fluctuation.

### EXAMPLES

The present invention is described in more detail below by way of Examples and Comparative Examples. The present invention is by no means limited to the following Examples as long as its modifications do not deviate from the gist of the present invention. In the following description of Examples, the term “part(s)” is on a mass basis unless otherwise stated.

First, synthesis examples of a polymer (electron transporting substance) having a structural unit represented by the formula (1) and a polymer (electron transporting substance) having a structural unit represented by the formula (2) are described.

### Synthesis Example of Polymer having Structural Unit represented by Formula (1) (Compound Example: P-3)

The following materials were prepared.

| | | |
|---|---|---|
| N-Methylpyrrolidone | 50 | parts |
| 3,4,9,10-Perylenetetracarboxylic dianhydride (manufactured | 1.96 | parts |
| by Tokyo Chemical Industry Co., Ltd.) | | |
| Poly(propylene glycol) bis(2-aminopropyl ether) (Mn: 230, | 1.38 | parts |
| manufactured by Sigma-Aldrich) | | |

Those materials were mixed, and the mixture was heated to 180° C. while being stirred. The mixture was subjected to a reaction for 48 hours, and was then cooled. Subsequently, the mixture was poured into 50 ml of water, and a precipitate was separated by filtration. The resultant precipitate was washed with hot water, and was then dried to provide 3.0 parts of a polymer (P-3) having a structural unit represented by the formula (1). The resultant compound was identified by NMR. At the time of the identification, peak positions were measured by ¹H-NMR (400 MHZ, JMN-EX400, manufactured by JEOL Ltd.) through use of CDCl₃ as a solvent. As a result, a target product having the following peak positions was identified.
δ 8.6-7.8 ppm (broad m, perylene moiety)
δ 4.3-4.1 ppm (broad m, alkyl moiety linked to imide nitrogen)
δ 4.0-3.2 ppm (broad m, ether moiety)
δ 1.60-1.11 ppm (broad s, methyl group)

The weight-average molecular weight of the resultant polymer is shown in Table 23. The weight-average molecular weight (Mw) was measured by gel permeation chromatography (GPC), and a value in terms of polystyrene measured with HLC-8220 manufactured by Tosoh Corporation was adopted.

### Synthesis Example of Polymer (Compound Example: N-3) Having Structural Unit Represented by Formula (2)

The following materials were prepared.

| | | |
|---|---|---|
| N,N-Dimethylacetamide | 50 | parts |
| 1,4,5,8-Naphthalenetetracarboxylic dianhydride | 1.34 | parts |
| (manufactured by Tokyo Chemical Industry Co., Ltd.) | | |
| Poly(propylene glycol) bis(2-aminopropyl ether) (Mn: 230, | 1.38 | parts |
| manufactured by Sigma-Aldrich) | | |

Those materials were mixed, and the mixture was heated to 100° C. while being stirred. The mixture was subjected to a reaction for 24 hours, and was then cooled. Subsequently, the mixture was poured into 50 ml of water, and a precipitate was separated by filtration. The resultant precipitate was washed with hot water, and was then dried to provide 3.0 parts of a polymer (N-3) having a naphthalene diimide structural unit represented by the formula (2). The resultant compound was identified by NMR. At the time of the identification, peak positions were measured by 1H-NMR (400 MHZ, JMN-EX400, manufactured by JEOL Ltd.) through use of CDCl₃ as a solvent. As a result, a target product having the following peak positions was identified.
δ 8.72 ppm (s, naphthalene moiety)
δ 5.44 ppm (m, proton on imide nitrogen-adjacent carbon)
δ 4.17 ppm (broad m, ether moiety)
δ 2.02 ppm (broad m, alkyl moiety)
δ 1.52-1.10 ppm (broad s, methyl group)

The weight-average molecular weight of the resultant polymer is shown in Table 32. The weight-average molecular weight (Mw) was measured by gel permeation chromatography (GPC), and a value in terms of polystyrene measured with HLC-8220 manufactured by Tosoh Corporation was adopted.

Synthesis examples of electron transporting substances used in Comparative Examples are described.

### Synthesis Example of Electron Transporting Substance (D01)

The following materials were prepared.

| 3,4,9,10-Perylenetetracarboxylic dianhydride (manufactured | 1.96 | parts |
|---|---|---|
| by Tokyo Chemical Industry Co., Ltd.) | | |
| DL-2-Amino-1-butanol (manufactured by Tokyo Chemical | 0.89 | part |

Industry Co., Ltd.)

Under a nitrogen atmosphere, those materials were mixed in 100 parts of dimethylacetamide, and the mixture was stirred at room temperature for 1 hour to prepare a suspension. Subsequently, the resultant suspension was refluxed for 8 hours, and a precipitate was separated by filtration, followed by recrystallization with ethyl acetate. Thus, 2.67 parts of an electron transporting substance (D01) was obtained.

The resultant compound was identified by NMR. At the time of the identification, peak positions were measured by 1H-NMR (400 MHZ, JMN-EX400, manufactured by JEOL Ltd.) through use of CDCl₃ as a solvent. As a result, a target product having the following peak positions was identified.
δ 9.0 ppm (s, hydroxy group)
δ 8.64 ppm (dd, perylene moiety)
δ 5.03 ppm (m, proton on imide nitrogen-adjacent carbon)
δ 4.08-3.78 ppm (m, ether moiety)
δ 1.90-1.70 ppm (m, methylene group)
δ 0.95 ppm (dd, methyl group)

### Synthesis Example of Electron Transporting Substance (D06)

4.65 Parts of 2,2′-dihydroxybiphenyl was dissolved in 1,000 parts of chloroform, and 50 parts of Fetizon's reagent (silver carbonate supported on Celite) was added to the solution. After that, the mixture was continuously heated to reflux for 40 hours. After the heating, the temperature of the reaction liquid was returned to room temperature, and Fetizon's reagent was filtered out. The solvent of the filtrate was removed, and the residue was subjected to dispersion washing with 500 parts of methanol. The dispersion washing was repeated three times to provide a dark brown solid. The solid was obtained in a yield of 0.85 part, and had a weight-average molecular weight (Mw) measured by GPC of 5,300.

### Synthesis Example of Electron Transporting Substance (D07)

Under a nitrogen atmosphere, 5.4 parts of 1,4,5,8-naphthalenetetracarboxylic dianhydride (manufactured by Tokyo Chemical Industry Co., Ltd.) and 3.0 parts of 3,5-diaminobenzoic acid (manufactured by Tokyo Chemical Industry Co., Ltd.) were added to 100 parts of dimethylacetamide. After that, the mixture was stirred at room temperature for 1 hour, and was then refluxed for 8 hours, followed by the separation of a precipitate by filtration. The resultant precipitate was washed with acetone to provide 6.2 parts of an electron transporting substance (D07). The resultant substance was particulate.

### Example 1

### Production of Electrophotographic Photosensitive Member

### <Support>

An aluminum cylinder having a length of 260.5 mm and a diameter of 30 mm was prepared. The aluminum cylinder was subjected to cutting processing (JIS B 0601:2014, ten-point average roughness Rzjis: 0.8 μm), and the processed aluminum cylinder was used as a support (electroconductive support).

### <Undercoat Layer>

Next, 5 parts of the exemplified compound (P-1) serving as an electron transporting substance was dissolved in a mixed solvent containing 48 parts of chloroform and 24 parts of o-xylene. The resultant coating liquid for an undercoat layer was applied onto the support by dip coating, and the resultant coating film was dried by being heated at 170° C. for 40 minutes. Thus, an undercoat layer having a thickness of 1.5 μm was formed.

### <Charge Generating Layer>

Next, a hydroxygallium phthalocyanine crystal (charge generating substance) of a crystal form having peaks at Bragg angles) (2θ±0.2° of 7.5°, 9.9°, 12.5°, 16.3°, 18.6°, 25.1°, and 28.3° in CuKα characteristic X-ray diffraction was prepared. 10 Parts of the hydroxygallium phthalocyanine crystal, 5 parts of a polyvinyl butyral resin (product name: S-LEC BX-1, manufactured by Sekisui Chemical Co., Ltd.), and 250 parts of cyclohexanone were loaded into a sand mill using glass beads each having a diameter of 1 mm, and were subjected to dispersion treatment for 2 hours. Next, 250 parts of ethyl acetate was added to the resultant to prepare a coating liquid for a charge generating layer. The coating liquid for a charge generating layer was applied onto the undercoat layer by dip coating to form a coating film, and the resultant coating film was dried at a temperature of 95° C. for 10 minutes to form a charge generating layer having a thickness of 0.15 μm.

### <Charge Transporting Layer>

The following materials were prepared.
Charge transporting substance represented by the following formula 5 parts

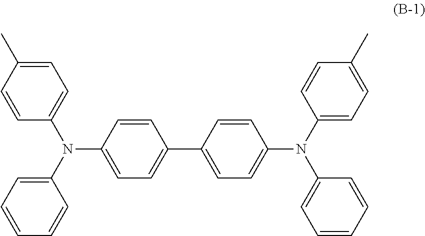 [SMILES: Cc1ccc(N(c2ccccc2)c2ccc(-c3ccc(N(c4ccccc4)c4ccc(C)cc4)cc3)cc2)cc1]

Charge transporting substance represented by the following formula 5 parts

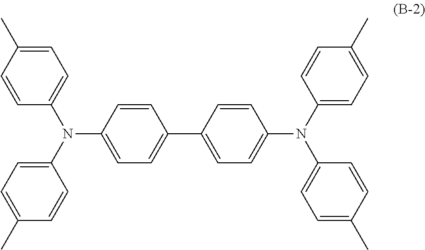 [SMILES: Cc1ccc(N(c2ccc(C)cc2)c2ccc(-c3ccc(N(c4ccc(C)cc4)c4ccc(C)cc4)cc3)cc2)cc1]

Polycarbonate (product name: Iupilon Z-400, manufactured by Mitsubishi Engineering-Plastics Corporation) 10 parts

Those materials were dissolved in a mixed solvent of 25 parts of orthoxylene, 25 parts of methyl benzoate, and 25 parts of dimethoxymethane to prepare a coating liquid for a charge transporting layer.

The thus prepared coating liquid for a charge transporting layer was applied onto the above-mentioned charge generating layer by dip coating to form a coating film, and the coating film was dried by being heated at a temperature of 120° C. for 30 minutes to form a charge transporting layer having a thickness of 25 μm.

### [Evaluation]

### <Potential Fluctuation Evaluation>

A laser beam printer (product name: LaserJet Enterprise M609dn) manufactured by Hewlett-Packard Company was prepared for a potential fluctuation evaluation. Before the use in the evaluation, the above-mentioned laser beam printer was changed so as to operate at a process speed of 370 mm/s, a variable charging condition, and a variable laser exposure amount.

The potential fluctuation evaluation was performed as described below. The produced electrophotographic photosensitive member was mounted on the above-mentioned laser beam printer manufactured by Hewlett-Packard Company, and was placed under a normal-temperature and normal-humidity (23° C./50% RH) environment. The surface potential of the electrophotographic photosensitive member was set so that the potential of the unexposed portion thereof at the initial stage became-500 V, and the exposure light amount thereof became 0.3 uJ/cm². After 10,000 sheets of paper had been passed through the photosensitive member (hereinafter also referred to as “after endurance”), the potential of the exposed portion thereof was measured. The surface potential was measured as follows: a cartridge including the photosensitive member was reconstructed; a potential probe (model 6000B-8, manufactured by Trek Japan) was mounted at the developing position of the photosensitive member; and the potential of the central portion of the drum thereof was measured with a surface potentiometer (model 344, manufactured by Trek Japan). At the time of the paper passing, a letter image having a print percentage of 1% was printed on A4 size plain paper, and the image was output on 10,000 sheets of the paper. That is, as described above, in the present invention, a potential fluctuation was evaluated by a value obtained by calculating a fluctuation amount between the potential at the initial stage and that after the endurance. The result is shown in Table 23.

### <Electron Mobility Evaluation>

An electron mobility was determined by a time-of-flight method. It has been known that the electron mobility depends on an electric field intensity, and a value when the electric field intensity was 3×10⁷ V/m was used.

A specific measurement method is as described below.

First, the coating liquid for an undercoat layer was applied onto an aluminum sheet with a wire bar, and was dried at 160° C. for 10 minutes to form an undercoat layer having a thickness of 5.0 μm for an electron mobility evaluation. After that, the coating liquid for a charge generating layer was applied thereto with a wire bar, and was dried at 100° C. for 10 minutes to form a charge generating layer having a thickness of 0.2 μm. Thus, a measurement sample was produced. The produced measurement sample was sandwiched between glass transparent electrodes coated with an electroconductive substance such as an ITO coating, and a circuit formed of a power source and a resistance for current measurement was formed. Subsequently, the sample was irradiated with light from a transparent electrode side on condition that a voltage was applied thereto while being regulated so that an electric field became 3.0×10⁷ V/m. At this time, the time of flight (t) of a carrier flying in the sample is obtained by observing a current waveform at the time of the flight of an electron injected into the undercoat layer out of electrons, which are generated in the charge generating layer, in the undercoat layer by hopping conduction with an oscilloscope. A velocity (v=d/t) is determined from the time of flight (t) and the thickness (d) of the sample. An electron mobility (u) in the sample was determined by dividing the velocity (v) by an electric field intensity (E) because the velocity (v) was the product (v=μE) of the electron mobility (u) and the electric field intensity (E).

The resultant mobility is shown in Table 23.

In addition, a volume resistivity was also measured by using a similarly produced measurement sample. The obtained result is shown in Table 23.

### Examples 2 to 6, 11 to 39, and 44 to 417

Electrophotographic photosensitive members were each produced in the same manner as in Example 1 except that in Example 1, the electron transporting substance was changed to an electron transporting substance shown in each of Tables 23 to 31, and the photosensitive members were similarly evaluated. The results are shown in Tables 23 to 31.

### Example 7

An electrophotographic photosensitive member was produced in the same manner as in Example 1 except that in Example 1, its undercoat layer was formed as described below, and the photosensitive member was similarly evaluated. The results are shown in Table 23.

### <Undercoat Layer>

The following materials were prepared.

| | | |
|---|---|---|
| Exemplified compound (P-3) serving as the electron | 8 | parts |
| transporting substance | | |
| Blocked isocyanate compound (product name: SBB-70P | 4.01 | parts |
| (solid content: 70%, isocyanate:blocking group = 6.7:3.3 | | |
| (mass ratio), manufactured by Asahi Kasei Corporation)) | | |
| serving as the isocyanate compound | | |
| Styrene-acrylic resin (product name: UC-3920, | 0.12 | part |
| manufactured by Toagosei Co., Ltd.) serving as the resin | | |

Those materials were dissolved in a mixed solvent formed of 48 parts of 1-butanol and 24 parts of acetone. The resultant coating liquid for an undercoat layer was applied onto the support by dip coating, and the resultant coating film was cured (polymerized) by being heated at 170° C. for 40 minutes. Thus, an undercoat layer having a thickness of 1.5 μm was formed.

### Examples 8 to 10 and 40 to 43

In Example 7, the kind or amount of the electron transporting substance was changed to that shown in Table 23. In addition, a content ratio between the electron transporting substance in the undercoat layer, and the total of the isocyanate compound and the resin therein was changed so that the content (mass %) of the electron transporting substance in the undercoat layer had a value shown in Table 23. A ratio between the isocyanate compound and the resin was made constant. Electrophotographic photosensitive members were each produced in the same manner as in Example 7 except the foregoing, and were similarly evaluated. The results are shown in Table 23.

### Examples 501 to 506, 511 to 539, and 544 to 917

Electrophotographic photosensitive members were each produced in the same manner as in Example 1 except that in Example 1, the electron transporting substance was changed to an electron transporting substance shown in each of Tables 32 to 40, and the photosensitive members were similarly evaluated. The results are shown in Tables 32 to 40.

### Examples 507 to 510 and 540 to 543

In Example 7, the kind or amount of the electron transporting substance was changed to that shown in Table 32. In addition, a content ratio between the electron transporting substance in the undercoat layer, and the total of the isocyanate compound and the resin therein was changed so that the content (mass %) of the electron transporting substance in the undercoat layer had a value shown in Table 32. A ratio between the isocyanate compound and the resin was made constant. Electrophotographic photosensitive members were each produced in the same manner as in Example 7 except the foregoing, and were similarly evaluated. The results are shown in Table 32.

### Examples 418 and 918

Electrophotographic photosensitive members were each produced by: changing the support to a support described below; forming an electroconductive layer on the support as described below; and forming the same undercoat layer, charge generating layer, and charge transporting layer as those of Example 1 and Example 501 on the electroconductive layer, and the photosensitive members were evaluated. The results are shown in Tables 31 and 40.

### <Support>

An aluminum cylinder having a diameter of 30 mm and a length of 260.5 mm was used as a support (cylindrical support).

### <Electroconductive Layer>

Anatase type titanium oxide having a primary particle diameter of 200 nm on average was used as a base, and a titanium-niobium sulfuric acid solution containing 33.7 parts of titanium in terms of TiO₂ and 2.9 parts of niobium in terms of Nb₂O₅ was prepared. 100 Parts of the base was dispersed in pure water to provide 1,000 parts of a suspension, and the suspension was warmed to 60° C. The titanium-niobium sulfuric acid solution and 10 mol/L sodium hydroxide were dropped into the suspension over 3 hours so that the suspension had a pH of 2 to 3. After the total amount of the solutions had been dropped, the pH was adjusted to a value near a neutral region, and a polyacrylamide-based flocculant was added to the mixture to precipitate a solid content. The supernatant was removed, and the residue was filtered and washed, followed by drying at 110° C. Thus, an intermediate containing 0.1 mass % of organic matter derived from the flocculant in terms of C was obtained. The intermediate was calcined in nitrogen at 750° C. for 1 hour, and was then calcined in air at 450° C. to produce titanium oxide particles. The resultant particles had an average particle diameter (average primary particle diameter) of 220 nm in a particle diameter measurement method using a scanning electron microscope.

Subsequently, 50 parts of a phenol resin (monomer/oligomer of a phenol resin) (product name: PLYOPHEN J-325, manufactured by DIC Corporation, resin solid content: 60%, density after curing: 1.3 g/cm²) serving as a binding material was prepared. 50 Parts of the phenol resin was dissolved in 35 parts of 1-methoxy-2-propanol serving as a solvent to provide a solution.

60 Parts of titanium oxide particles were added to the solution. The mixture was loaded into a vertical sand mill using 120 parts of glass beads having an average particle diameter of 1.0 mm as a dispersion medium, and was subjected to dispersion treatment under the conditions of a dispersion liquid temperature of 23±3° C. and a number of revolutions of 1,500 rpm (peripheral speed: 5.5 m/s) for 4 hours to provide a dispersion liquid. The glass beads were removed from the dispersion liquid with a mesh.

Subsequently, the following materials were prepared.

| | | |
|---|---|---|
| Silicone oil (product name: SH28 PAINT ADDITIVE, | 0.01 | part |
| manufactured by Dow Corning Toray Co., Ltd.) | | |
| serving as a leveling agent | | |
| Silicone resin particles (product name: KMP-590, | 8 | parts |
| manufactured by Shin-Etsu Chemical Co., Ltd., | | |
| average particle diameter: 2 μm, density: 1.3 g/cm³) | | |
| serving as a surface roughness imparting material | | |

Those materials were added to the dispersion liquid after the removal of the glass beads, and the mixture was stirred and filtered under pressure with PTFE filter paper (product name: PF060, manufactured by Advantec Toyo Kaisha, Ltd.) to prepare a coating liquid for an electroconductive layer.

The thus prepared coating liquid for an electroconductive layer was applied onto the above-mentioned support by dip coating to form a coating film, and the coating film was cured by being heated at 150° C. for 20 minutes. Thus, an electroconductive layer having a thickness of 25 μm was formed.

### Comparative Example 1

An electrophotographic photosensitive member was produced and evaluated in the same manner as in Example 1 except that in Example 1, the electron transporting substance (P-1) was changed to the electron transporting substance (D01). The results are shown in Table 41.

The abbreviation “Nd” in Table 41 means that a value was not determined because the value was unmeasurable. A possible cause for the fact that the measurement could not be performed is the elution of part of the undercoat layer after the immersion of the undercoat layer in the coating liquid for a charge generating layer after its formation.

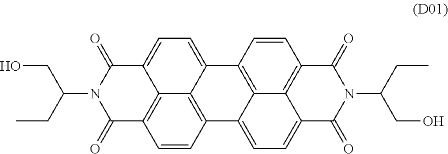 [SMILES: CCC(CO)N1C(=O)c2ccc3c4ccc5c6c(ccc(c7ccc(c2c37)C1=O)c64)C(=O)N(C(CC)CO)C5=O]

### Comparative Examples 2 to 5

In Example 7, the kind or amount of the electron transporting substance (P-3) was changed to that shown in Table 41. In addition, a content ratio between the electron transporting substance in the undercoat layer, and the total of the isocyanate compound and the resin therein was changed so that the content (mass %) of the electron transporting substance in the undercoat layer had a value shown in Table 41. A ratio between the isocyanate compound and the resin was made constant. Electrophotographic photosensitive members were each produced in the same manner as in Example 7 except the foregoing, and were similarly evaluated. The results are shown in Table 41.

### Comparative Example 6

An electrophotographic photosensitive member was produced and evaluated in the same manner as in Comparative Example 3 except that in Comparative Example 3, the electron transporting substance (D01) was changed to the electron transporting substance (D04). The results are shown in Table 41.

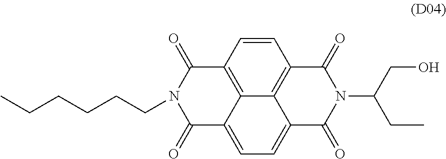 [SMILES: CCCCCCN1C(=O)c2ccc3c4c(ccc(c24)C1=O)C(=O)N(C(CC)CO)C3=O]

### Comparative Example 7

An electrophotographic photosensitive member was produced and evaluated in the same manner as in Comparative Example 3 except that in Comparative Example 3, the electron transporting substance (D01) was changed to the electron transporting substance (D05). The results are shown in Table 41.

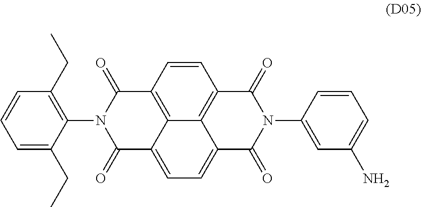 [SMILES: CCc1cccc(CC)c1N1C(=O)c2ccc3c4c(ccc(c24)C1=O)C(=O)N(c1cccc(N)c1)C3=O]

### Comparative Example 8

An electrophotographic photosensitive member was produced and evaluated in the same manner as in Example 1 except that in Example 1, the electron transporting substance (P-1) was changed to the electron transporting substance (D06), and its undercoat layer was formed as described below. The results are shown in Table 41.

### <Undercoat Layer>

8 Parts of the electron transporting substance (D06) was dissolved in 80 parts of chloroform. The resultant coating liquid for an undercoat layer was applied onto the support by dip coating, and the resultant coating film was dried by being heated at 100° C. for 15 minutes. Thus, an undercoat layer having a thickness of 1.5 μm was formed.

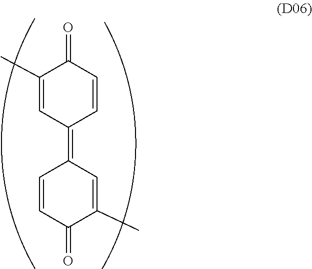

### Comparative Example 9

An electrophotographic photosensitive member was produced and evaluated in the same manner as in Example 506 except that in Example 506, the electron transporting substance (N-3) was changed to the electron transporting substance (D07), and its undercoat layer was formed as described below. The results are shown in Table 41.

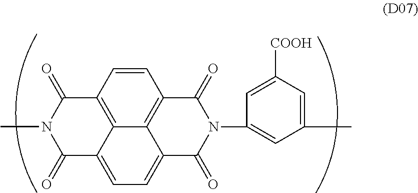

### <Undercoat Layer>

40 Parts of the electron transporting substance (D07), and 500 parts of distilled water, 300 parts of methanol, and 8 parts of triethylamine each serving as a dispersion medium were mixed, and the mixture was subjected to dispersion treatment with a sand mill apparatus using glass beads each having a diameter of 1 mm for 2 hours to provide a coating liquid for an undercoat layer. The resultant coating liquid for an undercoat layer was applied onto the support by dip coating, and the resultant coating film was dried by being heated at 120° C. for 10 minutes. Thus, an undercoat layer having a thickness of 1.5 μm was formed.

### Comparative Example 10

An electrophotographic photosensitive member was produced and evaluated in the same manner as in Example 506 except that in Example 506, the electron transporting substance (N-3) was changed to the electron transporting substance (D08), and its undercoat layer was formed as described below. The results are shown in Table 41.

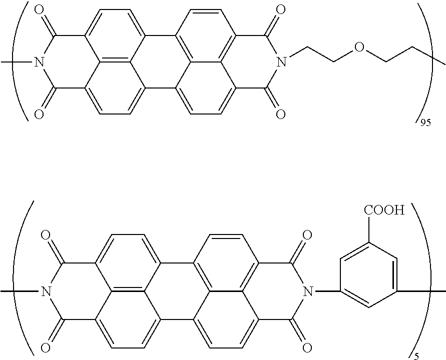

In the structure of the electron transporting substance (D08), the ratios of the repeating structures are each represented in the unit of mol %.

### <Undercoat Layer>

40 Parts of the electron transporting substance (D08), and 300 parts of distilled water, 500 parts of methanol, and 8 parts of triethylamine each serving as a dispersion medium were mixed, and the mixture was subjected to dispersion treatment with a sand mill apparatus using glass beads each having a diameter of 1 mm for 2 hours to provide a coating liquid for an undercoat layer. The resultant coating liquid for an undercoat layer was applied onto the support by dip coating, and the resultant coating film was dried by being heated at 120° C. for 10 minutes. Thus, an undercoat layer having a thickness of 1.5 μm was formed.

TABLE 23

| | | | | Electron | Volume | Potential | Potential | |
|---|---|---|---|---|---|---|---|---|
| | Electron transporting substance | | | mobility | resistivity | of exposed | of exposed | |
| | | Weight- | Content in | of undercoat | of undercoat | portion at | portion | |
| | | average | undercoat | layer | layer | initial | after | Potential |
| | | molecular | layer | (×10⁻⁸ cm²/ | (×10¹⁰ | stage | endurance | fluctuation |
| Example | Kind | weight | (mass %) | V · sec) | (Ω · cm) | (×(−1) V) | (×(−1) V) | ΔVL |
| 1 | P-1 | 5,220 | 100 | 24.7 | 405.6 | 120 | 141 | 20 |
| 2 | P-2 | 5,800 | 100 | 37.0 | 270.4 | 114 | 127 | 14 |
| 3 | P-3 | 1,276 | 100 | 53.8 | 185.9 | 109 | 119 | 9 |
| 4 | P-3 | 3,190 | 100 | 53.8 | 185.9 | 109 | 119 | 9 |
| 5 | P-3 | 6,380 | 100 | 53.8 | 185.9 | 109 | 119 | 9 |
| 6 | P-3 | 12,760 | 100 | 53.8 | 185.9 | 109 | 119 | 9 |
| 7 | P-3 | 12,760 | 80 | 43.0 | 185.9 | 112 | 123 | 12 |
| 8 | P-3 | 12,760 | 60 | 32.3 | 185.9 | 115 | 131 | 15 |
| 9 | P-3 | 12,760 | 50 | 26.9 | 185.9 | 119 | 137 | 19 |
| 10 | P-3 | 12,760 | 45 | 24.2 | 185.9 | 121 | 141 | 21 |
| 11 | P-3 | 22,330 | 100 | 53.8 | 185.9 | 109 | 119 | 9 |
| 12 | P-3 | 28,710 | 100 | 51.2 | 195.3 | 110 | 120 | 10 |
| 13 | P-3 | 29,986 | 100 | 50.2 | 199.2 | 110 | 120 | 10 |
| 14 | P-3 | 38,280 | 100 | 40.8 | 245.1 | 112 | 125 | 12 |
| 15 | P-4 | 6,960 | 100 | 55.5 | 180.3 | 109 | 118 | 9 |
| 16 | P-5 | 7,540 | 100 | 62.6 | 159.8 | 108 | 116 | 8 |
| 17 | P-6 | 8,120 | 100 | 63.4 | 157.7 | 108 | 116 | 8 |
| 18 | P-7 | 8,700 | 100 | 64.1 | 156.0 | 108 | 116 | 8 |
| 19 | P-8 | 9,280 | 100 | 64.7 | 154.5 | 108 | 115 | 8 |
| 20 | P-9 | 9,860 | 100 | 65.3 | 153.2 | 108 | 115 | 8 |
| 21 | P-10 | 10,440 | 100 | 61.6 | 162.2 | 108 | 116 | 8 |
| 22 | P-15 | 13,340 | 100 | 48.2 | 207.3 | 110 | 121 | 10 |
| 23 | P-20 | 16,240 | 100 | 39.6 | 252.4 | 113 | 125 | 13 |
| 24 | P-21 | 17,400 | 100 | 37.0 | 270.4 | 114 | 127 | 14 |
| 25 | P-22 | 19,140 | 100 | 33.6 | 297.4 | 115 | 130 | 15 |
| 26 | P-23 | 20,880 | 100 | 30.8 | 324.5 | 116 | 132 | 16 |
| 27 | P-24 | 22,040 | 100 | 29.2 | 342.5 | 117 | 134 | 17 |
| 28 | P-25 | 23,200 | 100 | 18.5 | 540.8 | 127 | 154 | 27 |
| 29 | P-26 | 23,780 | 100 | 18.0 | 554.3 | 128 | 155 | 28 |
| 30 | P-27 | 27,840 | 100 | 15.4 | 649.0 | 132 | 165 | 32 |
| 31 | P-28 | 33,640 | 100 | 12.8 | 784.1 | 139 | 178 | 39 |
| 32 | P-29 | 39,440 | 100 | 10.9 | 919.3 | 146 | 192 | 46 |
| 33 | P-30 | 45,240 | 100 | 9.5 | 1,054.5 | 153 | 205 | 53 |
| 34 | P-31 | 6,620 | 100 | 49.3 | 405.6 | 110 | 120 | 10 |
| 35 | P-32 | 7,200 | 100 | 74.0 | 270.4 | 107 | 114 | 7 |
| 36 | P-33 | 7,780 | 100 | 107.6 | 185.9 | 105 | 109 | 5 |
| 37 | P-34 | 8,360 | 100 | 110.9 | 180.3 | 105 | 109 | 5 |
| 38 | P-35 | 8,940 | 100 | 125.2 | 159.8 | 104 | 108 | 4 |
| 39 | P-36 | 9,520 | 100 | 126.8 | 157.7 | 104 | 108 | 4 |
| 40 | P-36 | 9,520 | 80 | 101.4 | 157.7 | 105 | 110 | 5 |
| 41 | P-36 | 9,520 | 60 | 76.1 | 157.7 | 107 | 113 | 7 |
| 42 | P-36 | 9,520 | 50 | 63.4 | 157.7 | 108 | 116 | 8 |
| 43 | P-36 | 9,520 | 45 | 57.1 | 157.7 | 109 | 118 | 9 |
| 44 | P-37 | 10,100 | 100 | 128.2 | 156.0 | 104 | 108 | 4 |
| 45 | P-38 | 10,680 | 100 | 129.4 | 154.5 | 104 | 108 | 4 |
| 46 | P-39 | 11,260 | 100 | 130.5 | 153.2 | 104 | 108 | 4 |
| 47 | P-40 | 11,840 | 100 | 123.3 | 162.2 | 104 | 108 | 4 |
| 48 | P-50 | 17,640 | 100 | 79.2 | 252.4 | 106 | 113 | 6 |
| 49 | P-51 | 18,800 | 100 | 74.0 | 270.4 | 107 | 114 | 7 |
| 50 | P-52 | 20,540 | 100 | 67.2 | 297.4 | 107 | 115 | 7 |

TABLE 24

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 51 | P-53 | 22,280 | 100 | 61.6 | 324.5 | 108 | 116 | 8 |
| 52 | P-54 | 23,440 | 100 | 58.4 | 342.5 | 109 | 117 | 9 |
| 53 | P-55 | 24,600 | 100 | 55.5 | 360.5 | 109 | 118 | 9 |
| 54 | P-56 | 25,180 | 100 | 36.1 | 554.3 | 114 | 128 | 14 |
| 55 | P-57 | 29,240 | 100 | 30.8 | 649.0 | 116 | 132 | 16 |
| 56 | P-58 | 35,040 | 100 | 25.5 | 784.1 | 120 | 139 | 20 |
| 57 | P-59 | 40,840 | 100 | 21.8 | 919.3 | 123 | 146 | 23 |
| 58 | P-60 | 46,640 | 100 | 19.0 | 1054.5 | 126 | 153 | 26 |
| 59 | P-61 | 6,820 | 100 | 49.3 | 405.6 | 110 | 120 | 10 |
| 60 | P-62 | 7,400 | 100 | 74.0 | 270.4 | 107 | 114 | 7 |
| 61 | P-63 | 7,980 | 100 | 107.6 | 185.9 | 105 | 109 | 5 |
| 62 | P-64 | 8,560 | 100 | 110.9 | 180.3 | 105 | 109 | 5 |
| 63 | P-65 | 9,140 | 100 | 125.2 | 159.8 | 104 | 108 | 4 |
| 64 | P-66 | 9,720 | 100 | 126.8 | 157.7 | 104 | 108 | 4 |
| 65 | P-67 | 10,300 | 100 | 128.2 | 156.0 | 104 | 108 | 4 |
| 66 | P-68 | 10,880 | 100 | 129.4 | 154.5 | 104 | 108 | 4 |
| 67 | P-69 | 11,460 | 100 | 130.5 | 153.2 | 104 | 108 | 4 |
| 68 | P-70 | 12,040 | 100 | 123.3 | 162.2 | 104 | 108 | 4 |
| 69 | P-80 | 17,840 | 100 | 79.2 | 252.4 | 106 | 113 | 6 |
| 70 | P-81 | 19,000 | 100 | 74.0 | 270.4 | 107 | 114 | 7 |
| 71 | P-82 | 20,740 | 100 | 67.2 | 297.4 | 107 | 115 | 7 |
| 72 | P-83 | 22,480 | 100 | 61.6 | 324.5 | 108 | 116 | 8 |
| 73 | P-84 | 23,640 | 100 | 58.4 | 342.5 | 109 | 117 | 9 |
| 74 | P-85 | 24,800 | 100 | 37.0 | 540.8 | 114 | 127 | 14 |
| 75 | P-86 | 25,380 | 100 | 36.1 | 554.3 | 114 | 128 | 14 |
| 76 | P-87 | 29,440 | 100 | 30.8 | 649.0 | 116 | 132 | 16 |
| 77 | P-88 | 35,240 | 100 | 25.5 | 784.1 | 120 | 139 | 20 |
| 78 | P-89 | 41,040 | 100 | 21.8 | 919.3 | 123 | 146 | 23 |
| 79 | P-90 | 46,840 | 100 | 19.0 | 1,054.5 | 126 | 153 | 26 |
| 80 | P-91 | 6,240 | 100 | 55.0 | 181.8 | 109 | 118 | 9 |
| 81 | P-92 | 7,840 | 100 | 65.7 | 152.3 | 108 | 115 | 8 |
| 82 | P-93 | 9,600 | 100 | 67.0 | 149.2 | 107 | 115 | 7 |
| 83 | P-94 | 10,040 | 100 | 64.1 | 156.0 | 108 | 116 | 8 |
| 84 | P-106 | 10,920 | 100 | 43.2 | 231.4 | 112 | 123 | 12 |
| 85 | P-107 | 10,200 | 100 | 63.1 | 158.5 | 108 | 116 | 8 |
| 86 | P-108 | 11,360 | 100 | 56.6 | 176.5 | 109 | 118 | 9 |
| 87 | P-109 | 10,640 | 100 | 60.5 | 165.3 | 108 | 117 | 8 |
| 88 | P-110 | 11,800 | 100 | 54.5 | 183.4 | 109 | 118 | 9 |
| 89 | P-111 | 12,960 | 100 | 49.7 | 201.4 | 110 | 120 | 10 |
| 90 | P-123 | 13,400 | 100 | 48.0 | 208.2 | 110 | 121 | 10 |
| 91 | P-124 | 16,920 | 100 | 38.0 | 262.9 | 113 | 126 | 13 |
| 92 | P-125 | 21,320 | 100 | 20.1 | 497.0 | 125 | 150 | 25 |
| 93 | P-126 | 25,280 | 100 | 17.0 | 589.3 | 129 | 159 | 29 |
| 94 | P-127 | 27,920 | 100 | 15.4 | 650.8 | 133 | 165 | 33 |
| 95 | P-135 | 14,040 | 100 | 45.8 | 218.2 | 111 | 122 | 11 |
| 96 | P-136 | 12,160 | 100 | 52.9 | 189.0 | 109 | 119 | 9 |
| 97 | P-137 | 13,600 | 100 | 47.3 | 211.3 | 111 | 121 | 11 |
| 98 | P-146 | 14,160 | 100 | 45.4 | 220.0 | 111 | 122 | 11 |
| 99 | P-147 | 16,480 | 100 | 39.0 | 256.1 | 113 | 126 | 13 |

TABLE 25

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 101 | P-149 | 6,520 | 100 | 19.7 | 506.6 | 125 | 151 | 25 |
| 102 | P-150 | 7,100 | 100 | 30.2 | 331.0 | 117 | 133 | 17 |
| 103 | P-151 | 7,680 | 100 | 39.1 | 255.7 | 113 | 126 | 13 |
| 104 | P-152 | 8,260 | 100 | 41.5 | 240.7 | 112 | 124 | 12 |
| 105 | P-153 | 8,840 | 100 | 43.7 | 229.0 | 111 | 123 | 11 |
| 106 | P-154 | 9,420 | 100 | 41.0 | 244.0 | 112 | 124 | 12 |
| 107 | P-155 | 10,000 | 100 | 38.6 | 259.0 | 113 | 126 | 13 |
| 108 | P-156 | 10,580 | 100 | 36.5 | 274.0 | 114 | 127 | 14 |
| 109 | P-157 | 11,160 | 100 | 34.6 | 289.0 | 114 | 129 | 14 |
| 110 | P-158 | 12,320 | 100 | 31.3 | 319.1 | 116 | 132 | 16 |
| 111 | P-159 | 14,060 | 100 | 27.5 | 364.2 | 118 | 136 | 18 |
| 112 | P-160 | 16,960 | 100 | 22.8 | 439.3 | 122 | 144 | 22 |
| 113 | P-161 | 22,760 | 100 | 18.8 | 530.5 | 127 | 153 | 27 |
| 114 | P-162 | 28,560 | 100 | 15.0 | 665.7 | 133 | 167 | 33 |
| 115 | P-163 | 34,360 | 100 | 12.5 | 800.9 | 140 | 180 | 40 |
| 116 | P-164 | 40,160 | 100 | 10.7 | 936.1 | 147 | 194 | 47 |
| 117 | P-165 | 45,960 | 100 | 9.3 | 1,071.3 | 154 | 207 | 54 |
| 119 | P-167 | 5,380 | 100 | 23.9 | 418.0 | 121 | 142 | 21 |
| 120 | P-168 | 5,820 | 100 | 36.9 | 271.3 | 114 | 127 | 14 |
| 121 | P-169 | 6,260 | 100 | 48.0 | 208.5 | 110 | 121 | 10 |
| 122 | P-170 | 6,700 | 100 | 51.2 | 195.2 | 110 | 120 | 10 |
| 123 | P-171 | 7,140 | 100 | 54.1 | 184.9 | 109 | 118 | 9 |
| 124 | P-172 | 7,580 | 100 | 50.9 | 196.3 | 110 | 120 | 10 |
| 125 | P-173 | 8,020 | 100 | 48.1 | 207.7 | 110 | 121 | 10 |
| 126 | P-174 | 8,460 | 100 | 45.6 | 219.1 | 111 | 122 | 11 |
| 127 | P-175 | 8,900 | 100 | 43.4 | 230.5 | 112 | 123 | 12 |
| 128 | P-176 | 9,340 | 100 | 41.3 | 241.9 | 112 | 124 | 12 |
| 129 | P-177 | 9,780 | 100 | 39.5 | 253.3 | 113 | 125 | 13 |
| 130 | P-178 | 11,100 | 100 | 34.8 | 287.5 | 114 | 129 | 14 |
| 131 | P-179 | 13,300 | 100 | 25.8 | 387.5 | 119 | 139 | 19 |
| 132 | P-180 | 17,700 | 100 | 19.4 | 515.7 | 126 | 152 | 26 |
| 133 | P-181 | 22,100 | 100 | 19.4 | 515.2 | 126 | 152 | 26 |
| 134 | P-182 | 26,500 | 100 | 16.2 | 617.7 | 131 | 162 | 31 |
| 135 | P-183 | 30,900 | 100 | 13.9 | 720.3 | 136 | 172 | 36 |
| 136 | P-184 | 35,300 | 100 | 12.2 | 822.8 | 141 | 182 | 41 |
| 137 | P-185 | 4,930 | 100 | 26.1 | 383.1 | 119 | 138 | 19 |
| 138 | P-186 | 4,930 | 100 | 26.1 | 383.1 | 119 | 138 | 19 |
| 139 | P-187 | 5,360 | 100 | 24.0 | 416.5 | 121 | 142 | 21 |
| 140 | P-188 | 5,790 | 100 | 37.0 | 269.9 | 113 | 127 | 13 |
| 141 | P-189 | 6,220 | 100 | 48.3 | 207.1 | 110 | 121 | 10 |
| 142 | P-190 | 6,650 | 100 | 51.6 | 193.8 | 110 | 119 | 10 |
| 143 | P-191 | 7,080 | 100 | 54.5 | 183.4 | 109 | 118 | 9 |
| 144 | P-192 | 7,510 | 100 | 51.4 | 194.5 | 110 | 119 | 10 |
| 145 | P-193 | 7,940 | 100 | 48.6 | 205.6 | 110 | 121 | 10 |
| 146 | P-194 | 8,370 | 100 | 46.1 | 216.8 | 111 | 122 | 11 |
| 147 | P-195 | 8,800 | 100 | 43.9 | 227.9 | 111 | 123 | 11 |
| 148 | P-196 | 9,230 | 100 | 41.8 | 239.1 | 112 | 124 | 12 |
| 149 | P-197 | 9,660 | 100 | 40.0 | 250.2 | 113 | 125 | 13 |
| 150 | P-198 | 10,950 | 100 | 35.3 | 283.6 | 114 | 128 | 14 |

TABLE 26

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 151 | P-199 | 13,100 | 100 | 26.2 | 381.7 | 119 | 138 | 19 |
| 152 | P-200 | 17,400 | 100 | 19.7 | 507.0 | 125 | 151 | 25 |
| 153 | P-201 | 21,700 | 100 | 19.8 | 505.8 | 125 | 151 | 25 |
| 154 | P-202 | 26,000 | 100 | 16.5 | 606.1 | 130 | 161 | 30 |
| 155 | P-203 | 30,300 | 100 | 14.2 | 706.3 | 135 | 171 | 35 |
| 156 | P-204 | 34,600 | 100 | 12.4 | 806.5 | 140 | 181 | 40 |
| 157 | P-205 | 5,200 | 100 | 24.8 | 404.0 | 120 | 140 | 20 |
| 158 | P-206 | 5,760 | 100 | 22.3 | 447.6 | 122 | 145 | 22 |
| 159 | P-207 | 6,320 | 100 | 20.4 | 491.1 | 125 | 149 | 25 |
| 160 | P-208 | 6,880 | 100 | 31.2 | 320.7 | 116 | 132 | 16 |
| 161 | P-209 | 7,440 | 100 | 40.4 | 247.8 | 112 | 125 | 12 |
| 162 | P-210 | 8,000 | 100 | 42.9 | 233.1 | 112 | 123 | 12 |
| 163 | P-211 | 8,560 | 100 | 45.1 | 221.7 | 111 | 122 | 11 |
| 164 | P-212 | 9,120 | 100 | 42.3 | 236.2 | 112 | 124 | 12 |
| 165 | P-213 | 9,680 | 100 | 39.9 | 250.7 | 113 | 125 | 13 |
| 166 | P-214 | 10,240 | 100 | 37.7 | 265.2 | 113 | 127 | 13 |
| 167 | P-215 | 15,840 | 100 | 24.4 | 410.3 | 121 | 141 | 21 |
| 168 | P-216 | 21,440 | 100 | 18.0 | 555.3 | 128 | 156 | 28 |
| 169 | P-217 | 27,040 | 100 | 14.3 | 700.3 | 135 | 170 | 35 |
| 170 | P-218 | 5,480 | 100 | 23.5 | 425.8 | 121 | 143 | 21 |
| 171 | P-219 | 6,180 | 100 | 20.8 | 480.2 | 124 | 148 | 24 |
| 172 | P-220 | 5,920 | 100 | 51.3 | 389.6 | 110 | 119 | 10 |
| 173 | P-221 | 6,500 | 100 | 77.9 | 256.6 | 106 | 113 | 6 |
| 174 | P-222 | 7,080 | 100 | 114.5 | 174.6 | 104 | 109 | 4 |
| 175 | P-223 | 7,660 | 100 | 119.1 | 167.9 | 104 | 108 | 4 |
| 176 | P-224 | 8,240 | 100 | 135.4 | 147.8 | 104 | 107 | 4 |
| 177 | P-225 | 8,820 | 100 | 138.0 | 145.0 | 104 | 107 | 4 |
| 178 | P-226 | 9,400 | 100 | 140.3 | 142.6 | 104 | 107 | 4 |
| 179 | P-227 | 22,740 | 100 | 62.5 | 319.9 | 108 | 116 | 8 |
| 180 | P-228 | 23,900 | 100 | 63.7 | 313.8 | 108 | 116 | 8 |
| 181 | P-229 | 24,480 | 100 | 62.2 | 321.4 | 108 | 116 | 8 |
| 182 | P-230 | 7,720 | 100 | 51.3 | 389.6 | 110 | 119 | 10 |
| 183 | P-231 | 8,300 | 100 | 77.9 | 256.6 | 106 | 113 | 6 |
| 184 | P-232 | 8,880 | 100 | 114.5 | 174.6 | 104 | 109 | 4 |
| 185 | P-233 | 9,460 | 100 | 119.1 | 167.9 | 104 | 108 | 4 |
| 186 | P-234 | 10,040 | 100 | 135.4 | 147.8 | 104 | 107 | 4 |
| 187 | P-235 | 10,620 | 100 | 138.0 | 145.0 | 104 | 107 | 4 |
| 188 | P-236 | 11,200 | 100 | 140.3 | 142.6 | 104 | 107 | 4 |
| 189 | P-237 | 24,540 | 100 | 62.5 | 319.9 | 108 | 116 | 8 |
| 190 | P-238 | 25,700 | 100 | 63.7 | 313.8 | 108 | 116 | 8 |
| 191 | P-239 | 26,280 | 100 | 62.2 | 321.4 | 108 | 116 | 8 |
| 192 | P-240 | 6,120 | 100 | 51.3 | 389.6 | 110 | 119 | 10 |
| 193 | P-241 | 6,700 | 100 | 77.9 | 256.6 | 106 | 113 | 6 |
| 194 | P-242 | 7,280 | 100 | 114.5 | 174.6 | 104 | 109 | 4 |
| 195 | P-243 | 7,860 | 100 | 119.1 | 167.9 | 104 | 108 | 4 |
| 196 | P-244 | 8,440 | 100 | 135.4 | 147.8 | 104 | 107 | 4 |
| 197 | P-245 | 9,020 | 100 | 138.0 | 145.0 | 104 | 107 | 4 |
| 198 | P-246 | 9,600 | 100 | 140.3 | 142.6 | 104 | 107 | 4 |
| 199 | P-247 | 22,940 | 100 | 62.5 | 319.9 | 108 | 116 | 8 |
| 200 | P-248 | 24,100 | 100 | 63.7 | 313.8 | 108 | 116 | 8 |

TABLE 27

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 201 | P-249 | 24,680 | 100 | 64.2 | 311.6 | 108 | 116 | 8 |
| 202 | P-250 | 5,720 | 100 | 51.8 | 386.4 | 110 | 119 | 10 |
| 203 | P-251 | 6,300 | 100 | 78.8 | 253.8 | 106 | 113 | 6 |
| 204 | P-252 | 6,880 | 100 | 116.0 | 172.3 | 104 | 109 | 4 |
| 205 | P-253 | 7,460 | 100 | 120.9 | 165.4 | 104 | 108 | 4 |
| 206 | P-254 | 8,040 | 100 | 137.6 | 145.3 | 104 | 107 | 4 |
| 207 | P-255 | 8,620 | 100 | 140.5 | 142.4 | 104 | 107 | 4 |
| 208 | P-256 | 9,200 | 100 | 143.0 | 139.9 | 103 | 107 | 3 |
| 209 | P-257 | 22,540 | 100 | 64.4 | 310.3 | 108 | 116 | 8 |
| 210 | P-258 | 23,700 | 100 | 65.7 | 304.3 | 108 | 115 | 8 |
| 211 | P-259 | 24,280 | 100 | 64.2 | 311.6 | 108 | 116 | 8 |
| 212 | P-260 | 5,520 | 100 | 51.8 | 386.4 | 110 | 119 | 10 |
| 213 | P-261 | 6,100 | 100 | 78.8 | 253.8 | 106 | 113 | 6 |
| 214 | P-262 | 6,680 | 100 | 116.0 | 172.3 | 104 | 109 | 4 |
| 215 | P-263 | 7,260 | 100 | 120.9 | 165.4 | 104 | 108 | 4 |
| 216 | P-264 | 7,840 | 100 | 137.6 | 145.3 | 104 | 107 | 4 |
| 217 | P-265 | 8,420 | 100 | 140.5 | 142.4 | 104 | 107 | 4 |
| 218 | P-266 | 9,000 | 100 | 143.0 | 139.9 | 103 | 107 | 3 |
| 219 | P-267 | 22,340 | 100 | 64.4 | 310.3 | 108 | 116 | 8 |
| 220 | P-268 | 23,500 | 100 | 65.7 | 304.3 | 108 | 115 | 8 |
| 221 | P-269 | 24,080 | 100 | 64.2 | 311.6 | 108 | 116 | 8 |
| 222 | P-270 | 6,320 | 100 | 51.8 | 386.4 | 110 | 119 | 10 |
| 223 | P-271 | 6,900 | 100 | 78.8 | 253.8 | 106 | 113 | 6 |
| 224 | P-272 | 7,480 | 100 | 116.0 | 172.3 | 104 | 109 | 4 |
| 225 | P-273 | 8,060 | 100 | 120.9 | 165.4 | 104 | 108 | 4 |
| 226 | P-274 | 8,640 | 100 | 137.6 | 145.3 | 104 | 107 | 4 |
| 227 | P-275 | 9,220 | 100 | 140.5 | 142.4 | 104 | 107 | 4 |
| 228 | P-276 | 9,800 | 100 | 143.0 | 139.9 | 103 | 107 | 3 |
| 229 | P-280 | 7,220 | 100 | 51.8 | 386.4 | 110 | 119 | 10 |
| 230 | P-281 | 7,800 | 100 | 78.8 | 253.8 | 106 | 113 | 6 |
| 231 | P-282 | 8,380 | 100 | 116.0 | 172.3 | 104 | 109 | 4 |
| 232 | P-283 | 8,960 | 100 | 120.9 | 165.4 | 104 | 108 | 4 |
| 233 | P-284 | 9,540 | 100 | 137.6 | 145.3 | 104 | 107 | 4 |
| 234 | P-285 | 10,120 | 100 | 140.5 | 142.4 | 104 | 107 | 4 |
| 235 | P-286 | 10,700 | 100 | 143.0 | 139.9 | 103 | 107 | 3 |
| 236 | P-290 | 7,020 | 100 | 51.8 | 386.4 | 110 | 119 | 10 |
| 237 | P-291 | 7,600 | 100 | 78.8 | 253.8 | 106 | 113 | 6 |
| 238 | P-292 | 8,180 | 100 | 116.0 | 172.3 | 104 | 109 | 4 |
| 239 | P-293 | 8,760 | 100 | 120.9 | 165.4 | 104 | 108 | 4 |
| 240 | P-294 | 9,340 | 100 | 137.6 | 145.3 | 104 | 107 | 4 |
| 241 | P-295 | 9,920 | 100 | 140.5 | 142.4 | 104 | 107 | 4 |
| 242 | P-296 | 10,500 | 100 | 143.0 | 139.9 | 103 | 107 | 3 |
| 243 | P-300 | 6,360 | 100 | 51.8 | 386.4 | 110 | 119 | 10 |
| 244 | P-301 | 6,940 | 100 | 78.8 | 253.8 | 106 | 113 | 6 |
| 245 | P-302 | 7,520 | 100 | 116.0 | 172.3 | 104 | 109 | 4 |
| 246 | P-303 | 8,100 | 100 | 120.9 | 165.4 | 104 | 108 | 4 |
| 247 | P-304 | 8,680 | 100 | 137.6 | 145.3 | 104 | 107 | 4 |
| 248 | P-305 | 9,260 | 100 | 140.5 | 142.4 | 104 | 107 | 4 |
| 249 | P-306 | 9,840 | 100 | 143.0 | 139.9 | 103 | 107 | 3 |
| 250 | P-310 | 6,400 | 100 | 51.8 | 386.4 | 110 | 119 | 10 |

TABLE 28

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 251 | P-311 | 6,980 | 100 | 78.8 | 253.8 | 106 | 113 | 6 |
| 252 | P-312 | 7,560 | 100 | 116.0 | 172.3 | 104 | 109 | 4 |
| 253 | P-313 | 8,140 | 100 | 120.9 | 165.4 | 104 | 108 | 4 |
| 254 | P-314 | 8,720 | 100 | 137.6 | 145.3 | 104 | 107 | 4 |
| 255 | P-315 | 9,300 | 100 | 140.5 | 142.4 | 104 | 107 | 4 |
| 256 | P-316 | 9,880 | 100 | 143.0 | 139.9 | 103 | 107 | 3 |
| 257 | P-320 | 6,620 | 100 | 51.8 | 386.4 | 110 | 119 | 10 |
| 258 | P-321 | 7,200 | 100 | 78.8 | 253.8 | 106 | 113 | 6 |
| 259 | P-322 | 7,780 | 100 | 116.0 | 172.3 | 104 | 109 | 4 |
| 260 | P-323 | 8,360 | 100 | 120.9 | 165.4 | 104 | 108 | 4 |
| 261 | P-324 | 8,940 | 100 | 137.6 | 145.3 | 104 | 107 | 4 |
| 262 | P-325 | 9,520 | 100 | 140.5 | 142.4 | 104 | 107 | 4 |
| 263 | P-326 | 10,100 | 100 | 143.0 | 139.9 | 103 | 107 | 3 |
| 264 | P-330 | 5,560 | 100 | 51.8 | 386.4 | 110 | 119 | 10 |
| 265 | P-331 | 6,140 | 100 | 78.8 | 253.8 | 106 | 113 | 6 |
| 266 | P-332 | 6,720 | 100 | 116.0 | 172.3 | 104 | 109 | 4 |
| 267 | P-333 | 7,300 | 100 | 120.9 | 165.4 | 104 | 108 | 4 |
| 268 | P-334 | 7,880 | 100 | 137.6 | 145.3 | 104 | 107 | 4 |
| 269 | P-335 | 8,460 | 100 | 140.5 | 142.4 | 104 | 107 | 4 |
| 270 | P-336 | 9,040 | 100 | 143.0 | 139.9 | 103 | 107 | 3 |
| 271 | P-340 | 6,120 | 100 | 51.8 | 386.4 | 110 | 119 | 10 |
| 272 | P-341 | 6,700 | 100 | 78.8 | 253.8 | 106 | 113 | 6 |
| 273 | P-342 | 7,280 | 100 | 116.0 | 172.3 | 104 | 109 | 4 |
| 274 | P-343 | 7,860 | 100 | 120.9 | 165.4 | 104 | 108 | 4 |
| 275 | P-344 | 8,440 | 100 | 137.6 | 145.3 | 104 | 107 | 4 |
| 276 | P-345 | 9,020 | 100 | 140.5 | 142.4 | 104 | 107 | 4 |
| 277 | P-346 | 9,600 | 100 | 143.0 | 139.9 | 103 | 107 | 3 |
| 278 | P-350 | 7,080 | 100 | 51.8 | 386.4 | 110 | 119 | 10 |
| 279 | P-351 | 7,660 | 100 | 78.8 | 253.8 | 106 | 113 | 6 |
| 280 | P-352 | 8,240 | 100 | 116.0 | 172.3 | 104 | 109 | 4 |
| 281 | P-353 | 8,820 | 100 | 120.9 | 165.4 | 104 | 108 | 4 |
| 282 | P-354 | 9,400 | 100 | 137.6 | 145.3 | 104 | 107 | 4 |
| 283 | P-355 | 9,980 | 100 | 140.5 | 142.4 | 104 | 107 | 4 |
| 284 | P-356 | 10,560 | 100 | 143.0 | 139.9 | 103 | 107 | 3 |
| 285 | P-360 | 7,940 | 100 | 51.8 | 386.4 | 110 | 119 | 10 |
| 286 | P-361 | 8,520 | 100 | 78.8 | 253.8 | 106 | 113 | 6 |
| 287 | P-362 | 9,100 | 100 | 116.0 | 172.3 | 104 | 109 | 4 |
| 288 | P-363 | 9,680 | 100 | 120.9 | 165.4 | 104 | 108 | 4 |
| 289 | P-364 | 10,260 | 100 | 137.6 | 145.3 | 104 | 107 | 4 |
| 290 | P-365 | 10,840 | 100 | 140.5 | 142.4 | 104 | 107 | 4 |
| 291 | P-366 | 11,420 | 100 | 143.0 | 139.9 | 103 | 107 | 3 |
| 292 | P-370 | 7,640 | 100 | 51.8 | 386.4 | 110 | 119 | 10 |
| 293 | P-371 | 8,220 | 100 | 78.8 | 253.8 | 106 | 113 | 6 |
| 294 | P-372 | 8,800 | 100 | 116.0 | 172.3 | 104 | 109 | 4 |
| 295 | P-373 | 9,380 | 100 | 120.9 | 165.4 | 104 | 108 | 4 |
| 296 | P-374 | 9,960 | 100 | 137.6 | 145.3 | 104 | 107 | 4 |
| 297 | P-375 | 10,540 | 100 | 140.5 | 142.4 | 104 | 107 | 4 |
| 298 | P-376 | 11,120 | 100 | 143.0 | 139.9 | 103 | 107 | 3 |
| 299 | P-380 | 7,920 | 100 | 51.8 | 386.4 | 110 | 119 | 10 |
| 300 | P-381 | 8,500 | 100 | 78.8 | 253.8 | 106 | 113 | 6 |

TABLE 29

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 301 | P-382 | 9,080 | 100 | 116.0 | 172.3 | 104 | 109 | 4 |
| 302 | P-383 | 9,660 | 100 | 120.9 | 165.4 | 104 | 108 | 4 |
| 303 | P-384 | 10,240 | 100 | 137.6 | 145.3 | 104 | 107 | 4 |
| 304 | P-385 | 10,820 | 100 | 140.5 | 142.4 | 104 | 107 | 4 |
| 305 | P-386 | 11,400 | 100 | 143.0 | 139.9 | 103 | 107 | 3 |
| 306 | P-390 | 7,920 | 100 | 51.8 | 386.4 | 110 | 119 | 10 |
| 307 | P-391 | 6,100 | 100 | 78.8 | 253.8 | 106 | 113 | 6 |
| 308 | P-392 | 6,680 | 100 | 116.0 | 172.3 | 104 | 109 | 4 |
| 309 | P-393 | 7,260 | 100 | 120.9 | 165.4 | 104 | 108 | 4 |
| 310 | P-394 | 7,840 | 100 | 137.6 | 145.3 | 104 | 107 | 4 |
| 311 | P-395 | 8,420 | 100 | 140.5 | 142.4 | 104 | 107 | 4 |
| 312 | P-396 | 9,000 | 100 | 143.0 | 139.9 | 103 | 107 | 3 |
| 313 | P-400 | 6,760 | 100 | 51.8 | 386.4 | 110 | 119 | 10 |
| 314 | P-401 | 7,340 | 100 | 78.8 | 253.8 | 106 | 113 | 6 |
| 315 | P-402 | 7,920 | 100 | 116.0 | 172.3 | 104 | 109 | 4 |
| 316 | P-403 | 8,500 | 100 | 120.9 | 165.4 | 104 | 108 | 4 |
| 317 | P-404 | 9,080 | 100 | 137.6 | 145.3 | 104 | 107 | 4 |
| 318 | P-405 | 9,660 | 100 | 140.5 | 142.4 | 104 | 107 | 4 |
| 319 | P-406 | 10,240 | 100 | 143.0 | 139.9 | 103 | 107 | 3 |
| 320 | P-410 | 6,920 | 100 | 51.8 | 386.4 | 110 | 119 | 10 |
| 321 | P-411 | 7,500 | 100 | 78.8 | 253.8 | 106 | 113 | 6 |
| 322 | P-412 | 8,080 | 100 | 116.0 | 172.3 | 104 | 109 | 4 |
| 323 | P-413 | 8,660 | 100 | 120.9 | 165.4 | 104 | 108 | 4 |
| 324 | P-414 | 9,240 | 100 | 137.6 | 145.3 | 104 | 107 | 4 |
| 325 | P-415 | 9,820 | 100 | 140.5 | 142.4 | 104 | 107 | 4 |
| 326 | P-416 | 10,400 | 100 | 143.0 | 139.9 | 103 | 107 | 3 |
| 327 | P-420 | 8,320 | 100 | 51.8 | 386.4 | 110 | 119 | 10 |
| 328 | P-421 | 8,900 | 100 | 78.8 | 253.8 | 106 | 113 | 6 |
| 329 | P-422 | 9,480 | 100 | 116.0 | 172.3 | 104 | 109 | 4 |
| 330 | P-423 | 10,060 | 100 | 120.9 | 165.4 | 104 | 108 | 4 |
| 331 | P-424 | 10,640 | 100 | 137.6 | 145.3 | 104 | 107 | 4 |
| 332 | P-425 | 11,220 | 100 | 140.5 | 142.4 | 104 | 107 | 4 |
| 333 | P-426 | 11,800 | 100 | 143.0 | 139.9 | 103 | 107 | 3 |
| 334 | P-430 | 5,720 | 100 | 51.8 | 386.4 | 110 | 119 | 10 |
| 335 | P-431 | 6,300 | 100 | 78.8 | 253.8 | 106 | 113 | 6 |
| 336 | P-432 | 6,880 | 100 | 116.0 | 172.3 | 104 | 109 | 4 |
| 337 | P-433 | 7,460 | 100 | 120.9 | 165.4 | 104 | 108 | 4 |
| 338 | P-434 | 8,040 | 100 | 137.6 | 145.3 | 104 | 107 | 4 |
| 339 | P-435 | 8,620 | 100 | 140.5 | 142.4 | 104 | 107 | 4 |
| 340 | P-436 | 9,200 | 100 | 143.0 | 139.9 | 103 | 107 | 3 |
| 341 | P-440 | 8,240 | 100 | 51.8 | 386.4 | 110 | 119 | 10 |
| 342 | P-441 | 8,820 | 100 | 78.8 | 253.8 | 106 | 113 | 6 |
| 343 | P-442 | 9,400 | 100 | 116.0 | 172.3 | 104 | 109 | 4 |
| 344 | P-443 | 9,980 | 100 | 120.9 | 165.4 | 104 | 108 | 4 |
| 345 | P-444 | 10,560 | 100 | 137.6 | 145.3 | 104 | 107 | 4 |
| 346 | P-445 | 11,140 | 100 | 140.5 | 142.4 | 104 | 107 | 4 |
| 347 | P-446 | 11,720 | 100 | 143.0 | 139.9 | 103 | 107 | 3 |
| 348 | P-450 | 7,600 | 100 | 51.8 | 386.4 | 110 | 119 | 10 |
| 349 | P-451 | 8,180 | 100 | 78.8 | 253.8 | 106 | 113 | 6 |
| 350 | P-452 | 8,760 | 100 | 116.0 | 172.3 | 104 | 109 | 4 |

TABLE 30

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 351 | P-453 | 9,340 | 100 | 120.9 | 165.4 | 104 | 108 | 4 |
| 352 | P-454 | 9,920 | 100 | 137.6 | 145.3 | 104 | 107 | 4 |
| 353 | P-455 | 10,500 | 100 | 140.5 | 142.4 | 104 | 107 | 4 |
| 354 | P-456 | 11,080 | 100 | 143.0 | 139.9 | 103 | 107 | 3 |
| 355 | P-460 | 8,120 | 100 | 51.8 | 386.4 | 110 | 119 | 10 |
| 356 | P-461 | 8,700 | 100 | 78.8 | 253.8 | 106 | 113 | 6 |
| 357 | P-462 | 9,280 | 100 | 116.0 | 172.3 | 104 | 109 | 4 |
| 358 | P-463 | 9,860 | 100 | 120.9 | 165.4 | 104 | 108 | 4 |
| 359 | P-464 | 10,440 | 100 | 137.6 | 145.3 | 104 | 107 | 4 |
| 360 | P-465 | 11,020 | 100 | 140.5 | 142.4 | 104 | 107 | 4 |
| 361 | P-466 | 11,600 | 100 | 143.0 | 139.9 | 103 | 107 | 3 |
| 362 | P-470 | 6,600 | 100 | 51.8 | 386.4 | 110 | 119 | 10 |
| 363 | P-471 | 7,180 | 100 | 78.8 | 253.8 | 106 | 113 | 6 |
| 364 | P-472 | 7,760 | 100 | 116.0 | 172.3 | 104 | 109 | 4 |
| 365 | P-473 | 8,340 | 100 | 120.9 | 165.4 | 104 | 108 | 4 |
| 366 | P-474 | 8,920 | 100 | 137.6 | 145.3 | 104 | 107 | 4 |
| 367 | P-475 | 9,500 | 100 | 140.5 | 142.4 | 104 | 107 | 4 |
| 368 | P-476 | 10,080 | 100 | 143.0 | 139.9 | 103 | 107 | 3 |
| 369 | P-480 | 9,600 | 100 | 51.8 | 386.4 | 110 | 119 | 10 |
| 370 | P-481 | 10,180 | 100 | 78.8 | 253.8 | 106 | 113 | 6 |
| 371 | P-482 | 10,760 | 100 | 116.0 | 172.3 | 104 | 109 | 4 |
| 372 | P-483 | 11,340 | 100 | 120.9 | 165.4 | 104 | 108 | 4 |
| 373 | P-484 | 11,920 | 100 | 137.6 | 145.3 | 104 | 107 | 4 |
| 374 | P-485 | 12,500 | 100 | 140.5 | 142.4 | 104 | 107 | 4 |
| 375 | P-486 | 13,080 | 100 | 143.0 | 139.9 | 103 | 107 | 3 |
| 376 | P-490 | 13,600 | 100 | 51.8 | 386.4 | 110 | 119 | 10 |
| 377 | P-491 | 14,180 | 100 | 78.8 | 253.8 | 106 | 113 | 6 |
| 378 | P-492 | 14,760 | 100 | 116.0 | 172.3 | 104 | 109 | 4 |
| 379 | P-493 | 15,340 | 100 | 120.9 | 165.4 | 104 | 108 | 4 |
| 380 | P-494 | 15,920 | 100 | 137.6 | 145.3 | 104 | 107 | 4 |
| 381 | P-495 | 16,500 | 100 | 140.5 | 142.4 | 104 | 107 | 4 |
| 382 | P-496 | 17,080 | 100 | 143.0 | 139.9 | 103 | 107 | 3 |
| 383 | P-500 | 13,600 | 100 | 51.8 | 386.4 | 110 | 119 | 10 |
| 384 | P-501 | 6,460 | 100 | 78.8 | 253.8 | 106 | 113 | 6 |
| 385 | P-502 | 7,040 | 100 | 116.0 | 172.3 | 104 | 109 | 4 |
| 386 | P-503 | 7,620 | 100 | 120.9 | 165.4 | 104 | 108 | 4 |
| 387 | P-504 | 8,200 | 100 | 137.6 | 145.3 | 104 | 107 | 4 |
| 388 | P-505 | 8,780 | 100 | 140.5 | 142.4 | 104 | 107 | 4 |
| 389 | P-506 | 9,360 | 100 | 143.0 | 139.9 | 103 | 107 | 3 |
| 390 | P-510 | 6,160 | 100 | 51.8 | 386.4 | 110 | 119 | 10 |
| 391 | P-511 | 6,740 | 100 | 78.8 | 253.8 | 106 | 113 | 6 |
| 392 | P-512 | 7,320 | 100 | 116.0 | 172.3 | 104 | 109 | 4 |
| 393 | P-513 | 7,900 | 100 | 120.9 | 165.4 | 104 | 108 | 4 |
| 394 | P-514 | 8,480 | 100 | 137.6 | 145.3 | 104 | 107 | 4 |
| 395 | P-515 | 9,060 | 100 | 140.5 | 142.4 | 104 | 107 | 4 |
| 396 | P-516 | 9,640 | 100 | 143.0 | 139.9 | 103 | 107 | 3 |
| 397 | P-520 | 7,400 | 100 | 51.8 | 386.4 | 110 | 119 | 10 |
| 398 | P-521 | 7,980 | 100 | 78.8 | 253.8 | 106 | 113 | 6 |
| 399 | P-522 | 8,560 | 100 | 116.0 | 172.3 | 104 | 109 | 4 |
| 400 | P-523 | 9,140 | 100 | 120.9 | 165.4 | 104 | 108 | 4 |

TABLE 31

| | Electron transporting substance | | | Electron | | Potential of | Potential of | |
|---|---|---|---|---|---|---|---|---|
| | | Weight- | Content in | mobility of | Volume | exposed | exposed | |
| | | average | undercoat | undercoat | resistivity of | portion at | portion after | Potential |
| | | molecular | layer | layer | undercoat layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 401 | P-524 | 9,720 | 100 | 137.6 | 145.3 | 104 | 107 | 4 |
| 402 | P-525 | 10,300 | 100 | 140.5 | 142.4 | 104 | 107 | 4 |
| 403 | P-526 | 10,880 | 100 | 143.0 | 139.9 | 103 | 107 | 3 |
| 404 | P-530 | 6,720 | 100 | 51.8 | 386.4 | 110 | 119 | 10 |
| 405 | P-531 | 7,300 | 100 | 78.8 | 253.8 | 106 | 113 | 6 |
| 406 | P-532 | 7,880 | 100 | 116.0 | 172.3 | 104 | 109 | 4 |
| 407 | P-533 | 8,460 | 100 | 120.9 | 165.4 | 104 | 108 | 4 |
| 408 | P-534 | 9,040 | 100 | 137.6 | 145.3 | 104 | 107 | 4 |
| 409 | P-535 | 9,620 | 100 | 140.5 | 142.4 | 104 | 107 | 4 |
| 410 | P-536 | 10,200 | 100 | 143.0 | 139.9 | 103 | 107 | 3 |
| 411 | P-540 | 5,220 | 100 | 25.9 | 772.7 | 119 | 139 | 19 |
| 412 | P-541 | 5,800 | 100 | 39.4 | 507.6 | 113 | 125 | 13 |
| 413 | P-542 | 6,380 | 100 | 58.0 | 344.7 | 109 | 117 | 9 |
| 414 | P-543 | 6,960 | 100 | 60.5 | 330.8 | 108 | 117 | 8 |
| 415 | P-544 | 7,540 | 100 | 68.8 | 290.6 | 107 | 115 | 7 |
| 416 | P-545 | 8,120 | 100 | 70.2 | 284.7 | 107 | 114 | 7 |
| 417 | P-546 | 8,700 | 100 | 71.5 | 279.7 | 107 | 114 | 7 |
| 418 | P-1 | 5,220 | 100 | 24.7 | 405.6 | 120 | 141 | 20 |

TABLE 32

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 501 | N-1 | 3,980 | 100 | 20.1 | 498.7 | 125 | 150 | 25 |
| 502 | N-2 | 4,560 | 100 | 29.2 | 342.9 | 117 | 134 | 17 |
| 503 | N-3 | 1,028 | 100 | 41.4 | 241.5 | 112 | 124 | 12 |
| 504 | N-3 | 2,570 | 100 | 41.4 | 241.5 | 112 | 124 | 12 |
| 505 | N-3 | 5,140 | 100 | 41.4 | 241.5 | 112 | 124 | 12 |
| 506 | N-3 | 10,280 | 100 | 41.4 | 241.5 | 112 | 124 | 12 |
| 507 | N-3 | 10,280 | 80 | 33.1 | 241.5 | 115 | 130 | 15 |
| 508 | N-3 | 10,280 | 60 | 24.8 | 241.5 | 120 | 140 | 20 |
| 509 | N-3 | 10,280 | 50 | 20.7 | 241.5 | 124 | 148 | 24 |
| 510 | N-3 | 10,280 | 45 | 18.6 | 241.5 | 127 | 154 | 27 |
| 511 | N-3 | 17,990 | 100 | 41.4 | 241.5 | 112 | 124 | 12 |
| 512 | N-3 | 23,130 | 100 | 41.4 | 241.5 | 112 | 124 | 12 |
| 513 | N-3 | 24,158 | 100 | 41.4 | 241.5 | 112 | 124 | 12 |
| 514 | N-3 | 30,840 | 100 | 41.4 | 241.5 | 112 | 124 | 12 |
| 515 | N-4 | 5,720 | 100 | 41.9 | 238.9 | 112 | 124 | 12 |
| 516 | N-5 | 6,300 | 100 | 46.4 | 215.3 | 111 | 122 | 11 |
| 517 | N-6 | 6,880 | 100 | 46.4 | 215.5 | 111 | 122 | 11 |
| 518 | N-7 | 7,460 | 100 | 46.4 | 215.7 | 111 | 122 | 11 |
| 519 | N-8 | 8,040 | 100 | 46.3 | 215.9 | 111 | 122 | 11 |
| 520 | N-9 | 8,620 | 100 | 46.3 | 216.0 | 111 | 122 | 11 |
| 521 | N-10 | 9,200 | 100 | 43.4 | 230.6 | 112 | 123 | 12 |
| 522 | N-15 | 12,100 | 100 | 33.0 | 303.3 | 115 | 130 | 15 |
| 523 | N-20 | 15,000 | 100 | 26.6 | 375.9 | 119 | 138 | 19 |
| 524 | N-21 | 16,160 | 100 | 24.7 | 405.0 | 120 | 141 | 20 |
| 525 | N-22 | 17,900 | 100 | 22.3 | 448.6 | 122 | 145 | 22 |
| 526 | N-23 | 19,640 | 100 | 20.3 | 492.2 | 125 | 149 | 25 |
| 527 | N-24 | 20,800 | 100 | 19.2 | 521.3 | 126 | 152 | 26 |
| 528 | N-25 | 21,960 | 100 | 12.1 | 825.6 | 141 | 183 | 41 |
| 529 | N-26 | 22,540 | 100 | 11.8 | 847.4 | 142 | 185 | 42 |
| 530 | N-27 | 26,600 | 100 | 10.0 | 1,000.0 | 150 | 200 | 50 |
| 531 | N-28 | 32,400 | 100 | 8.2 | 1,218.0 | 161 | 222 | 61 |
| 532 | N-29 | 38,200 | 100 | 7.0 | 1,436.1 | 172 | 244 | 72 |
| 533 | N-30 | 44,000 | 100 | 6.0 | 1,654.1 | 183 | 265 | 83 |
| 534 | N-31 | 5,380 | 100 | 22.6 | 883.4 | 122 | 144 | 22 |
| 535 | N-32 | 5,960 | 100 | 34.1 | 587.2 | 115 | 129 | 15 |
| 536 | N-33 | 6,540 | 100 | 49.7 | 402.7 | 110 | 120 | 10 |
| 537 | N-34 | 7,120 | 100 | 51.3 | 389.7 | 110 | 119 | 10 |
| 538 | N-35 | 7,700 | 100 | 58.0 | 344.8 | 109 | 117 | 9 |
| 539 | N-36 | 8,280 | 100 | 58.8 | 339.9 | 108 | 117 | 8 |
| 540 | N-36 | 8,280 | 80 | 47.1 | 339.9 | 111 | 121 | 11 |
| 541 | N-36 | 8,280 | 60 | 35.3 | 339.9 | 114 | 128 | 14 |
| 542 | N-36 | 8,280 | 50 | 29.4 | 339.9 | 117 | 134 | 17 |
| 543 | N-36 | 8,280 | 45 | 26.5 | 339.9 | 119 | 138 | 19 |
| 544 | N-37 | 8,860 | 100 | 59.6 | 335.7 | 108 | 117 | 8 |
| 545 | N-38 | 9,440 | 100 | 60.2 | 332.2 | 108 | 117 | 8 |
| 546 | N-39 | 10,020 | 100 | 60.8 | 329.1 | 108 | 116 | 8 |
| 547 | N-40 | 10,600 | 100 | 57.5 | 348.1 | 109 | 117 | 9 |
| 548 | N-50 | 16,400 | 100 | 37.1 | 538.6 | 113 | 127 | 13 |
| 549 | N-51 | 17,560 | 100 | 34.7 | 576.7 | 114 | 129 | 14 |
| 550 | N-52 | 19,300 | 100 | 31.6 | 633.8 | 116 | 132 | 16 |

TABLE 33

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 551 | N-53 | 21,040 | 100 | 28.9 | 691.0 | 117 | 135 | 17 |
| 552 | N-54 | 22,200 | 100 | 27.4 | 729.1 | 118 | 136 | 18 |
| 553 | N-55 | 23,360 | 100 | 26.1 | 767.2 | 119 | 138 | 19 |
| 554 | N-56 | 23,940 | 100 | 17.0 | 1,179.3 | 129 | 159 | 29 |
| 555 | N-57 | 28,000 | 100 | 14.5 | 1,379.3 | 134 | 169 | 34 |
| 556 | N-58 | 33,800 | 100 | 12.0 | 1,665.0 | 142 | 183 | 42 |
| 557 | N-59 | 39,600 | 100 | 10.3 | 1,950.7 | 149 | 198 | 49 |
| 558 | N-60 | 45,400 | 100 | 8.9 | 2,236.5 | 156 | 212 | 56 |
| 559 | N-61 | 5,560 | 100 | 22.9 | 874.2 | 122 | 144 | 22 |
| 560 | N-62 | 6,140 | 100 | 34.5 | 579.2 | 114 | 129 | 14 |
| 561 | N-63 | 6,720 | 100 | 50.5 | 396.2 | 110 | 120 | 10 |
| 562 | N-64 | 7,300 | 100 | 52.3 | 382.6 | 110 | 119 | 10 |
| 563 | N-65 | 7,880 | 100 | 59.2 | 337.9 | 108 | 117 | 8 |
| 564 | N-66 | 8,460 | 100 | 60.1 | 332.5 | 108 | 117 | 8 |
| 565 | N-67 | 9,040 | 100 | 61.0 | 328.0 | 108 | 116 | 8 |
| 566 | N-68 | 9,620 | 100 | 61.7 | 324.1 | 108 | 116 | 8 |
| 567 | N-69 | 10,200 | 100 | 62.4 | 320.8 | 108 | 116 | 8 |
| 568 | N-70 | 10,780 | 100 | 59.0 | 339.0 | 108 | 117 | 8 |
| 569 | N-80 | 16,580 | 100 | 38.4 | 521.4 | 113 | 126 | 13 |
| 570 | N-81 | 17,740 | 100 | 35.9 | 557.9 | 114 | 128 | 14 |
| 571 | N-82 | 19,480 | 100 | 32.6 | 612.6 | 115 | 131 | 15 |
| 572 | N-83 | 21,220 | 100 | 30.0 | 667.3 | 117 | 133 | 17 |
| 573 | N-84 | 22,380 | 100 | 28.4 | 703.8 | 118 | 135 | 18 |
| 574 | N-85 | 23,540 | 100 | 18.0 | 1,110.4 | 128 | 156 | 28 |
| 575 | N-86 | 24,120 | 100 | 17.6 | 1,137.7 | 128 | 157 | 28 |
| 576 | N-87 | 28,180 | 100 | 15.0 | 1,329.2 | 133 | 166 | 33 |
| 577 | N-88 | 33,980 | 100 | 12.5 | 1,602.8 | 140 | 180 | 40 |
| 578 | N-89 | 39,780 | 100 | 10.7 | 1,876.4 | 147 | 194 | 47 |
| 579 | N-90 | 45,580 | 100 | 9.3 | 2,150.0 | 154 | 208 | 54 |
| 580 | N-91 | 5,000 | 100 | 42.6 | 235.0 | 112 | 123 | 12 |
| 581 | N-92 | 6,600 | 100 | 48.4 | 206.8 | 110 | 121 | 10 |
| 582 | N-93 | 8,360 | 100 | 47.7 | 209.5 | 110 | 121 | 10 |
| 583 | N-94 | 8,800 | 100 | 45.3 | 220.6 | 111 | 122 | 11 |
| 584 | N-106 | 9,680 | 100 | 30.2 | 330.8 | 117 | 133 | 17 |
| 585 | N-107 | 8,960 | 100 | 44.5 | 224.6 | 111 | 122 | 11 |
| 586 | N-108 | 10,120 | 100 | 39.4 | 253.6 | 113 | 125 | 13 |
| 587 | N-109 | 9,400 | 100 | 42.4 | 235.6 | 112 | 124 | 12 |
| 588 | N-110 | 10,560 | 100 | 37.8 | 264.7 | 113 | 126 | 13 |
| 589 | N-111 | 11,720 | 100 | 34.0 | 293.7 | 115 | 129 | 15 |
| 590 | N-123 | 12,160 | 100 | 32.8 | 304.8 | 115 | 130 | 15 |
| 591 | N-124 | 15,680 | 100 | 25.4 | 393.0 | 120 | 139 | 20 |
| 592 | N-125 | 20,080 | 100 | 13.2 | 754.9 | 138 | 175 | 38 |
| 593 | N-126 | 24,040 | 100 | 11.1 | 903.8 | 145 | 190 | 45 |
| 594 | N-127 | 26,680 | 100 | 10.0 | 1,003.0 | 150 | 200 | 50 |
| 595 | N-135 | 14,040 | 100 | 31.2 | 320.8 | 116 | 132 | 16 |
| 596 | N-136 | 12,160 | 100 | 36.5 | 273.7 | 114 | 127 | 14 |
| 597 | N-137 | 13,600 | 100 | 32.3 | 309.8 | 115 | 131 | 15 |
| 598 | N-146 | 14,160 | 100 | 30.9 | 323.8 | 116 | 132 | 16 |
| 599 | N-147 | 16,480 | 100 | 26.2 | 382.0 | 119 | 138 | 19 |

TABLE 34

| | Electron transporting substance | | | Electron | Volume | Potential of | Potential | |
|---|---|---|---|---|---|---|---|---|
| | | Weight- | Content in | mobility of | resistivity of | exposed | of exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 601 | N-149 | 6,520 | 100 | 15.1 | 661.7 | 133 | 166 | 33 |
| 602 | N-150 | 7,100 | 100 | 22.7 | 440.6 | 122 | 144 | 22 |
| 603 | N-151 | 7,680 | 100 | 28.9 | 345.9 | 117 | 135 | 17 |
| 604 | N-152 | 8,260 | 100 | 30.3 | 329.9 | 116 | 133 | 16 |
| 605 | N-153 | 8,840 | 100 | 31.5 | 317.5 | 116 | 132 | 16 |
| 606 | N-154 | 9,420 | 100 | 29.3 | 341.7 | 117 | 134 | 17 |
| 607 | N-155 | 10,000 | 100 | 27.3 | 365.9 | 118 | 137 | 18 |
| 608 | N-156 | 10,580 | 100 | 25.6 | 390.1 | 120 | 139 | 20 |
| 609 | N-157 | 11,160 | 100 | 24.1 | 414.4 | 121 | 141 | 21 |
| 610 | N-158 | 12,320 | 100 | 21.6 | 462.8 | 123 | 146 | 23 |
| 611 | N-159 | 14,060 | 100 | 18.7 | 535.5 | 127 | 154 | 27 |
| 612 | N-160 | 16,960 | 100 | 15.2 | 656.6 | 133 | 166 | 33 |
| 613 | N-161 | 22,760 | 100 | 12.4 | 809.0 | 140 | 181 | 40 |
| 614 | N-162 | 28,560 | 100 | 9.7 | 1,027.1 | 151 | 203 | 51 |
| 615 | N-163 | 34,360 | 100 | 8.0 | 1,245.1 | 162 | 225 | 62 |
| 616 | N-164 | 40,160 | 100 | 6.8 | 1,463.2 | 173 | 246 | 73 |
| 617 | N-165 | 45,960 | 100 | 5.9 | 1,681.2 | 184 | 268 | 84 |
| 619 | N-167 | 5,380 | 100 | 19.3 | 518.8 | 126 | 152 | 26 |
| 620 | N-168 | 5,820 | 100 | 29.0 | 344.4 | 117 | 134 | 17 |
| 621 | N-169 | 6,260 | 100 | 37.1 | 269.6 | 113 | 127 | 13 |
| 622 | N-170 | 6,700 | 100 | 39.0 | 256.6 | 113 | 126 | 13 |
| 623 | N-171 | 7,140 | 100 | 40.6 | 246.4 | 112 | 125 | 12 |
| 624 | N-172 | 7,580 | 100 | 37.8 | 264.8 | 113 | 126 | 13 |
| 625 | N-173 | 8,020 | 100 | 35.3 | 283.2 | 114 | 128 | 14 |
| 626 | N-174 | 8,460 | 100 | 33.2 | 301.6 | 115 | 130 | 15 |
| 627 | N-175 | 8,900 | 100 | 31.3 | 320.0 | 116 | 132 | 16 |
| 628 | N-176 | 9,340 | 100 | 29.6 | 338.3 | 117 | 134 | 17 |
| 629 | N-177 | 9,780 | 100 | 28.0 | 356.7 | 118 | 136 | 18 |
| 630 | N-178 | 11,100 | 100 | 24.3 | 411.9 | 121 | 141 | 21 |
| 631 | N-179 | 13,300 | 100 | 17.6 | 566.7 | 128 | 157 | 28 |
| 632 | N-180 | 17,700 | 100 | 12.9 | 773.5 | 139 | 177 | 39 |
| 633 | N-181 | 22,100 | 100 | 12.8 | 784.2 | 139 | 178 | 39 |
| 634 | N-182 | 26,500 | 100 | 10.5 | 949.6 | 147 | 195 | 47 |
| 635 | N-183 | 30,900 | 100 | 9.0 | 1,115.0 | 156 | 212 | 56 |
| 636 | N-184 | 35,300 | 100 | 7.8 | 1,280.5 | 164 | 228 | 64 |
| 637 | N-185 | 4,930 | 100 | 21.6 | 462.4 | 123 | 146 | 23 |
| 638 | N-186 | 4,930 | 100 | 21.6 | 462.4 | 123 | 146 | 23 |
| 639 | N-187 | 5,360 | 100 | 19.4 | 516.3 | 126 | 152 | 26 |
| 640 | N-188 | 5,790 | 100 | 29.2 | 342.1 | 117 | 134 | 17 |
| 641 | N-189 | 6,220 | 100 | 37.4 | 267.5 | 113 | 127 | 13 |
| 642 | N-190 | 6,650 | 100 | 39.3 | 254.2 | 113 | 125 | 13 |
| 643 | N-191 | 7,080 | 100 | 41.0 | 243.9 | 112 | 124 | 12 |
| 644 | N-192 | 7,510 | 100 | 38.2 | 261.9 | 113 | 126 | 13 |
| 645 | N-193 | 7,940 | 100 | 35.7 | 279.9 | 114 | 128 | 14 |
| 646 | N-194 | 8,370 | 100 | 33.6 | 297.8 | 115 | 130 | 15 |
| 647 | N-195 | 8,800 | 100 | 31.7 | 315.8 | 116 | 132 | 16 |
| 648 | N-196 | 9,230 | 100 | 30.0 | 333.8 | 117 | 133 | 17 |
| 649 | N-197 | 9,660 | 100 | 28.4 | 351.7 | 118 | 135 | 18 |
| 650 | N-198 | 10,950 | 100 | 24.7 | 405.6 | 120 | 141 | 20 |

TABLE 35

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 651 | N-199 | 13,100 | 100 | 17.9 | 557.3 | 128 | 156 | 28 |
| 652 | N-200 | 17,400 | 100 | 13.2 | 759.4 | 138 | 176 | 38 |
| 653 | N-201 | 21,700 | 100 | 13.0 | 769.2 | 138 | 177 | 38 |
| 654 | N-202 | 26,000 | 100 | 10.7 | 930.8 | 147 | 193 | 47 |
| 655 | N-203 | 30,300 | 100 | 9.2 | 1,092.5 | 155 | 209 | 55 |
| 656 | N-204 | 34,600 | 100 | 8.0 | 1,254.1 | 163 | 225 | 63 |
| 657 | N-205 | 5,200 | 100 | 20.2 | 496.2 | 125 | 150 | 25 |
| 658 | N-206 | 5,760 | 100 | 17.7 | 566.4 | 128 | 157 | 28 |
| 659 | N-207 | 6,320 | 100 | 15.7 | 636.6 | 132 | 164 | 32 |
| 660 | N-208 | 6,880 | 100 | 23.6 | 424.1 | 121 | 142 | 21 |
| 661 | N-209 | 7,440 | 100 | 30.0 | 333.0 | 117 | 133 | 17 |
| 662 | N-210 | 8,000 | 100 | 31.5 | 317.7 | 116 | 132 | 16 |
| 663 | N-211 | 8,560 | 100 | 32.7 | 305.8 | 115 | 131 | 15 |
| 664 | N-212 | 9,120 | 100 | 30.4 | 329.2 | 116 | 133 | 16 |
| 665 | N-213 | 9,680 | 100 | 28.4 | 352.5 | 118 | 135 | 18 |
| 666 | N-214 | 10,240 | 100 | 26.6 | 375.9 | 119 | 138 | 19 |
| 667 | N-215 | 15,840 | 100 | 16.4 | 609.9 | 130 | 161 | 30 |
| 668 | N-216 | 21,440 | 100 | 11.9 | 843.8 | 142 | 184 | 42 |
| 669 | N-217 | 27,040 | 100 | 9.3 | 1,077.7 | 154 | 208 | 54 |
| 670 | N-218 | 5,480 | 100 | 18.8 | 531.3 | 127 | 153 | 27 |
| 671 | N-219 | 6,180 | 100 | 16.2 | 619.0 | 131 | 162 | 31 |
| 672 | N-220 | 4,700 | 100 | 23.7 | 842.7 | 121 | 142 | 21 |
| 673 | N-221 | 5,280 | 100 | 35.2 | 568.0 | 114 | 128 | 14 |
| 674 | N-222 | 5,860 | 100 | 50.8 | 394.0 | 110 | 120 | 10 |
| 675 | N-223 | 6,440 | 100 | 52.0 | 384.9 | 110 | 119 | 10 |
| 676 | N-224 | 7,020 | 100 | 58.3 | 343.3 | 109 | 117 | 9 |
| 677 | N-225 | 7,600 | 100 | 58.7 | 340.7 | 109 | 117 | 9 |
| 678 | N-226 | 8,180 | 100 | 59.1 | 338.5 | 108 | 117 | 8 |
| 679 | N-227 | 21,520 | 100 | 24.2 | 826.9 | 121 | 141 | 21 |
| 680 | N-228 | 22,680 | 100 | 24.6 | 813.3 | 120 | 141 | 20 |
| 681 | N-229 | 23,260 | 100 | 24.0 | 834.1 | 121 | 142 | 21 |
| 682 | N-230 | 6,500 | 100 | 26.3 | 760.5 | 119 | 138 | 19 |
| 683 | N-231 | 7,080 | 100 | 40.2 | 497.0 | 112 | 125 | 12 |
| 684 | N-232 | 7,660 | 100 | 59.5 | 336.1 | 108 | 117 | 8 |
| 685 | N-233 | 8,240 | 100 | 62.2 | 321.4 | 108 | 116 | 8 |
| 686 | N-234 | 8,820 | 100 | 71.1 | 281.4 | 107 | 114 | 7 |
| 687 | N-235 | 9,400 | 100 | 72.7 | 275.0 | 107 | 114 | 7 |
| 688 | N-236 | 9,980 | 100 | 74.2 | 269.5 | 107 | 113 | 7 |
| 689 | N-237 | 23,320 | 100 | 34.2 | 584.7 | 115 | 129 | 15 |
| 690 | N-238 | 24,480 | 100 | 34.9 | 572.8 | 114 | 129 | 14 |
| 691 | N-239 | 25,060 | 100 | 34.1 | 586.4 | 115 | 129 | 15 |
| 692 | N-240 | 6,120 | 100 | 24.1 | 829.5 | 121 | 141 | 21 |
| 693 | N-241 | 6,700 | 100 | 35.9 | 556.6 | 114 | 128 | 14 |
| 694 | N-242 | 7,280 | 100 | 52.0 | 384.7 | 110 | 119 | 10 |
| 695 | N-243 | 7,860 | 100 | 53.4 | 374.7 | 109 | 119 | 9 |
| 696 | N-244 | 8,440 | 100 | 60.0 | 333.3 | 108 | 117 | 8 |
| 697 | N-245 | 9,020 | 100 | 60.6 | 330.1 | 108 | 117 | 8 |
| 698 | N-246 | 9,600 | 100 | 61.1 | 327.4 | 108 | 116 | 8 |
| 699 | N-247 | 22,940 | 100 | 25.4 | 787.9 | 120 | 139 | 20 |
| 700 | N-248 | 24,100 | 100 | 25.8 | 774.7 | 119 | 139 | 19 |

TABLE 36

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 701 | N-249 | 24,680 | 100 | 25.2 | 794.3 | 120 | 140 | 20 |
| 702 | N-250 | 4,500 | 100 | 23.3 | 857.6 | 121 | 143 | 21 |
| 703 | N-251 | 5,080 | 100 | 34.4 | 580.9 | 115 | 129 | 15 |
| 704 | N-252 | 5,660 | 100 | 49.4 | 404.5 | 110 | 120 | 10 |
| 705 | N-253 | 6,240 | 100 | 50.5 | 396.4 | 110 | 120 | 10 |
| 706 | N-254 | 6,820 | 100 | 56.4 | 354.5 | 109 | 118 | 9 |
| 707 | N-255 | 7,400 | 100 | 56.7 | 352.6 | 109 | 118 | 9 |
| 708 | N-256 | 7,980 | 100 | 57.0 | 351.0 | 109 | 118 | 9 |
| 709 | N-257 | 21,320 | 100 | 23.0 | 870.7 | 122 | 144 | 22 |
| 710 | N-258 | 22,480 | 100 | 23.3 | 856.9 | 121 | 143 | 21 |
| 711 | N-259 | 23,060 | 100 | 22.8 | 879.0 | 122 | 144 | 22 |
| 712 | N-260 | 4,300 | 100 | 22.9 | 874.5 | 122 | 144 | 22 |
| 713 | N-261 | 4,880 | 100 | 33.6 | 595.5 | 115 | 130 | 15 |
| 714 | N-262 | 5,460 | 100 | 48.0 | 416.4 | 110 | 121 | 10 |
| 715 | N-263 | 6,040 | 100 | 48.8 | 409.5 | 110 | 120 | 10 |
| 716 | N-264 | 6,620 | 100 | 54.5 | 367.2 | 109 | 118 | 9 |
| 717 | N-265 | 7,200 | 100 | 54.6 | 366.1 | 109 | 118 | 9 |
| 718 | N-266 | 7,780 | 100 | 54.8 | 365.1 | 109 | 118 | 9 |
| 719 | N-267 | 21,120 | 100 | 21.7 | 920.4 | 123 | 146 | 23 |
| 720 | N-268 | 22,280 | 100 | 22.1 | 906.2 | 123 | 145 | 23 |
| 721 | N-269 | 22,860 | 100 | 21.5 | 929.8 | 123 | 146 | 23 |
| 722 | N-270 | 4,860 | 100 | 24.0 | 832.0 | 121 | 142 | 21 |
| 723 | N-271 | 5,440 | 100 | 35.8 | 558.8 | 114 | 128 | 14 |
| 724 | N-272 | 6,020 | 100 | 51.7 | 386.5 | 110 | 119 | 10 |
| 725 | N-273 | 6,600 | 100 | 53.1 | 376.6 | 109 | 119 | 9 |
| 726 | N-274 | 7,180 | 100 | 59.7 | 335.2 | 108 | 117 | 8 |
| 727 | N-275 | 7,760 | 100 | 60.2 | 332.1 | 108 | 117 | 8 |
| 728 | N-276 | 8,340 | 100 | 60.7 | 329.5 | 108 | 116 | 8 |
| 729 | N-280 | 5,980 | 100 | 25.7 | 777.7 | 119 | 139 | 19 |
| 730 | N-281 | 7,800 | 100 | 39.1 | 511.9 | 113 | 126 | 13 |
| 731 | N-282 | 8,380 | 100 | 57.4 | 348.2 | 109 | 117 | 9 |
| 732 | N-283 | 8,960 | 100 | 59.8 | 334.7 | 108 | 117 | 8 |
| 733 | N-284 | 9,540 | 100 | 67.9 | 294.4 | 107 | 115 | 7 |
| 734 | N-285 | 10,120 | 100 | 69.3 | 288.7 | 107 | 114 | 7 |
| 735 | N-286 | 10,700 | 100 | 70.4 | 283.9 | 107 | 114 | 7 |
| 736 | N-290 | 5,820 | 100 | 25.5 | 783.8 | 120 | 139 | 20 |
| 737 | N-291 | 6,400 | 100 | 38.7 | 517.2 | 113 | 126 | 13 |
| 738 | N-292 | 6,980 | 100 | 56.7 | 352.5 | 109 | 118 | 9 |
| 739 | N-293 | 7,560 | 100 | 58.9 | 339.4 | 108 | 117 | 8 |
| 740 | N-294 | 8,140 | 100 | 66.9 | 299.0 | 107 | 115 | 7 |
| 741 | N-295 | 8,720 | 100 | 68.1 | 293.6 | 107 | 115 | 7 |
| 742 | N-296 | 9,300 | 100 | 69.2 | 289.0 | 107 | 114 | 7 |
| 743 | N-300 | 5,980 | 100 | 25.7 | 777.7 | 119 | 139 | 19 |
| 744 | N-301 | 6,560 | 100 | 39.1 | 511.9 | 113 | 126 | 13 |
| 745 | N-302 | 7,140 | 100 | 57.4 | 348.2 | 109 | 117 | 9 |
| 746 | N-303 | 7,720 | 100 | 59.8 | 334.7 | 108 | 117 | 8 |
| 747 | N-304 | 8,300 | 100 | 67.9 | 294.4 | 107 | 115 | 7 |
| 748 | N-305 | 8,880 | 100 | 69.3 | 288.7 | 107 | 114 | 7 |
| 749 | N-306 | 9,460 | 100 | 70.4 | 283.9 | 107 | 114 | 7 |
| 750 | N-310 | 6,060 | 100 | 25.8 | 774.8 | 119 | 139 | 19 |

TABLE 37

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 751 | N-311 | 6,980 | 100 | 39.3 | 509.4 | 113 | 125 | 13 |
| 752 | N-312 | 7,560 | 100 | 57.8 | 346.2 | 109 | 117 | 9 |
| 753 | N-313 | 8,140 | 100 | 60.2 | 332.4 | 108 | 117 | 8 |
| 754 | N-314 | 8,720 | 100 | 68.4 | 292.2 | 107 | 115 | 7 |
| 755 | N-315 | 9,300 | 100 | 69.8 | 286.4 | 107 | 114 | 7 |
| 756 | N-316 | 9,880 | 100 | 71.1 | 281.5 | 107 | 114 | 7 |
| 757 | N-320 | 5,380 | 100 | 24.9 | 803.1 | 120 | 140 | 20 |
| 758 | N-321 | 5,960 | 100 | 37.5 | 533.8 | 113 | 127 | 13 |
| 759 | N-322 | 6,540 | 100 | 54.6 | 366.1 | 109 | 118 | 9 |
| 760 | N-323 | 7,120 | 100 | 56.5 | 354.3 | 109 | 118 | 9 |
| 761 | N-324 | 7,700 | 100 | 63.8 | 313.5 | 108 | 116 | 8 |
| 762 | N-325 | 8,280 | 100 | 64.7 | 309.0 | 108 | 115 | 8 |
| 763 | N-326 | 8,860 | 100 | 65.5 | 305.2 | 108 | 115 | 8 |
| 764 | N-330 | 4,320 | 100 | 22.9 | 872.7 | 122 | 144 | 22 |
| 765 | N-331 | 4,900 | 100 | 33.7 | 593.9 | 115 | 130 | 15 |
| 766 | N-332 | 5,480 | 100 | 48.2 | 415.2 | 110 | 121 | 10 |
| 767 | N-333 | 6,060 | 100 | 49.0 | 408.1 | 110 | 120 | 10 |
| 768 | N-334 | 6,640 | 100 | 54.7 | 365.8 | 109 | 118 | 9 |
| 769 | N-335 | 7,220 | 100 | 54.8 | 364.6 | 109 | 118 | 9 |
| 770 | N-336 | 7,800 | 100 | 55.0 | 363.6 | 109 | 118 | 9 |
| 771 | N-340 | 4,880 | 100 | 24.1 | 830.8 | 121 | 142 | 21 |
| 772 | N-341 | 5,460 | 100 | 35.9 | 557.7 | 114 | 128 | 14 |
| 773 | N-342 | 6,040 | 100 | 51.9 | 385.6 | 110 | 119 | 10 |
| 774 | N-343 | 6,620 | 100 | 53.2 | 375.7 | 109 | 119 | 9 |
| 775 | N-344 | 7,200 | 100 | 59.8 | 334.3 | 108 | 117 | 8 |
| 776 | N-345 | 7,780 | 100 | 60.4 | 331.1 | 108 | 117 | 8 |
| 777 | N-346 | 8,360 | 100 | 60.9 | 328.4 | 108 | 116 | 8 |
| 778 | N-350 | 5,840 | 100 | 25.5 | 783.1 | 120 | 139 | 20 |
| 779 | N-351 | 6,420 | 100 | 38.7 | 516.5 | 113 | 126 | 13 |
| 780 | N-352 | 7,000 | 100 | 56.8 | 352.0 | 109 | 118 | 9 |
| 781 | N-353 | 7,580 | 100 | 59.0 | 338.8 | 108 | 117 | 8 |
| 782 | N-354 | 8,160 | 100 | 67.0 | 298.4 | 107 | 115 | 7 |
| 783 | N-355 | 8,740 | 100 | 68.3 | 293.0 | 107 | 115 | 7 |
| 784 | N-356 | 9,320 | 100 | 69.4 | 288.4 | 107 | 114 | 7 |
| 785 | N-360 | 6,700 | 100 | 26.5 | 754.8 | 119 | 138 | 19 |
| 786 | N-361 | 7,280 | 100 | 40.6 | 492.1 | 112 | 125 | 12 |
| 787 | N-362 | 7,860 | 100 | 60.2 | 332.0 | 108 | 117 | 8 |
| 788 | N-363 | 8,440 | 100 | 63.1 | 316.9 | 108 | 116 | 8 |
| 789 | N-364 | 9,020 | 100 | 72.2 | 277.1 | 107 | 114 | 7 |
| 790 | N-365 | 9,600 | 100 | 74.0 | 270.4 | 107 | 114 | 7 |
| 791 | N-366 | 10,180 | 100 | 75.6 | 264.6 | 107 | 113 | 7 |
| 792 | N-370 | 6,440 | 100 | 26.2 | 762.3 | 119 | 138 | 19 |
| 793 | N-371 | 7,020 | 100 | 40.1 | 498.6 | 112 | 125 | 12 |
| 794 | N-372 | 7,600 | 100 | 59.3 | 337.4 | 108 | 117 | 8 |
| 795 | N-373 | 8,180 | 100 | 62.0 | 322.8 | 108 | 116 | 8 |
| 796 | N-374 | 8,760 | 100 | 70.7 | 282.8 | 107 | 114 | 7 |
| 797 | N-375 | 9,340 | 100 | 72.4 | 276.4 | 107 | 114 | 7 |
| 798 | N-376 | 9,920 | 100 | 73.8 | 271.0 | 107 | 114 | 7 |
| 799 | N-380 | 6,740 | 100 | 26.5 | 753.7 | 119 | 138 | 19 |
| 800 | N-381 | 7,320 | 100 | 40.7 | 491.1 | 112 | 125 | 12 |

TABLE 38

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 801 | N-382 | 7,900 | 100 | 60.4 | 331.3 | 108 | 117 | 8 |
| 802 | N-383 | 8,480 | 100 | 63.3 | 316.1 | 108 | 116 | 8 |
| 803 | N-384 | 9,060 | 100 | 72.4 | 276.3 | 107 | 114 | 7 |
| 804 | N-385 | 9,640 | 100 | 74.2 | 269.5 | 107 | 113 | 7 |
| 805 | N-386 | 10,220 | 100 | 75.8 | 263.7 | 107 | 113 | 7 |
| 806 | N-390 | 4,280 | 100 | 22.8 | 876.3 | 122 | 144 | 22 |
| 807 | N-391 | 4,860 | 100 | 33.5 | 597.1 | 115 | 130 | 15 |
| 808 | N-392 | 5,440 | 100 | 47.9 | 417.7 | 110 | 121 | 10 |
| 809 | N-393 | 6,020 | 100 | 48.7 | 410.9 | 110 | 121 | 10 |
| 810 | N-394 | 6,600 | 100 | 54.3 | 368.6 | 109 | 118 | 9 |
| 811 | N-395 | 7,180 | 100 | 54.4 | 367.5 | 109 | 118 | 9 |
| 812 | N-396 | 7,760 | 100 | 54.5 | 366.7 | 109 | 118 | 9 |
| 813 | N-400 | 5,520 | 100 | 25.1 | 796.5 | 120 | 140 | 20 |
| 814 | N-401 | 6,100 | 100 | 37.9 | 528.1 | 113 | 126 | 13 |
| 815 | N-402 | 6,680 | 100 | 55.3 | 361.5 | 109 | 118 | 9 |
| 816 | N-403 | 7,260 | 100 | 57.3 | 349.2 | 109 | 117 | 9 |
| 817 | N-404 | 7,840 | 100 | 64.8 | 308.5 | 108 | 115 | 8 |
| 818 | N-405 | 8,420 | 100 | 65.8 | 303.8 | 108 | 115 | 8 |
| 819 | N-406 | 9,000 | 100 | 66.7 | 299.7 | 107 | 115 | 7 |
| 820 | N-410 | 5,680 | 100 | 25.3 | 789.5 | 120 | 139 | 20 |
| 821 | N-411 | 6,260 | 100 | 38.3 | 522.1 | 113 | 126 | 13 |
| 822 | N-412 | 6,840 | 100 | 56.1 | 356.5 | 109 | 118 | 9 |
| 823 | N-413 | 7,420 | 100 | 58.2 | 343.8 | 109 | 117 | 9 |
| 824 | N-414 | 8,000 | 100 | 65.9 | 303.3 | 108 | 115 | 8 |
| 825 | N-415 | 8,580 | 100 | 67.1 | 298.2 | 107 | 115 | 7 |
| 826 | N-416 | 9,160 | 100 | 68.1 | 293.8 | 107 | 115 | 7 |
| 827 | N-420 | 7,090 | 100 | 26.9 | 744.7 | 119 | 137 | 19 |
| 828 | N-421 | 7,670 | 100 | 41.4 | 483.4 | 112 | 124 | 12 |
| 829 | N-422 | 8,250 | 100 | 61.5 | 325.0 | 108 | 116 | 8 |
| 830 | N-423 | 8,830 | 100 | 64.7 | 309.2 | 108 | 115 | 8 |
| 831 | N-424 | 9,410 | 100 | 74.2 | 269.6 | 107 | 113 | 7 |
| 832 | N-425 | 9,990 | 100 | 76.2 | 262.3 | 107 | 113 | 7 |
| 833 | N-426 | 10,570 | 100 | 78.1 | 256.2 | 106 | 113 | 6 |
| 834 | N-430 | 4,480 | 100 | 23.3 | 859.2 | 121 | 143 | 21 |
| 835 | N-431 | 5,060 | 100 | 34.3 | 582.3 | 115 | 129 | 15 |
| 836 | N-432 | 5,640 | 100 | 49.3 | 405.6 | 110 | 120 | 10 |
| 837 | N-433 | 6,220 | 100 | 50.3 | 397.6 | 110 | 120 | 10 |
| 838 | N-434 | 6,800 | 100 | 56.2 | 355.7 | 109 | 118 | 9 |
| 839 | N-435 | 7,380 | 100 | 56.5 | 353.9 | 109 | 118 | 9 |
| 840 | N-436 | 7,960 | 100 | 56.8 | 352.3 | 109 | 118 | 9 |
| 841 | N-440 | 7,000 | 100 | 26.8 | 746.9 | 119 | 137 | 19 |
| 842 | N-441 | 7,580 | 100 | 41.2 | 485.3 | 112 | 124 | 12 |
| 843 | N-442 | 8,160 | 100 | 61.3 | 326.5 | 108 | 116 | 8 |
| 844 | N-443 | 8,740 | 100 | 64.3 | 310.9 | 108 | 116 | 8 |
| 845 | N-444 | 9,320 | 100 | 73.7 | 271.2 | 107 | 114 | 7 |
| 846 | N-445 | 9,900 | 100 | 75.7 | 264.1 | 107 | 113 | 7 |
| 847 | N-446 | 10,480 | 100 | 77.5 | 258.1 | 106 | 113 | 6 |
| 848 | N-450 | 6,960 | 100 | 26.7 | 747.9 | 119 | 137 | 19 |
| 849 | N-451 | 7,540 | 100 | 41.1 | 486.1 | 112 | 124 | 12 |
| 850 | N-452 | 8,120 | 100 | 61.1 | 327.2 | 108 | 116 | 8 |

TABLE 39

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 851 | N-453 | 8,700 | 100 | 64.2 | 311.6 | 108 | 116 | 8 |
| 852 | N-454 | 9,280 | 100 | 73.5 | 272.0 | 107 | 114 | 7 |
| 853 | N-455 | 9,860 | 100 | 75.5 | 264.9 | 107 | 113 | 7 |
| 854 | N-456 | 10,440 | 100 | 77.3 | 258.9 | 106 | 113 | 6 |
| 855 | N-460 | 6,360 | 100 | 26.2 | 764.8 | 119 | 138 | 19 |
| 856 | N-461 | 6,940 | 100 | 39.9 | 500.7 | 113 | 125 | 13 |
| 857 | N-462 | 7,520 | 100 | 59.0 | 339.1 | 108 | 117 | 8 |
| 858 | N-463 | 8,100 | 100 | 61.6 | 324.7 | 108 | 116 | 8 |
| 859 | N-464 | 8,680 | 100 | 70.3 | 284.7 | 107 | 114 | 7 |
| 860 | N-465 | 9,260 | 100 | 71.8 | 278.4 | 107 | 114 | 7 |
| 861 | N-466 | 9,840 | 100 | 73.2 | 273.1 | 107 | 114 | 7 |
| 862 | N-470 | 5,360 | 100 | 24.9 | 804.1 | 120 | 140 | 20 |
| 863 | N-471 | 5,940 | 100 | 37.4 | 534.7 | 113 | 127 | 13 |
| 864 | N-472 | 6,520 | 100 | 54.5 | 366.8 | 109 | 118 | 9 |
| 865 | N-473 | 7,100 | 100 | 56.3 | 355.0 | 109 | 118 | 9 |
| 866 | N-474 | 7,680 | 100 | 63.7 | 314.2 | 108 | 116 | 8 |
| 867 | N-475 | 8,260 | 100 | 64.6 | 309.8 | 108 | 115 | 8 |
| 868 | N-476 | 8,840 | 100 | 65.4 | 306.0 | 108 | 115 | 8 |
| 869 | N-480 | 8,360 | 100 | 27.8 | 719.7 | 118 | 136 | 18 |
| 870 | N-481 | 8,940 | 100 | 43.3 | 461.8 | 112 | 123 | 12 |
| 871 | N-482 | 9,520 | 100 | 65.1 | 307.3 | 108 | 115 | 8 |
| 872 | N-483 | 10,100 | 100 | 69.0 | 289.8 | 107 | 114 | 7 |
| 873 | N-484 | 10,680 | 100 | 79.8 | 250.8 | 106 | 113 | 6 |
| 874 | N-485 | 11,260 | 100 | 82.5 | 242.3 | 106 | 112 | 6 |
| 875 | N-486 | 11,840 | 100 | 85.0 | 235.2 | 106 | 112 | 6 |
| 876 | N-490 | 12,360 | 100 | 29.5 | 678.5 | 117 | 134 | 17 |
| 877 | N-491 | 12,940 | 100 | 46.9 | 426.2 | 111 | 121 | 11 |
| 878 | N-492 | 13,520 | 100 | 71.9 | 278.3 | 107 | 114 | 7 |
| 879 | N-493 | 14,100 | 100 | 77.5 | 258.0 | 106 | 113 | 6 |
| 880 | N-494 | 14,680 | 100 | 91.0 | 219.8 | 105 | 111 | 5 |
| 881 | N-495 | 15,260 | 100 | 95.5 | 209.4 | 105 | 110 | 5 |
| 882 | N-496 | 15,840 | 100 | 99.7 | 200.7 | 105 | 110 | 5 |
| 883 | N-500 | 4,640 | 100 | 23.6 | 847.0 | 121 | 142 | 21 |
| 884 | N-501 | 5,220 | 100 | 35.0 | 571.7 | 114 | 129 | 14 |
| 885 | N-502 | 5,800 | 100 | 50.4 | 397.0 | 110 | 120 | 10 |
| 886 | N-503 | 6,380 | 100 | 51.5 | 388.2 | 110 | 119 | 10 |
| 887 | N-504 | 6,960 | 100 | 57.7 | 346.5 | 109 | 117 | 9 |
| 888 | N-505 | 7,540 | 100 | 58.1 | 344.1 | 109 | 117 | 9 |
| 889 | N-506 | 8,120 | 100 | 58.5 | 342.1 | 109 | 117 | 9 |
| 890 | N-510 | 4,920 | 100 | 24.1 | 828.3 | 121 | 141 | 21 |
| 891 | N-511 | 5,500 | 100 | 36.0 | 555.6 | 114 | 128 | 14 |
| 892 | N-512 | 6,080 | 100 | 52.1 | 383.8 | 110 | 119 | 10 |
| 893 | N-513 | 6,660 | 100 | 53.5 | 373.7 | 109 | 119 | 9 |
| 894 | N-514 | 7,240 | 100 | 60.2 | 332.4 | 108 | 117 | 8 |
| 895 | N-515 | 7,820 | 100 | 60.8 | 329.1 | 108 | 116 | 8 |
| 896 | N-516 | 8,400 | 100 | 61.3 | 326.3 | 108 | 116 | 8 |
| 897 | N-520 | 6,160 | 100 | 25.9 | 771.3 | 119 | 139 | 19 |
| 898 | N-521 | 6,740 | 100 | 39.5 | 506.4 | 113 | 125 | 13 |
| 899 | N-522 | 7,320 | 100 | 58.2 | 343.7 | 109 | 117 | 9 |
| 900 | N-523 | 7,900 | 100 | 60.7 | 329.7 | 108 | 116 | 8 |

TABLE 40

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 901 | N-524 | 8,480 | 100 | 69.1 | 289.6 | 107 | 114 | 7 |
| 902 | N-525 | 9,060 | 100 | 70.5 | 283.6 | 107 | 114 | 7 |
| 903 | N-526 | 9,640 | 100 | 71.8 | 278.6 | 107 | 114 | 7 |
| 904 | N-530 | 5,480 | 100 | 25.1 | 798.4 | 120 | 140 | 20 |
| 905 | N-531 | 6,060 | 100 | 37.8 | 529.7 | 113 | 126 | 13 |
| 906 | N-532 | 6,640 | 100 | 55.1 | 362.8 | 109 | 118 | 9 |
| 907 | N-533 | 7,220 | 100 | 57.0 | 350.6 | 109 | 118 | 9 |
| 908 | N-534 | 7,800 | 100 | 64.5 | 309.9 | 108 | 115 | 8 |
| 909 | N-535 | 8,380 | 100 | 65.5 | 305.2 | 108 | 115 | 8 |
| 910 | N-536 | 8,960 | 100 | 66.4 | 301.2 | 108 | 115 | 8 |
| 911 | N-540 | 3,980 | 100 | 22.1 | 906.8 | 123 | 145 | 23 |
| 912 | N-541 | 4,560 | 100 | 32.1 | 623.4 | 116 | 131 | 16 |
| 913 | N-542 | 5,140 | 100 | 45.5 | 439.2 | 111 | 122 | 11 |
| 914 | N-543 | 5,720 | 100 | 46.0 | 434.4 | 111 | 122 | 11 |
| 915 | N-544 | 6,300 | 100 | 51.1 | 391.5 | 110 | 120 | 10 |
| 916 | N-545 | 6,880 | 100 | 51.0 | 391.9 | 110 | 120 | 10 |
| 917 | N-546 | 7,460 | 100 | 51.0 | 392.2 | 110 | 120 | 10 |
| 918 | N-1 | 3,980 | 100 | 20.1 | 299.2 | 117 | 125 | 8 |

TABLE 41

| | Electron transporting substance | | | Electron | Volume | Potential of | Potential of | |
|---|---|---|---|---|---|---|---|---|
| | | Weight- | Content in | mobility of | resistivity of | exposed | exposed | |
| | | average | undercoat | undercoat | undercoat | portion at | portion after | Potential |
| Comparative | | molecular | layer | layer | layer | initial stage | endurance | fluctuation |
| Example | Kind | weight | (mass %) | (×10⁻⁸ cm²/V · sec) | (×10¹⁰ Ω · cm) | (×(−1) V) | (×(−1) V) | ΔVL |
| 1 | D01 | — | 100 | Nd | Nd | Nd | Nd | Nd |
| 2 | D01 | — | 80 | Nd | Nd | Nd | Nd | Nd |
| 3 | D01 | — | 60 | 1.9 | 315.8 | 133 | 264 | 132 |
| 4 | D01 | — | 50 | 1.2 | 416.7 | 152 | 360 | 208 |
| 5 | D01 | — | 45 | 0.8 | 562.5 | 178 | 491 | 313 |
| 6 | D04 | — | 60 | 0.9 | 666.7 | 179 | 457 | 278 |
| 7 | D05 | — | 60 | 1.0 | 600.0 | 173 | 423 | 250 |
| 8 | D06 | 5,300 | 100 | 0.5 | 2,000.0 | 235 | 485 | 250 |
| 9 | D07 | 10,300 | 100 | 0.6 | 1,666.7 | 214 | 423 | 208 |
| 10 | D08 | 11,000 | 100 | 1.2 | 833.3 | 150 | 286 | 136 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-065927, filed Apr. 13, 2023, which is hereby incorporated by reference herein in its entirety.

What is claimed is:

1. An electrophotographic photosensitive member comprising in this order:
a support;
an undercoat layer; and
a photosensitive layer,
wherein the undercoat layer comprises at least one kind of polymer selected from the group consisting of: a polymer having a structural unit represented by the following formula (1); and a polymer having a structural unit represented by the following formula (2): 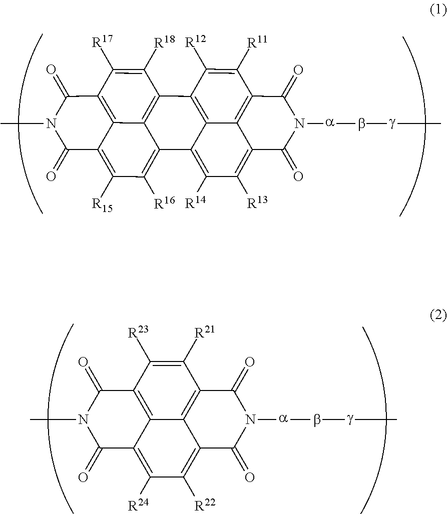
in the formulae (1) and (2),
α, β, and γ represent structures represented by the following formulae (α), (β), and (γ), respectively, and
R¹¹, R¹², R¹³, R¹⁴, R¹⁵, R¹⁶, R¹⁷, R¹⁸, R²¹, R²², R²³, and R²⁴ each independently represent a hydrogen atom, a halogen atom, a nitro group, a cyano group, a trifluoromethyl group, a substituted or unsubstituted alkoxy group, a substituted or unsubstituted thiol group, a substituted or unsubstituted amino group, a substituted or unsubstituted alkyl group, a substituted or unsubstituted alkynyl group, or a substituted or unsubstituted aryl group: 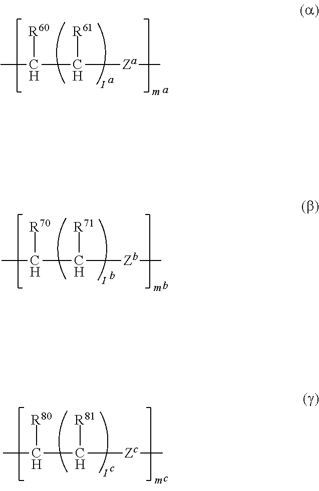
in the formulae (α), (β), and (γ),
R⁶⁰, R⁶¹, R⁷⁰, R⁷¹, R⁸⁰, and R⁸¹ each independently represent a hydrogen atom, a substituted or unsubstituted alkyl group, or a substituted or unsubstituted aryl group,
Z^{a}, Z^{b}, and Z^{c} each independently represent a single bond, an imino group, an oxygen atom, or a sulfur atom,
1^{a}, 1^{b}, and 1^{c} each independently represent an integer of 0 or more,
m^{a} represents an integer of 1 or more,
m^{b} and m^{c} each independently represent an integer of 0 or more,
when Z^{a} represents a single bond, R⁶⁰ represents a substituted or unsubstituted alkyl group,
when Z^{a} represents an imino group or a sulfur atom, R⁶⁰ represents a hydrogen atom, or a substituted or unsubstituted alkyl group,
when Z^{a} represents an oxygen atom, and R⁶⁰ represents a hydrogen atom, m^{a} represents an integer of 2 or more, and
when Z^{a} represents an oxygen atom, and R⁶⁰ represents a substituted or unsubstituted alkyl group, m^{a} represents an integer of 1 or more.

2. The electrophotographic photosensitive member according to claim 1, wherein a content of the at least one kind of polymer selected from the group consisting of: the polymer having the structural unit represented by the formula (1); and the polymer having the structural unit represented by the formula (2) with respect to a total mass of the undercoat layer is 50 mass % or more.

3. The electrophotographic photosensitive member according to claim 1, wherein at least one of R¹¹, R¹², R¹³, R¹⁴, R¹⁵, R¹⁶, R¹⁷, and R¹⁸ in the formula (1), and at least one of R²¹, R²², R²³, and R²⁴ in the formula (2) each independently represent a halogen atom, a nitro group, a cyano group, a trifluoromethyl group, a substituted or unsubstituted alkoxy group having 20 or less carbon atoms, a substituted or unsubstituted thiol group having 20 or less carbon atoms, a substituted or unsubstituted amino group having 20 or less carbon atoms, a substituted or unsubstituted alkyl group having 20 or less carbon atoms, a substituted or unsubstituted alkynyl group having 20 or less carbon atoms, or a substituted or unsubstituted aryl group having 20 or less carbon atoms.

4. The electrophotographic photosensitive member according to claim 1, wherein at least one of R⁶⁰ and R⁶¹ in the formula (α), R⁷⁰ and R⁷¹ in the formula (β), and R⁸⁰ and R⁸¹ in the formula (γ) represents a substituted or unsubstituted alkyl group having 20 or less carbon atoms, or a substituted or unsubstituted aryl group having 20 or less carbon atoms.

5. The electrophotographic photosensitive member according to claim 1, wherein 1^{a} in the formula (α), 1^{b} in the formula (β), and 1^{c} in the formula (γ) each independently represent an integer of 0 to 10.

6. The electrophotographic photosensitive member according to claim 1,
wherein m^{a} in the formula (α) represents an integer of 1 to 40, and
wherein m^{b} in the formula (β) and m^{c} in the formula (Y) each independently represent an integer of 0 to 40.

7. The electrophotographic photosensitive member according to claim 1, wherein R⁶⁰ in the formula (α) represents a substituted or unsubstituted alkyl group having 20 or less carbon atoms.

8. The electrophotographic photosensitive member according to claim 1,
wherein m^{a} in the formula (α) represents an integer of 2 to 30, and
wherein a sum of m^{a} in the formula (α), m^{b} in the formula (β), and m^{c} in the formula (γ) is 3 to 30.

9. The electrophotographic photosensitive member according to claim 1, wherein the at least one kind of polymer selected from the group consisting of: the polymer having the structural unit represented by the formula (1); and the polymer having the structural unit represented by the formula (2) has a weight-average molecular weight of 30,000 or less.

10. The electrophotographic photosensitive member according to claim 1, wherein the undercoat layer has a volume resistivity of 1×10¹⁰Ω·cm or more.

11. A process cartridge comprising:
an electrophotographic photosensitive member; and
at least one unit selected from the group consisting of: a charging unit; a developing unit; and a cleaning unit,
the process cartridge integrally supporting the electrophotographic photosensitive member and the at least one unit, and being detachably attachable to an electrophotographic apparatus,
the electrophotographic photosensitive member comprising in this order:
a support;
an undercoat layer; and
a photosensitive layer,
wherein the undercoat layer comprises at least one kind of polymer selected from the group consisting of: a polymer having a structural unit represented by the following formula (1); and a polymer having a structural unit represented by the following formula (2): 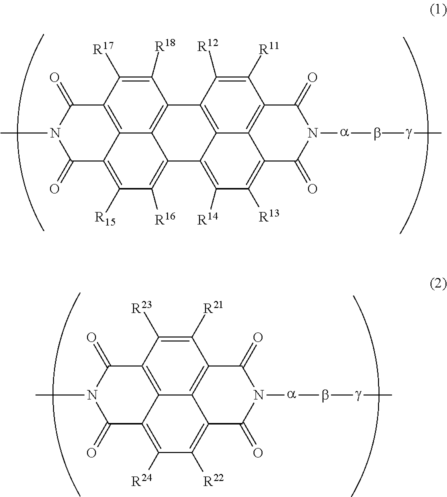
in the formulae (1) and (2),
α, β, and γ represent structures represented by the following formulae (α), (β), and (γ), respectively, and
R¹¹, R¹², R¹³, R¹⁴, R¹⁵, R¹⁶, R¹⁷, R¹⁸, R²¹, R²², R²³, and R²⁴ each independently represent a hydrogen atom, a halogen atom, a nitro group, a cyano group, a trifluoromethyl group, a substituted or unsubstituted alkoxy group, a substituted or unsubstituted thiol group, a substituted or unsubstituted amino group, a substituted or unsubstituted alkyl group, a substituted or unsubstituted alkynyl group, or a substituted or unsubstituted aryl group: 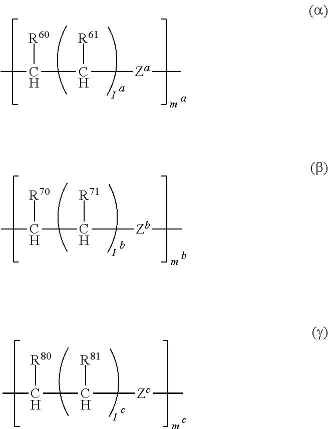
in the formulae (α), (β), and (γ),
R⁶⁰, R⁶¹, R⁷⁰, R⁷¹, R⁸⁰, and R⁸¹ each independently represent a hydrogen atom, a substituted or unsubstituted alkyl group, or a substituted or unsubstituted aryl group, Z^{a}, Z^{b}, and Z^{c} each independently represent a single bond, an imino group, an oxygen atom, or a sulfur atom,
1^{a}, 1^{b}, and 1^{c} each independently represent an integer of 0 or more,
m^{a} represents an integer of 1 or more,
m^{b} and m^{c} each independently represent an integer of 0 or more,
when Z^{a} represents a single bond, R⁶⁰ represents a substituted or unsubstituted alkyl group,
when Z^{a} represents an imino group or a sulfur atom, R⁶⁰ represents a hydrogen atom, or a substituted or unsubstituted alkyl group,
when Z^{a} represents an oxygen atom, and R⁶⁰ represents a hydrogen atom, m^{a} represents an integer of 2 or more, and
when Z^{a} represents an oxygen atom, and R⁶⁰ represents a substituted or unsubstituted alkyl group, m^{a} represents an integer of 1 or more.

12. An electrophotographic apparatus comprising:
an electrophotographic photosensitive member;
a charging unit;
an exposing unit;
a developing unit; and
a transfer unit,
the electrophotographic photosensitive member comprising in this order:
a support;
an undercoat layer; and
a photosensitive layer,
wherein the undercoat layer comprises at least one kind of polymer selected from the group consisting of: a polymer having a structural unit represented by the following formula (1); and a polymer having a structural unit represented by the following formula (2): 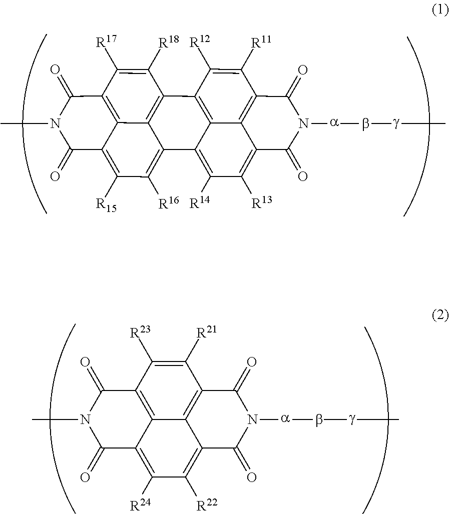
in the formulae (1) and (2),
α, β, and γ represent structures represented by the following formulae (α), (β), and (γ), respectively, and
R¹¹, R¹², R¹³, R¹⁴, R¹⁵, R¹⁶, R¹⁷, R¹⁸, R²¹, R²², R²³, and R²⁴ each independently represent a hydrogen atom, a halogen atom, a nitro group, a cyano group, a trifluoromethyl group, a substituted or unsubstituted alkoxy group, a substituted or unsubstituted thiol group, a substituted or unsubstituted amino group, a substituted or unsubstituted alkyl group, a substituted or unsubstituted alkynyl group, or a substituted or unsubstituted aryl group: 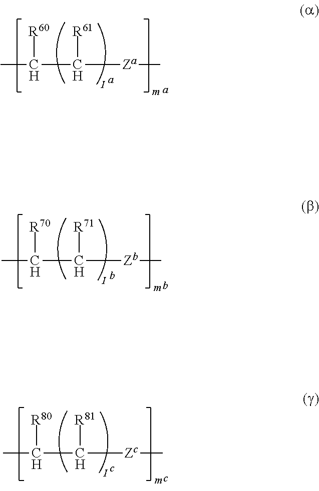
in the formulae (α), (β), and (γ),
R⁶⁰, R⁶¹, R⁷⁰, R⁷¹, R⁸⁰, and R⁸¹ each independently represent a hydrogen atom, a substituted or unsubstituted alkyl group, or a substituted or unsubstituted aryl group,
Z^{a}, Z^{b}, and Z^{c} each independently represent a single bond, an imino group, an oxygen atom, or a sulfur atom,
1^{a}, 1^{b}, and 1^{c} each independently represent an integer of 0 or more,
m^{a} represents an integer of 1 or more,
m^{b} and m^{c} each independently represent an integer of 0 or more,
when Z^{a} represents a single bond, R⁶⁰ represents a substituted or unsubstituted alkyl group,
when Z^{a} represents an imino group or a sulfur atom, R⁶⁰ represents a hydrogen atom, or a substituted or unsubstituted alkyl group,
when Z^{a} represents an oxygen atom, and R⁶⁰ represents a hydrogen atom, m^{a} represents an integer of 2 or more, and
when Z^{a} represents an oxygen atom, and R⁶⁰ represents a substituted or unsubstituted alkyl group, m^{a} represents an integer of 1 or more.
